(19) United States
(12) Patent Application Publication
(10) Pub. No.: US 2024/0104762 A1
(43) Pub. Date: Mar. 28, 2024

(54) Computer Eye (PC Eye)

(71) Applicant: Naoyuki MURAKAMI, Kanagawa (JP)

(72) Inventor: Naoyuki MURAKAMI, Kanagawa (JP)

(21) Appl. No.: 18/276,109

(22) PCT Filed: Mar. 9, 2022
(86) PCT No.: PCT/JP2022/010430

§ 371 Date: Aug. 7, 2023

(30) Foreign Application Priority Data
Feb. 5, 2021 (JP) 2021-017588

(51) Int. Cl. G06T 7/70

(52) U.S. Cl. CPC G06T 7/70

(57) ABSTRACT

The purpose of the present invention is to convert many visual tasks performed by a user to visual tasks for a computer. Learning is carried out from the many visual tasks of a computer. By connecting image recognition photographed by a television camera and a tracking laser distance measuring device to a computer and causing the computer to make visual assessments for image recognition, it is possible to continuously ascertain the development of a moving three-dimensional space, which it turn makes it possible to perform tasks in a space that develops in three dimensions, which was difficult when the visual tasks were performed by a human. For example, in a automobile that acquires parking travel data, an image designated by a tracking television camera system undergoes recognition, and the automobile is made to move in reverse, is made to execute parking travel in the forward direction, and is parked using forward parking travel data while analyzing the distance to the indicated image and the connection to simulated travel.

### FIELD

Computer software, Numerical control technology, Image processing technology, Internet connection technology, Numerical control technology, television camera operation technology, Laser distance measuring device, Interpolation calculation.

### BACKGROUND

Related methods of image recognition, distance measurement and numerical control

### MODE FOR CARRYING OUT THE INVENTION

Development of a numerically controlled laser measuring device and a numerically controlled television camera.

### SUMMARY

Make a recognizable image of a subject on a monitor screen showing a screen photographed by a television camera. Measure the distance of the subject on the monitor screen that shows the screen photographed by the television camera. Recognize the position of an object on a monitor screen showing the screen photographed by a television camera. Recognize the voice of the subject on the monitor screen showing the screen photographed by the television camera. Acquired information is stored and calculated in a computer. By giving the computer eye information, the computer can make the same judgment as a human's visual judgment. It utilizes the computer's excellent visual judgment function by replacing it with human visual judgment. By having computers with eyes and ears, we can obtain infinite possibilities of computers in place of humans.

In place of human's visual judgment, the excellent function of computer visual judgment is used, and changes learning by human visual judgment into learning by computer visual judgment.

EFFECTReplace much of human visual work with computer visual work. Let the computer learn from many visual tasks. By connecting the image recognition photographed by the television camera and the tracking laser distance measuring device to the computer and giving the computer the visual judgment of image recognition. It enables to work in a three-dimensional space, which was previously difficult for human visual work by continuously recognizing the development of the moving three-dimensional space.

### BRIEF DESCRIPTION OF THE DRAWINGS

FIG. 1 is an explanatory diagram of a tracking television camera system that is attached to an automobile for acquiring automatic driving data and that is manually parked by a driver familiar with driving the automobile to acquire parking driving operation data.

FIG. 2 is an explanatory diagram of the image recognition by the tracking television camera system, analyzing the distance between the image and the recognized image, and acquiring forward parking driving data while the automobile parked facing forward to the parking lot.

FIG. 3 is an explanatory diagram of the image recognition by the tracking television camera system, analyzing the distance between the image and the recognized image, and acquiring backward parking driving data while the automobile parked backwards to the parking lot.

FIG. 4 is an explanatory diagram of the image recognition by the tracking television camera system, analyzing the distance between the image and the recognized image, and acquiring backward parking driving data while the automobile parked backwards to the parking lot.

FIG. 5 is an explanatory diagram of acquiring forward parking driving data by recognizing an instructed image by the tracking television camera system and measuring the distance from the instructed image while the automobile parks backward.

FIG. 6 is an explanatory diagram of acquiring backward parking driving data by recognizing an instructed image by the tracking television camera system and measuring the distance from the instructed image while the automobile parks forward.

FIG. 7 is an explanatory diagram of acquiring forward parking driving data by recognizing an instructed image by the tracking television camera system and measuring the distance from the instructed image while the automobile parks forward.

FIG. 8 is an explanatory diagram showing that an automobile having driving data for parking drives forward into the parking range and parks by backward parking driving data with recognizing an image instructed by a tracking television camera system and analyzing the distance from the instructed image.

FIG. 9 is an explanatory diagram showing that an automobile having driving data for parking corrects the parking running position in running forward and parks by backward parking driving data with analyzing the by image recognition of a tracking television camera system and distance of the recognized image.

FIG. 10 is an explanatory diagram of an automobile for which parking travel data is acquired, the image instructed by the tracking television camera system is recognized, the automobile is reversed, the vehicle is parked forward, and the vehicle is parked using the forward parking travel data while analyzing the distance to the instructed image and the connection with the simulation running.

FIG. 11 is an explanatory diagram showing that an automobile drives backward to the parking position with analyzing recognized image by a tracking television camera system and the distance between images of automobiles recognized by using forward parking data and parks in a public parking lot.

FIG. 12 is an explanatory diagram showing that an automobile drives forward to park with recognizing indicated image by a tracking television camera system and analyzing the distance of the indicated image by using backward parking data and parks in a public parking lot.

FIG. 13 is an explanatory diagram showing that an automobile drives backward to a position to enable backward simulation drive with recognizing indicated image by a tracking television camera system and analyzing the distance of the indicated image by using backward parking data and parks in a public parking lot.

FIG. 14 is an explanatory diagram showing that an automobile drives forward to a range to enable forward simulation drive with recognizing indicated image by a tracking television camera system and analyzing the distance of the indicated image by using backward parking data and drives to range of parking data and parks by forward simulation drive in a public parking lot.

FIG. 15 is an explanatory diagram showing that an automobile in a public parking lot parks by using forward parking data while recognizing an instructed image by a tracking television camera system and analyzing the distance from the instructed image.

FIG. 16 and FIG. 173 are diagrams showing that an automobile in a public parking lot parks by using forward parking data with recognizing an image instructed by a tracking television camera system, displaying the result of recognition, analyzing the distance from the instructed image, and informing that the recognition is performed.

FIG. 17 is an explanatory diagram showing that an automobile in a public parking lot measures the distance between parked automobiles from the shape recognized by the tracking television camera system, travels to a parkable position, and parks with analyzing the distance from the image-recognized shape by using backward parking data.

FIG. 18 is an explanatory diagram showing that an automobile in a public parking lot measures the distance between parked automobiles from the shape recognized by the tracking television camera system and parks with analyzing the distance from the image-recognized shape by using forward parking data.

FIG. 19 is an explanatory diagram showing that an automobile in a public parking lot measures the distance between parked automobiles from the shape recognized by the tracking television camera system and parks with analyzing the distance from the image-recognized shape by using backward parking data.

FIG. 20 is an explanatory diagram for acquiring stop data for avoiding a collision with a subject. Specifically, FIG. 20 shows that an automobile stops in front of the subject by manual operation from several distances on the avoidance data acquisition road, acquire the driving numerical value of the driving device driven by the stop operation, and acquires driving numerical values of driving equipment for stop driving from all distances by an interpolation calculation method.

FIG. 21 is an explanatory diagram showing that a tracking television camera system acquires avoidance driving data for a collision avoidance driving method by image recognition and distance measurement.

FIG. 22 is an explanatory diagram for acquiring data of avoidance driving in which the automobile is driven with maximum avoidance driving operation in order to acquire data of maximum avoidance driving.

FIG. 23 is a diagram showing data acquisition positions in data acquisition travel of avoidance driving. Specifically, FIG. 23 shows that the data acquisition driving of avoidance driving acquires avoidance driving data that continues to drive with maximum avoidance driving operation in order to obtain maximum avoidance driving data.

FIG. 24 is an explanatory diagram for measuring the distance at which it is determined that avoidance driving is to be performed in manual driving, the driving data acquisition position for acquiring from start position of the avoidance position to the position at which avoidance driving, and the driving position.

FIG. 25 is an explanatory diagram of the distance at which avoidance driving in manual operation was determined and the distance at which avoidance driving was started in avoidance driving data acquisition driving.

FIG. 26 is an explanatory diagram of the distance at which avoidance driving in manual operation was determined and the distance at which avoidance driving was started in avoidance driving data acquisition driving.

FIG. 27 is an explanatory diagram of the distance at which avoidance driving in manual operation was determined and the distance at which avoidance driving was started in avoidance driving data acquisition driving.

FIG. 28 is an explanatory diagram of the distance at which avoidance driving in manual operation was determined and the distance at which avoidance driving was started in avoidance driving data acquisition driving.

FIG. 29 is an explanatory diagram of the distance at which avoidance driving in manual operation was determined and the distance at which avoidance driving was started in avoidance driving data acquisition driving.

FIG. 30 is an explanatory diagram of the distance at which avoidance driving in manual operation was determined and the distance at which avoidance driving was started in avoidance driving data acquisition driving.

FIG. 31 is an explanatory diagram of the distance at which the maximum avoidance driving in manual driving was determined and the distance at which the maximum avoidance driving was started in avoidance driving data acquisition driving.

FIG. 32 is an explanatory diagram for acquiring manual driving data for avoidance driving data acquisition driving that does not make pedestrians feel dangerous at different running speeds.

FIG. 33 is an explanatory diagram of acquisition of accident avoidance driving data by manual driving on the traveling road A in avoidance driving data acquisition driving.

FIG. 34 is an explanatory diagram of acquisition of accident avoidance driving data by manual driving on a traveling road B in avoidance driving data acquisition driving.

FIG. 35 is an explanatory diagram of acquisition of accident avoidance driving data by manual driving on a traveling road C in avoidance driving data acquisition driving.

FIG. 36 is an explanatory diagram of acquisition of accident avoidance driving data by manual driving on a traveling road D in avoidance driving data acquisition driving.

FIG. 37 is an explanatory diagram of acquisition of accident avoidance driving data by manual driving on the traveling road E in avoidance driving data acquisition driving.

FIG. 38 is an explanatory diagram of acquisition of accident avoidance driving data by manual driving on a traveling road F in avoidance driving data acquisition driving.

FIG. 39 is an explanatory view of acquisition of accident avoidance driving data by manual driving on all traveling roads in avoidance driving data acquisition driving.

FIG. 40 is an explanatory diagram for acquiring accident avoidance driving data by driving for each traveling speed in avoidance driving data acquisition driving with an automobile traveling from the right.

FIG. 41 is an explanatory diagram showing the automobile with the tracking television camera system which is attached a television camera with a wide angle of view on the front of the automobile. FIG. 41 shows that the automobile aims the tracking laser distance measuring device and the tracking television camera of the tracking television camera system in the direction of the position of the detected subject in the wide photographing range, identifies the subject recognized in the image, and avoid an accident by the accident avoidance driving data.

FIG. 42 is an explanatory diagram showing that an automobile installed the tracking television camera system in different positions on the front of the automobile identifies the horizontal direction of the running sound by the phase difference of the running sound of the microphone, directs the tracking laser distance measuring device and the numerical control television camera toward the specified direction, measures the distance, recognizes the running automobile and drives to avoid accidents to corresponds to the advancing automobile by using accident avoidance driving data.

FIG. 43 is an explanatory diagram showing an automobile driving by the accident avoidance driving data. The automobile has the tracking television camera system of the pixel distance measurement tracking television cameras on the front and rear positions. The automobile drives with the tracking television camera system and acquire the avoidance driving data.

FIG. 44 is an explanatory diagram for acquiring overtaking data by manual operation on all traveling roads in overtaking data acquisition operation.

FIG. 45 is an explanatory diagram of automatic driving by an automobile equipped with a tracking television camera system that acquires accident avoidance data on a general driving road.

FIG. 46 is an explanatory diagram of measuring the distance of the width of a parked automobile using an image acquired by image recognition to determine whether there is room for passage at the position of the traveling road by an automobile equipped with a tracking television camera system that acquires accident avoidance data on a general driving road.

FIG. 47 is an explanatory diagram of automatic driving that calculates preparations for avoidance by an automobile equipped with a tracking television camera system that acquires accident avoidance data on a general driving road.

FIG. 48 is an explanatory diagram of automatic driving for prediction of avoidance by an automobile equipped with a tracking television camera system that acquires accident avoidance data on a general driving road.

FIG. 49 is an explanatory diagram of automatic driving for maximally predicting accident avoidance by an automobile equipped with a tracking television camera system that acquires accident avoidance data on a general driving road.

FIG. 50 is an explanatory diagram of automatic avoidance driving by an automobile equipped with a tracking television camera system that acquires accident avoidance data on a general driving road.

FIG. 51 is an explanatory diagram of maximum avoidance automatic driving by an automobile equipped with a tracking television camera system that acquires accident avoidance data on a general driving road.

FIG. 52 is an explanatory diagram of automatic driving by an automobile equipped with a tracking television camera system that acquires accident avoidance data on a general driving road. The automobile scans a dark object that is difficult for the television camera to recognize as an image with a tracking laser distance measuring device at night, photographs the subject at the angle of view and focal length, recognizes the image, and responds.

FIG. 53 is an explanatory diagram of automatic driving to perform image recognition of only unique things around the road and add to the driving position of GPS location information to the memory by an automobile equipped with a tracking television camera system that acquires accident avoidance data on a general driving road.

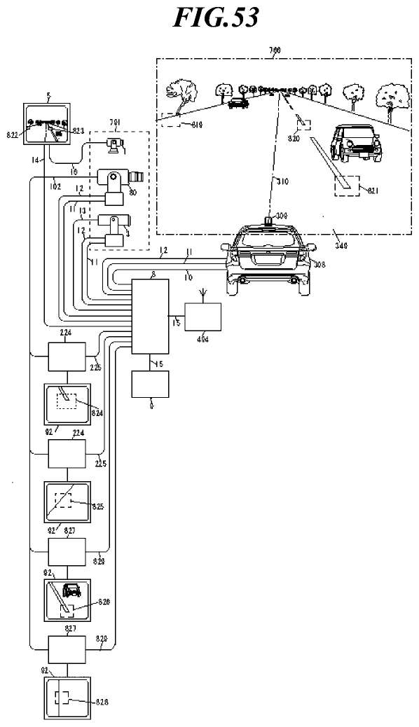

FIG. 54 is an explanatory diagram of driving by an automobile equipped with a tracking television camera system that acquires accident avoidance data on a general driving road. The automobile calculates the obstacles recognized by the image of the television camera, deploys them at the tire positions, and avoids the obstacles while driving.

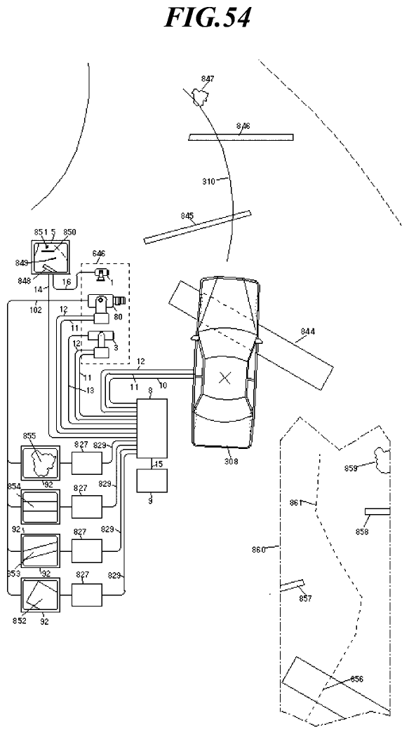

FIG. 55 is an explanatory diagram of driving by an automobile equipped with a tracking television camera system that acquires accident avoidance data on a general driving road. The automobile develops the obstacle recognized by the image of the television camera in accordance with the travel, deploys the obstacle at the calculated tire position, and travels without avoiding the obstacle.

FIG. 56 is an explanatory diagram of driving by an automobile equipped with a tracking television camera system that acquires accident avoidance data on a general driving road. The automobile recognizes and stores images of obstacles ahead of the road that are photographed by the television camera. Assuming that the automobile travels to an obstacle, based on the position of the front wheel tire of the automobile contacting the obstacle and the image of the obstacle in its direction and distance, with the position of the stored image changed, the automobile analyzes the impact received by the front tires of the automobile in advance. The automobile then pre-adjusts the suspension to accommodate the impact.

FIG. 57 is an explanatory diagram showing that a four-legged walking robot equipped with a tracking television camera system that acquires accident avoidance data on a walking path with obstacles. The four-legged walking robot detects an obstacle ahead of the walking path photographed by the television camera, recognizes and stores the obstacle. The robot walks on its four legs so that the four legs do not come into contact with the obstacle at the position where the image of the memory is developed.

FIG. 58 is an explanatory diagram showing that a four-legged walking robot equipped with a tracking television camera system that acquires accident avoidance data on a walking path with obstacles. The four-legged walking robot analyzes the image in advance and develops the images to avoid contact with the step by the four legs from the memorized image of the step.

FIG. 59 is an explanatory diagram showing that an automobile travels by the tracking television camera system that acquires driving data and accident avoidance data, always analyzes the image recognition by the tracking television camera system and the distance between the recognized image and the image.

FIG. 60 is an explanatory diagram showing that an automobile travels by the tracking television camera system that acquires data performs the best avoidance driving at the time of avoidance since the automobile always analyzes the distance between the image recognition by the tracking television camera system and the recognized images in traveling.

FIG. 61 is an explanatory diagram showing that an automobile travels by the tracking television camera system that acquires data selects the best avoidance driving at the time of avoidance since the automobile always analyzes the distance between the recognized images in traveling and the image recognition by the tracking television camera system.

FIG. 62 is an explanatory diagram showing that an automobile travels by the tracking television camera system that acquires data continues to perform the best avoidance driving at the driving by using avoidance data with analyzing the distance between the image recognition by the tracking television camera system and the recognized images in traveling.

FIG. 63 is an explanatory diagram showing that an automobile travels by the tracking television camera system that acquires data and it runs while always analyzing the distance between the image recognized by the tracking television camera system and the image recognized by the image recognition, and calculates the means for accident avoidance.

FIG. 64 is an explanatory diagram showing that an automobile travels by the tracking television camera system that acquires data and it runs while always analyzing the distance between the image recognized by the tracking television camera system and the image recognized by the image recognition, and measures the width of the road ahead.

FIG. 65 is an explanatory diagram showing that an automobile travels by the tracking television camera system that acquires data and it runs while always analyzing the distance between the image recognized by the tracking television camera system and the image recognized by the image recognition, and measures the width of the oncoming automobile and the traveling road ahead

FIG. 66 is an explanatory diagram showing that an automobile travels by the tracking television camera system that acquires data and it runs in a road dedicated to automobiles, stores the distance between the image recognition of the preceding automobile and the image recognized by the image recognition, develops at the running position, and follows the automobile.

FIG. 67 is an explanatory diagram showing that an automobile travels by the tracking television camera system that acquires data and it runs in a road dedicated to automobiles and always follows a preceding automobile while measuring the distance between the image recognition of the preceding automobile and the image recognized by the tracking television camera system.

FIG. 68 is an explanatory diagram showing that an automobile checks the image of unique objects in the vicinity of the driving road in order to correct the GPS position information as an auxiliary device on the driving road of the automobile. Furthermore, the automobile supplements the GPS position information with the direction of the driving route by associating the distance and direction to the unique object with the GPS position information.

FIG. 68 is an explanatory diagram showing that an automobile calculates the distance between the automobile and the curb at the position where the automobile has traveled the distance from the direction and distance of the curb on the traveling road, and calculates the traveling position of the automobile.

FIG. 70 is an explanatory diagram for intensively checking the image of the preceding automobile in the direction in which the automobile is traveling, confirming that there is no approaching automobile in the opposite lane, and overtaking based on overtaking driving data.

FIG. 71 is an explanatory measuring the distance of the working position of the robot with a tracking laser distance measuring device.

FIG. 72 is an explanatory diagram of capturing an image of a robot's working position with a tracking television camera.

FIG. 73 is an explanatory diagram showing an image of the robot's working position and measuring the distance with a tracking laser distance measuring device and a tracking television camera.

FIG. 74 is an explanatory diagram showing the robot's working position on the fixed television camera monitor screen photographed by a fixed television camera, the image of the robot's working position and the distance measured by the tracking laser distance measuring device and the tracking television camera, and the working position is recognized as an image.

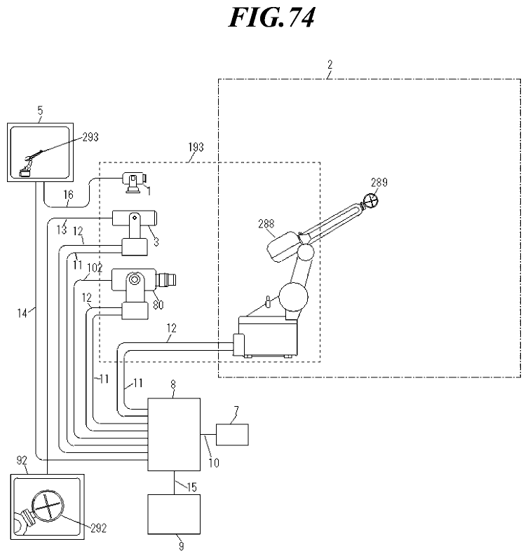

FIG. 75 is an explanatory diagram showing the LED light emitting element at the position of the image element where the image of the image element is detected is emitted, the time of the displayed light from the image is measured, and the distance is calculated in the measuring the distance measured by the television camera distance measuring device by the image element.

FIG. 76 is an explanatory diagram showing that the LED light emitting element emits light to irradiate the working position of the robot with parallel light and the field angle and focal length of the image element are adjusted, and is photographed With the measured distance of the reflected light by a tracking television camera of the image element.

FIG. 77 is an explanatory diagram showing a tracking television camera tracks and photographs workers working near the robot's working position. The image of the worker is recognized by the image photographed by the tracking television camera, and the distance to the worker is measured. As a result, the position of the worker senses that the worker has approached the working position of the robot, and causes the robot to work at a position at a distance that avoids contact with the worker.

FIG. 78 is an explanatory diagram showing the work operation of the robot by displaying the measured distance on the screen of the tracking television camera monitor after measuring the distance of the work position of the robot.

FIG. 79 is an explanatory diagram showing a pixel measurement television camera distance measuring device that measures the distance of the robot's working position, adjusts the angle of view and focal length of the image element tracking television camera based on the measurement direction and distance, and the work position photographed by the robot on the monitor screen of the tracking television camera and the image photographed by the image element tracking television camera are recognized.

FIG. 80 is an explanatory diagram showing the work of several driving mechanisms of the robot is photographed with a television camera, and the working position of several driving mechanisms of the robot is displayed on several television camera monitor screens, and the distance of the working position of several driving mechanisms are measured by a tracking laser distance measuring device. The work of the robot, which measures the distance of the working position of the robot, is displayed on the screens of several fixed television camera monitors, and the work of several drive mechanisms of the robot is displayed via the Internet on several fixed televisions. On the screen of the camera monitor, the work operation of several drive mechanisms of the robot is performed.

FIG. 81 is an explanatory diagram showing some television cameras photograph the work of some of the robot's drive mechanisms. The images are displayed on the television camera monitor screen, and the images are displayed respectively, and the working positions of several driving mechanisms of the robot are measured by a tracking laser distance measuring device. The work of the robot whose distance to the working position of the robot is measured is performed on the screens of the fixed television camera monitors, and the work of several driving mechanisms of the robot is performed. The operations of the robot of several drive mechanisms are performed on the screen of some fixed television camera monitors via the Internet.

FIG. 82 is an explanatory diagram showing a tracking laser distance measuring device measures the distance of a subject on a fixed television camera monitor screen. After confirming the image of the subject photographed by the tracking television camera at the angle of view and focal length corresponding to the measured distance, the numerically controlled robot equipped with a barcode reader is moved to the position of the subject confirmed by the image. The robot reads the barcode attached on the subject which has the image of the barcode.

FIG. 83 is an explanatory diagram showing shaped objects are detected on the screen of a fixed television camera monitor, and the distance of the detected position is measured with a laser distance measuring device. The object is photographed at the detected position where the distance is measured by a tracking television camera by adjusting the angle of view and the focal length to the measured distance. The description of the image information display is image-recognized in the image of the shaped object on the photographed television camera monitor screen, and the numerically controlled television camera attached to the numerically controlled robot reads the displayed information of the shaped object.

FIG. 84 is an explanatory diagram showing the work position of the robot is confirmed on the fixed television camera monitor screen, and the distance of the work position is measured with a tracking laser distance measuring device. The 2D screen display of the photographing direction of the fixed television camera and the 3D screen display with the measured distance is displayed.

FIG. 85 is an explanatory diagram showing the working position of the robot on the fixed television camera monitor screen is set on the screen photographed by another television camera associated with the fixed television camera, and the robot works in the working position.

FIG. 86 is an explanatory diagram showing the working position of the robot is confirmed on the fixed television camera monitor screen, and the distance of the working position is measured with multiple tracking laser distance measuring devices, and the highly accurate working position of the robot is measured.

FIG. 87 is an explanatory diagram showing the working position of the robot is confirmed on the fixed television camera monitor screen, and the image is confirmed and the distance is measured by the pixel measurement television camera distance measuring device attached to the working position.

FIG. 88 is an explanatory diagram showing the welding work by a robot. The space for welding work is built into a common frame, and each time the image is confirmed by a tracking television camera, the confirmed image is measured by a tracking laser distance measuring device, and the space for welding work is the measured space.

FIG. 89 is an explanatory diagram showing the welding support robot brings the processed material A into the welding work space, and assists the image confirmation work of the processed material A, the measurement of the processed material A, and the appropriate shape confirmation by the welding support robot.

FIG. 90 is an explanatory diagram showing work material A is placed on the workbench since the welding work space is a measured space. The image is confirmed by the tracking television camera of processed material A again installed on the workbench, and is measured by the tracking laser distance measuring device.

FIG. 91 is an explanatory diagram showing the welding support robot brings processed material B into the welding work space. The welding support robot checks the image of processed material B, and measures processed material B, and deploys them at appropriate positions.

FIG. 92 is an explanatory diagram showing temporarily place processed material A on processed material B, the image is checked by a tracking television camera, and is measured with a tracking laser distance measuring device.

FIG. 93 is an explanatory diagram showing point welding for fixing processed material A to processed material B, confirming the image of the point with a tracking television camera, and the point welding while measuring is executed with a tracking laser distance measuring device.

FIG. 94 is an explanatory diagram showing the image is confirmed with a tracking television camera after point welding, and measured with a tracking laser distance measuring device.

FIG. 95 is an explanatory diagram showing welding processed material A to processed material B, confirming the image of the welding point with a tracking television camera and welding while measuring with a tracking laser distance measuring device.

FIG. 96 is an explanatory diagram showing the image is confirmed with a tracking television camera after point welding, and measured with a tracking laser distance measuring device.

FIG. 97 is an explanatory diagram showing the welding support robot lifts the finished product that has been welded in the space of the welding work by the welding support robot, and performs the image confirmation work of the finished product and the measurement of the finished product at the optimum position for each.

FIG. 98 is an explanatory diagram showing the welding support robot brings the finished product that has been welded into the welding work space by the welding support robot, and the welding support robot performs the image confirmation work of the finished product and the measurement of the finished product at the optimum position for each.

FIG. 99 is an explanatory diagram showing the welding work by the robot on a movable stand. The space for welding work is built into a common movable stand, and each time the image is confirmed by a tracking television camera, the confirmed image is measured by a tracking laser distance measuring device, and the space for the welding work by the movable stand is the space measured each time.

FIG. 100 is an explanatory diagram showing a drone flying over the sky is photographed with a fixed television camera, and a tracking television camera equipped with a laser distance measuring device is directed in the direction corresponding to the position on the fixed television camera monitor screen. Image recognition of the reflection mirror for distance measurement attached to the drone, photographed by the tracking television camera at the angle of view and focal length according to the distance measured by the laser distance measuring device. The position of the distance measuring displaying mirror image-recognized is the position of the laser distance measuring device as the measured distance.

FIG. 101 is an explanatory diagram showing the operation of the tracking television camera to photograph the distance measuring reflection mirror attached to the drone flying in the sky, and directing the tracking laser distance measuring device to the direction of recognizing the image of the mirror to measure the distance of the drone in the sky.

FIG. 102 is an explanatory diagram showing simultaneously measuring the distances of three distance measuring reflectors attached to three drones in the sky from three known positions and one unknown position, the three distance measuring reflectors can measure unknown positions by associating with known positions.

FIG. 103 is an explanatory diagram showing a tracking television camera distance measurement system measures the light emission time of the light source attached to the drone at three known positions and one unknown position, associates the unknown position with the known position, and measure an unknown position by measuring at different drone positions.

FIG. 104 is an explanatory diagram showing measuring the distances of the distance measurement reflectors attached to the drone from three known positions by simultaneously, the position of the distance measurement automobile that simultaneously measures the distances of the distance measurement reflectors can be calculated. Consecutively, the position of the distance measurement automobile can be associated with known locations.

FIG. 105 is an explanatory diagram showing the angle of view and focus of the tracking television camera are adjusted according to the distance measured by the laser distance measuring device by directing to the direction corresponding to the position of the windsurfer on the television camera monitor screen. The television camera monitor screen displays a wide-angle image photographed by a tracking television camera fitted with a laser distance measuring device built into the drone.

FIG. 106 is an explanatory diagram showing a numerically controlled television camera, a tracking television camera, and a tracking laser distance measuring device are installed in a drone equipped with a communication function that flies in the sky. The position of the windsurfer is indicated on the television camera monitor screen, which displays the image photographed by the numerical television camera. Turn the tracking television camera and tracking laser distance measuring device to the direction corresponding to the instructions on the screen, and it recognizes the windsurfer at the distance measured by the tracking laser distance measuring device, with the angle of view and focal length of the tracking television camera to track and photograph windsurfers.

FIG. 107 is an explanatory diagram showing measure the irradiation position and the known position of the visible light laser irradiated by the drone from the sky, and correct the position of the drone from the sky.

FIG. 108 is an explanatory diagram showing simultaneously measurement of the distance of the distance measurement reflection mirror attached to the drone flying in the sky from three known positions is performed. The traveling position and traveling direction of the distance measuring automobile for simultaneously measuring the distance of the distance measuring displaying mirror can be made known. The absolute position information is stored, transmitted to the Internet, received, and shared in order to share the position information of the object whose image is recognized from the distance measurement automobile with all traveling automobiles.

FIG. 109 is an explanatory diagram showing measurement of the positions of multiple drones flying over sky from multiple known locations and a moving automobile. the surroundings of the road are measured by the running car and the traveling direction of the road and the positions of things around the road are measured.

FIG. 110 is an explanatory diagram showing measure the position and direction of a drone flying above from a moving distance measurement automobile with a tracking television camera distance measurement system. The distance and direction from the automobile for distance measurement to the automobile to be measured are measured by measuring the distance and direction of the automobile to be measured by the tracking television camera distance measurement system.

FIG. 111 is an explanatory diagram showing a tracking television camera equipped with a laser distance measuring device tracks and photographs an image detected on a fixed television camera monitor screen from an image of an object photographed by the fixed television camera in a direction corresponding to the position. The tracking television camera photographs a subject whose image can be confirmed at an angle of view and a focal length corresponding to the distance measured by the laser distance measuring device.

FIG. 112 is an explanatory diagram showing numerically controlled television cameras are respectively caused to track and photographed in a direction corresponding to the display position of some images on the fixed television camera monitor screen where some images are detected from the photographed screen of the fixed television camera. The tracking television camera is caused to track to the direction corresponding to the position where the image is displayed, and personal image information is acquired by measuring distance measured by the tracking laser distance measuring device attached to the tracking television camera.

FIG. 113 is an explanatory diagram showing the subject is measured from changes in distance and measurement position by scanning by multiple tracking laser distance measuring devices, the tracking television camera is tracked in that direction, and personal image information is acquired from the image taken by adjusting the angle of view and focus on the distance measured by the tracking laser distance measuring device.

FIG. 114 is an explanatory diagram showing a tracking laser distance measuring device measures a moving subject from changes in distance and measurement position, a tracking television camera tracks it, and an image photographed according to the distance measured by the tracking laser distance measuring device is confirmed and personal image information is acquired from the image via Internet.

FIG. 115 is an explanatory diagram showing the tracking television camera equipped with the tracking laser distance measuring device tracks and photographs to the direction corresponding to the position of the image on the fixed television camera monitor screen that detected the image from the image photographed by the fixed television camera. At the distance measured by this tracking laser distance measuring device, the image photographed by the tracking television camera is acquired via the Internet, and the image information of a plurality of individuals is acquired, and the tracking television camera is used to photograph again.

FIG. 116 is an explanatory diagram showing the tracking television camera is equipped with a tracking laser distance measuring device for different photographing directions. From the image photographed by the fixed television camera, the tracking television camera tracks and photographs to the direction corresponding to the position where the image on the fixed television camera monitor screen whose image has been confirmed is detected, and acquires the image information of the individual whose image has been photographed in multiple directions.

FIG. 117 is an explanatory diagram showing from the image photographed by the fixed pixel tracking television camera, direct the tracking laser distance measuring device toward the direction corresponding to the position where the image on the fixed pixel tracking television camera monitor screen image was detected, measures the distance, and photographs the image with focusing on the range of the element. The position of the confirmed image is transmitted to several pixel tracking television systems that photographs from different directions, each pixel tracking television system measures the distance, and photographs by focusing on the range of the image sensor.

FIG. 118 is an explanatory diagram showing a measuring device with laser distance measurement and data reading functions is aimed in the direction of the position of the image detected on the monitor screen photographed by a fixed television camera, and the distance near the data display of the image of the subject is measured, read at the light collection and scanning speed corresponding to the measurement distance.

FIG. 119 is an explanatory diagram showing a measuring device with the function of tracking laser distance measurement and data reading and equipment for the reading range of the data reader with the function of a tracking television camera are installed. The data display distance is measured for the position of the data display image on the television camera monitor screen photographed by the tracking television camera at a wide angle. In accordance with this measured distance, reading the data display of the position of the image confirmed by the image photographed at a narrow angle by the tracking television camera is performed.

FIG. 120 is an explanatory diagram showing regarding the reading range of the data reader, a measuring instrument with functions of pixel tracking television camera, tracking laser distance measurement and data reading is installed. Measure the position of the data display image on the television camera monitor screen photographed by the pixel tracking television camera, measure the distance near the data display, and read the data display.

FIG. 121 is an explanatory diagram showing the data display is decoded by directing the tracking data reader and laser distance measuring device toward the direction corresponding to the position of the subject on the fixed television camera monitor screen. At the same time photographs from each direction, the image photographed by the tracking television camera and the image of the fixed television camera is stored in association with the data display.

FIG. 122 is an explanatory diagram showing a tracking laser distance measurement and a tracking television camera are directed to the position where the image on the fixed television camera monitor screen is detected, and the image photographed by the tracking television camera is image-recognized according to the distance measured by the tracking laser distance device. Decoding the data display based on the distance measured by the laser distance measuring device is performed by directing the data reader and laser distance measuring device attached to the robot toward the position where the image was detected on the fixed television camera monitor screen. The image photographed by the tracking television camera, the image recognition, and the image of the fixed television camera are stored in association with the data display.

FIG. 123 is an explanatory diagram showing the working machine of the robot is brought close to the position of the shaped object held by the worker on the fixed television camera monitor screen, and the television camera and tracking laser distance measuring device attached to the robot recognize the shaped object held by the worker. The work of the image information of the shaped object is performed as the work of the robot.

FIG. 124 is an explanatory diagram showing the working machine of the robot is brought close to the position of the hand of the worker on the fixed television camera monitor screen, and the television camera and tracking laser distance measuring device attached to the robot recognize the hand of the worker. The work of the image information of the hand is performed as the work of the robot.

FIG. 125 is an explanatory diagram showing the image of the runway photographed by the fixed television camera is measured by the tracking laser distance measuring device, and the image is recognized by the tracking television camera with a tracking television camera system attached to a small aircraft when landing on the runway. The landing attitude of the small aircraft is calculated from the image-recognized position and the distance, and it is handled by manual control or automatic control.

FIG. 126 is an explanatory diagram showing images are taken from the side of the runway of an airfield for small aircraft with a tracking television camera system. A fixed television camera detects an image of a small aircraft on the runway in preparation for landing. The image photographed by the tracking television camera to the direction corresponding to the detected position is analyzed and associated with the driving numerical value of the tracking television camera to correct the driving maneuver numerical value of the small aircraft.

FIG. 127 is an explanatory diagram showing a fixed television camera detects an image of a small aircraft ready to land on the runway from the front side of the runway of an airfield for small aircraft, and the tracking television camera and tracking laser distance measuring device are directed to the direction corresponding to the detected position. Comparing the driving numerical value of the tracking television camera for photographing with the driving numerical value of the tracking television camera acquired by image recognition in advance, and correcting the driving numerical value of the small airplane like correcting the driving numerical value of the tracking television camera.

FIG. 128 is an explanatory diagram showing the tracking laser distance measuring device is directed to the position corresponding to the position of the screen of the other ship, which is photographed by the fixed television camera and detected by the fixed television camera monitor screen by the tracking television camera system attached to the ship. The distance to the other ship whose image is detected is measured, and the image of the other ship whose image is detected is photographed by a tracking television camera, and the image is recognized.

FIG. 129 is an explanatory diagram showing the tracking laser distance measuring device is directed to the direction corresponding to the position of the fixed television camera monitor screen, which is photographed by the fixed television camera and detected by the fixed television camera monitor screen in the tracking television camera system attached to the ship. Measure the distance to the cruiser boat detected by the image. By continuously measuring and photographing the images of the cruiser boat, the traveling direction and traveling position of the cruiser boat can be predicted, and if a collision is predicted, the collision avoidance operation of the ship can be performed.

FIG. 130 is an explanatory diagram showing a tracking television camera distance measurement system attached to a ship detects images on the monitor screen of the numerically controlled television camera in a wide area of the sea photographed by the numerically controlled television camera. A tracking laser distance measuring device is directed to the position on the numerically controlled television camera monitor screen and the direction of the driving numerical value of the numerically controlled television camera, and the distance to the ship detected by image detection is measured. The image of the ship photographed by the tracking television camera at the measured distance is displayed on the monitor screen that is synthesized by superimposing the image at the position of the direction and distance on the fixed television camera monitor screen and the numerical control television camera monitor screen.

FIG. 131 is an explanatory diagram showing a tracking television camera is directed to the direction and distance of a subject detected by a radar detector attached to a ship, and the detected subject is continuously photographed and monitored at an angle of view and focal length corresponding to that distance.

FIG. 132 is an explanatory diagram showing the tracking laser distance measuring device and the tracking television camera are directed to the direction of the position of the other ship's screen, which is photographed by the fixed television camera and detected on the fixed television camera monitor screen with the tracking television camera distance measurement system attached to the ship. The distance to other ships is measured by recognizing the image photographed by the tracking television camera. Each ship that has been image-recognized is combined with a screen showing the direction of travel with the distance expanded.

FIG. 133 is an explanatory diagram showing a baseball player is photographed simultaneously by a plurality of mirror-tracking television cameras by the method of tracking distance measurement, and the batting form is confirmed.

FIG. 134 is an explanatory diagram showing the skater's skating position is photographed according to the skater's running direction and distance by the position on the fixed television camera monitor screen that shows the skater and the distance measured by the tracking laser distance measuring device.

FIG. 135 is an explanatory diagram showing image on a fixed television camera monitor screen of a soccer player dribbling a soccer ball. the direction of the position recognized as the soccer ball image and the distance measured by the tracking laser distance measuring device are photographed by the tracking television camera. Practice dribbling the soccer ball is performed by checking the images of the soccer ball taken from different directions.

FIG. 136 is an explanatory diagram showing the drive position of the numerically controlled drive frame to which the fixed television camera is attached is tracked to maintain the direction of the position where the image of the soccer ball is recognized and the distance measured by the tracking laser distance measuring device on a fixed television camera monitor screen photographing a soccer ball dribbling by a soccer player.

FIG. 137 is an explanatory diagram showing an image of a soccer player's dribbling practice photographed by a tracking television camera attached to a drive frame is displayed in front of the soccer player and moved in accordance with the soccer player's running of the dribble. Practice is performed by looking at the image of the soccer ball.

FIG. 138 is an explanatory diagram showing the feel of the head, the position of the ball, the position of the head, and the direction of movement of the ball are photographed by a tracking television camera when a soccer player touches the ball during the practice of heading. In order to check and practice in detail with the image, the vicinity of the soccer player's head is photographed.

FIG. 139 is an explanatory diagram showing a soccer ball projector that tracks the soccer player's running, a numerically controlled driving rack equipped with a tracking television camera and a television camera monitor screen are driven according to the soccer player's running.

FIG. 140 is an explanatory diagram showing a numerically controlled drive frame equipped with a tracking television camera system is driven in line with the movement of soccer players during direct kick practice. A numerically controlled projection machine projects a soccer ball with the same driving numerical value, and a soccer player practices a direct kick with a wearable image receiver.

FIG. 141 is an explanatory diagram showing a working range of the numerically controlled robot, which is photographed by a television camera, is photographed by a tracking television camera system, and the photographed image and the operation data of the robot are operated at different locations connected via the Internet on the television camera monitor screen.

FIG. 142 is an explanatory diagram showing a work operation of the robot is further divided and operated by combining the image of the 3D formation assumed by the computer on the television camera monitor screen at a different location via the Internet.

FIG. 143 is an explanatory diagram showing a stage of the theater is photographed by a tracking television camera system, and the stage is displayed onto a fixed television camera monitor screen via the Internet.

FIG. 144 is an explanatory diagram showing a stage of a theater is photographed by a tracking television camera system, and performers of a favorite stage are image-recognized on a fixed television camera monitor screen via the Internet. A tracking television camera is made to track the recognition image, and the performer of the favorite stage can be appreciated.

FIG. 145 is an explanatory diagram showing a stage of the theater is photographed by a large number of tracking television camera systems, each tracking television camera is operated on each fixed television camera monitor screen via the Internet, and the screen of each performer on the favorite stage is appreciated. The cheering from the audience watching on the monitor screen of many tracking television cameras is transmitted to the stage via the Internet.

FIG. 146 is an explanatory diagram showing a stage in a theater is photographed by a number of tracking television camera systems, each tracking television camera is operated on a large number of fixed television camera monitor screens via the Internet, and the screens of performers on the favorite stage are appreciated. On the fixed television camera monitor screen, it is able to operate each tracking directional microphone and appreciate the lines of the performers on the stage of your choice.

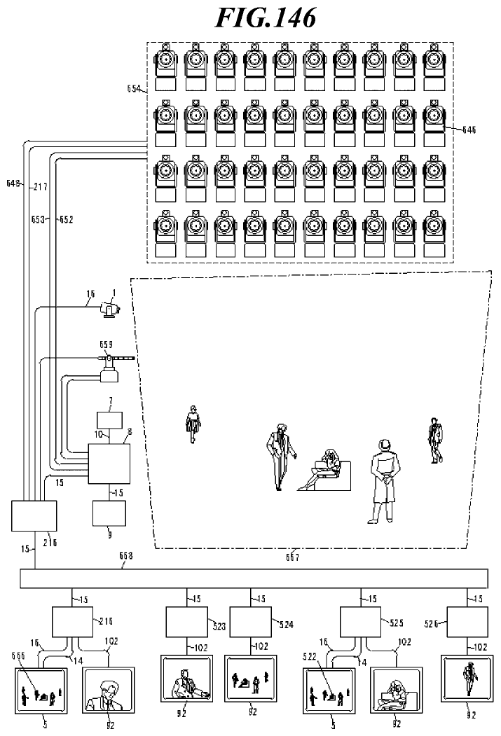

FIG. 147 is an explanatory diagram showing each jazz performer on a tracking television camera monitor screen on which all the jazz performers are displayed on the live jazz stage is indicated on the screen. This drives the tracking television camera in the direction of the designated jazz performer corresponding to the top position of the tracking television camera monitor screen. The jazz performer is photographed at an angle of view and focal length equivalent to the distance measured by a laser distance measuring device attached to a tracking television camera.

FIG. 148 is an explanatory diagram showing it is possible to select and view performers on the jazz live stage via the Internet by connecting images of all jazz performers and each performer photographed by a tracking camera to the Internet network.

FIG. 149 is an explanatory diagram showing a jazz live stage is photographed by a large number of tracking television camera systems, and the operation of each tracking television camera system is connected to the Internet network. As a result, it is possible to operate the performances of live jazz performers on stage via the Internet using a smartphone screen operation application, photographed images with each tracking television camera, and appreciate each image.

FIG. 150 is an explanatory diagram showing a tracking television camera system will be installed in the head office and branch offices. As a result, the screen photographed by the fixed television camera installed in each office can be operated by the tracking television camera on the fixed television camera monitor screen connected via the Internet. Furthermore, the screen photographed by the tracking television camera can be viewed on the tracking television camera monitor screen via the Internet.

FIG. 151 is an explanatory diagram showing a tracking television camera system for appreciation is installed on a famous work of art, and operations are received on the fixed television camera monitor screen of the tracking television camera system via the Internet. Images photographed by the tracking television camera can be manipulated via the Internet using a smartphone screen operation application, photographed by the tracking television camera, and viewed.

FIG. 152 is an explanatory diagram showing a plurality of tracking television camera systems is installed at a soccer stadium where children play games. It is able watch a game photographed by a tracking television camera via the Internet by operating on the fixed television camera monitor screen of the tracking television camera system.

FIG. 153 is an explanatory diagram showing a tracking television camera system is installed above the pitch of the soccer field. On the combined screen of the fixed fish-eye lens television camera monitor screen and the CG screen displaying the pitch, the photographing direction of the tracking television camera built into each tracking television camera system is indicated. The soccer ball on the screen photographed by each tracking television camera is image-recognized, and the soccer ball is tracked. The optimal image is selected from the images taken by each tracking television camera that photographs the vicinity of the soccer ball, and the player watches the game.

FIG. 154 is an explanatory diagram showing the photographing direction of each numerically controlled television camera is indicated on a composite screen of the fisheye lens fixed television camera monitor screen of the tracking television camera system and the CG screen displaying the pitch. A tracking laser distance measuring device measures the distance in the direction corresponding to the image recognition position of the soccer ball on the screen photographed by the numerically controlled television camera. The soccer ball is photographed with a tracking television camera at an angle of view and focal length corresponding to that distance.

FIG. 155 is an explanatory diagram showing a wire tracking drive system for moving the tracking television camera system is installed above the pitch of the soccer field, and the wire tracking drive system is driven on a composite screen of a fixed television camera monitor screen and a CG screen displaying the pitch. The soccer ball is photographed by adjusting the angle of view and focal length of the tracking television camera in the direction corresponding to the image recognition position of the soccer ball on the screen photographed by the numerically controlled television camera incorporated in the tracking television camera system.

FIG. 156 is an explanatory diagram showing the driving position of the tracking television camera system is indicated on a composite screen of a fixed television camera monitor screen and a CG screen displaying the pitch. As a result, the wire driving mechanism is driven by the driving numerical value obtained in advance for each wire driving mechanism at the indicated position, and the tracking television camera system takes an image at the indicated position.

FIG. 157 is an explanatory diagram showing instructions are given on the fixed camera monitor screen of the fisheye fixed television camera installed in the center of the venue. It instructs the movement of the photographing position of the tracking television camera system supported by the wire drive mechanism and the photographing direction of the numerically controlled television camera. A tracking television camera photographs in the direction of the image recognized by the numerically controlled television camera on the monitor screen of the numerically controlled television camera.

FIG. 158 is an explanatory diagram showing a tracking television camera system Voice analysis of numerically controlled directional microphones installed at different positions on the front of the automobile. A numerically controlled directional microphone is pointed in the direction of the analyzed sound, the distance is measured, and accident avoidance driving data corresponding to the progressing automobile of the sound is used for avoidance driving.

### DESCRIPTION

For the purposes of this application, the patents in this application are patent applications related to U.S. Pat. Nos. 55,476,870, 55,476,005, 5,508,308, 6,719,494, and Japanese Patent Application No. 2018-174323 and patents derived therefrom previously issued by the applicant. Therefore, in the description of the implementation of the present application, the description described in the above-mentioned patented and published Japanese Patent Application No. 2018-174323 will be omitted. The above-mentioned U.S. Pat. No. 6,719,494 has a PCT international application number PCT/JP2019/036238, and Japanese patent application 2018-174323 has a PCT international application number PCT/2019/004491. In the description of the implementation of the present application, for clarity of explanation, the implementation of the above-filed patent with the present application will be described. The specification described in the acquired patent describes photographing a drive mechanism driven by numerical control with a television camera and displaying the image of the television camera. At all positions on the television camera monitor screen, the driving numerical values of the drive mechanism are obtained in advance by the interpolation calculation on the television camera monitor screen. The driving numerical value is used to drive and operate the driving mechanism at all positions on the television camera monitor screen. The drive number of the position that drove that drive mechanism is relevant. The specification of the above-mentioned filed patent describes measuring the position of the irradiation of the laser distance measuring device of the drive mechanism driven by numerical control and setting the irradiation position to the drive position of the drive mechanism driven by numerical control described in the above acquired patent. The irradiating position of the laser distance measuring device of the drive mechanism driven by numerical control can be manipulated at all positions on the television camera monitor screen.

Therefore, the distance can be measured with the laser distance measuring device at all positions on the television camera monitor screen. It is possible to measure the position of the image photographed by the television camera. Based on the specification described in the acquired patent above, the photographed image can be recognized by photographing the position of the image photographed by the television camera at the distance measured by another television camera driven by numerical control. The position on the television camera monitor screen photographed by the television camera can be associated with the distance measured by the numerically controlled laser distance measuring device, the driving numerical value of the laser distance measuring device, the image photographed by the numerically controlled television camera, its image recognition, and the numerically controlled driving numerical value of the television camera. Numerical values and names associated with all positions on the television camera monitor screen are connected to a computer and stored therein, thereby being used as numerical values for computer calculation. Driving numerical values for purposeful numerical control equipment are calculated by measured distance and drive values of the laser distance measuring device connected to the computer and related to the position values on the television camera monitor screen, the photographed position of the numerically controlled television camera, its image recognition and Numerical control television camera driving numerical values. Then, it is driven. Instead of human work, a numerically controlled robot detects an image with a television camera, recognizes the image and measures its position with a numerically controlled television camera and a numerically controlled laser distance measuring device. Then, the numerically controlled robot corresponds to the image recognition, or the image recognition corresponding to the image recognition is made to correspond. The present invention is a related patent derived by image-recognizing the operating position of the drive mechanism at all positions on the television camera monitor screen and measuring the distance from the image-recognized operating position with a laser distance measuring device.

In distance measurement, the present invention can be implemented in the same manner as in Japanese Patent Application No. 2018-174323, which has already been filed. However, the embodiments of the present invention mainly describe the well-known laser distance measuring device method of PCT International Application No. PCT/JP2019/036238 of U.S. Pat. No. 6,719,494. The fixed television camera is for establishing the positional relationship of the devices driven by the driving numerical values, and establishes the positional relationship on the screen photographed by the fixed television camera of the present invention. At all positions on the screen photographed by the fixed television camera, the driving position of the numerical driving mechanism, its driving numerical value, the photographing position of the television camera of the numerical driving mechanism, image recognition of photographed image and its driving numerical value, measurement position of laser distance measuring device of numerical driving mechanism, its measurement distance and its driving numerical value and distance to measure microphone sound direction establish a positional relationship with the voice source. Although the matters described in the examples are general examples, the matters described below are described in advance for the sake of simplification. The operation on the fixed television camera monitor screen, the numerical control television camera monitor screen, and the tracking television camera monitor screen is omitted in the drawing, but the explanation is that the numerical value of the position on the television camera monitor screen is obtained. The images photographed by the numerically controlled television camera and the tracking television camera are recognizable screens, and are photographed by adjusting the angle of view and focal length of the image. The numerically controlled television camera, the tracking television camera, the laser distance measuring device, the numerically controlled robot, and the numerically controlled equipment are driven by driving numerical values, and the driven position is grasped by the controller. All positions on the screen of the measured distance of the laser distance measuring device of the tracking television camera system, the fixed television camera monitor screen, the numerical control television camera monitor screen, and the tracking television camera monitor screen are grasped as position numerical values. The distance measured by the laser distance measuring device of the tracking television camera system enables the movement of the numerically controlled robot in the factory yard. The autonomous driving automobile is equipped with a tracking television camera system, and the autonomous driving data is acquired by manually operating the numerical drive mechanism incorporated in the autonomous driving automobile. Autonomous automobiles operate by driving a numerical drive mechanism based on acquired data and numerical values calculated by a computer. Each “television camera monitor screen” described in the explanatory diagrams and described in the specification describes that the present invention displays the driving driven by the driving numerical value on the television camera monitor screen and associates the driving. so it's listed. However, installation of each television camera monitor screen is not always required.

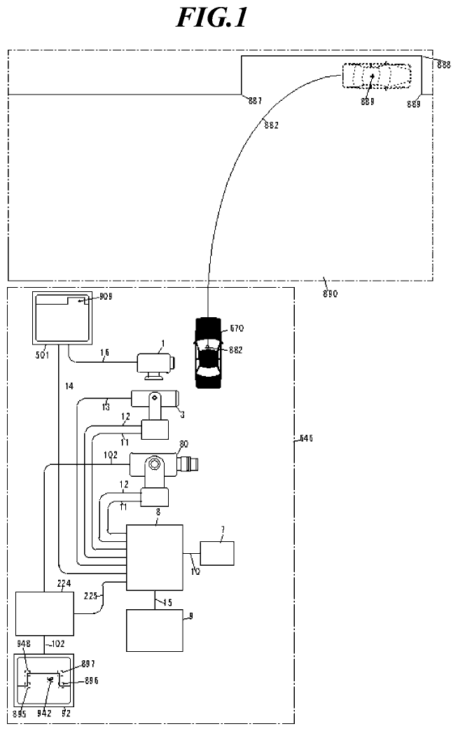

Example: It is attached to an automatic driving data acquisition car 670 that runs under the numerical control of the tracking television camera system 646 in FIG. 1. As forward parking travel data acquisition range 890, a driver who is familiar with driving the automobile is caused to manually park and travel sideways. Numerical control driving operation data of the parked automatic driving data acquisition car 670 is acquired. The tracking television camera system 646 incorporates a fixed television camera 1 that photographs the direction of travel, a tracking laser distance measuring device 3 driven by numerical control, and a tracking television camera 80 driven by numerical control. A tracking laser distance measuring device 3 is directed in a direction corresponding to the position of a subject whose image is detected on a fixed television camera monitor screen 5, which displays a screen photographed by the fixed television camera 1. Then, the distance to the subject whose image is recognized by the fixed television camera 1 is measured. It is a tracking television camera system 646 attached to an automobile in which a fixed television camera 1, a tracking laser distance measuring device 3, and a tracking television camera 80 are driven by numerical control.

At the angle of view and the focal length corresponding to the distance to the object measured by the tracking laser distance measuring device 3, the direction is photographed by the tracking television camera 80, and the photographed image is checked in detail and the image is analyzed. The subject whose image has been confirmed can recognize the parking position angles A 886, B 887, and C 888 and the planned parking position 889 in the image-recognized parking from the automatic driving data acquisition car 670 from the direction and the distance. It is possible to recognize the parking position angles A, B, and C displayed on the fixed television camera monitor screen at the start positions 895, 896, 897 of forward parking data acquisition. The start positions 895, 896, 897 of forward parking data acquisition is photographed by the tracking television camera 80 by confirming the image of all the subjects detected by image detection on the fixed television camera monitor screen 5 and the distance of the position of the subject. In the following description, image recognition necessary for description will be described.

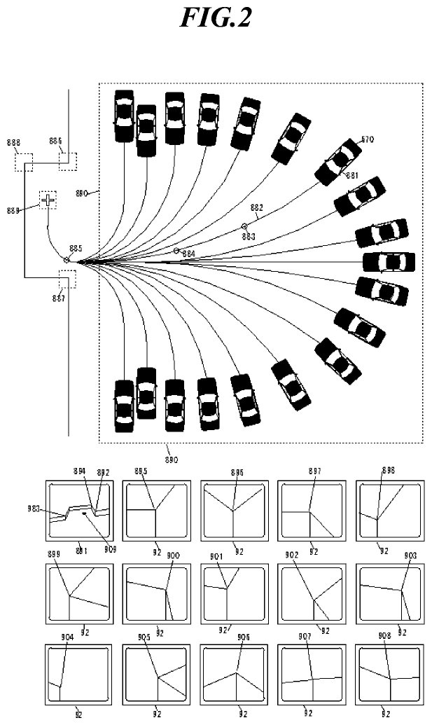

Example: The tracking television camera system 646 in FIG. 2 is attached to the front of the automatic driving data acquisition car 670. As the image-recognized forward parking travel data acquisition range 890, the driver who is familiar with driving the automobile manually parks the automobile, parks the automobile sideways, and acquires the travel operation data of the parked travel. The fixed television camera 1 of the tracking television camera system 646 photographs at the forward parking travel data acquisition start position 881. The image on the fixed television camera monitor screen 891 and the parking position angles A, B, and C appearing on the fixed television camera monitor screen at the forward parking travel data acquisition start position 892, 983, 894 are detected. The tracking laser distance measuring device 3 is directed in the direction corresponding to the position on the screen, and the distance is measured.

According to the measured distance, the tracking television camera 80 photographs at that angle of view and focal length. The images of the parking position angles A, B, and C appearing on the tracking television camera monitor screen at the forward parking travel data acquisition start positions 895, 896, and 897 on the tracking television camera monitor screen 92 are recognized respectively. The measured distance and each photographing direction are associated with the driving numerical value of the traveling drive mechanism before parking traveling at the forward parking traveling data acquisition start position 881 and stored.

The fixed television camera 1 of the tracking television camera system 646 during parking is photographed at the forward parking travel data acquisition position 883. On the fixed television camera monitor screen 891, the parking position angles A, B, and C appearing on the fixed television camera monitor screen at the forward parking travel data acquisition start positions 892, 893, and 894 are detected. The tracking laser distance measuring device 3 is directed to the direction corresponding to the position on the screen, and the distance is measured.

According to the measured distance, the tracking television camera 80 photographs at the angle of view and focal length. The images of the parking position angles A, B, and C appearing on the tracking television camera monitor screen 92 at positions 898, 899, and 900 for acquiring the forward parking travel data on the tracking television camera monitor screen 92 is stored in association with the measured distance obtained by image recognition and the photographing direction, forward parking travel data acquisition position A883, and driving numerical value of the travel drive mechanism during parking travel A. The parking position angles A, B, and C appearing on the fixed television camera monitor screen 891 at the forward parking data acquisition start positions 892, 893, and 894 are detected on the fixed television camera monitor screen 891 at the forward parking data acquisition position B884. Direct the tracking laser distance measuring device 3 to the direction corresponding to the position on the screen and measure the distance.

According to the measured distance, the tracking television camera 80 photographs at the angle of view and focal length. The images of the parking position angles A, B, and C appearing on the tracking television camera monitor screen 92 at positions 901, 902, and 903 for forward parking travel data acquisition on the tracking television camera monitor screen 92 is stored in association with the measured distance acquired by image recognition and the photographing direction, forward parking travel data acquisition position B884, and driving numerical value of the travel drive mechanism during parking travel B.

At the forward parking travel data acquisition position C885 Parking position angles A, B, and C appearing on the fixed television camera monitor screen 891 of forward parking travel data acquisition start positions 892, 893, and 894 are detected on the fixed television camera monitor screen 891 during parking travel C. According to the measured distance, the tracking television camera 80 photographs at the angle of view and focal length. The images of the parking position angles A, B, and C appearing on the tracking television camera monitor screen 92 at positions 904, 905, and 906 for forward parking travel data acquisition on the tracking television camera monitor screen 92 is stored by associating the forward parking travel data acquisition position C 885 with the driving numerical value of the travel drive mechanism during parking travel C with the measured distance acquired by image recognition and the photographing direction.

On the fixed television camera monitor screen 891 of the planned parking position 889, the parking position angles A and B appearing on the fixed television camera monitor screens of the forward parking traveling data acquisition start positions 892 and 893 are detected. The tracking laser distance measuring device 3 is directed to the direction corresponding to the position on the screen, and the distance is measured. According to the measured distance, the tracking television camera 80 photographs at the angle of view and focal length. The image of the parking position angles A, B 907, and 908 at the planned parking position 889 of the forward parking traveling on the tracking television camera monitor screen 92 is stored in association with the measured distance acquired by image recognition, the photographing direction, and the driving numerical value of the traveling drive mechanism at the planned parking position 889.

In the same way, parked travel data is photographed from several different positions in the forward parking travel data acquisition range 890, and some of them are associated and stored. The images on the fixed television camera monitor screens at forward parking data acquisition start positions 892, 893, and 894 on the fixed television camera monitor screen with image detection in the forward parking data acquisition range 890 recognized by the tracking television camera system 646 from the parking position angles A, B, and C shown on the screen are associated with the distance and direction. The driving force value of the traveling driving mechanism that parks from all the positions in the forward parking data acquisition range 890 is acquired by interpolation calculation or by simulation calculations based on the driving force value of the traveling drive mechanism and stored.

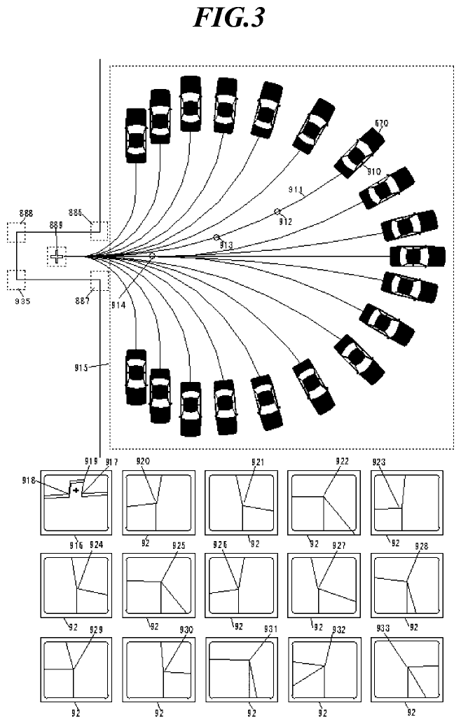

Example: The tracking television camera system 646 in FIG. 3 is attached to the rear of the automatic driving data acquisition car 670. A driver who is familiar with driving the automobile manually parks the automobile in the backward parking data acquisition range 915, parks the automobile backwards, and acquires the driving operation data of the parking. Similar to the above explanation, the image on the fixed television camera monitor screen at the image detected reverse parking data acquisition start position 916 in the reverse parking data acquisition range 915, recognized by the tracking television camera system 646 from the parking position angles A, B, and C shown on the fixed television camera monitor screens at the acquisition start positions 917, 918, and 919 of the reverse parking travel data acquisition start position is associated with the distance and direction. The driving numerical value of the traveling driving mechanism that parks from all the positions in the backward parking traveling data acquisition range 915 is acquired by interpolation calculation or by simulation calculations based on the driving numerical value of the traveling driving mechanism, and stored.

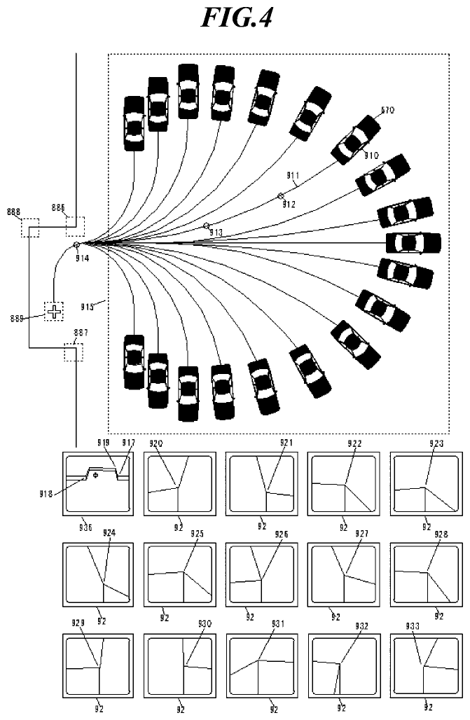

Example: The tracking television camera system 646 in FIG. 4 is attached to the rear of the automatic driving data acquisition car 670. The backward parking travel data acquisition range 915 is manually parked by a driver who is familiar with driving the automobile, and the automobile is parked in parallel, and the travel operation data of the parking travel is acquired by the same method.

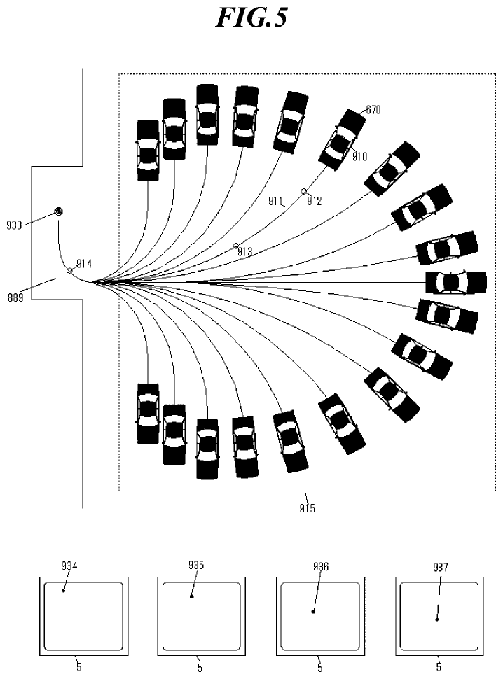

Example: The tracking television camera system 646 in FIG. 5 is attached to the rear of the automatic driving data acquisition car 670. The automobile is manually parked in the backward parking data acquisition range 915 by a driver who is familiar with driving the automobile, and the automobile is parked forward, and the driving operation data of the automobile is acquired by the same method.

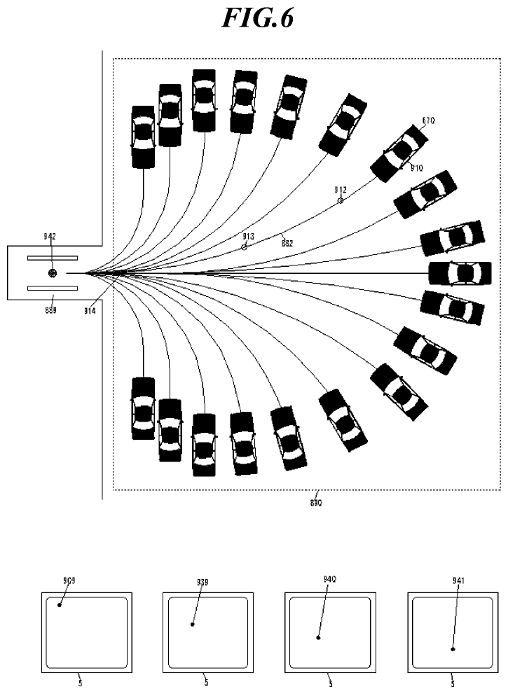

Example: The tracking television camera system 646 in FIG. 6 is attached to the front of the automatic driving data acquisition car 670. The forward parking travel data acquisition range 890 is manually parked by a driver who is familiar with driving the automobile, and the automobile is parked backward, and the travel operation data of the parking travel is acquired by the same method.

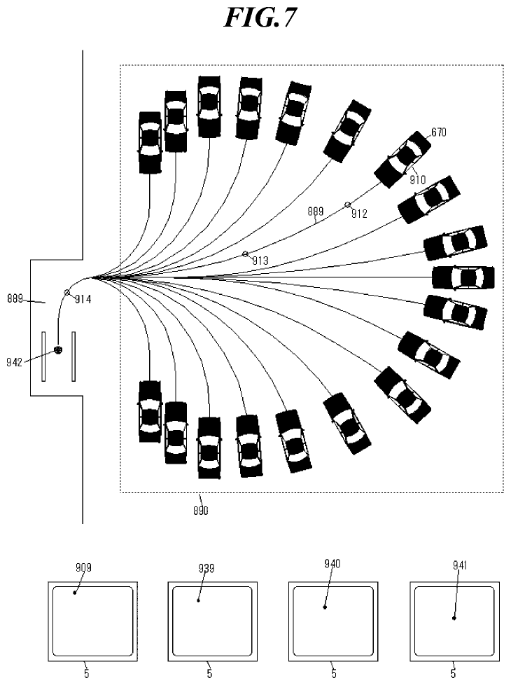

Example: The tracking television camera system 646 in FIG. 7 is attached to the front of the automatic driving data acquisition car 670. The forward parking data acquisition range 890 is manually parked by a driver who is familiar with driving the automobile, and the forward parallel parking is performed.

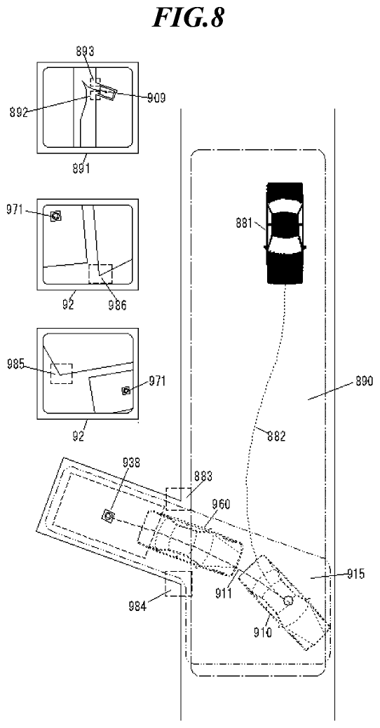

Example: The tracking television camera system 646 in FIG. 8 is attached to the front and rear of the automatic driving data acquisition car 670. A unique forward parking travel data acquisition range 890 and a backward parking travel data acquisition range 915 are manually parked by a driver who is familiar with driving the automobile and parked obliquely forward. Its unique parked driving maneuver data is acquired in a similar manner.

In addition to the forward parking travel data acquisition start position 881 in the unique forward parking travel data acquisition range 890, the unique parked travel operation data is acquired in a similar manner from several points. A tracking television camera system 646 attached to the front recognizes each image, and each measured distance and each photographing direction are associated with each driving numerical value of each parking driving mechanism and stored. In addition to the backward parking data acquisition start position 910 of the forward parking data acquisition route 882 in the unique backward parking data acquisition range 915, the unique parked driving data is acquired from several points in a similar manner. A tracking television camera system 646 attached to the rear surface recognizes each image, and each measured distance and each photographing direction are associated with each driving force value of the drive mechanism that has traveled in each parking run and stored.

Associate the following images with their distance and direction. —an image detected on the fixed television camera monitor screen in the forward parking data acquisition route 882 of the unique forward parking data acquisition range 890 and the reverse parking data acquisition route 911 of the unique forward parking data acquisition range 915.
an image recognized by the tracking television camera system 646, and taken from the planned parking position on the fixed television camera monitor screen at parking position angle A, B and forward parking data acquisition start position 909, which is shown on the fixed television camera monitor screen at forward parking travel data acquisition start positions 892 and 893. The driving numerical value of the traveling drive mechanism for specific parking traveling from all positions on the forward parking data acquisition path 882 with a unique forward parking data acquisition range 890 and the backward parking traveling data acquisition route 911 in the backward parking traveling data acquisition range 915 is acquired by interpolation or in simulation calculations based on the unique driving numerical value of the traveling drive mechanism, and stored.

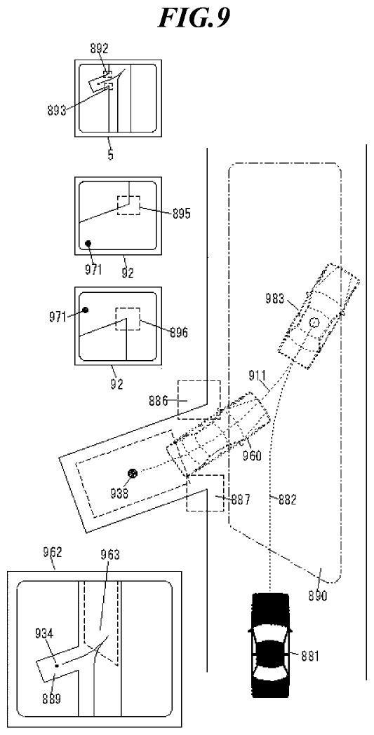

Example: A forward parking data acquisition route 882 in the unique forward parking data acquisition range 890 in FIG. 9. A tracking television camera system 646 is attached to the front of the automatic driving data acquisition car 670 to acquire the driving operation data of the unique parked driving. In addition to the forward parking travel data acquisition start position 881 of the unique forward parking travel data acquisition range 890, the unique parking travel operation data is acquired from several start positions in a similar manner. Each image is recognized, and each measured distance and each photographing direction are associated with each driving numerical value of each traveling driving mechanism for parking traveling and stored.

The image detected on the fixed television camera monitor screen 5 in the above-mentioned unique forward parking travel data acquisition range 890 is associated with the image recognized by the tracking television camera system 646, which is photographed from the planned parking position shown on the fixed television camera monitor screen at the forward parking data acquisition start position 909 shown on the fixed television camera monitor screen of the forward parking travel data acquisition start position 892, 893 that is fixed parking position angle A, B displayed on the television camera monitor screen and forward parking travel data acquisition start position 909, and its distance and direction. the automobile is parked and traveled from all positions in the unique forward parking travel data acquisition range 890 based on the unique drive value of the travel drive mechanism. The driving numerical value of the traveling drive mechanism is acquired by interpolation or simulation calculation and stored. In order to correct the acquired calculated numerical value, the forward parking travel to be corrected is manually carried out. Using the drive value of the drive mechanism, the correction operation of the interpolation method obtains the drive value of the forward parking drive to be corrected in a similar manner.

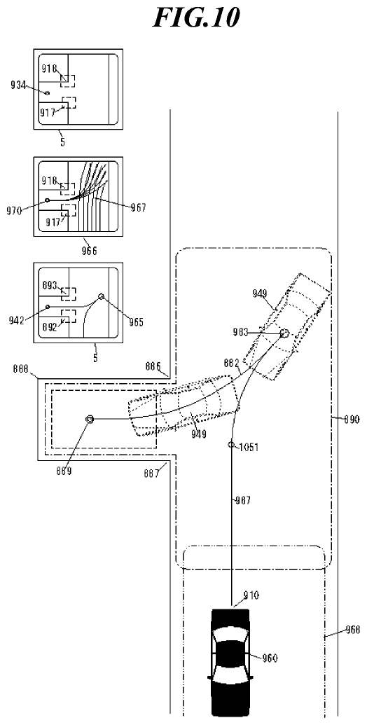

Example: In order to connect to the parking travel in the forward parking travel data acquisition range 890 from the simulation travel path 968 in FIG. 10. A tracking television camera system 646 is attached to the rear surface of an automatic driving data acquisition car 670 to acquire simulation data connected to the unique driving operation data. From each simulation travel path 968, travel to the forward parking travel data acquisition range 890, and simulate travel from several reverse simulation acquisition start positions 910. And the tracking television camera system 646 calculates and selects simulation travel data for several forward parking travels to the parking travel turn-around position 983. On the fixed television monitor screen 5, the parking position angles A and B shown on the fixed television camera monitor screen at the reverse parking travel data acquisition start positions 917 and 918 and the parking position angles A 886, B 887, C 888 and planned parking position 889 shown on the fixed television camera monitor screen of backward parking travel data acquisition start position 934 are image-recognized. The data that the simulation travel data 1051 connects with the forward parking travel data acquisition path 882 is selected from the previously stored memory in association with the respective drive values of the travel drive mechanism of the parked automobile based on the image identification of each measurement distance and each photographing direction, like the simulation travel path 966 and the forward parking driving data driving path on the television monitor screen, the reverse parking driving data driving path 967 and the simulation travel path.

On the television monitor screen of the simulation travel path 966 and the forward parking data running path, the backward parking data running path 967 and the simulation travel path are selected. As a result, the automobile travels to the parking travel turn-around position 983 in the simulation travel 1051 that is connected to the forward parking travel data acquisition route 882. In the meantime, the parking position angles A and B shown on the fixed television camera monitor screen of the forward parking travel data acquisition start positions 892 and 893 on fixed television camera monitor screen 5 and the planned parking position 942 for forward parking travel data acquisition are image-recognized. Then, on the CG synthesized screen, the joining position of the reverse parking data travel path 965 and the simulation travel path is displayed and confirmed.

In the simulation run 1051, the automobile travels to the parking travel turn-around position 983, and the drive value of the automobile 960 in reverse parking travel is replaced with the drive value of the automobile 949 in forward parking travel. Then, the automatic television camera system 646 is attached to the front of the automatic driving data acquisition car 670 at the position of the unique forward parking travel data acquisition range 890. The forward parking travel data acquisition start positions 892 and 893 on the fixed television camera monitor screen 5, and the parking position angles A and B appearing on the fixed television camera monitor screen and the forward parking travel data acquisition planned parking position 942 are image-recognized. Forward parking travel data acquisition route 882 is traveled forward parking travel data, and the automobile is parked at planned parking position 889. The planned parking position is image-recognized, and the travel data until the automobile travels within the parking data travel range is calculated by simulation. It becomes possible to park the automobile automatically from various parking positions by driving with the simulated driving data.

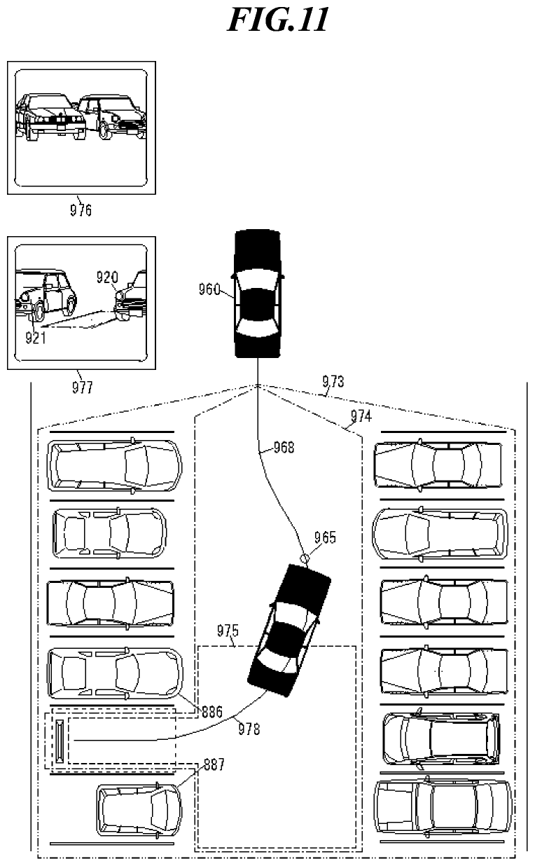

Example: The distance and angle of the position of the image analysis of the parked automobiles recognized on the tracking television camera monitor screen in FIG. 11 and shown on the television camera monitor screen 976 The image was recognized are calculated, and the distance between the parked automobiles on the screen is measured. Similarly, at the position of the image analysis of the parked automobiles displayed on the tracking television camera monitor screen 977, the image recognition on the calculation screen of the parking location is performed, and the distance between several forward parked automobiles is measured. The distance between the parking position angle A shown on the tracking television camera monitor screen of the Reverse parking travel data acquisition start position 920 and the parking position angle B shown on the tracking television camera monitor screen at the reverse parking traveling data acquisition start position 921 is measured and the parking is judged possible.

A simulation travel path 968 is calculated from the position of the automobile 960 parked backwards and photographed by the tracking television camera of the tracking television camera system 646 attached to the rear surface of the automobile 960 parked backwards. From the backward parking travelable range 974 to the connection to the position in the backward parking travelable range 975, travel with the calculated driving numerical value of the drive mechanism calculated by the simulation method. At the joint position 965 of the reverse parking travel data travel path and the simulation travel path, the rearward traveling direction of the tracking television camera system 646 is photographed, and the image is recognized on the screen photographed by the tracking television camera 80. Then, the tracking laser distance measuring device 3 measures the distance. The automobile 960 in reverse parking judges that the distance measured between the automobile-to-automobile parking position angle A 886 and the parking position angle B 887 during forward parking at that location determines is possible to park again. The automobile 960 in reverse parking travels and parks according to the backward parking travel data of the travel path 978.

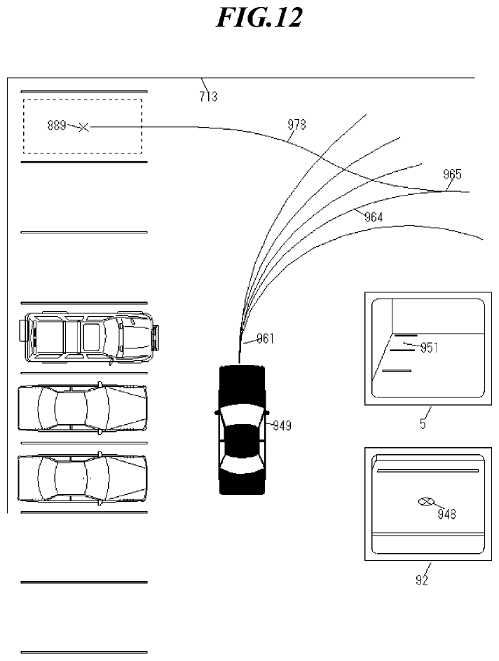

Example: A tracking television camera 80 photographs the image position of the side of the parked automobile on the far left side of the fixed television camera monitor screen 951 detected image on fixed television camera monitor screen 5 photographed by the fixed television camera 1 of the tracking television camera system 646 attached to the front of the automobile 949 parked forward in FIG. 12. The direction and distance of the planned parking position at the far end shown on the tracking television camera monitor screen 948 of this forward parking travel are measured. The calculation is performed by simulation based on the automobile position 949 of the forward parking travel, so that the backward parking travel data-calculation is performed by simulation from the forward parking travel automobile position 949 so as to match the already acquired parking travel start position on the reverse parking travel data travel path 987 and the drive numerical value of the drive mechanism of the automobile. The automobile simulates traveling to the backward parking data travel area 964, and turns back at the junction of the backward parking travel data travel path 965 and the simulation travel path. The automobile is parked in the planned parking position 889 after traveling backwards on the backward parking travel data travel path 978.

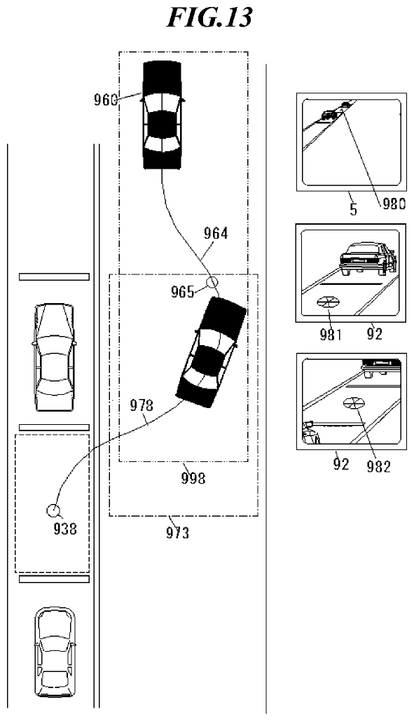

Example: The rear parking position shown on the fixed television camera monitor screen 980 of reverse parking driving on fixed television camera monitor screen 5 photographed by the fixed television camera 1 of the tracking television camera system 646 attached to the rear surface of the automobile 960 that is parked backwards in FIG. 13 is detected by image recognition on the screen. The tracking laser distance measuring device 3 is directed in the direction corresponding to the detected or selected position, and the distance to the image is measured.

The angle of view and the focal length corresponding to the measured distance are matched, the detected or selected image is photographed by the tracking television camera 80, and the image on the tracking television camera monitor screen 92 is image-recognized. Confirm that the image is the planned parking position 938 for acquiring backward parking travel data, and confirm by voice or image the rear parking position shown on the tracking television camera monitor screen 981 for backward parking travel on the tracking television camera monitor screen 92.

The corrected parking position displayed on the tracking television camera monitor screen 982 of the backward parking traveling on the tracking television camera monitor screen 92 is corrected on the tracking television camera monitor screen 92. The measurement direction and the photographing direction of the tracking laser distance measuring device 3 and the tracking television camera 80 are changed so that the parking position of the screen is displayed in the center of the tracking television camera monitor screen 92. By checking the image again and measuring the distance, the direction and distance from the backward parking automobile 960 to the planned parking position 938 for which the backward parking data is acquired are confirmed. As a result, the distance of the planned backward parking data acquisition parking position 938 of the forward parallel parking planned position already acquired by the tracking television camera system 646 is measured.

The driving numerical value of the drive mechanism which shared with the joint position 965 of the backward parking data travel path for traveling to the travel range 973 of the backward parking data travel path 978 and the simulation travel path, is calculated using the measured numerical value, and simulation driving is performed to the backward parking driving data driving area 964. After traveling up to the backward parking data travel range 973, the automobile is parked on the backward parking data travel path 978 and parked at the planned parking position 938 from which the backward parking travel data was acquired.

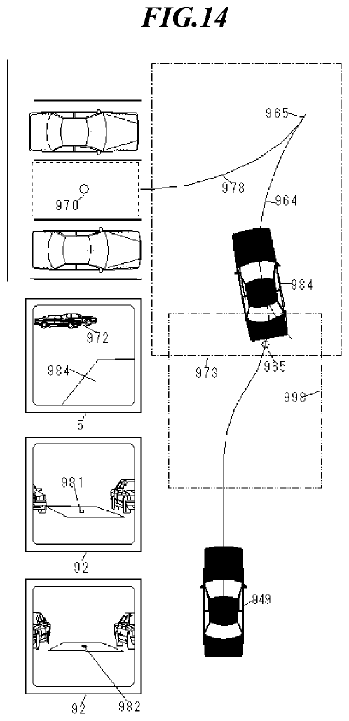

Example: An image on the screen of the rear parking position displayed on the fixed television camera monitor screen 972 of forward parking traveling on the fixed television camera monitor screen 5 photographed by the fixed television camera 1 of tracking television camera system 646 attached to the front of the automobile 949 in forward parking travel in FIG. 14 is detected. The tracking laser distance measuring device 3 is directed in the direction corresponding to the detected position, and the distance to the detected image is measured. The angle of view and focal length corresponding to the measured distance are matched, the detected image is photographed by the tracking television camera 80, and the image on the tracking television camera monitor screen 92 is image-recognized. The image is recognized, the distance is measured, and it is determined that backward parking is possible. Assuming that the automobile is to be parked at the image-recognized position, the automobile travels toward the simulation travel data acquisition range 984 on the fixed television camera monitor screen 5 that displays data acquisition range 998 of simulation driving, and travels while searching for a position at which simulation travel of the parked automobile can be calculated.

The automobile travels so that the rear parking position shown on the fixed television camera monitor screen 980 of backward parking running on the fixed television camera monitor screen 5 can be detected by image recognition on the screen. The tracking laser distance measuring device 3 is directed in the direction corresponding to the detected position, and the distance to the detected image is measured. Check the image and calculate the simulation run to the 964 reverse parking run data run area at the position where the distance was measured. The angle of view and the focal length corresponding to the measured distance are matched, the detected image is photographed by the tracking television camera 80, and the image on the tracking television camera monitor screen 92 is image-recognized.

The automobile is reverse parked and traveled on the backward parking travel data travel path 978 from the joint position 965 of the backward parking data travel path and the simulation travel path. In accordance with backward parking and traveling, the stored image on the tracking television camera monitor screen 92 photographed by the tracking television camera 80 attached to the front of the forward parking automobile 949 is converted in accordance with the position measured by the tracking television camera system 646 and the traveling direction position. The image of the parking position confirmed on the converted tracking television camera monitor screen 92 is displayed on the monitor screen that is image-converted in accordance with the parking run.

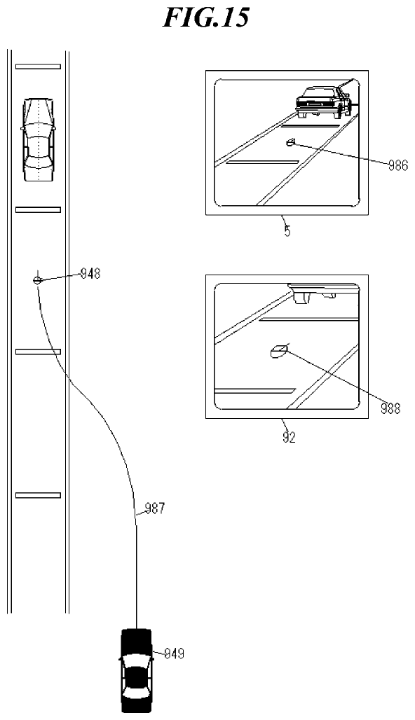

Example: The parking position shown on the fixed television camera monitor screen 986 on the fixed television camera monitor screen 5 photographed by the fixed television camera 1 of the tracking television camera system 646 attached to the front of the automobile 949 parked forward in FIG. 15 is detected by image recognition on the screen. The detected position is indicated, the tracking laser distance measuring device 3 is directed in the direction corresponding to the position, and the distance to the detected image is measured. The angle of view and focal length corresponding to the measured distance are matched, the detected image is photographed by the tracking television camera 80, and the parking position of the image on the tracking television camera monitor screen 92 is recognized. The image is recognized and the distance is measured, the image around the parking position is image-recognized by the image photographed by the tracking television camera 80, and the distance is measured by the tracking laser distance measuring device 3. From the parking positions learned in the past, it is determined that parallel parking is possible, and the forward parking travel data travel path 987 for parking at the image-recognized position is selected, traveled, and parked. The parking run is memorized and added to the learning.

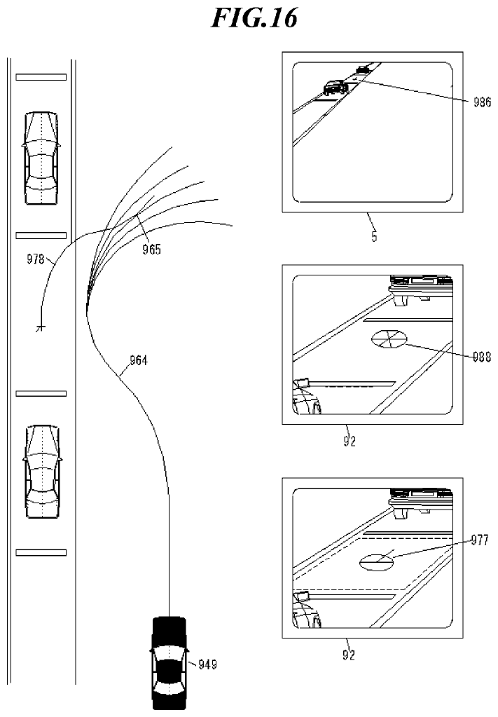

Example: The parking position shown on the fixed television camera monitor screen 986 on the fixed television camera monitor screen 5 photographed by the fixed television camera 1 of the tracking television camera system 646 attached to the front of the automobile 949 parked forward in FIG. 16 is detected by image recognition on the screen. The tracking laser distance measuring device 3 is directed in the direction corresponding to the detected position, and the distance to the detected image is measured. The angle of view and focal length corresponding to the measured distance are adjusted, the detected image is photographed by the tracking television camera 80, image recognition is performed, and a parking simulation screen 988 is displayed on the tracking television camera monitor.

The parking location calculation screen 977 is displayed at the image analysis position of the parked automobile shown on the tracking television camera monitor screen by confirming of the planned parking position 978 on the parking simulation screen shown on the tracking television camera monitor 988, or correction of the parking position shown on the screen. By confirming the parking position, the simulation driving to the backward parking data driving area 964 is corrected, and the parking driving to turn back at the joining position 965 between the backward parking driving data driving path and the simulation driving path is selected and the parking is performed with running on the backward parking travel data travel path 978. The tracking television camera system 646 is instructed to park, and the tracking television camera system 646 recognizes the image of the parking position. By confirming the display of the screen or correcting the screen according to the instruction, the forward parking automobile 949 is parked at the planned parking position 889 and parked.

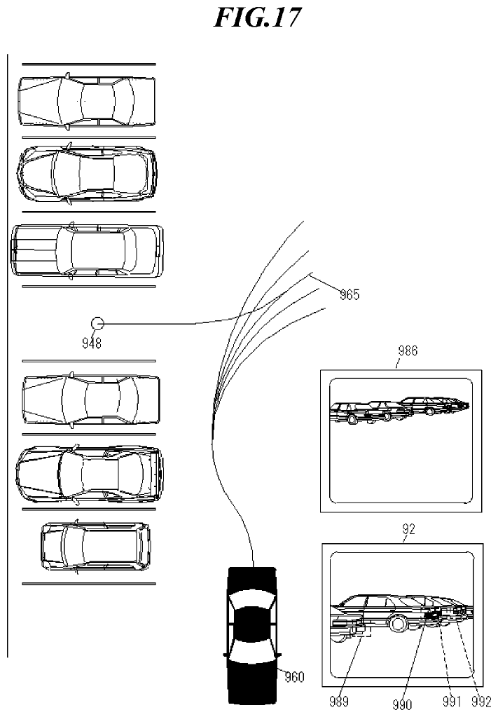

Example: The fixed television camera monitor screen 986 photographed by the fixed television camera 1 of the tracking television camera system 646 attached to the rear front of the automobile 960 in FIG. 17 that is parked backward is detected by recognizing the parking position on the screen. Direct the tracking laser distance measuring device 3 toward the direction corresponding to the detected position, and measure the distance to the detected image. The angle of view and focal length corresponding to the measured distance are matched, the detected image is photographed by the tracking television camera 80, and the parking position of the image on the tracking television camera monitor screen 92 is recognized.

The image is recognized, the distance is measured, and the surroundings of the parking position are tracked. Image analysis A 989, B 990, C 991 and D 992 of the rear of the parked automobile on the television camera monitor screen 92 are photographed by the tracking television camera 80 is used for image recognition. The tracking laser distance measuring device 3 measures the distance and calculates the distance between the parked automobiles. In case that it is determined that forward row parking is possible from the past learned parked automobiles, the automobile is turned back at the joint position 965 between the backward parking driving data driving path and the simulation driving path in simulation running, and parked at the planned parking position at the far end shown on the image-recognized forward parking running tracking television camera monitor screen 948. The tracking television camera system 646 repeatedly recognizes the image of the tracking television camera monitor screen 92 photographed by the tracking television camera 80 and measures the distance while traveling around the planned parking position.

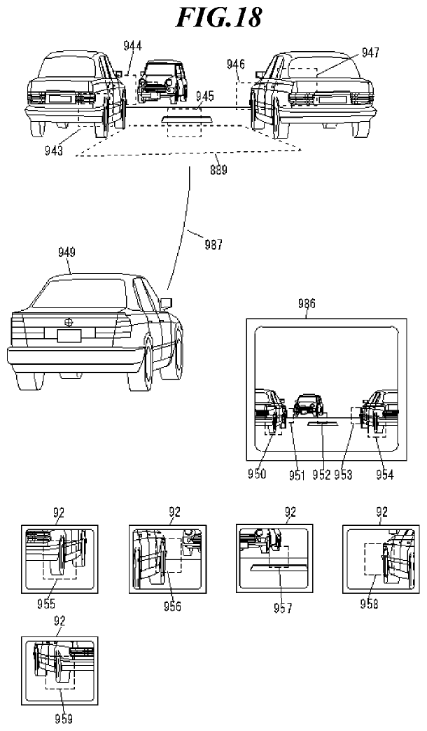

The following multiple images photographed by the fixed television camera 1 of the tracking television camera system 646 attached to the front of the forward parking automobile 949 in FIG. 18 are detected and image recognition is performed.
The image position of the side of the parked automobile on the left front of the fixed television camera monitor screen 950 on the screen of the parking position displayed on the fixed television camera monitor screen 986,
The image position of the side of the parked automobile on the left rear of the fixed television camera monitor screen 951,
The image position of the curb of the parking lot in the center of the fixed television camera monitor screen 952,
The image position 953 of the side of the parked automobile on the far right of the fixed television camera monitor screen,
The image position 954 of the side of a parked automobile in front of the fixed television camera monitor screen

The tracking laser distance measuring device 3 is directed to each direction corresponding to the plurality of detected positions, and the distances to the plurality of detected images are measured.

The plurality of detected images is photographed by the tracking television camera 80 by matching the angle of view and the focal length corresponding to the plurality of measured distances. The following multiple images are image-recognized and stored.
The side of the parked automobile in front of the left displayed in the tracking television camera monitor screen 955 of forward parking running on the tracking television camera monitor screen 92,
The side of the parked automobile on the far left, as seen on the television camera monitor screen 956
The Curb 957 of the parking lot displayed on the television camera monitor screen tracking forward parking
The side of the parked automobile in the back on the right, which is displayed in the tracking television camera monitor screen 958 of forward parking
The side of the parked automobile in front of the right displayed on the television camera monitor screen 959 tracking forward parking.

From the position of the forward parked automobile 949 whose distance is measured by recognizing the image, the side positions of the left front parked automobile 943, the left rear parked automobile 944, parking lot edge 945, right side of parked automobile 946 and right front side of parked automobile 947 photographed by the television camera 80 and the respective distances are measured. As a result, parking at the planned parking position 889 on the forward parking travel data acquisition route 882 can be grasped. Based on the parking method learned in the past, it is determined that backward parking is appropriate, and the automobile is parked on the forward parking travel data travel path 987 and parked at the parking position. Each recognized image is stored and used as a reference for image recognition for the next and subsequent parking runs.

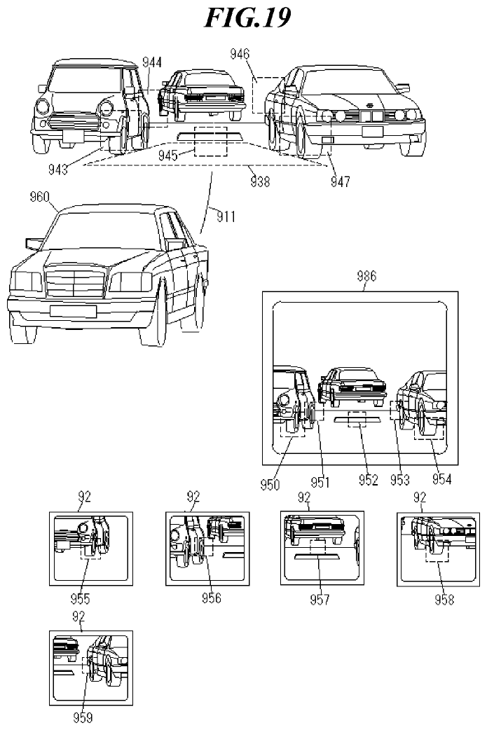

Example: The following multiple images are detected and recognized on the fixed television camera monitor screen 986 photographed by the fixed television camera 1 of the tracking television camera system 646 attached to the rear front of the automobile 960 that is parked backwards in FIG. 19.
The image position of the side of the parked automobile in front of the left of the fixed television camera monitor screen 950,
The image position of the side of the parked automobile on the far left of the fixed television camera monitor screen 951,
The image location of parking lot curb in center of fixed television camera monitor screen 952,
The image position of the side of the parked automobile on the far right of the fixed television camera monitor screen 953,
The image position of side of parked automobile in front of fixed television camera monitor screen 954

The tracking laser distance measuring device 3 is directed in each direction corresponding to the plurality of detected positions, and the distances to the plurality of detected images are measured. The angles of view and the focal lengths corresponding to the plurality of measured distances are matched, the plurality of detected images is photographed by the tracking television camera 80, and the following plurality of images is image-analyzed on the tracking television camera monitor screen 92 and stored.
The side of the parked automobile in front of the left displayed in the tracking television camera monitor screen 955 of forward parking,
The side of the parked automobile in the back on the left, which is displayed in the tracking television camera monitor screen 956 of forward parking,
The curb of the parking lot displayed on the tracking television camera monitor screen 957 of forward parking,
The side of the parked automobile in the back on the right, which is displayed in the tracking television camera monitor screen 958 of forward parking,
The side of the parked automobile in front of the right displayed on the television camera monitor screen 959 tracking forward parking

From the position of the backward parking automobile 960 whose image is recognized and the distance is measured, the following positions and their distances photographed by the tracking television camera 80 around the parking position are measured.
the side 943 of the parked automobile on the left front,
the side 944 of the parked automobile on the far left,
The parking lot edge 945,
the side 946 of the parked automobile on the far right,
the side 947 of the parked automobile in front of the right

As a result, it is possible to grasp the space of the planned parking position 938 for which the backward parking travel data is acquired. The automobile determines that forward parking is appropriate based on the parking method learned in the past by grasping the space and parking at the planned parking position for which the backward parking data was acquired, and then runs to park according to the travel data on the backward parking travel data acquisition route 911 and parked at the parking position. The image of each recognized automobile is stored and used as a reference for image recognition of the next and subsequent parking runs.

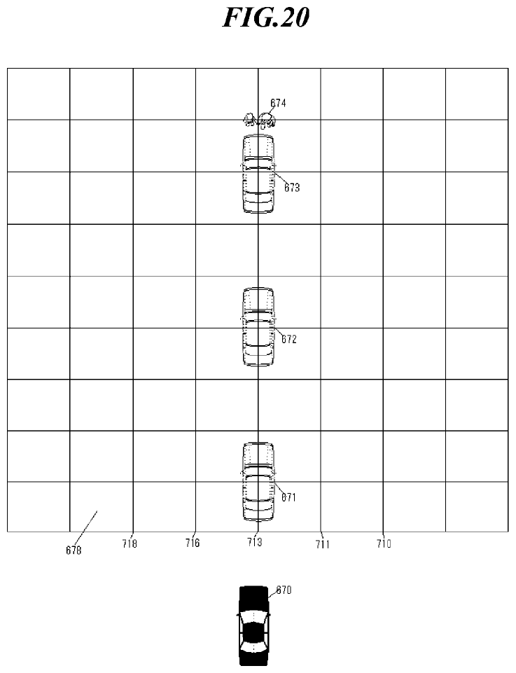

Example: This is a method of acquiring stop data for a stop method that does not make the autonomous driving data acquisition vehicle 670 in FIG. 20 feel fear of a subject 674 that should avoid collision. Travel at the same speed on the driving route C 713, and acquire data for each driving operation until the distance to the object stops at the positions A 671, B 672, C 673 of the automatic driving data acquisition car. In the same way, drive at the same speed on the roads A 710, B 711,713, D 716 and E 718, and acquire the data of each driving operation from the position A 671, B 672, C 673 of the automatic driving data acquisition car until it stops.

At that speed, at every position on the road, the fearless stopping method, the driving numerical value, which is the running data, of the numerically controlled drive mechanism of the automatic driving data acquisition car 670 is associated as the running data acquired at the position where the stop operation was started. From all the positions on the travel path, the stop travel data acquired at the position where the stop operation was started is acquired by calculation such as an interpolation method. Similarly for different speeds, the stopping travel data for all speeds at all positions on the travel path are obtained by interpolation calculation.

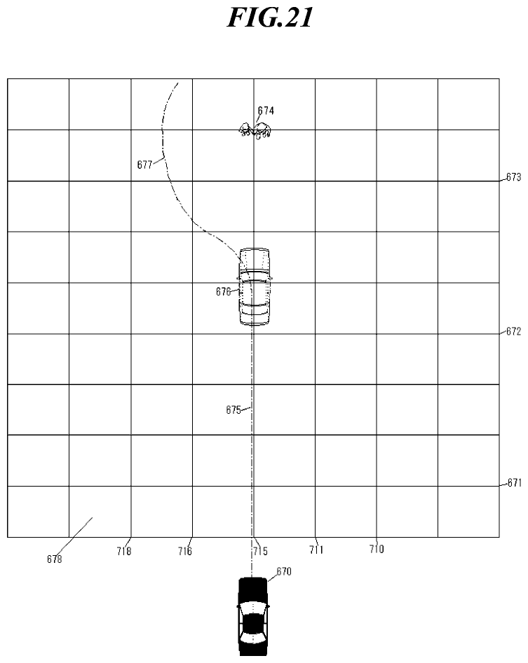

Example: This avoidance driving data acquisition method is an avoidance method that does not make the automatic driving data acquisition car 670 in FIG. 21 feel fear toward the object 674 that should avoid collision. Drive at the same speed on road C 715, start evasive driving from the distances of positions A 671, B 672, C 673 of the automatic driving data acquisition car, and acquire data for each driving operation. In the same way, on the roads A 710, B 711, D 716 and E 718 travel at the same speed and start evasive driving from the positions A 671, B 672, C 673 of the automatic driving data acquisition car, and acquire the data of each travel operation.

As an avoidance driving method that does not make people feel the fear at all positions on the road at several running speeds, and does not make people feel the fear at the position where the avoidance driving is started, the driving numerical value, which is the avoidance driving data, of the numerically controlled drive mechanism of the automatic driving data acquisition car 670 is associated as the acquired avoidance driving data from the position at which the avoidance driving was started. Avoidance travel data for starting avoidance driving at all positions on the travel path is acquired by interpolation calculation. Similarly, at different normal speeds, the avoidance driving data for all normal speeds on the road for avoidance driving without feeling fearfulness are acquired by interpolation calculation.

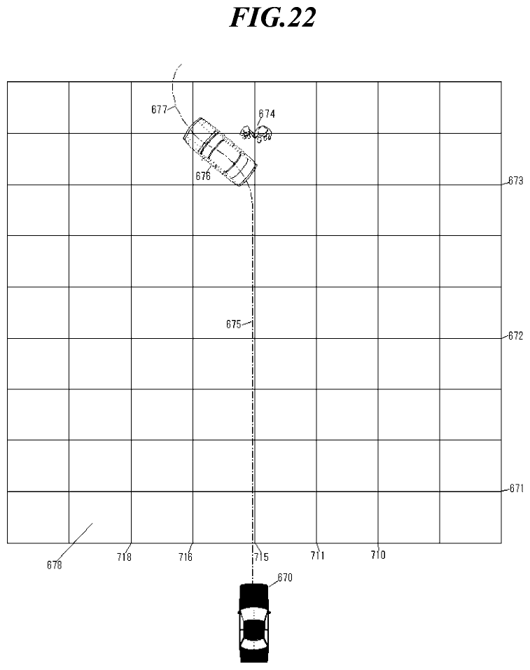

Example: This is a method for acquiring side-passing driving data by maximally avoiding driving with respect to an object 674 to which the automatic driving data acquisition car 670 in FIG. 22 should avoid collision. Drive at the same speed on road C 715, and drive from the positions A 671, B 672, C 673 of the automatic driving data acquisition car to the side of the subject 674 to avoid collision with maximum avoidance driving, and acquire data for each driving operation. In the same way, the automobile travels at the same speed on roads A 710, B 711, D 716 and E 718 and from the distances of automobile data acquisition positions A 671, B 672 and C 673 the data for each driving operation is acquired, in which the automobile is driven sideways with maximum avoidance driving.

As a side passing driving method for avoiding a collision with the object 674 to be avoided by maximum avoidance driving at that traveling speed at all positions on the traveling road, the position at which the side-passing operation started is associated with the acquired travel data. At all positions on the travel path, travel data for maximally avoiding collision with the object 674 to be avoided by maximal avoidance driving is acquired by interpolation calculation. Similarly at different speeds, at all positions where the maximum avoidance operation started, traveling data for avoiding collision with the object 674 to be avoided by collision avoidance driving at all speeds on the traveling road is acquired by interpolation calculation.

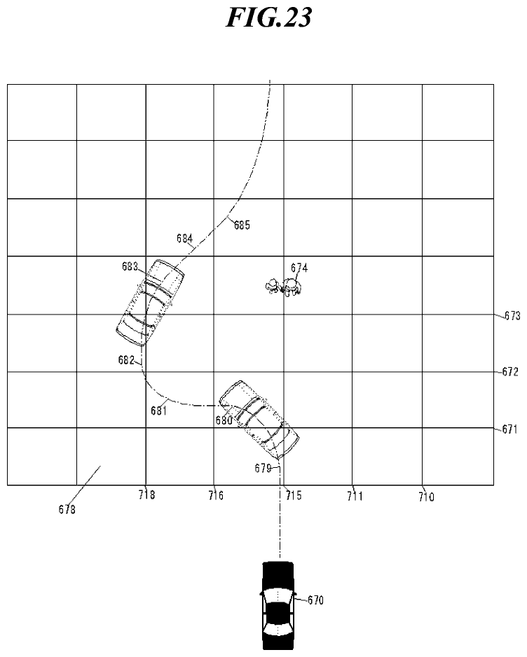

Example: This is a method of acquiring driving data by a maximum avoidance driving method that does not cause the automatic driving data acquisition car 670 in FIG. 23 to collide with an object 674 to be avoided. On the travel route C 715, travel at the same speed, and drive through the object 674 to be avoided without colliding with the maximum avoidance drive at each of the following positions from the position A of the autonomous driving data acquisition car 671.
Collision avoidance driving data acquisition A679,
Collision avoidance driving data acquisition B680,
Collision avoidance driving data acquisition C681,
Collision avoidance driving data acquisition D682,
Collision avoidance driving data acquisition E683,
Collision avoidance driving data acquisition F684,
Collision avoidance driving data acquisition G685

In the same way, on the traveling roads A 710, B 711, D 716, E and F 718 the automobile travels at the same speed and passes through with the maximum avoidance driving method of the acquisition of data on collision avoidance driving data A 679, B 680, C 681, D 682, E 683 and F 684, 685. Even its maximum collision avoidance result is taken into account since the maximum collision avoidance for each driving maneuver is acquired by a driver who is familiar with the operation of the driving automobile and acquires avoidance data. Similarly at different normal speeds, even its maximum collision avoidance result is taken into account since the maximum collision avoidance for each maneuver is obtained by a driver who is familiar with driving the automobile in question.

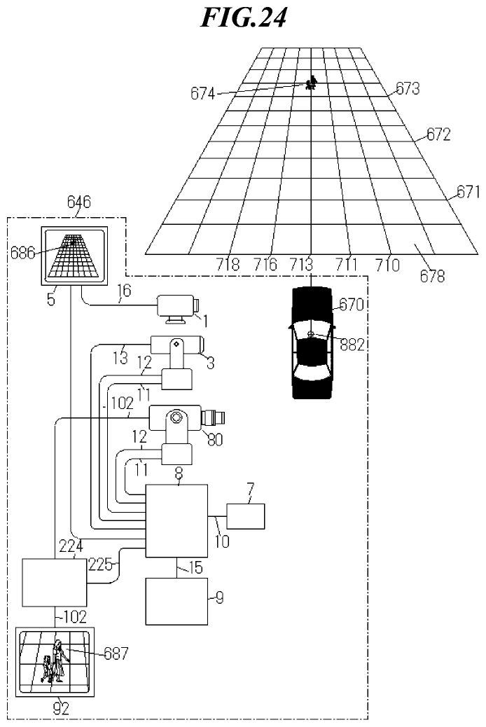

Example: The tracking television camera system 646 installed in the avoidance driving data acquisition automatic driving automobile shown in FIG. 24 detects an image of a subject 686 in the fixed television camera monitor screen 5 photographed by the fixed television camera 1 and photographed by the fixed television camera monitor attached to the automatic driving automobile. The tracking laser distance measuring device 3 is directed in the direction corresponding to the detected position on the screen, and the distance to the detected image is measured. The tracking television camera 80 photographs the detected image at the angle of view and focal length corresponding to the distance. The image of the object 687 to be avoided is recognized and analyzed by analyzing the image photographed by the tracking television camera monitor attached to the automatic driving automobile on the tracking television camera monitor screen 92.

Avoidance driving that makes the parent and child feel as little fear as possible, and avoidance driving that makes the occupant of the car feel as little fear as possible is used to drive the automobile by a driver who is familiar with the driving of the automobile by recognizing that the image analyzed is a parent and child pedestrian who should avoid driving. Then, the traveling operation data of the traveling is acquired. Collision avoidance driving data acquisition autonomous driving data acquisition car 670 is a method of acquiring avoidance driving data while measuring the distance to object 674 on road surface 678 to avoid collision. The acquisition method is to have a driver who is familiar with driving the automobile drive the automobile, and acquire it as learning data for image analysis and avoidance judgment of the loaded tracking television camera system.

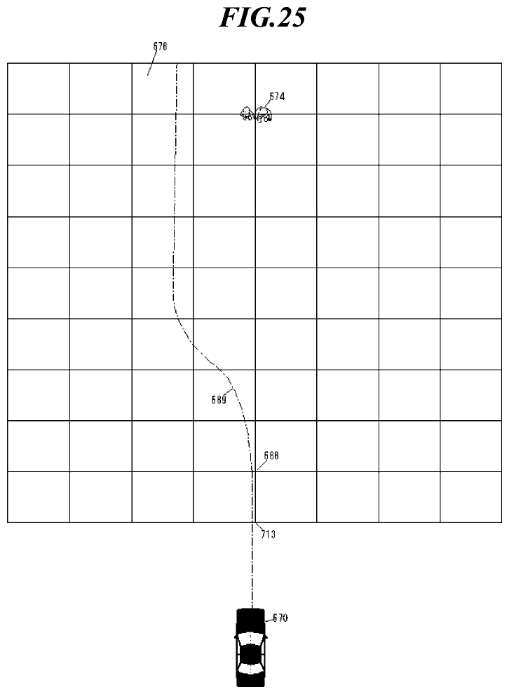

Avoidance driving data acquisition driving 689 in which the automatic driving data acquisition car 670 determines collision avoidance at an avoidance driving start position A 688 for avoiding a collision with an object 674 that should be avoided, and performs avoidance driving A on the collision avoidance driving data acquisition road surface 678 in FIG. 25.

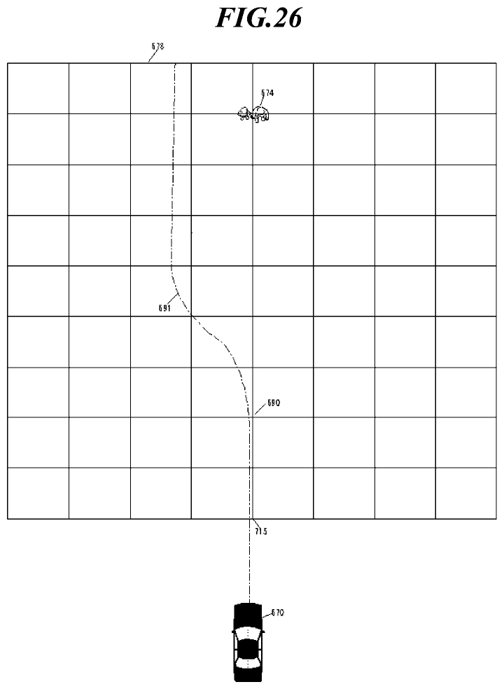

Example: Avoidance driving data acquisition driving 691 in which the automatic driving data acquisition car 670 determines collision avoidance at an avoidance driving start position B 690 for avoiding a collision with an object 674 to be collision-avoided, and performs avoidance driving B on the collision avoidance driving data acquisition road surface 678 in FIG. 26.

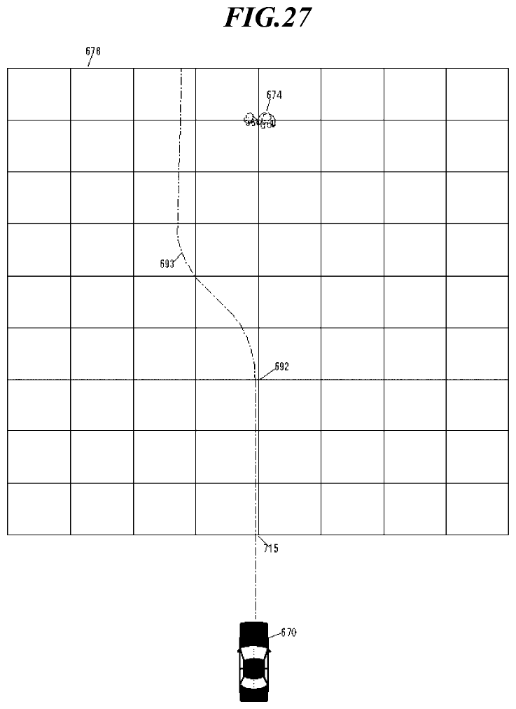

Example: Avoidance driving data acquisition driving 693 in which the automatic driving data acquisition car 670 determines collision avoidance at an avoidance driving start position C 692 for avoiding a collision with an object 674 to be collision-avoided, and performs avoidance driving C on the collision avoidance driving data acquisition road surface 678 in FIG. 27.

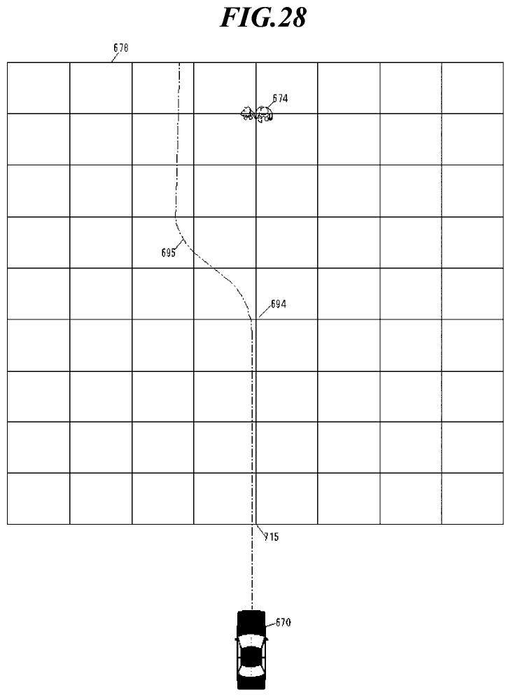

Example: Avoidance driving data acquisition driving 695 in which the automatic driving data acquisition car 670 determines collision avoidance at an avoidance driving start position D 694 for avoiding a collision with an object 674 to be collision-avoided, and performs avoidance driving D on collision avoidance driving data acquisition road surface 678 in FIG. 28.

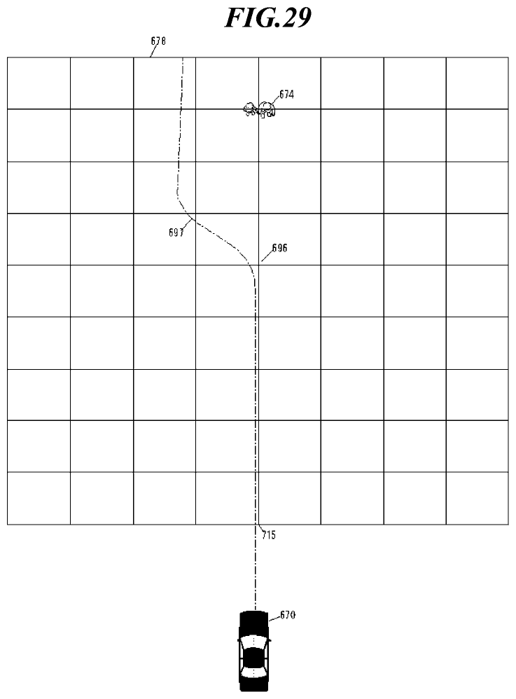

Example: Avoidance driving data acquisition driving 697 in which the automatic driving data acquisition car 670 determines collision avoidance at an avoidance driving start position E 696 for avoiding a collision with an object 674 to be collision-avoided, and performs avoidance driving E on the collision avoidance driving data acquisition road surface 678 in FIG. 29.

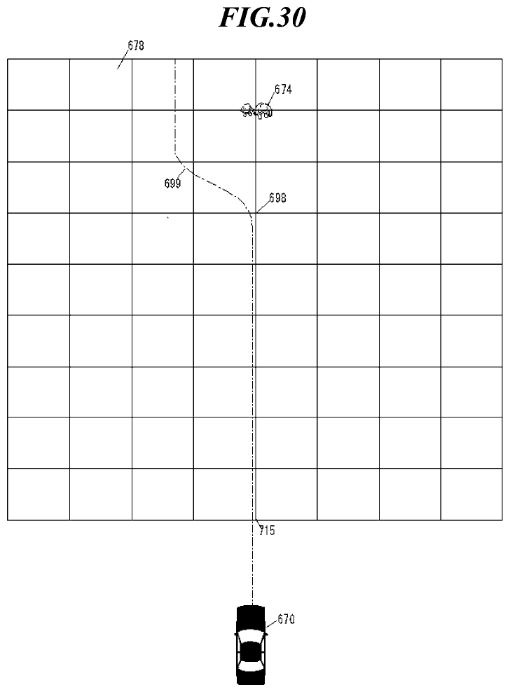

Example: Avoidance driving data acquisition driving 699 in which the automatic driving data acquisition car 670 determines collision avoidance at an avoidance driving start position F 698 for avoiding collision with an object 674 to be collision-avoided, and performs avoidance driving F on collision avoidance driving data acquisition road surface 678 in FIG. 30.

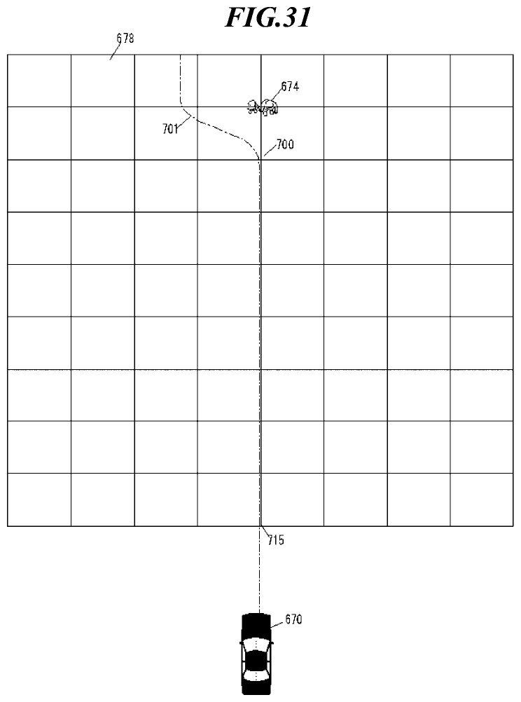

Example: Avoidance driving data acquisition driving 701 in which the automatic driving data acquisition car 670 determines that collision avoidance is to be performed at the avoidance driving start position G 700 for avoiding collision with an object 674 to be collision avoided, and performs avoidance driving G on collision avoidance driving data acquisition road surface 678 in FIG. 31.

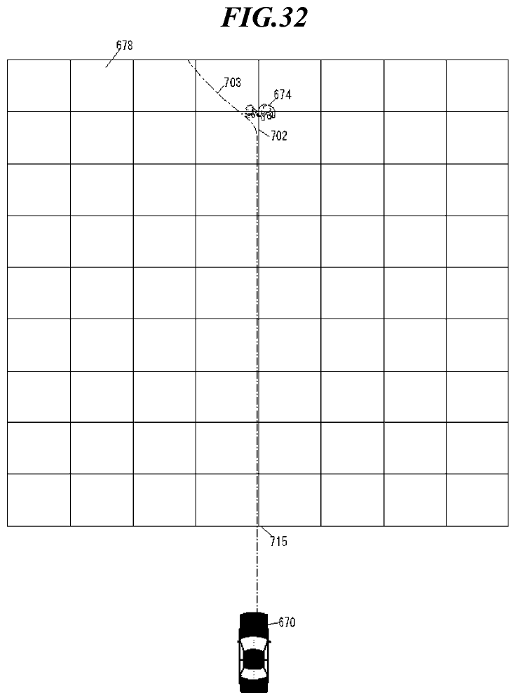

Example: The automatic driving data acquisition car 670 judges collision avoidance at the avoidance driving start position H 702 for avoiding collision with the object 674 to be collision avoided, and performs maximum avoidance driving data acquisition operation 703 of avoidance driving H, and acquires numerical values of the acceleration/deceleration sensor and impact sensor that measure the impact on the collision avoidance driving data acquisition road surface 678 in FIG. 32.

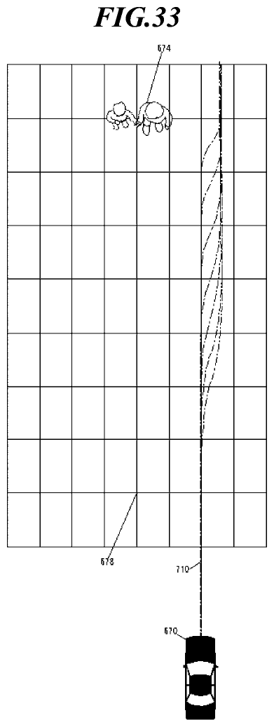

Example: The automatic driving data acquisition car 670 traveling on the travel path A 710 of the collision avoidance driving data acquisition road surface 678 in FIG. 33. The avoidance driving data is the driving position of the mechanism related to the driving of the automatic driving data acquisition car 670, the measured distance and direction, the acceleration/deceleration sensor, and the impact sensor.

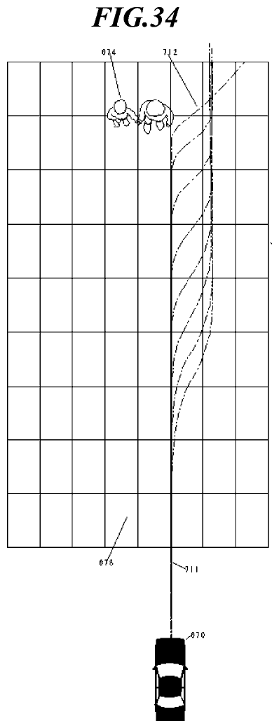

Example: Automatic driving data acquisition car 670 that drives on the road B 711 of the road surface 678 for collision avoidance driving data acquisition in FIG. 34 is in avoidance driving data acquisition driving 712 in which maximum avoidance driving B is performed only to avoid collision with object 674 to be avoided.

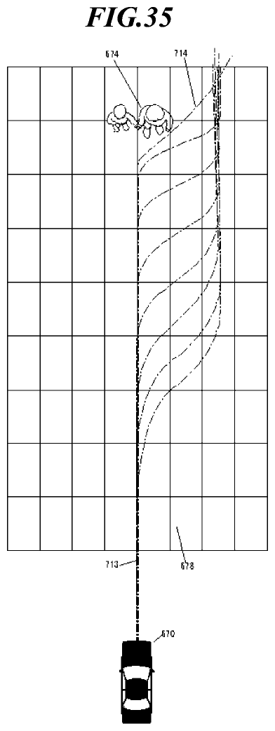

Example: Automatic driving data acquisition car 670 that drives on the road C 713 of the road surface 678 for collision avoidance driving data acquisition in FIG. 35 is avoidance driving data acquisition driving 714 in which maximum avoidance driving C is performed only to avoid collision with object 674 to be avoided.

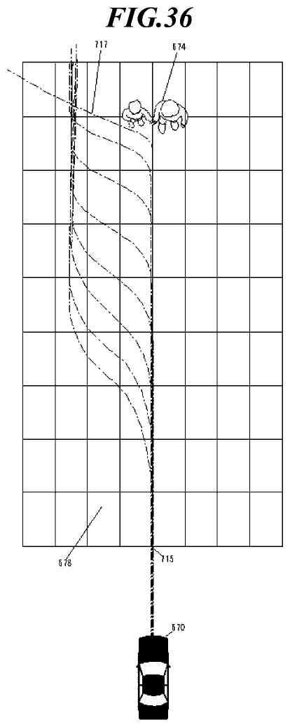

Example: Automatic driving data acquisition car 670 that drives on the road D 715 of the road surface 678 for collision avoidance driving data acquisition in FIG. 36 performs maximum avoidance driving D 719 only to avoid collision with object 674 to avoid collision.

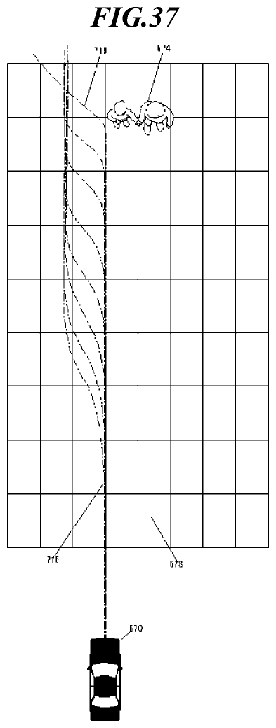

Example: Automatic driving data acquisition car 670 that drives on the road E 716 of the road surface 678 for collision avoidance driving data acquisition in FIG. 37 performs maximum avoidance driving E 717 only to avoid collision with object 674 to avoid collision.

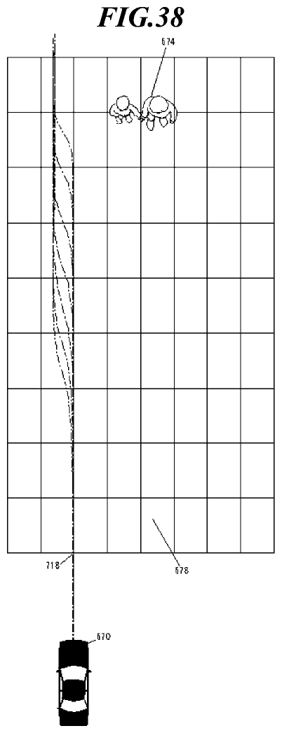

Example: Automatic driving data acquisition car 670 driving on the road F 718 of the collision avoidance driving data acquisition road surface 678 in FIG. 38 is in avoidance driving data acquisition driving only to avoid collision with subject 674 that should be avoided.

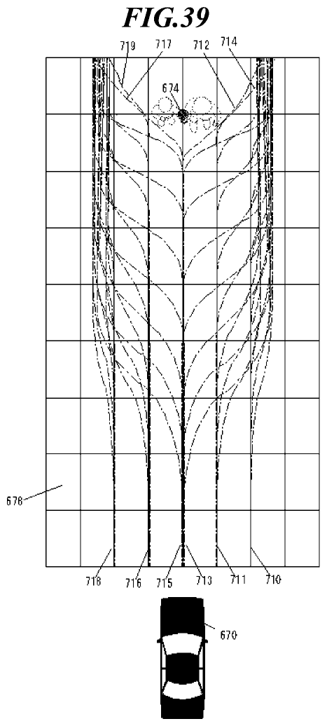

Example: The automatic driving data acquisition car 670 traveling on the roads A 710, B 711, C 713, D 715, E 716 and F 718 of the collision avoidance driving data acquisition road surface 678 in FIG. 39. The automatic driving data acquisition car 670 that drives at the same speed in the direction of the subject 674 to avoid collision travels from all positions on the collision avoidance driving data acquisition road surface 678 toward the subject 674 to avoid collision using the data from the position where the avoidance driving operation was started to the end of the avoidance driving operation. The avoidance driving operation data of the automatic driving data acquisition car 670 is acquired by the interpolation method and stored.

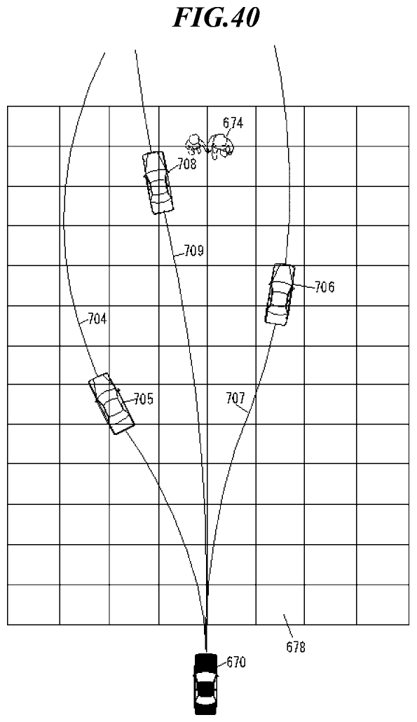

Example: The automatic driving data acquisition car 670 that drives on the road surface 678 for collision avoidance driving data acquisition road surface 678 in FIG. 40 is a 20 km automatic driving automobile 704 that travels on the road surface 678 for collision avoidance driving data acquisition, and acquires data in 20 km avoidance driving and maximum avoidance driving 705. A 60 km self-driving automobile 706 travels on the road surface 678 for collision avoidance driving data acquisition, and acquires data for 60 km avoidance driving and maximum avoidance driving 707. A 100 km self-driving car 708 travels on the collision avoidance driving data acquisition road surface 678, and acquires data for 100 km avoidance driving and maximum avoidance driving 709. From the avoidance traveling data obtained at several running speeds in the manner described above, at each different running speed, according to the traveling speed, the avoidance traveling data for all the speed traveling of the normal traveling is acquired by the calculation of the interpolation method and stored.

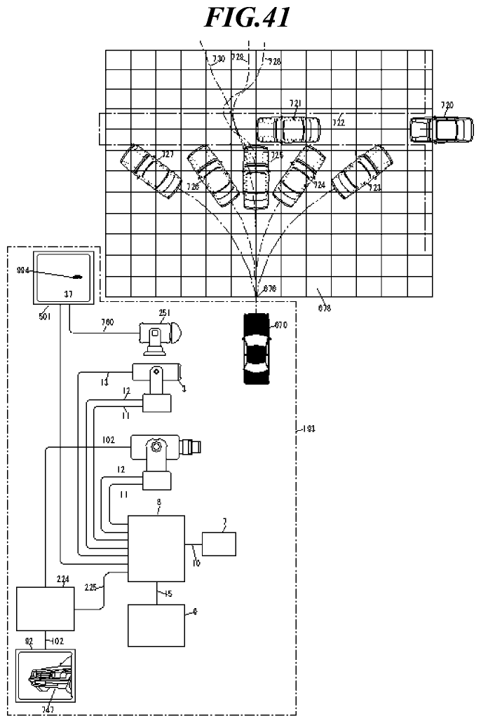

Example: A fixed fish-eye lens television camera 251 is attached to the front of an automatic driving data acquisition car 670 in which a tracking television camera system 646 is incorporated and which travels on the collision avoidance driving data acquisition road surface 678 in FIG. 41. The tracking laser distance measuring device 3 and the tracking television camera 80 are directed to a direction corresponding to the position of the automobile detected by the fisheye lens fixed television camera monitor screen 501 taken by the fisheye lens fixed television camera 251.

The tracking laser distance measuring device 3 measures the distance from the left to the traveling automobile 720 on the front right side. The image analyzer 224 analyzes the image of the tracking television camera monitor screen 92 that displays the screen photographed by the tracking television camera 80 at the angle of view and focal length according to the measured distance. The position of the traveling automobile 720 on the front right side is analyzed from the image information 225 of the image analysis signal acquired by image recognition, its direction, and its measured distance. The importance of the recognized image information is compared and judged, and tracking is continued in the imaging direction of the tracking television camera 80. The tracking laser distance measuring device 3 measures the distance each time in the direction of the tracking television camera 80 to be tracked.

From the difference between the measured direction and distance, the direction and distance to be measured by the traveling automobile 720 on the right front side is predicted. Avoidance driving is predicted by selecting the best avoidance driving at the predicted position and direction from previously acquired avoidance data. The image information and the surroundings in that direction are measured to confirm the avoidance driving range. Avoidance driving is performed by selecting data capable of coping with avoidance driving assuming that the automobile is within the avoidance driving range from already acquired avoidance driving data by calculating the movement degree of the traveling automobile and assuming its traveling position. Acquire each data of avoidance driving and add it to learning of avoidance driving.

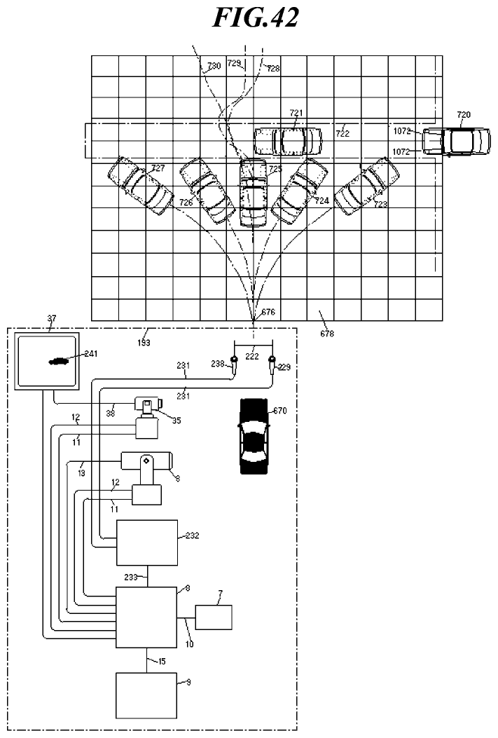

Example: Sound signals picked up by microphones A 229 and B 238 mounted at intervals on the front of the automatic driving data acquisition car 670 in FIG. 42 are stored. The stored sound is analyzed by the sound analyzer 232, and the horizontal direction of the sound source of the collected sound is calculated from the phase difference of the collected sound signal. The tracking laser distance measuring device 3 and the numerically controlled television camera 35 of the tracking television camera system 646 are directed to the calculated direction. In the image photographed by the numerically controlled television camera 35 in the calculated direction, the traveling automobile 720 on the front right side from the left is image-detected. The tracking laser distance measuring device 3 is directed to the direction corresponding to the position of the automobile 241 whose image is detected and displayed on the numerical control television camera monitor screen 37, and the distance to the traveling automobile from the left is measured. The image photographed by the numerically controlled television camera 35 is recognized based on the measured distance.

From the image of the traveling automobile that has undergone image recognition of the measured direction and distance, the position of the traveling automobile, its traveling direction, and its moving speed are measured. The direction and distance of the traveling automobile are predicted, and the best avoidance driving at the predicted position is selected from avoidance data acquired in advance to perform avoidance driving. The image information acquired by image recognition, the position of the automobile 241 image-detected on the numerical control television camera monitor screen 37, the distance measured by the tracking laser distance measuring device 3, the direction of travel calculated from the audio signal, the calculated measured distance, the driving value of the drive mechanism of the automobile, and the audio signal are stored. Data that can cope with avoidance driving is acquired from these stored numerical values, and avoidance driving is stored and added to learning. Assuming the position of the traveling automobile from the voice signal by memorizing and learning the sound signal picked up by the microphone installed in the direction of travel of the automobile, avoidance driving is performed by selecting data that can respond to avoidance driving from the already acquired avoidance driving data.

A plurality of directional ultrasonic wave generators 1072 is attached to the front of the running automobile in the running direction. It is possible to receive the transmission of the running automobile and calculate the running direction and running speed of the running automobile at the position where the signal is received by attaching information such as the running speed of the running automobile and sending it. The traveling speed between the automobile and the traveling automobile, the direction and the distance of the position can be calculated by receiving the signal with a plurality of ultrasonic generators in the automobile that receives the signal. The direction of the approaching automobile is quickly detected at the propagation destination of the ultrasonic wave, and the numerical control television camera 35 and the tracking laser distance measuring device 3 are directed in that direction, so that early image detection and the distance of the approaching automobile can be measured.

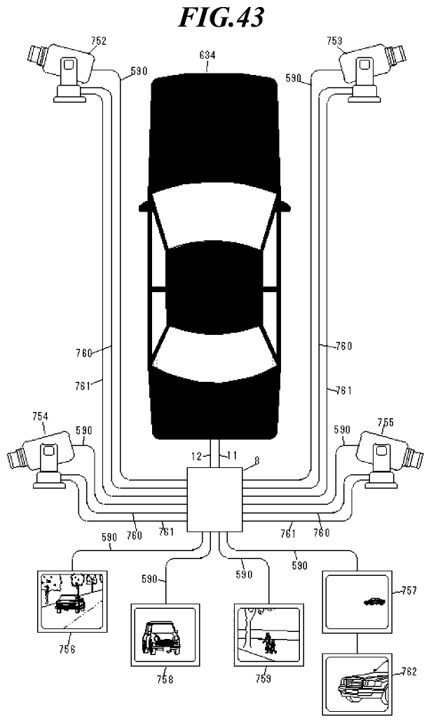

Example: A pixel distance measurement tracking television camera system is installed in front and behind an automatic driving data acquisition car 670 that runs on the collision avoidance driving data acquisition road surface 678 shown in FIG. 43. The LED light emitting element 107 at the position corresponding to the position of the image element of the pixel distance measurement and tracking television camera B 753 at the position where the image of the subject on the pixel distance measurement and tracking television camera monitor screen B 757 photographed by pixel distance measurement tracking television camera B 753, is detected is caused to emit light. The light is applied to the subject through the optical lens of the pixel distance measurement tracking television camera B753. The reflection time of the irradiated displayed light is measured to measure the distance to the subject.

The pixel range of the pixel distance measuring and tracking television camera B 753 corresponding to the measured distance is narrowed at the position of the image element of the pixel distance measurement tracking television camera B 753 at the detected position, and the enlarged screen of the pixel distance measuring and tracking television camera monitor screen B 762 of the object is subjected to image analysis by an image analyzer. The importance of the recognized image information is compared and determined, and tracking is continued in the photographing direction of the pixel distance measurement tracking television camera B 753. The distance is measured each time in the direction of the tracking pixel distance measurement tracking television camera B 753. Based on the difference between the measured direction and distance, the direction and distance to be measured by the automobile ahead on the right side is predicted. Avoidance driving is predicted by selecting the best avoidance driving at the predicted position and direction from previously acquired avoidance data.

In the pixel distance measurement and tracking television camera system attached before and after the automatic driving data acquisition car 670, the image information of the pixel distance measurement and tracking television camera screens A 752, B 753, C 754 and D 755 photographed by the pixel distance measurement and tracking television cameras A 756, B 757, C 758 and D 759 and the surroundings in that direction are measured to confirm the avoidance driving range. By calculating the moving speed of the traveling automobile and assuming its traveling position, it is assumed that there is an avoidance driving range, and data that can respond to avoidance driving is selected from the data of avoidance driving that has already been acquired, and avoidance driving is performed. Acquire each data of avoidance driving and add it to learning of avoidance driving. Although it has not been commercialized yet, the pixel distance measurement tracking television camera system is compact without a drive mechanism, and can be attached to each position of the automatic driving data acquisition car to acquire avoidance driving data from each position.

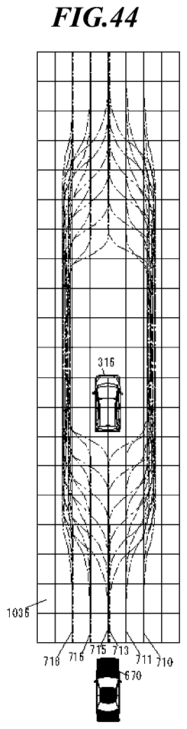

Example: The automatic driving data acquisition car 670 that drives on the driving roads A 710, B 711, C 713, D 715, E 716 and F 718 of the overtaking driving data acquisition road surface 1063 in FIG. 44 is in overtaking driving data acquisition driving in order to avoid contact with the preceding automobile 316 and overtake. Based on the distance measured by the tracking laser distance measuring device 3, the speed difference between the automatic driving data acquisition car 670 and the preceding automobile 316 is measured. In order to overtake the preceding automobile 316 while avoiding contact with the preceding automobile 316 from all positions on the overtaking driving data acquisition road surface 1063, the overtaking driving data of the automatic driving data acquiring automobile 670 that drives from behind the preceding automobile 316 is acquired by interpolation by using the data of the automatic driving data acquisition car 670 which runs at the same overtaking speed in the direction of the preceding automobile 316 from the position at which the overtaking operation is started to the end of the overtaking operation, and stored.

Similar overtaking driving data is acquired at several different driving speeds of the preceding automobile 316, and the overtaking driving data of the automatic driving data acquisition car 670 at all speeds is acquired by interpolation calculation and stored. In the overtaking run, an overtaking possible range is set each time, and within the range, priority is assigned to the overtaking running data driving, and the overtaking run is performed. At the position on the television camera monitor screen that shows the direction and distance measured by the distance measurement system and the related automobiles running in the vicinity, it is possible to calculate driving data that can be connected to the overtaking driving data in the simulation before starting overtaking with the overtaking driving data, and to execute overtaking driving with the connected simulation calculation value since overtaking is different depending on the situation.

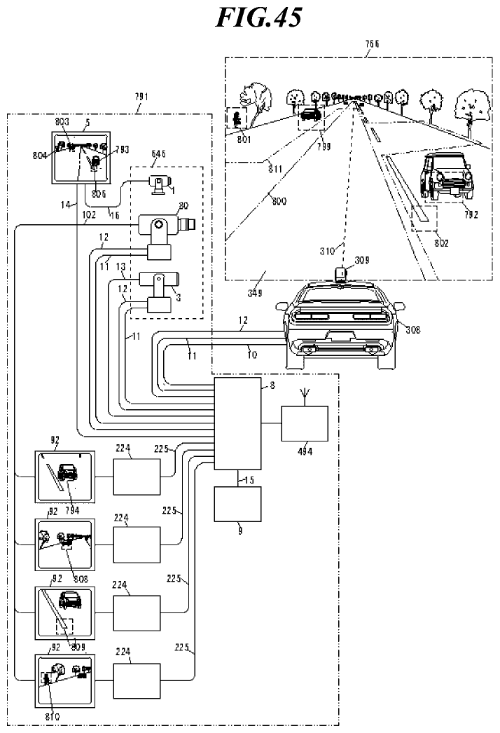

Example: The car of the tracking driving system traveling automobile 308 in FIG. 45 installs the tracking television camera distance measurement system 791 attached to the automatic driving car that has acquired the accident avoidance data of the tracking driving system 309 and runs on the general car driving road 349. The images of the preceding automobile 803, child on sidewalk 804, oncoming automobile 805 and center lane 806 detected on the fixed television camera monitor screen of the tracking driving system 309 are detected on the fixed television camera monitor screen 5 on which the subject photographed and detected by the fixed television camera 1 of the tracking driving system 309 is displayed.

The tracking laser distance measuring device 3 is directed to the direction of the position of each detected image on the fixed television camera monitor screen 5, and the distance is measured. The angle of view and the focal length are adjusted according to the respective measured distances, and, the driver drives while recognizing the images of the oncoming automobile 807, automobile ahead, 808, center lane 809, children on sidewalk 810 of tracking television camera monitor screen 92 of the tracking driving system on the tracking driving system tracking television camera monitor screen 92 by the tracking television camera 80 for each subject.

The directions and distances of these image-recognized images from the car of the tracking driving system traveling car 308 are measured. Therefore, the automobile is driven while recognizing the position of the image-recognized subject and confirming that the automobile is outside the collision range that has already been acquired. By analyzing the image-recognized position, the automobile is driven by predicting the collision range. This is driving within the driving lane range 800 within the driving range 811 of the tracking driving system fixed television camera imaging range 766.

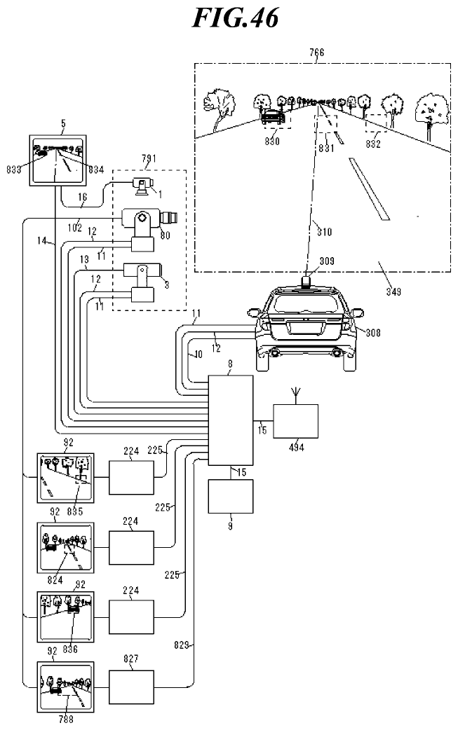

An image of a parked automobile 833 on the left side of the direction of travel and a median strip mark 834 on the right side of the direction of travel are detected on the fixed television camera monitor screen 5 of the tracking driving system photographed by the fixed television camera 1 of the tracking driving system 309 in FIG. 46. A tracking television camera 80 and a tracking laser distance measuring device 3 are directed to the direction of the position of each detected image on the fixed television camera monitor screen 5, and the respective distances are measured. The angle of view and the focal length are adjusted according to the respective measured distances, and, a right curbstone 835, a traveling direction median strip marking 824, a left parked automobile 836, a parked automobile and right center line 788 on the tracking television camera monitor screen of the tracking driving system are image-recognized on each tracking television camera monitor screen 92 photographed by the tracking television camera 80.

In order to confirm the travel route of the automobile, it is necessary to grasp the situation ahead of the travel route as much as possible. The tracking television camera 80 and the tracking laser distance measuring device 3 are directed toward the position of each detected image, and the tracking laser distance measuring device 3 measures the distance to the detected object since the subject whose image was detected by the fixed television camera 1 is far away. The angle of view of the tracking television camera 80 is narrowed according to the distance, the focal length is adjusted to the distance, and an image having an angle of view matching the shape of the subject is image-recognized. The shape of the subject can be analyzed in detail from the position where the image of the subject appears on the on the tracking television camera monitor screen 92 whose image has been confirmed, the direction and angle of view photographed by the tracking television camera 80, and the numerical values of the distance and position to the subject measured by the tracking laser distance measuring device 3.

Using the analyzed numerical value, Between the image-recognized median strip mark 824 on the tracking television camera monitor screen of the tracking driving system on the tracking television camera monitor screen 92 and the image-recognized left parked automobile 836 on the tracking television camera monitor screen of the tracking driving system, the distance between the parked automobile on the tracking television camera monitor screen and the right center line 788 is calculated and measured, and it is confirmed that the automobile of the tracking driving system traveling automobile 308 can pass and travel. Since the directions and distances of these image-recognized images are measured from the car of the tracking driving system traveling automobile 308, the automobile is traveling while recognizing the image-recognized positions.

The images of the parked automobile 833 on the left side in the direction of travel and the median strip mark 834 on the right side of the direction of travel detected on the fixed television camera monitor screen of the tracking driving system are image-recognized and their positions and shapes are measured. The shape recognition of the image at each distance is compared with the known shape image, and image recognition is performed as a passable shape image. Further, the distance between each image is calculated from the position where each image is measured, and the automobile continues traveling assuming that the automobile can pass through. Continuing the run, each image is recognized several times until it approaches each image, and the accuracy of calculation of the distance between each image is improved. The image is recognized, the possible running is predicted from the image, and an avoidance range is provided for running. The running operation is stored. The image recognized and analyzed is stored.

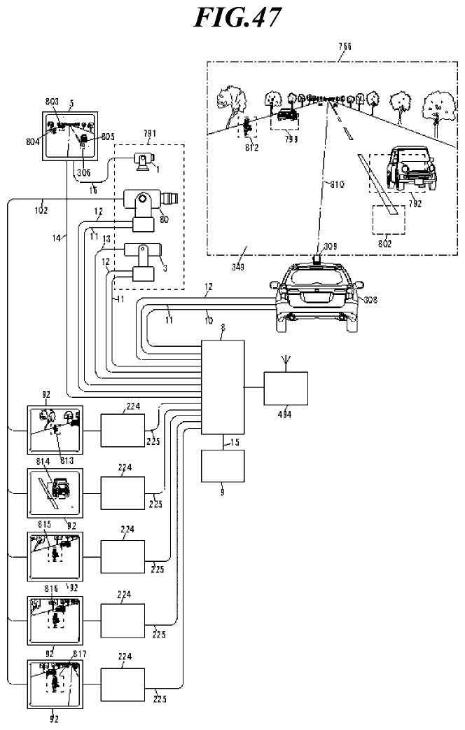

Example: The automobile of the tracking driving system traveling automobile 308 in FIG. 47 installs the tracking television camera distance measurement system 791 attached to the automatic driving automobile that has acquired the accident avoidance data of the tracking driving system 309 and travels at a speed for which an upper limit is set on the general automobile driving road 349. On the fixed television camera monitor screen 5 on which the subject photographed and image-detected by the fixed television camera 1 of the tracking driving system 309 is displayed, the images of a preceding automobile 803, a child on sidewalk 804, an oncoming automobile 805 and center lane 806 detected by the fixed television camera monitor screen of the tracking driving system 309 are detected.

A tracking television camera 80 and a tracking laser distance measuring device 3 are directed to the direction of the position of each detected image on the fixed television camera monitor screen 5, and the distance is measured. The angle of view and focal length are adjusted according to each measured distance, and the tracking television camera 80 photographs each subject, on the tracking television camera monitor screen 92, a child 814 on the roadway, an oncoming automobiles 815, a child on the road 816, a child in the direction of travel 817 and children in the direction of travel recognized as images on the tracking driving system tracking television camera monitor screen are recognized as objects to be avoided.

The directions and distances of these image-recognized images from the automobile of the tracking driving system traveling automobile 308 are measured. Therefore, the automobile is driven while recognizing the image-recognized position and confirming that the automobile is outside the collision range that has already been calculated and acquired. By recognizing the image-recognized position and driving while predicting the collision range, by making the determination of what the recognized image is known in advance or learning from the memory, the avoidance range of the image is widened, and the image recognition of the image and the distance measurement are concentrated.

The date and time are attached to the situation where the child is present on the roadway, and the memory of the position already image-recognized as the unique position by GPS direction measurement is shared on the Internet. As a result, the automobile equipped with the tracking television camera distance measurement system 791 attached to the automatic driving automobile that acquired the accident avoidance data of the tracking driving system 309 can drives in the same situation according to the memory of the position of the image recognition of the image. Furthermore, this automobile adds a memory at that position acquired by the same method, and the image recognition position memory of the acquired image is used as a position memory shared on the Internet, and can be learned from that memory.

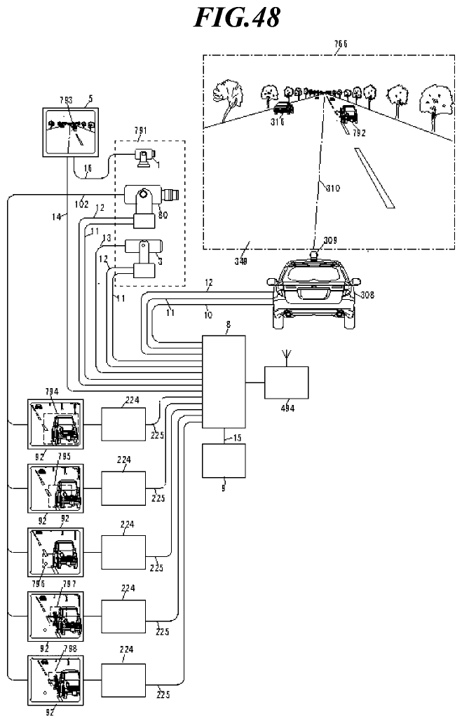

Example: The automobile of the tracking driving system traveling automobile 308 in FIG. 48 is installed a tracking television camera distance measurement system 791 attached to an autonomous automobile that has acquired accident avoidance data from the tracking driving system 309, and travels on the general automobile traveling road 349 at the speed for which the upper limit is set. The image of the oncoming automobile detected on the tracking driving system fixed television camera monitor screen 793 is detected on the fixed television camera monitor screen 5 photographed by the fixed television camera 1 of the tracking driving system 309.

The tracking television camera 80 and the tracking laser distance measuring device 3 are directed to the direction of the position of the detected image on the fixed television camera monitor screen 5, and the distance is measured. The angle of view and focal length are adjusted according to the measured distance. On the tracking television camera monitor screen 92 photographed by the tracking television camera 80 of the subject, the driver concentrates on image recognition according to the learned prediction of an oncoming automobile 794, oncoming automobile perimeter 795, a ball around the oncoming automobile 796, an oncoming automobile perimeter child 797 and an oncoming automobile perimeter child 798 recognizing the image on the tracking driving system tracking television camera monitor screen. Knowing or learning in advance the image of the learned prediction related to the image recognized image concentrates image recognition and distance measurement on the image to avoid the collision.

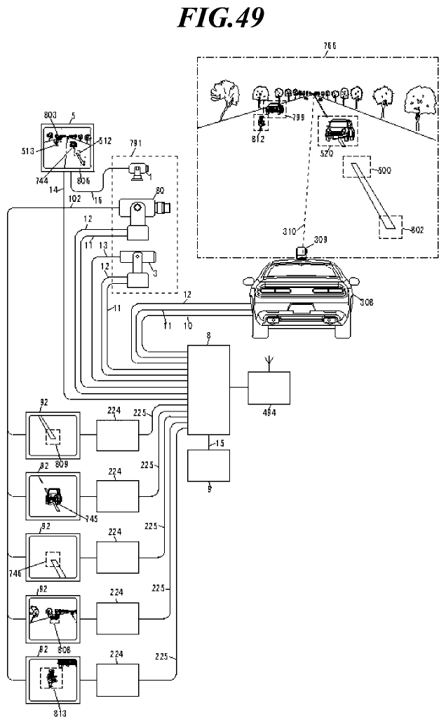

Example: The automobile of the tracking driving system traveling automobile 308 in FIG. 49 installs the tracking television camera distance measurement system 791 attached to the automatic driving automobile that has acquired the accident avoidance data of the tracking driving system 309 and travels on the general automobile driving road 349. A forward automobile 803, a center lane 806, an oncoming automobile 744 crossing the center lane, a forward center line 512, and an image 513 of a child are detected on the fixed television camera monitor screen 5 on which the subject photographed and detected by the fixed television camera 1 of the tracking driving system 309 on the fixed television camera monitor screen of the tracking driving system.

The tracking television camera 80 and the tracking laser distance measuring device 3 are directed toward the positions of the detected images on the fixed television camera monitor screen 5, respectively, and the distances are measured. The angle of view and focal length are adjusted according to each measured distance, and the tracking television camera 80 photographs each subject. On the tracking television camera monitor screen 92 photographed by the tracking driving system, the automobile runs while recognizing the images of a center lane 809, an oncoming automobile 745 crossing the center lane, center lane 746, preceding automobile 808 and a child on the roadway 813 on the tracking driving system tracking television camera monitor screen.

The directions and distances of these image-recognized images from the car of the tracking driving system traveling car 308 are measured. Therefore, the oncoming automobile 520 that has crossed the center line is recognized at an early stage, and the automobile is driven while confirming that the automobile is within the maximum collision avoidance range that has already been calculated and acquired. The child on the road recognized by the image on the tracking television camera monitor screen 813 of the tracking driving system is run in a simulation that prioritizes collision avoidance of the image. Predicting the image recognition of the oncoming automobile 520 that has advanced beyond the center line, and based on the position where the oncoming automobile was recognized, the driving that avoids the collision is calculated and assumed by simulation.

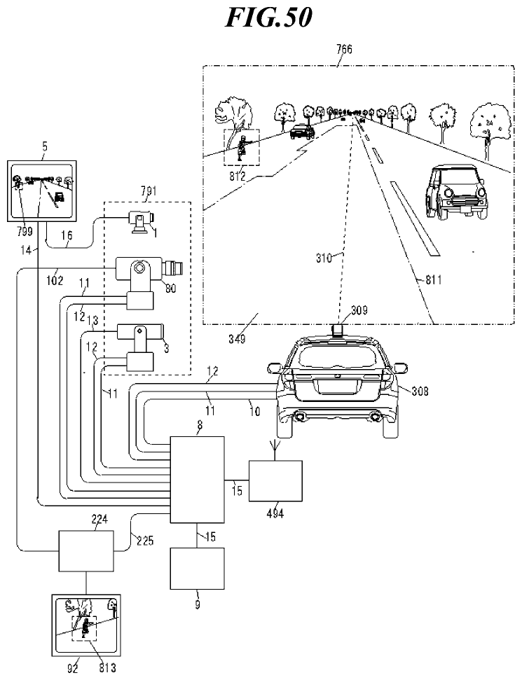

Example: A automobile of the tracking driving system traveling automobile 308 in FIG. 50 installs a tracking television camera distance measurement system 791 attached to an automatic driving automobile that has acquired accident avoidance data from the tracking driving system 309, and runs on a general car road 349 at a speed for which the upper limit is set. An image of a child 799 on the roadway detected by the tracking driving system fixed television camera monitor screen is detected on the fixed television camera monitor screen 5 photographed by the fixed television camera 1 of the tracking driving system 309.

The tracking television camera 80 and the tracking laser distance measuring device 3 are directed to the direction of the position of the detected image on the fixed television camera monitor screen 5 to measure the distance. The angle of view and the focal length are adjusted according to the measured distance, a child 813 on the roadway image-recognized on the tracking driving system tracking television camera monitor screen is image-recognized as a child on the tracking television camera monitor screen 92 in which the subject is photographed by the tracking television camera 80, and the child on the roadway is image-recognized continuously. The direction in which the automobile of the tracking driving system traveling automobile 308 travels and the position and traveling direction of its child are calculated and predicted as the child.

In order to avoid collision with the child, the avoidance direction of the tracking driving system traveling automobile 308 is measured from the position of the image detected by the image on the fixed television camera monitor screen 5 photographed by the fixed television camera 1 to the direction where there is no image that can detect the image of the avoidance direction by using avoidance traveling data acquired in advance, and the tracking laser distance measuring device 3 is directed in that direction and the distance is measured. The angle of view and focal length are adjusted according to the measured distance. The object is photographed by the tracking television camera 80, and the image is recognized that there is no image in the avoidance direction on the tracking television camera monitor screen 92 photographed by the tracking television camera 80, and the avoidance range is calculated using the avoidance traveling data acquired in advance.

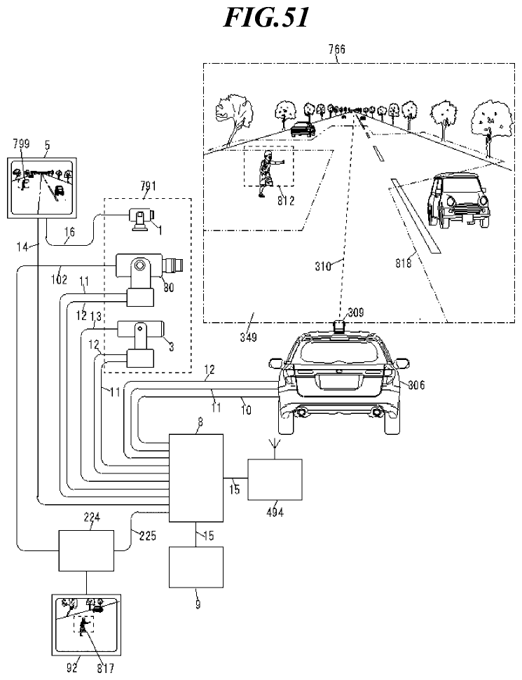

Example: A automobile of the tracking driving system traveling automobile 308 in FIG. 51 installs a tracking television camera distance measurement system 791 attached to an automatic driving automobile that has acquired accident avoidance data from the tracking driving system 309, and runs on a general car road 349 at a speed for which the upper limit is set. An image of a child 799 on the roadway detected by the tracking driving system fixed television camera monitor screen is detected on the fixed television camera monitor screen 5 photographed by the fixed television camera 1 of the tracking driving system 309.

The tracking television camera 80 and the tracking laser distance measuring device 3 are directed to the direction of the position of the detected image on the fixed television camera monitor screen 5 to measure the distance. The angle of view and focal length are adjusted according to the measured distance, and the tracking television camera 80 photographs the subject. On the tracking television camera monitor screen 92, an image of a child 817 in the recognized running direction on the tracking driving system tracking television camera monitor screen is recognized. The image of the child on the roadway is recognized again, and the direction in which the automobile of the tracking driving system traveling automobile 308 travels, the position of the child, and the traveling direction are calculated and predicted. The angle of view and the focal length are adjusted according to the measured distance, the several images are recognized on the tracking television camera monitor screen 92, and the traveling direction and position are calculated.

At that calculated position, this evasive driving data driving selection is made, including the maximum evasive driving previously acquired to avoid collision with the child. The maximum avoidance driving data acquired by the tracking driving system traveling automobile 308 is acquired by a driver who is familiar with the driving of the automobile, but the situation on a general automobile driving road is different. Therefore, the memory learned in the past is referred to as a method of searching for the avoidance direction. Using the various avoidance driving methods as learning data, avoidance driving data is learned and acquired.

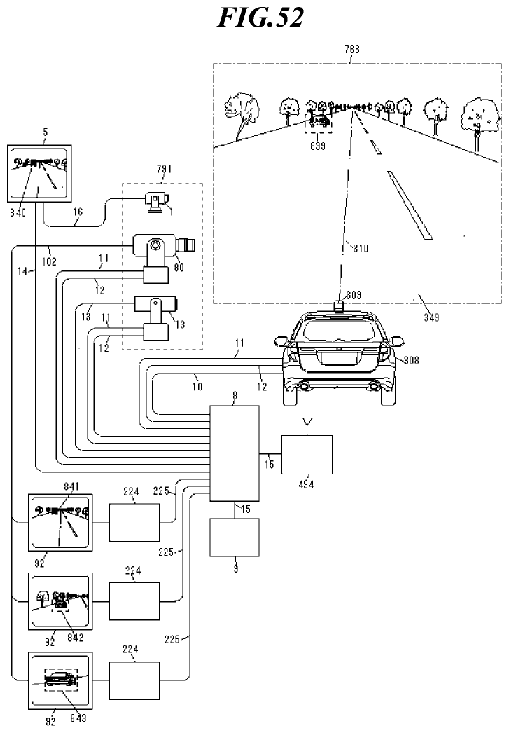

Example: A automobile of the tracking driving system traveling automobile 308 in FIG. 52 equipped with a tracking television camera system that has acquired accident avoidance of a tracking driving system 309 data installs a tracking television camera distance measurement system 791 attached to an automatic driving car that has acquired accident avoidance data from the tracking driving system 309, and runs on a general car road 349 at a speed for which the upper limit is set. This is the range on the screen where no image can be detected on the fixed television camera monitor screen 5 in which the fixed television camera 1 of the tracking driving system 309 photographs the traveling direction.

A tracking laser distance measuring device 3 and a tracking television camera 80 are directed toward a position where an image cannot be detected on the fixed television camera monitor screen 5 to measure the distance, and the tracking television camera 80 photographs at a wider angle of view. The distance can be measured by receiving the displayed light from the subject of the dark parked automobile 839 on the left side of the travel path ahead of the measuring laser beam of the tracking laser distance measuring device 3. The tracking television camera 80 is directed to a direction corresponding to the position of the difficult dark left parked automobile 840 image detected on the tracking driving system fixed television camera monitor screen on the fixed television camera monitor screen 5, which corresponds to the drive value of the tracking laser distance measuring device 3. At an angle of view corresponding to the distance that can be measured, the focal length is adjusted to the distance that the distance can be measured, and the difficult subject whose image is detected is photographed.

On the tracking television camera monitor screen 92, a dark subject 842 on the roadway recognized as an image on the tracking driving system tracking television camera monitor screen is recognized. The tracking laser distance measuring device 3 is directed to the position of the subject whose image is detected on the tracking television camera monitor screen 92, and the distance to the subject is measured again. The tracking television camera 80 is directed to the direction in which the re-measured distance is obtained, and the subject is photographed by increasing the sensitivity of the tracking television camera 80 at the angle of view and focal length corresponding to the re-measured distance. The image of the dark parked automobile 843 ahead of the driving road is recognized on the tracking driving system tracking television camera monitor screen, which is photographed by the tracking television camera 80.

Example: A automobile of the tracking driving system traveling automobile 308 in FIG. 52 equipped with a tracking television camera system that has acquired accident avoidance of a tracking driving system 309 data installs a tracking television camera distance measurement system 791 attached to an automatic driving car that has acquired accident avoidance data from the tracking driving system 309, and runs on a general car road 349 at a speed for which the upper limit is set. On the fixed television camera monitor screen 5 photographed by the fixed television camera 1 of the tracking driving system 309, the tracking driving system fixed television camera detects the left curbstone 822 in the direction of travel detected on the tracking driving system fixed television camera monitor screen, the median strip mark 823 in the direction of travel detected on the monitor screen, and several other images.

The tracking television camera 80 and the tracking laser distance measuring device 3 are directed toward the positions of the detected images on the fixed television camera monitor screen 5, respectively, and the respective distances are measured. The angle of view and the focal length are adjusted according to each measured distance, and image recognition is performed on each tracking television camera monitor screen 92 as a unique image of the recognized median strip marking 824, a left curbstone 825, the passing direction median strip marking 826 acquired by image recognition calculation on the tracking driving system tracking television camera monitor screen and a left curb 828 in passing direction on tracking driving system tracking television camera monitor screen on the tracking driving system tracking television camera monitor screen.

Since the directions and distances of these unique image-recognized images from the car of the tracking driving system traveling automobile 308 are measured, the automobile is traveling while recognizing the unique image-recognized positions. Those image-recognized positions are recognized and stored, and running while recognizing their unique image-recognized positions that are continuous with those stored image recognitions. The position of the automobile of the tracking driving system traveling automobile 308 that measured the image of each unique position can be the position measured by GPS. Since the directions and distances of these unique image-recognized images from the car of the tracking driving system traveling automobile 308 are measured, the automobile is traveling while recognizing the unique image-recognized positions. Learning is performed by sharing and memorizing the related numerical values associated with a large number of tracking driving system traveling automobiles 308. By sharing the location information of GPS and time and the measured location, the automobile of the tracking driving system traveling automobile 308 can drive while tracking and confirming the appropriate image already acquired.

Example: A automobile of the tracking driving system traveling automobile 308 in FIG. 52 equipped with a tracking television camera system 646 that has acquired accident avoidance of a tracking driving system 309 data installs a tracking television camera distance measurement system 791 attached to an automatic driving car that has acquired accident avoidance data from the tracking driving system 309, and runs on a general car road 349 at a speed for which the upper limit is set. On the fixed television camera monitor screen 5 photographed by the fixed television camera 1 of the tracking driving system 309, the images of the obstacles A 848, B 849, C 850 and D 851 on the traveling road detected on the tracking driving system fixed television camera monitor screen are detected.

The tracking television camera 80 and the tracking laser distance measuring device 3 are directed toward the positions of the detected images on the fixed television camera monitor screen 5, respectively, and the respective distances are measured. Obstacles A 844, B 845, C 846, and D 847 on the road in the traveling direction 310 are photographed by adjusting the angle of view and the focal length according to each measured distance. Furthermore, on the tracking television camera monitor screen 92, image analysis of the obstacles A 852, B 853, C 854, and D 855 on the traveling road recognized on the tracking driving system tracking television camera monitor screen is performed.

The shape of the obstacle at the destination, the running direction, the position and the distance are known by image analysis on the tracking television camera monitor screen 92. As a result, the arrangement of each obstacle can be calculated on the tracking driving system tracking television camera monitor screen 860 developed by the measured distance and direction in the traveling direction 310 of the traveling automobile 308, and the position of an obstacle to pass A 856, an obstacle to pass B 857, an obstacle to pass C 858, an obstacle D in passing direction 859 in the direction of travel can be calculated by image recognition calculation on the tracking driving system tracking television camera monitor screen. The tracking driving system traveling automobile 308 runs on the image-recognized calculated progress route screen on the tracking driving system tracking television camera monitor screen 861 avoiding those obstacles using traveling data for collision avoidance acquired in advance.

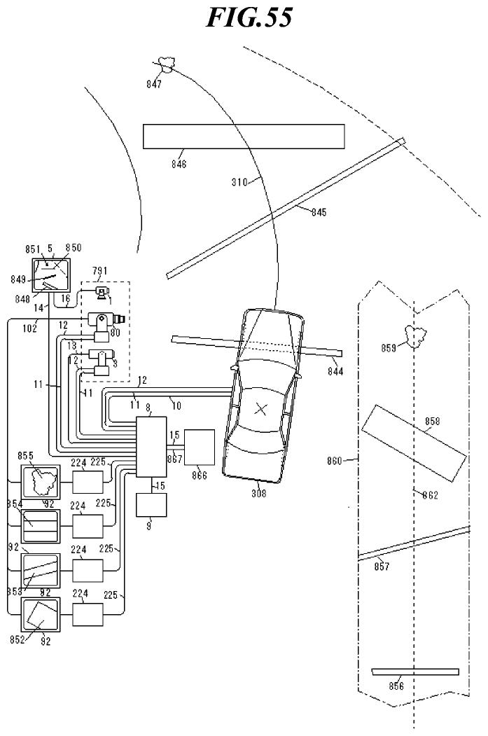

Example: The automobile of the tracking driving system traveling automobile 308 in FIG. 55 installs a tracking television camera distance measurement system 791 attached to an automatic driving car that has acquired accident avoidance data from the tracking driving system 309, and runs on a general car road 349 at a speed for which the upper limit is set. On the fixed television camera monitor screen 5 photographed by the fixed television camera 1 of the tracking driving system 309, the images of the obstacles A 848, B 849, C 850 and D 851 on the traveling road detected on the tracking driving system fixed television camera monitor screen are detected.

The tracking television camera 80 and the tracking laser distance measuring device 3 are directed toward the positions of the detected images on the fixed television camera monitor screen 5, respectively, and the respective distances are measured. The angle of view and focal length are adjusted according to each measured distance, each obstacle is photographed, and the image of the obstacle A on the traveling road recognized on the tracking driving system on the tracking television camera monitor screen is image-analyzed on the tracking television camera monitor screen 92.

For the obstacles at the destination, image-analyzed on the tracking television camera monitor screen 92, the direction, position and distance of the destination are image-recognized. As a result, each arrangement on the image-recognized operation screen on the tracking driving system tracking television camera monitor screen 860, which displays the placement of each obstacle by its measured distance and direction, can be image-recognized as a continuous operation screen as the position of the obstacle A 856, obstacle B 857, to be passed, obstacle C 858 to be passed and obstacle D 859 in the passing direction on the traveling direction on the monitor screen for which the image recognition operation has been performed.

The tracking driving system traveling automobile 308 acquires in advance an image of an obstacle recognized as an image of its destination during its travel, and uses a converter 866 of the direction and position of the image recognized on the tracking driving system tracking television camera monitor screen to determine the position of the automobile. The tracking driving system traveling automobile 308 acquires in advance an image of an obstacle that has been image-recognized at its destination while traveling. A converter 866 for the direction and position of the image recognized by the image on the tracking driving system tracking television camera monitor screen displays the image position of the obstacle recognized by the image in the distance and direction of the automobile in accordance with the running position of the automobile. The tracking driving system traveling automobile 308, which is equipped with a converter 866 for the direction and position of the image recognized on the tracking driving system tracking television camera monitor screen travels while deploying the image of the obstacle at the previously acquired travel position and the image of the obstacle at that travel position in the measured distance and direction. The position of the obstacle grasped by the impact of the suspension received from the tires of the car of the tracking driving system traveling automobile 308 comes to the position of the tire at the measured distance since the image of the obstacle whose image is being recognized is analyzed by grasping its position, shape, and article in advance. From the image of the obstacle analyzed by changing the image position of the obstacle with the converter, the automobile travels over the obstacle by absorbing the impact of the obstacle by using a traveling method that lowers the impact according to the impact applied to the position of the tire when the automobile runs.

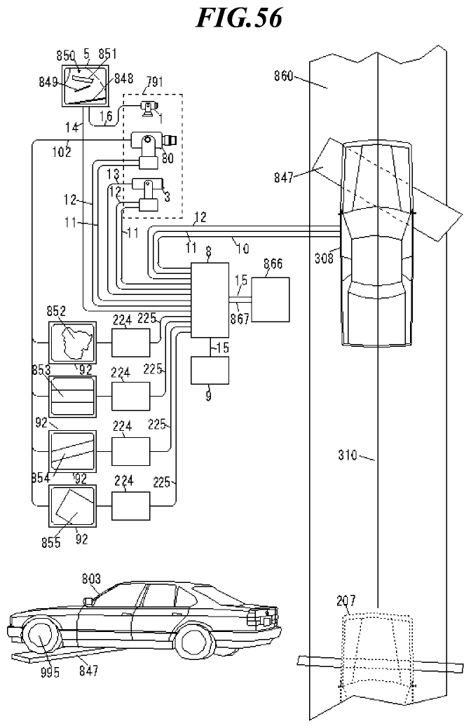

Example: The car of the tracking driving system traveling automobile 308 installed with the tracking television camera system that acquired the accident avoidance data of FIG. 56 is installed with the tracking television camera distance measurement system 791 attached to the automatic driving car that acquired the accident avoidance data of the tracking driving system 309, and runs on a general car road 349 at a speed for which the upper limit is set.

The images of the obstacles A 848, B, 849, C 950 and D 951 on the traveling road detected on the tracking driving system fixed television camera monitor screen are detected on the fixed television camera monitor screen 5 photographed by the fixed television camera 1 of the tracking driving system traveling automobile 308. The tracking television camera 80 and the tracking laser distance measuring device 3 are directed toward the positions of the detected images on the fixed television camera monitor screen 5, respectively, and the respective distances are measured. The angle of view and the focal length are adjusted according to each measured distance, and the tracking television camera 80 photographs each image.

On the tracking television camera monitor screen 92, obstacles A 852, B 853, C 854, and D 855 on the traveling road recognized as images on the tracking driving system tracking television camera monitor screen are analyzed.

The automobile of the tracking driving system traveling automobile 308 recognizes the image of the obstacle D 855 on the driving road on the tracking driving system tracking television camera monitor screen on the tracking television camera monitor screen 92 image-confirmed at the image-recognized position 207. From the position 207 where the tire 995 of the left wheel of the automobile with the tracking driving system runs over the obstacle D 847 on the road is image-recognized to the position of the image where the tire 995 runs over the obstacle D 847 on the road. In the direction of travel and up to the distance traveled, a tracking television camera image direction and position converter 866 analyzes the shape of the image of the obstacle it rides in accordance with the measured distance and direction. As a result, the image of the tire 995 of the left wheel of the tracking driving system traveling automobile riding on the obstacle D847 on the traveling road can be confirmed, so that it is possible to cope with the impact absorption in the shape of the obstacle in advance.

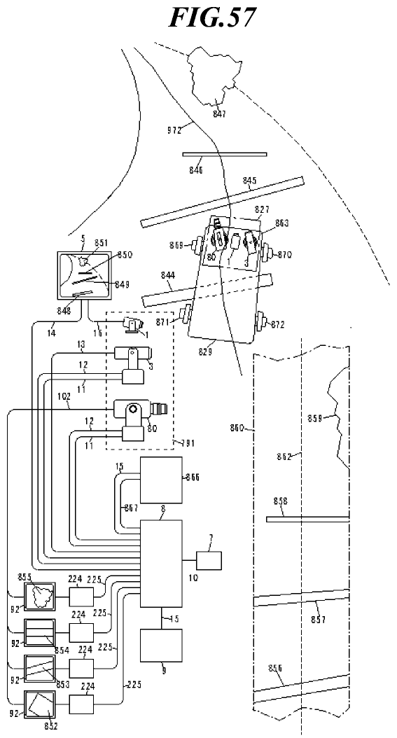

Example: A tracking television camera image position development system 863 is installed on the four-legged traveling machine 829 in FIG. 57. The images of the obstacles A 848, B 849, C 850, and D 851 recognized by the tracking operation system on the fixed television camera monitor screen are detected on the fixed television camera monitor screen 5 photographed by the fixed television camera 1 of the four-legged traveling machine 829.

The tracking television camera 80 and the tracking laser distance measuring device 3 are directed to the direction of the position of each detected image on the fixed television camera monitor screen 5 to measure the distance. The tracking television camera 80 adjusts the angle of view and focal length according to the measured distance. The images of obstacles A 852, B 853, C 854, and D 855 acquired by image analysis on the tracking driving system tracking television camera monitor screen are analyzed on the tracking television camera monitor screen 92 that has been photographed.

An obstacle at the destination analyzed on the tracking television camera monitor screen 92 is subjected to image position development processing by a converter 866 for the direction and position of the image of the tracking television camera. Tracking driving system tracking television camera monitor screen displays image recognition calculation screen 860 on the destination of the driving route. The images on the tracking television camera monitor screen 92 of the obstacles A 856, B 857, C 858, and D 859 image-analyzed on the tracking driving system tracking television camera monitor screen of the obstacles photographed from the direction in which the four-legged traveling machine 829 has traveled are image-processed in terms of the measurement direction and the measured distance by the tracking television camera image direction and position converter 866 as the position viewed from the traveling direction in which the four-legged traveling machine 829 travels. On the expanded virtual screen, the positions of the obstacle A 856 passed through, the passing obstacle B 857, the obstacle C 858 to be passed in the direction of passage and the obstacle D 859 to be passed analyzed by the image analysis on the tracking driving system tracking television camera monitor screen can be displayed.

In the image processing of the image position development system 863 of the tracking television camera, the four-legged traveling machine 829 travels using the driving legs. The four-legged traveling machine 829 avoids the obstacle A 844 on the traveling road by using the position of the obstacle A 856 on the screen and information acquired by analyzing the image of the obstacle A 852 on the monitor screen. The four-legged traveling machine 829 avoids the obstacle A844 on the traveling road by using the position of the obstacle A856 that passed through in the direction of travel after image analysis on the monitor screen of the driving leg hanging on obstacle A844 on the running path directly below the frame on the tracking driving system tracking television camera monitor screen and information acquired by analyzing the image of the obstacle A 852 on the tracking driving system tracking television camera monitor screen. The analyzed information of the obstacle A 852 on the road recognized by the image on the tracking driving system tracking television camera monitor screen and the position of the obstacle by the direction and distance measured by the tracking laser distance measuring device 3 are continuously developed by the converter 866 for the direction and position of the image of the tracking television camera. As a result, the four-legged traveling machine 829 can run on its driving legs while avoiding the position of the obstacle developed according to the traveling position of the four-legged traveling machine 829.

The fixed television camera 1 photographs an obstacle on the running path in the direction in which the four-legged traveling machine 829 walks, and the image of the obstacle is detected on the fixed television camera monitor screen 5. The tracking laser distance measuring device 3 and the tracking television camera 80 are directed to the direction of the image of the obstacle to measure the distance to the obstacle. An image photographed by matching the angle of view and focal length of the tracking television camera 80 according to the measured distance is analyzed on the tracking television camera monitor screen 92. The image-analyzed obstacle continues to be developed as a spatial position developed on the tracking television camera monitor screen 92 where the tracking television camera 80 photographs the obstacle in accordance with the direction in which the four-legged traveling machine 829 walks at the direction and distance measured by the tracking laser distance measuring device 3. The two-dimensional screen of the tracking television camera monitor screen 92 accurately develops the position of the obstacle as a three-dimensional space by adding the accurate distance measured by the tracking laser distance measuring device 3. Obstacles on the two-dimensional tracking television camera monitor screen 92 photographed by the tracking television camera 80 are developed as positions of obstacles in a three-dimensional space assumed by the computer.

The three-dimensional space assumed by the computer of the tracking television camera image direction and position converter 866 unfolds according to the photographing direction of the tracking television camera 80. The distance measured by the tracking laser distance measuring device 3 and the driving numerical value in the direction photographed by the tracking television camera 80 at the walking position of the four-legged traveling machine 829 are developed. At the same time, the development according to the screen photographed by the tracking television camera 80 is developed in the three-dimensional space assumed by the computer of the development system 863 of the image position of the tracking television camera of the four-legged traveling machine 829, and the driving position of the driving legs of the four-legged traveling machine 829 is also developed in the three-dimensional space. As a result, in the three-dimensional space assumed by the computer of the four-legged traveling machine 829, the driving position of the driving leg can be avoided while avoiding the obstacle. The obstacle directly below the body of the foot-driven traveling machine 829 is an obstacle that was previously photographed by the tracking television camera 80 and developed in the three-dimensional space. However, four-legged traveling machine 829 continues to develop several images containing the obstacle in three-dimensional space, with the position of the several images containing the obstacle at the direction and distance measured by the tracking laser distance measuring device 3 according to the walking. As a result, the four-legged traveling machine 829 recognizes an obstacle that has come directly under the frame, and sets the driving positions of the driving legs.

Obstacle 844 directly below the frame of four-legged traveling machine 829 described in FIG. 57 is photographed by fixed television camera 1 and detected on fixed television camera monitor screen 5 before walking to that position. The tracking laser distance measuring device 3 measures the distance to the position of the obstacle whose image has been recognized. The image of the tracking television camera is developed into a three-dimensional space assumed by the computer of the orientation and position converter 866 by using the obstacle and the measured distance photographed by the tracking television camera 80 at the measured distance and image-analyzed on the tracking television camera monitor screen 92. The developing system 863 of the image position of the tracking television camera develops it in the three-dimensional space assumed by the computer on the screen in the direction in which the four-legged traveling machine 829 walks and the tracking television camera 80 photographs. Along with the walking of the four-legged traveling machine 829, the development of the three-dimensional space continues to be updated with the screen photographed by the tracking television camera 80 and the numerical values of the direction and distance measured by the tracking laser distance measuring device 3. The driving mechanism of the four-legged traveling machine 829 advances in accordance with the driving numerical value of the numerical control mechanism of the tracking television camera 80 in the direction in which the tracking television camera 80 photographs. In the running direction 862, the obstacle A 856 passed in the moving direction, the obstacle B 857 to be passed, the obstacle C 858 to be passed in the direction of passage and the obstacle D 859 in the direction of passage analyzed by the image analysis on the tracking driving system tracking television camera monitor screen of the calculation screen 860 recognized by the image on the monitor screen is developed and the robot walks with the driving leg.

Obstacles A 844, B 845, C 846, and D 849 on the road are developed into a three-dimensional space assumed by the computer by a development system 863 for image positions of the tracking television camera. The positions where the driving leg of the drive mechanism of the front left 869, the front right 870, the rear left 871 and the rear right 872 of the four-legged traveling machine 829 runs are developed in the three-dimensional space assumed by the computer at the position developed to the obstacle A 856 passed through, the obstacle B 657 to pass, the obstacle C 858 to be passed and the obstacle D 859 in the direction of passage by the image analysis on the tracking driving system tracking television camera monitor screen. The positions where the driving leg of the drive mechanism of the front left 869, front right 870, rear left 871, rear right 872 of the four-legged traveling machine 829 runs are developed in the three-dimensional space assumed by the computer at the position where the image analysis of the image analysis on the tracking driving system tracking television camera monitor screen develops to the passed obstacle A, the obstacle B to pass, the obstacle C to be passed, and obstacle D in the direction of passage. This makes it possible to avoid the obstacles A 844, B 845, C 846, and D 849 on the running path for the driving legs of the four-legged running machine 829 to run. The four-legged traveling machine 829 uses the image of that position which has previously converted the image position with the converter of that position and uses the driving legs of the front left 869, front right 870, rear left 871, and rear right 872 drive mechanisms to select a position where there is no obstacle and lower the driving legs to run. The development of the three-dimensional space assumed by the computer in the photographing direction of the tracking television camera 80 is developed in the three-dimensional space according to the photographing direction of the tracking television camera 80. The driving position of the driving legs of the four-legged traveling machine 829 avoids the obstacle A 844, B 845, C 846 and D 849 on the running path in the three-dimensional space developed by the system 863 that processes the images of the tracking laser distance measuring device and the tracking television camera with the driving numerical value in the photographing direction of the driving mechanism of the tracking television camera 80.

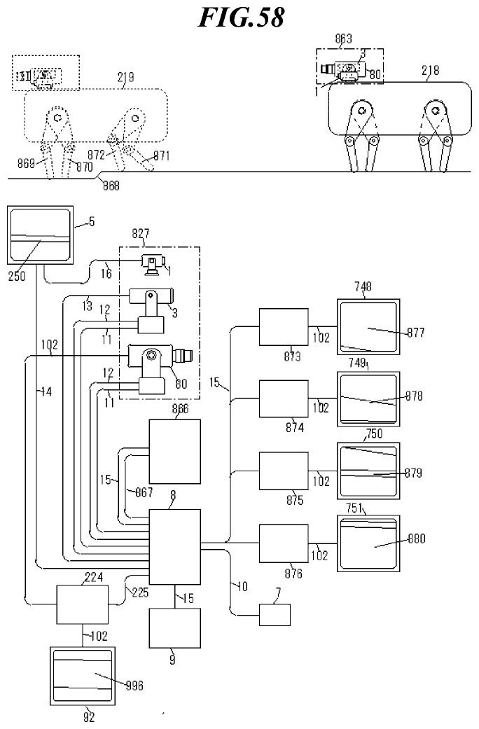

Example: A four-legged traveling machine 829 equipped with an image position deployment system 863 of tracking television camera, a tracking laser distance measuring device 3, and a tracking television camera 80 shown in FIG. 58. The direction and position of the recognized image on the tracking television camera monitor screen 92 photographed by the tracking television camera 80 of the tracking television camera distance measurement system 827 attached to the four-legged traveling machine changes in direction and position due to the movement of the four-legged traveling machine 829. The four-legged traveling machine 829 is provided with a converter 866 for the direction and position of the image of the tracking television camera, which converts the photographed and recognized image into an image with a different direction and position.

At the position of the four-legged traveling machine, the image of the step 250 on the fixed television camera monitor screen is detected on the fixed television camera monitor screen 5 photographed by the fixed television camera 1 at the step A218 of the travel path 868. The tracking television camera 80 and the tracking laser distance measuring device 3 are directed to the direction of the position of the detected image on the fixed television camera monitor screen 5, and the distance is measured. The angle of view and the focal length are adjusted according to the measured distance, and image analysis is performed on the tracking television camera monitor screen 92 photographed by the tracking television camera 80 for the step 996 of the obstacle on the running road recognized as an image on the tracking driving system on the tracking television camera monitor screen.

The fixed television camera 1 at the position B 219 of the four-legged traveling machine, which the four-legged traveling machine has advanced and moved, photographs and detects a new image on the fixed television camera monitor screen 5. The newly detected image is subjected to new image analysis at the position moved on the tracking television camera monitor screen 92. At the position B 219 of the four-legged drive machine, using the position and direction of the newly recognized image, the image recognized at the position A 218 of the four-legged traveling machine is image-converted using the converter 866 for the image direction and position of the tracking television camera. At the position where the four-legged traveling machine 829 has moved to the position B 219 of the four-legged traveling machine, the image confirmed at the position A 218 of the four-legged traveling machine is image-confirmed by using the image converter 866 at the position A 218 of the four-legged traveling machine based on the distance and direction of movement.

The image of the driving leg of the four-legged traveling machine 829 at a front left drive walking position 877 aligned with the image-converted monitor screen A 748, at a front right drive walking position 878, at a rear left drive mechanism walking position 879 aligned with image converted monitor screen C 750 and at a rear right drive numerical walking position 880 according to image converted monitor screen D 751 is image-confirmed. The front left driving numerical calculator 873, the front right driving numerical calculator 874, the rear left driving numerical calculator 875 and the rear right driving numerical calculator 876 drive the driving mechanism of each driving foot, and advances the steps 868 of the traveling path by walking with the driving foot. The four-legged traveling machine 219 recognizes an image of an obstacle acquired in advance by deploying the image of the obstacle at the position of the obstacle where the robot walks. The four-legged traveling machine 219 moves the driving legs of the front left drive mechanism 869, the front right drive mechanism 870, the rear left drive mechanism 871, and the rear right drive mechanism 872 in a drive method that matches the position of the developed image.

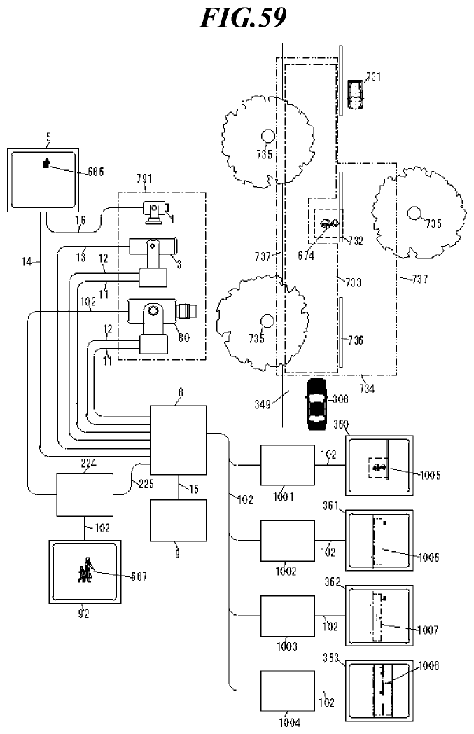

Example: A tracking driving system traveling automobile 308 equipped with a tracking television camera distance measurement system 791 attached to an automatic driving automobile that acquires accident avoidance data from a tracking driving system 309 in FIG. 59 travels on a general automobile road 349 at a speed for which the upper limit is set. An image of a subject 686 detected by a fixed television camera monitor attached to an automatically driving automobile was detected on a fixed television camera monitor screen 5 photographed by a fixed television camera 1 of a tracking television camera distance measurement system 791 attached to an automatically driving automobile. The tracking laser distance measuring device 3 is directed in the direction of the position of the image on the fixed television camera monitor screen 5 where the image is detected, and the distance is measured. The angle of view and focal length are adjusted according to the measured distance, the subject 687 image-analyzed appearing on the tracking television camera monitor attached to the automatic driving automobile is image-recognized on the tracking television camera monitor screen 92 photographed by the tracking television camera 80.

The direction and distance of the recognized image from the automobile of the tracking driving system traveling automobile 308 are measured. Therefore, by recognizing the image-recognized position, it is confirmed that the avoidance area 732 already acquired by the automobile is a direction and distance within the accident avoidance data range of the tracking driving system 309. At the same time, the tracking television camera distance measurement system 72 is used to perform image analysis of the image around the avoidance area 732 that has already been acquired before the image is recognized. In the image analysis, the maximum collision avoidance with the object 674 to be collision avoided is acquired by a driver who is familiar with the driving of the traveling automobile, and therefore the maximum collision avoidance result is taken into consideration.

In order to maximize the result of collision avoidance, a collision avoidance method is determined at the time of starting the avoidance operation. Therefore, the following driving system 309 constantly scans the image around the automobile of the following driving system traveling automobile 308. The tracking driving system 309 measures the direction and distance of the detected image. The object in the image is image-recognized, the image-recognized object is analyzed, and the automobile travels while setting a travel area 733 and a retreat area 734. An image analyzer corresponding to an image-analyzed object 687 appearing on a tracking television camera monitor attached to an automatic driving automobile at a position on the tracking television camera monitor screen 92 where the object 674 to be collision-avoided analyzed by image analyzer 224 is image-analyzed sets an avoidance area. The object 674 to be collision-avoided is image-analyzed by the image analyzer A 1001, and the image-analyzed object 687 displayed on the tracking television camera monitor attached to the self-driving automobile at the position on the tracking television camera monitor screen A 360 is analyzed.

A driving area 1006 corresponding to the subject 687 analyzed by the image analyzer B 1002 and displayed on the tracking television camera monitor attached to the automated driving automobile at position B on the tracking television camera monitor screen 361 when there is no subject 674 to avoid collision is set. An evacuation area 1007 is set corresponding to the subject 687 image-analyzed on the tracking television camera monitor attached to the automated driving automobile at the position C on the tracking television camera monitor screen 362 where the image analyzer C 1003 has image-analyzed the subject 674 to avoid collision. The image analyzer D1004 sets the position C on the tracking television camera monitor screen 363 of the image-analyzed object 674 to be collision-avoided, and the maximum avoidance driving area 1008 corresponding to the image-analyzed object 687 displayed on the tracking television camera monitor attached to the automated driving automobile.

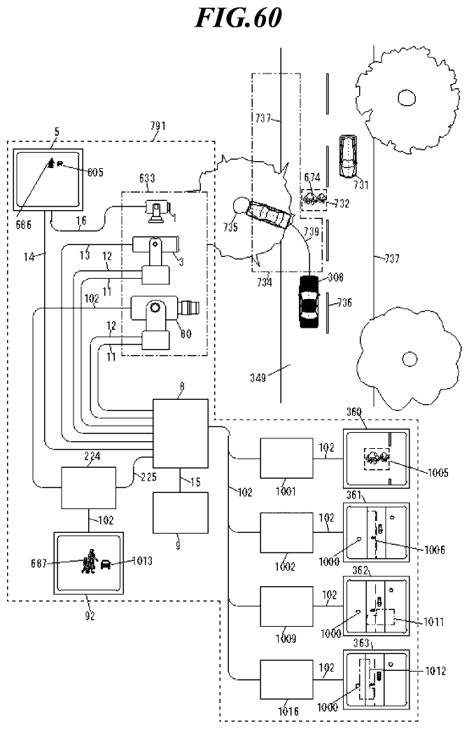

Example: A tracking driving system traveling automobile 308 equipped with a tracking television camera distance measurement system 791 attached to an automatic driving automobile that acquires accident avoidance data from a tracking driving system 309 in FIG. 60 travels on a general automobile road 349 at a speed for which the upper limit is set. On the fixed television camera monitor screen 5 photographed by the fixed television camera 1 with the tracking television camera distance measurement system 791 attached to the autonomous automobile, the image of the oncoming automobile 731 was detected at the same time as the object 674 of the oncoming automobile 805 that should be avoided, which was detected on the fixed television camera monitor screen of the tracking driving system and the object 686 displayed on the fixed television camera monitor attached to the automatic driving automobile. The tracking laser distance measuring device 3 measures the direction of the subject 686 displayed on the fixed television camera monitor attached to the automatic driving automobile and the direction of the oncoming automobile 805 detected by the image on the fixed television camera monitor screen of the tracking driving system. In accordance with the direction and the distance measured, a tracking television camera 80 photographs an object 674 to avoid collision and an oncoming automobile 731. The image analyzer 224 analyzes the image-analyzed subject 687 displayed on the tracking television camera monitor attached to the automatic driving automobile on the tracking television camera monitor screen 92 and the position image of the oncoming automobile 1013 to be avoided traveling in the oncoming lane displayed on the tracking television camera monitor attached to the automatic driving automobile and makes a judgment.

Based on the analysis by the image analyzer A 1001, it is determined that the collision with the object to be avoided 1005 on the tracking television camera monitor screen A 360 is to be absolutely avoided. The image analyzer B 1002 analyzes that it cannot be avoided by driving in the driving area 1006 on the tracking television camera monitor screen B 361. According to the analysis of the image analyzer C 1003, the maximum avoidance driving area A 1011 on the tracking television camera monitor screen E 362 and the analysis of the image analyzer D 1004 show the roadside tree 1000 just to the left on the tracking television camera monitor screen of the maximum avoidance driving area B 1012 on the tracking television camera monitor screen F 363. The avoidance data of the collision avoidance driving of the driver who is familiar with the driving of the car is carried out for the object 674 that should be avoided while driving into a street tree 735 to be collision avoided, and the decision driving to avoid the collision is carried out.

The maximum avoidance driving area A 1011 on the tracking television camera monitor screen 92 and the maximum avoidance driving area B 1012 on the tracking television camera monitor screen 92 are analyzed. The maximum avoidance driving area A 1011 is the area on the tracking television camera monitor screen 92 of the image-analyzed object 687 appearing on the tracking television camera monitor attached to the automatic driving automobile at the position on the tracking television camera monitor screen 92 where the image-analyzed object 674 analyzed by the image analyzer E 1009 to be collision-avoided ahead of the travel road is displayed. The maximum avoidance driving area B 1012 is an area on the tracking television camera monitor screen 92 of the image-analyzed subject 687 appearing on the tracking television camera monitor attached to the automatic driving automobile at the position on the tracking television camera monitor screen 92 where the image analysis of the subject 674 to be avoided by the image analyzer F 1016 is image-analyzed. By comparing and analyzing the maximum avoidance driving area A 1011 and the maximum avoidance driving area B 1012 obtained by image analysis, the evacuation driving area A 739, which causes less collision damage, was selected and crashed into the roadside tree 735. Accident avoidance data of the follow-up driving system 309 of this evacuation run A 739, numerical values measured by the acceleration/deceleration sensor and impact sensor 1064 attached to the follow-up driving system 309, and analyzed images are stored.

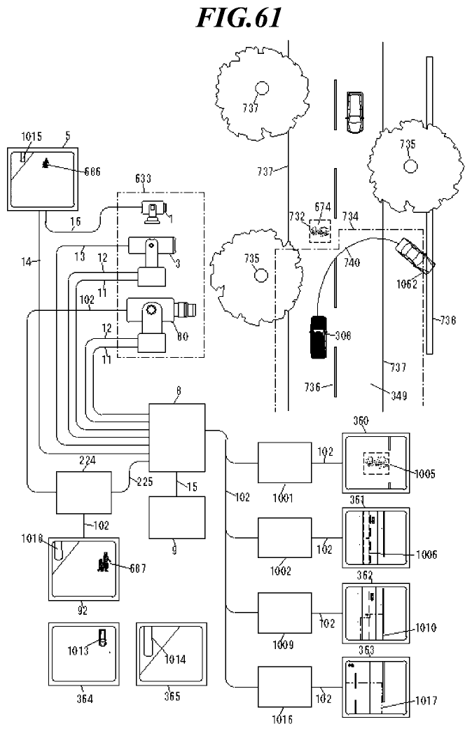

Example: A tracking driving system traveling automobile 308 equipped with a distance measurement system 791 attached to an automatic driving automobile that acquires accident avoidance data from a tracking driving system 309 in FIG. 61 travels on a general automobile road 349 at a speed for which the upper limit is set. An image of an object 674 displayed on the fixed television camera monitor screen 5 photographed by the fixed television camera 1 of the tracking driving system 309, to be collision-avoided ahead of the traveling road appears on the fixed television camera monitor screen 5, and an image of an object 686 appearing on the fixed television camera monitor attached to the automatic driving automobile is detected. At the same time, an image of a roadside tree 735 on the left side of the road on the fixed television camera monitor screen 5, and an image of the roadside tree 1015 just to the left of the fixed television camera monitor screen was detected.

The images on the fixed television camera monitor screen 5 are detected, and the distance is measured by directing the tracking laser distance measuring device 3 in the direction of the positions of those images. The angle of view and focal length are adjusted according to the measured distance, and the photographed screen is image-analyzed by the image analyzer 224 on the tracking television camera monitor screen 92 of the image-analyzed object 687 appearing on the tracking television camera monitor attached to the automatic driving automobile and the roadside tree 1018 to be avoided on the tracking television camera monitor. The avoidance area 732 of the subject 1005 to be avoided is analyzed by the image analyzer A 1001. Since the driving area 1006 has been analyzed by the image analyzer B 1002, it is analyzed that if the driving is continued, it will collide with the object 674 to be avoided, and avoidance data driving is selected.

The avoidance driving area 1010 is selected in E 362 on the tracking television camera monitor screen by the image analyzer E 1009. Then, an image of an oncoming automobile 1013 to be avoided traveling in the oncoming lane was detected on the tracking television camera monitor screen E 364 on the tracking television camera monitor screen. At F 365 on the tracking television camera monitor screen, it is detected the image of the left side street tree 1014 displayed on the tracking television camera monitor attached to the self-driving automobile. In order to avoid a collision with the oncoming automobile 731 analyzed by the image analyzer 224 or the roadside tree 735, the maximum avoidance driving area C 1017 of D 363 on the tracking television camera monitor analyzed by the image analyzer F 1016 is selected. Evacuation driving B 740 with less damage in the image-analyzed maximum avoidance driving area C 1017 is selected, and the automobile collides with the obliquely colliding wall 1062 of the image recognition wall 738. Add the values measured by the acceleration/deceleration sensor and the impact sensor in the maximum avoidance driving that have already been acquired to the selection frame, and select the avoidance method with less impact after the maximum avoidance driving.

The values measured by the acceleration/deceleration sensor and impact sensor are stored.

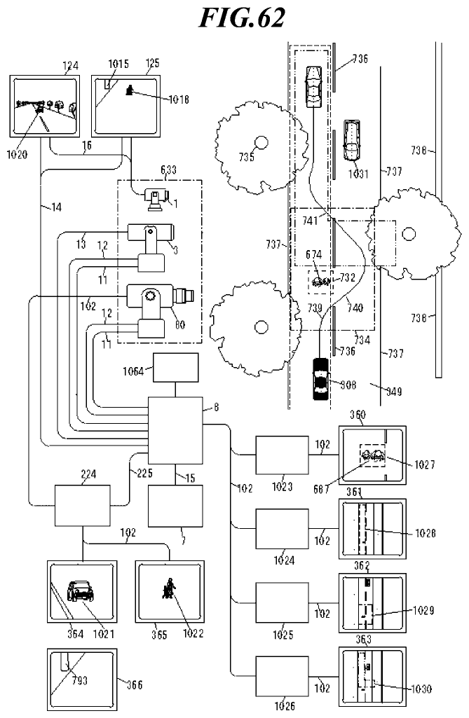

Example: A tracking driving system traveling automobile 308 equipped with a tracking television camera distance measurement system 791 attached to an automatic driving automobile that acquires accident avoidance data from a tracking driving system 309 in FIG. 62 travels on a general automobile road 349 at a speed for which the upper limit is set. An image of a subject 1018 to be avoided on the fixed television camera monitor screen is detected on the fixed television camera monitor screen B 125 photographed by the fixed television camera 1 of the tracking driving system 309. The tracking laser distance measuring device 3 is directed to the direction of the position of the detected image on the fixed television camera monitor screen B 125, and the distance to the subject is measured. The angle of view and focal length are adjusted according to the measured distance, and on the tracking television camera monitor screen F 365, the parent and child 1022 to be avoided traveling in the opposite lane appearing on the tracking television camera monitor attached to the automatic driving automobile are recognized. During avoidance driving to the object, the image of the advancing automobile 1020 in the oncoming lane to be avoided on the fixed television camera monitor screen A 124 is recognized. The tracking laser distance measuring device 3 is pointed in the direction of the position of the detected image on the fixed television camera monitor screen A 124, and the distance to the advancing automobile is measured. The angle of view and focal length are adjusted according to the measured distance, and on the tracking television camera monitor screen F 364, an image of an oncoming automobile 1021 to be avoided traveling in the oncoming lane is recognized on the tracking television camera monitor attached to the autonomous automobile.

A position evacuation area 1027 is set on the tracking television camera monitor screen A 360 obtained by image analysis of the parent and child of the subject 687 for which image analysis is performed by the image analyzer A 1023 and displayed on the tracking television camera monitor attached to the automatic driving automobile since the image analyzer 224 selects the object 674 to avoid collision. The image analyzer B 1024 performs image analysis of the parent and child of the subject 674 to avoid collision, and sets a restricted travel area 1028 on the position on the tracking television camera monitor screen B 361 to perform the avoidance travel of the evacuation travel A 739. The tracking laser distance measuring device 3 is directed to the direction of the position of the detected image of the advancing automobile 1020 on the fixed television camera monitor screen 124, and the distance is measured since the image of the advancing automobile 1020 in the oncoming lane to be avoided on the fixed television camera monitor screen A 124 is recognized during the avoidance driving of the parent and child. The angle of view and focal length are adjusted according to the measured distance to the traveling automobile, and the image recognition of the traveling automobile 1021 on the tracking driving system tracking television camera monitor screen is recognized on the tracking television camera monitor screen E 264. On the tracking television camera monitor screen 92 analyzed by the image analyzer 224, an oncoming automobile 1021 to be avoided traveling in the opposite lane, which is displayed on the tracking television camera monitor attached to the automatic driving automobile, is analyzed. Avoidance travel is performed in the maximum avoidance travel B 740 in the avoidance travel area D 1029 on the television camera monitor screen C 362 tracking the oncoming automobile 731 analyzed by the image analyzer C 1025.

In order to avoid collision with the oncoming automobile 731 analyzed by the image analyzer D 1026 during avoidance driving in the avoidance driving area D 1029 analyzed by the image analyzer C 1025, the maximum avoidance driving area E 1030 is set and the avoidance driving of the evacuation driving C 741 is performed. During avoidance driving of the oncoming automobile 731, the image of the roadside tree 1015 on the fixed television camera monitor screen 125 is recognized just before the left of the fixed television camera monitor screen. As a result, the tracking laser distance measuring device 3 is directed in the direction of the detected image of the roadside tree 735 on the fixed television camera monitor screen 125, and the distance is measured. The angle of view and focal length are adjusted according to the measured distance to the roadside tree, and the image-recognized roadside tree 793 on the tracking television camera monitor screen is analyzed on the tracking television camera monitor screen G 366. On the tracking television camera monitor screen G 366 analyzed by the image analyzer 224, in order to avoid a collision with the roadside tree 735 on the side of the road of the roadside tree 1014 on the left side shown on the tracking television camera monitor attached to the automatic driving automobile, the maximum avoidance driving area is newly set and the avoidance driving is performed.

In order to avoid a collision with the oncoming automobile 1031 whose image is analyzed by the image analyzer D 1026, the maximum avoidance driving area E 1030 is set and the avoidance driving of the evacuation driving C 741 is performed by analyzing the oncoming automobile that should be avoided traveling in the oncoming lane 1021 displayed on the tracking television camera monitor attached to the autonomous driving automobile. A roadside tree 1015 is detected on the fixed television camera monitor screen 125 just before the left of the fixed television camera monitor screen during the evacuation run of the evacuation run C 741. Therefore, the position of the image of the roadside tree 793 recognized on the tracking television camera monitor screen of the tracking driving system tracking television camera on the monitor screen 92 is the direction and position where the tracking driving system traveling automobile 308 changed the traveling directions of the evacuation traveling A 739, B 740, C 741. The position of the street tree 735 on the side of the road is grasped by the image-recognized street tree 793 on the tracking television camera monitor screen G 366 of the tracking driving system tracking television camera monitor screen. Namely, preparations are made to set the maximum avoidance travel area E 1030 and perform the evacuation travel C 741.

Avoidance driving for maximum collision avoidance with the object 674 to be collision-avoided and maximum avoidance driving for head-on collision with a automobile traveling in the oncoming lane are considered even to the maximum collision avoidance results since avoidance data is acquired by a driver who is familiar with driving the automobile. In the subsequent avoidance travels of evacuation travel A 739, evacuation travel B 740, and evacuation travel C 741, the numerical values measured by the acceleration/deceleration sensor and impact sensor 1064 and the recognized image are stored. Because of the variety of these cases, it is necessary to learn from a large number of cases where the best workarounds are also very diverse.

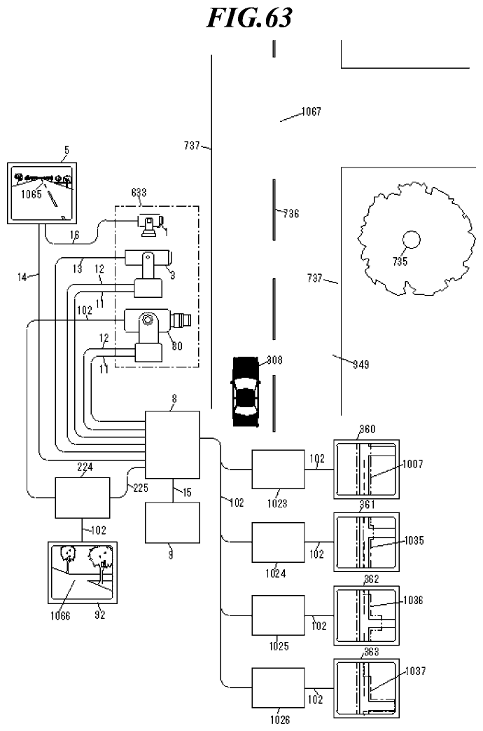

Example: A tracking driving system traveling automobile 308 equipped with a tracking television camera distance measurement system 791 attached to an automatic driving automobile that acquires accident avoidance data from a tracking driving system 309 in FIG. 63 travels on a general automobile road 349 at a speed for which the upper limit is set. An intersection 1067 photographed by the fixed television camera 1 of the following driving system 309 is detected on the fixed television camera monitor screen 5, and an image of an intersection 1065 detected on the fixed television camera monitor screen of the following driving system is detected.

In the direction of each position of the image of the intersection where the image on the fixed television camera monitor screen 5 is detected, the tracking laser distance measuring device 3 is directed to each corner and the distance is measured. The angle of view and the focal length are adjusted according to the measured distance, and the image-recognized intersection 1066 on the tracking television camera monitor screen 92 is image-analyzed on the tracking driving system tracking television camera monitor screen. Assuming a collision with a traveling automobile at an intersection 1066, which is image-analyzed on the tracking driving system tracking television camera monitor screen image analyzed by the image analyzer A 1024, a travelable area A 1007 is set at a position on the tracking television camera monitor screen A 360 where the image analyzer A 1023 has image-analyzed the avoidance.

In addition to the approach to the intersection, assuming a collision with an advancing automobile at an intersection 1066, 1067 recognized as an image on a tracking driving system tracking television camera monitor screen analyzed by the image analyzer 224, a travelable area B 1035 is set at a position on the tracking television camera monitor screen B 361 where the avoidance image analysis B 1024 has analyzed the avoidance image. In addition to approaching the intersection, assuming a collision with an advancing automobile at intersections 1066 and 1067 recognized by the tracking driving system tracking television camera monitor screen image analyzed by the image analyzer 224, a travelable area C 1036 is set at a position on the tracking television camera monitor screen C 362 where the image analyzer B 1024 that has image-analyzed the avoidance has image-analyzed the avoidance. Assuming a collision with an advancing automobile at an intersection 1066, 1067 recognized on the tracking driving system tracking television camera monitor screen image analyzed by the image analyzer 1025, Run while setting the drivable area D 1037 at the position on the tracking television camera monitor screen D 363 where the avoidance image was analyzed.

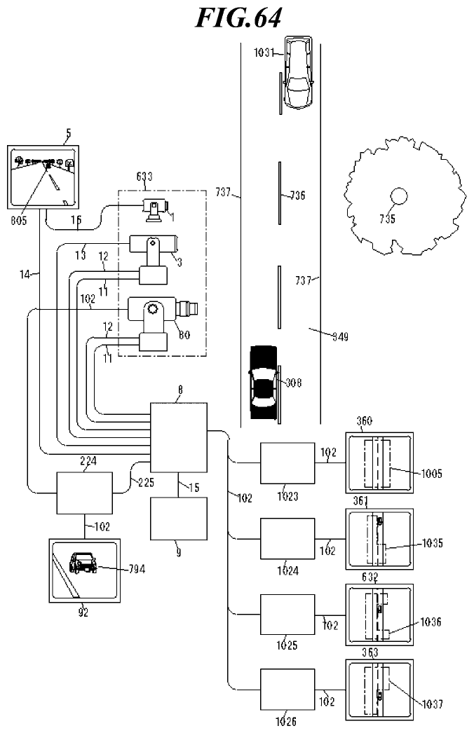

Example: A tracking driving system traveling automobile 308 equipped with a tracking television camera distance measurement system 791 attached to an automatic driving automobile that acquires accident avoidance data from a tracking driving system 309 in FIG. 64 travels on a general automobile road 349 at a speed for which the upper limit is set. An image of an oncoming automobile 1033 displayed on a fixed television camera monitor attached to the automatic driving automobile is detected on the fixed television camera monitor screen 5 photographed by the fixed television camera 1 of the tracking driving system 309 just before approaching the oncoming automobile 1031 from a distance. The tracking laser distance measuring device 3 is directed to the direction of the position of the detected image on the fixed television camera monitor screen 5 to measure the distance. The angle of view and focal length are adjusted according to the measured distance. If the image of the oncoming automobile 794 recognized on the tracking driving system tracking television camera monitor screen is not recognized on the tracking television camera monitor screen 92 photographed by the tracking television camera 80, the image analyzer A 1023 sets an unlimited driving range 1046.

When the image of the oncoming automobile 794 that was recognized on the tracking driving system tracking television camera monitor screen is recognized as an approaching image, the image analyzer B 1024 sets a limited driving range 1047 to the opposite lane in the range of the oncoming automobile position B 1043 that is displayed on the tracking television camera monitor attached to the autonomous automobile. When the image of the oncoming automobile 794 that was recognized on the tracking driving system tracking television camera monitor screen is recognized as an approaching image, the image analyzer C 1025 sets a prohibited driving range 1048 to the opposite lane in the range during driving of the oncoming automobile position C 1044 displayed on the tracking television camera monitor attached to the autonomous automobile.

In the case of the oncoming automobile position D1045 shown on the tracking television camera monitor attached to the autonomous automobile, the image analyzer D1026 sets the restricted driving range 1049 of the own lane. The means for avoiding an accident with the oncoming automobile 794 recognized on the tracking driving system tracking television camera monitor screen by the image analyzer 224 is calculated on the tracking television camera monitor screen 92 according to the traveling position and traveling speed of the oncoming automobile.

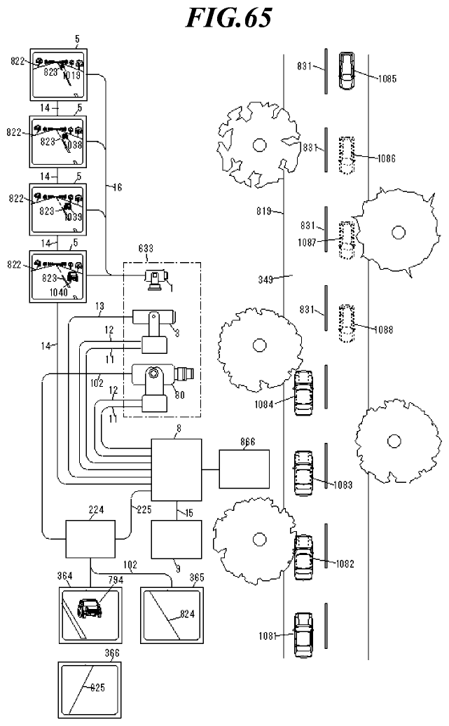

Example: A tracking driving system traveling automobile 308 equipped with a tracking television camera distance measurement system 791 attached to an automatic driving automobile that acquires accident avoidance data from a tracking driving system 309 in FIG. 65 travels on a general automobile road 349 at a speed for which the upper limit is set. On the fixed television camera monitor screen 5 of the image of the oncoming automobile at the approaching position A 1085 taken by the fixed television camera 1 of the tracking driving system 309 from the driving position A 1081, a distant approaching automobile 1019 displayed on the fixed television camera monitor attached to the automatic driving automobile, a median strip marking 823 in the direction of travel detected in the image on the tracking driving system fixed television camera monitor screen, and a left curbstone 822 in the direction of travel detected in the image on the tracking driving system fixed television camera monitor screen were detected.

The tracking laser distance measuring device 3 is directed to each direction in the direction of the position of the detected image on the fixed television camera monitor screen 5 to measure the distance. The angle of view and focal length are adjusted according to the measured distance, and the tracking television camera 80 photographs the image and analyzes the recognized oncoming automobile 794 on the tracking driving system tracking television camera monitor screen on the tracking television camera monitor screen E 364. On the tracking television camera monitor screen F 365, image analysis is performed on the recognized median strip marking 824 on the tracking driving system tracking television camera monitor screen. On the tracking television camera monitor screen G 366, image analysis is performed on the right curbstone 835 that has been image-recognized on the tracking driving system tracking television camera monitor screen.

At approach position B1086 taken by fixed television camera 1 from running position B1082, the distance between the image-recognized oncoming automobile 794 at the approaching oncoming automobile position 1041, the median strip marking 824, and the right curb 835 is calculated by the distance and angle measured by the tracking laser distance measuring device 3, and it is confirmed that passing is possible. Similarly, on the fixed television camera monitor screens B 149 and C 150 photographed by the fixed television camera 1, the oncoming automobile 1041 approaching the approaching positions C 1087 and D 1088 from the traveling positions C 1083 and D 1084, approaching automobiles 1039, 1040 and median markings 823 and left curbs 822 are detected. On the tracking television camera monitor screens E 364, F 365, and G 366, image analysis of the oncoming automobile 794, image analysis of the median strip marking 824, image analysis of the right curbstone 825, and measurement of distance and angle are performed, and confirmed that passing is possible.

When the tracking driving system traveling automobile 308 travels on a general automobile traveling road without a median strip, it is necessary to constantly monitor the movement of an approaching subject. The position 1041 of the approaching oncoming automobile is photographed by the fixed television camera 1, and the distance and direction of the approaching automobile 1019 detected on the fixed television camera monitor screen 5 are measured by the tracking laser distance measuring device 3. Image analysis is performed on the image photographed by the tracking television camera 80 at the measured distance, and it is determined that it is necessary to continue monitoring. By developing of the tracking television camera image orientation and position converter 866, the image position of the oncoming automobile 794 is developed and grasped in the three-dimensional space of the computer in the direction of travel of the tracking driving system driving automobile 308 and the direction of the approaching distance according to the traveling distance. This confirms that it is possible to pass each other safely.

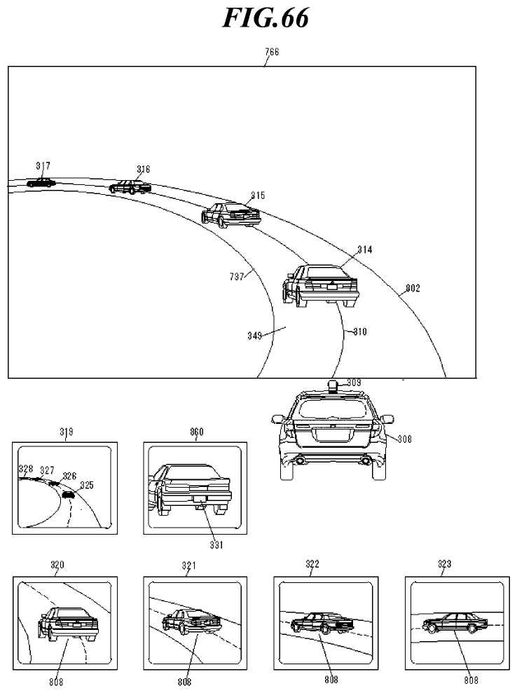

Example: The automobile of the driving system traveling automobile 308 installed with the tracking television camera system that acquired the accident avoidance data of FIG. 66 installs the tracking television camera system that acquired the accident avoidance data of the tracking drive system 309 and runs on the general automobile road 349 at the speed for which the upper limit is set. The preceding automobile in the preceding automobile in the tracking driving system fixed television camera photographing range 766 runs through the general automobile road 349 in the traveling direction 310 without any abnormality, and the image is detected.

The preceding automobile uses the tracking laser distance measuring device 3 to measure the respective distances from the traveling images of the preceding automobiles A 325, B 326, C 327, and D 328 at each position at each position where the preceding automobiles A 314, B 315, C 317, and D 318 detected the images on the tracking driving system fixed television camera monitor screen photographed by the fixed television camera 1 of the tracking driving system 309 and passed over the tracking driving system fixed television camera monitor screen 319. The screen showing the recognized automobile ahead on the tracking driving system tracking television camera monitor screen 808 photographed by the tracking television camera 80 are recognized on the tracking driving system tracking television camera monitor screens A 320, B 321, C 322 and D 323 at the angle of view and focal length corresponding to the measured distance, and the images are continuously stored.

According to the direction in which the tracking driving system traveling automobile 308 travels and the fixed television camera 1 photographs and the distance traveled, the continuously stored screens are developed into the tracking driving system tracking television camera monitor screens A 320, B 321, C 322, and D 323, which correspond to the positions to be tracked. The rear part 331 of the preceding automobile in the image displayed on the operation screen 860 after the image recognition on the tracking driving system tracking television camera monitor screen is image-recognized, and the automobile follows the automobile. A tracking driving system that tracks and runs follows the tracking distance and the tracking direction with the numerical values associated with the numerical control driving values of the tracking automobile by the computation of the complementary method. A display sign suitable for image recognition is used for tracked transportation automobiles and the like.

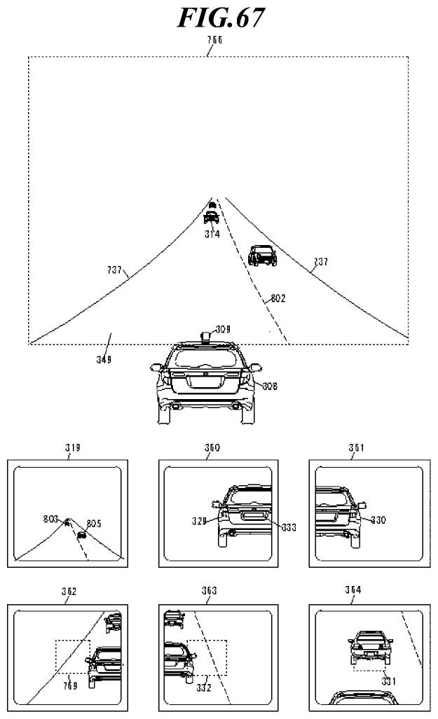

Example: The automobile of the driving system traveling automobile 308 installed with the tracking television camera system that acquired the accident avoidance data of FIG. 67 installs the tracking television camera system that acquired the accident avoidance data of the tracking drive system 309 and runs on the general automobile road 349 at the speed for which the upper limit is set. On the tracking driving system fixed television camera monitor screen 319 photographed by the fixed television camera 1 of the tracking driving system 309, the image of the preceding automobile 803 detected on the tracking driving system fixed television camera monitor screen and the image of the oncoming automobile 805 detected on the tracking driving system fixed television camera monitor screen of the tracking driving system fixed television camera are detected.

The distance of each detected image on the tracking driving system fixed television camera monitor screen 319 is measured by the tracking laser distance measuring device 3 of the tracking driving system 309. The angle of view and focal length are adjusted according to the measured distance. While driving while recognizing the image of the rear left of the automobile ahead of the preceding automobile on the tracking television camera monitor screen A 360, the rear right of the automobile ahead of the preceding automobile on B 361, the road curb stone on the left side of the rear of the traveling automobile of the preceding automobile on the screen C 632 and the road curb stone on the right side of the traveling automobile of the preceding automobile on the screen D 363.

It measures the position of the preceding automobile on the road and constantly confirms that there are no abnormalities in driving. Since there is no abnormality in the driving, the image of the rear part 331 of the preceding automobile on the tracking television camera monitor screen E 364 is followed. The time is attached to the information related to traveling acquired by the tracking driving system traveling automobile 308 attached to the preceding traveling automobile A 314 and transmitted to the surrounding automobiles. Detects abnormalities in preceding automobiles and quickly switches to corresponding driving. The number of times of image recognition is adjusted according to the recognized image, the degree of driving control operation learned from driving values of the driving control of the automobile during many image recognitions during past driving, and the degree of danger of the image recognized image.

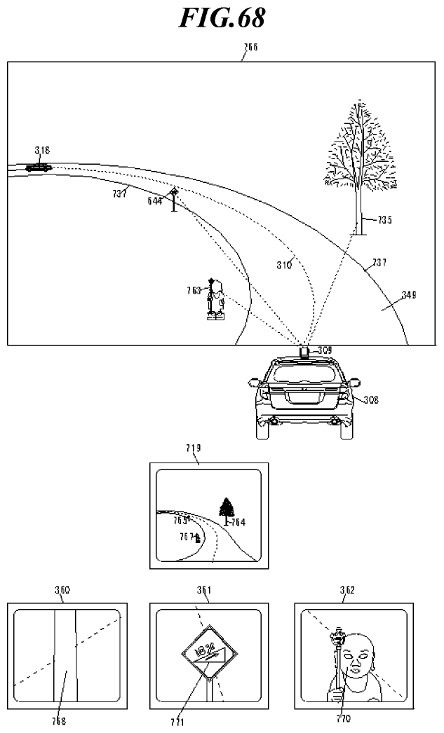

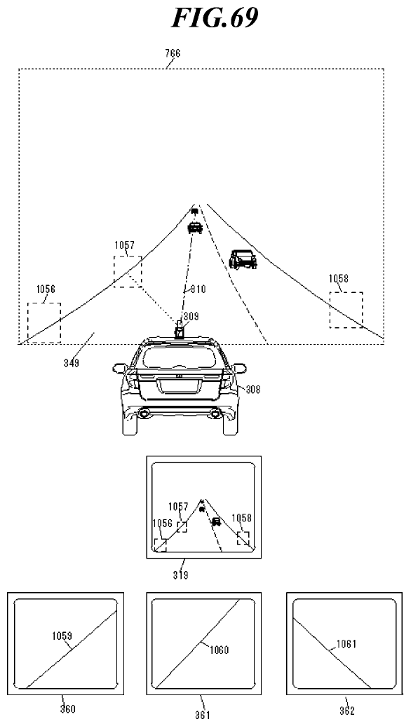

Example: The automobile of the driving system traveling automobile 308 installed with the tracking television camera system that acquired the accident avoidance data of FIG. 68 installs the tracking television camera system that acquired the accident avoidance data of the tracking drive system 309 and runs on the general automobile road 349 at the speed for which the upper limit is set. On the tracking driving system fixed television camera monitor screen 319 photographed by the fixed television camera 1 of the tracking driving system 309, the images of the sign tower 765, the stone Buddha 767, and the roadside tree 764 on the right side of the road appearing on the screen of the fixed television camera monitor are detected.

The distance of each detected image on the tracking driving system fixed television camera monitor screen 319 is measured by the tracking laser distance measuring device 3 of the tracking driving system 309. The angle of view and focal length are adjusted according to the measured distances, and the automobile runs as the image recognition of the unique position of the right side street tree 768 on the tracking television camera monitor screen A 360, the left sign tower 771 on the tracking television camera monitor screen of tracking television camera monitor screen B 361 and the left stone Buddha 770 on the tracking television camera monitor screen of tracking television camera monitor screen C 362.

The trees and trees image-recognized as unique positions, the markers, the stone buddhas, the measured distances, the traveling direction of the automobile of the tracking driving system traveling automobile 308, the GPS positioning, the traveling speed of the following driving system traveling automobile 308, and the driving numerical value of the driving mechanism of the traveling operation of the automobile are associated with each other to store the positions. The location image-recognized as the unique location and the storage of the unique name are shared on the Internet. As a result, the automobile equipped with the tracking driving system 309 can travel in the same place according to its location memory. Furthermore, the location memory obtained in the same way can be added, and the obtained location memory can be used to learn the location memory shared on the Internet.

Example: The automobile of the driving system traveling automobile 308 installed with the tracking television camera system that acquired the accident avoidance data of FIG. 69 installs the tracking television camera system that acquired the accident avoidance data of the tracking drive system 309 and runs on the general automobile road 349 at the speed for which the upper limit is set. Images of a curb stone 1056 on the left side, a far curb stone 1057 on the left side, and a curb stone 1058 on the right side are detected on the tracking driving system fixed television camera monitor screen 319 photographed by the fixed television camera 1 of the following driving system 309.

The respective distances of the detected images on the tracking driving system fixed television camera monitor screen 319 are measured by the tracking laser distance measuring device 3 of the tracking operation system 309. According to the measured distance, The automobile runs as an image recognition of the left side curb 1059 on the tracking driving system fixed television camera on camera monitor screen of the tracking television camera monitor screen A 360, the curbstone 1060 on the far left side on the tracking driving system fixed television camera on camera monitor screen of the tracking television camera monitor screen B 361 and the right side curb 1061 on the tracking driving system fixed television camera on camera monitor screen of the tracking television camera monitor screen C 362, which are photographed by the tracking television camera 80 by adjusting the angle of view and the focal length, and the curb on the side of the road and the center line.

Based on the image-recognized direction of the curb and the center line and the measured distance, the automobile of the tracking driving system traveling automobile 308 continues traveling. Then, the distance between the curbstone, the centerline, and the car of the tracking driving system running automobile 308 is calculated and confirmed at the position of the traveling road passing through the image-recognized side curbstone and the centerline. The curb on the left side, the center line, the curb on the right side, the measured road width, the position measured by GPS, and the heading in the direction of travel are displayed and stored under shared names.

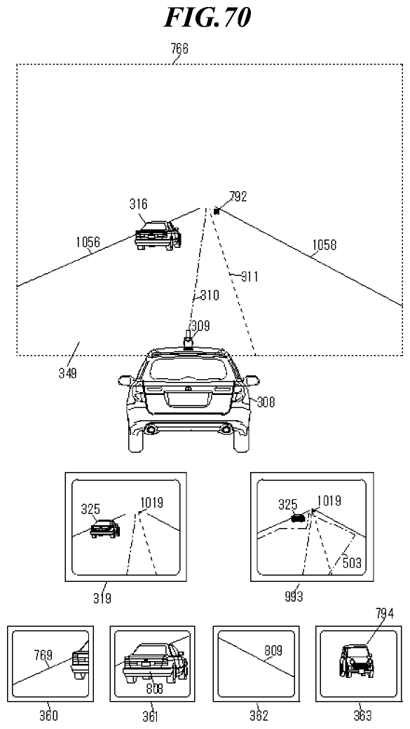

Example: The automobile of the driving system traveling automobile 308 installed with the tracking television camera system that acquired the overtaking driving data of FIG. 70 installs the tracking television camera system that acquired the overtaking driving data of the tracking drive system 309 and runs on the general automobile road 349 at the speed for which the upper limit is set. On the tracking driving system on fixed television camera monitor screen 319 photographed by the fixed television camera 1 of the tracking driving system 309, it detects the image of the preceding automobile A 325 detected on the tracking driving system fixed television camera monitor screen and the image of the distant approaching automobile 1019 displayed on the fixed television camera monitor attached to the self-driving automobile far away.

The detected image on the tracking driving system fixed television camera monitor screen 319 is measured by the tracking laser distance measuring device 3 of the tracking driving system 309 to measure the distance from the detected image in that direction and the running speed of the oncoming automobile 792 in the oncoming lane. According to the measured distance, the angle of view and the focal length are adjusted, and the distance is measured at the image-recognized position of the image-recognized left curb 769 on the tracking driving system tracking television camera monitor screen on the tracking television camera monitor screen A 360 in which the tracking television camera 80 photographs the direction. The distance is measured at the image-recognized position of the preceding automobile 808 on the tracking television camera monitor screen B 361 of the tracking television camera monitor screen.

The distance is measured at the image-recognized position of the image-recognized center lane 809 on the tracking television camera monitor screen C362 of the tracking driving system tracking television camera monitor screen. The distance is measured at the image-recognized position of the oncoming automobile 807 on the tracking television camera monitor screen D 363 of the tracking driving system tracking television camera monitor screen. To confirm that the oncoming automobile is far away, it is confirmed by measuring the distance at the image recognition position of the distant approaching automobile 1019 displayed on the fixed television camera monitor attached to the automatic driving automobile. An overtaking driving range 503 is calculated and set on a combined screen 993 with a fixed television camera monitor. Tracking television camera monitor screens A 360, B 361, C 362 and D 636 are developed for each image-analyzed object in front of and behind the running position of the computer of the tracking driving system traveling automobile 308 in the three-dimensional space according to the traveling direction 310 of the tracking driving system running automobile 308. The overtaking driving data of the tracking driving system 309 is used to accelerate and overtake the leading automobile 318 within the development range of the three-dimensional space.

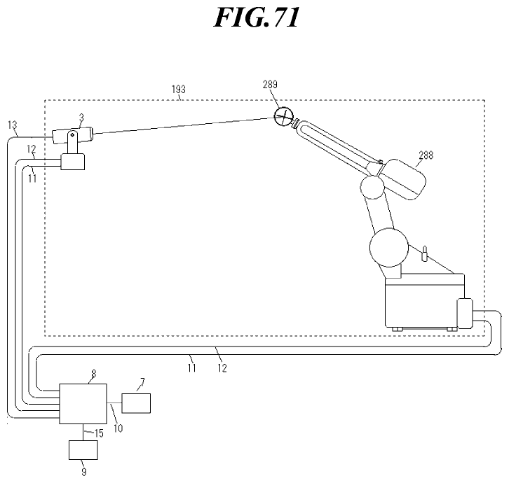

Example: The tracking laser distance measuring device 3 in FIG. 71 driven by numerical control measures the distance between the numerically controlled robot 288 and the robot working position 289 by operating the console 7. The measured distance, its measurement direction, the driving numerical value of the numerically controlled tracking laser distance measuring device 3, the robot working position 289 of the numerically controlled robot 288, and the driving numerical value of the numerically controlled robot 288 can be numerically positioned as the robot work space 177.

At the working position of the numerically controlled robot 288, the driving numerical value of the numerically controlled robot 288 at the robot working position 289 is associated with the direction and distance measured by the tracking laser distance measuring device 3 that drives the robot working position 289 by numerical control. Then, using the several associated numerical values, the relationship between the driving numerical value of the numerical control robot 288 at all the working positions, the direction and distance measured by the tracking laser distance measuring device 3 and the driving numerical value of the tracking laser distance measuring device 3 regarding all the work at the robot working position 289 is calculated and acquired by interpolation calculation or the like. Alternatively, it is acquired by simulation calculations related to some of the measured numerical values. By measuring distances with a plurality of tracking laser distance measuring devices 3, the robot working positions 289 of the robots can be associated more accurately.

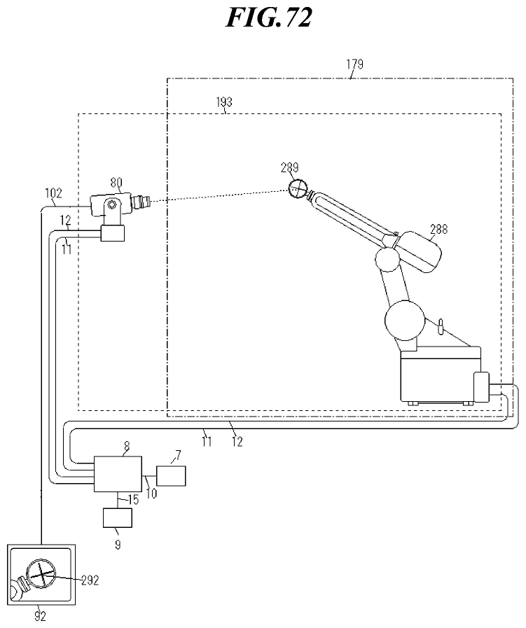

Example: In the tracking television camera photographing range 179 in FIG. 72, the robot working position 289 of the numerically controlled robot 288 is photographed by the numerically controlled tracking television camera 80. The direction, the angle of view, the focal length, etc. of the robot working position 289 are photographed by operating the operation console 7 so that the image of the working position 289 displayed on the screen photographed by the tracking television camera 80 is displayed in the center of the tracking television camera monitor screen 92. The drive values of the numerically controlled tracking television camera 80 and its photographed image and focal length, the operational numerical value of the operator console 7 that operated the robot working position 289 of the numerically controlled robot 288, and the drive values of the numerically controlled robot 288 can be positioned as the robot's workspace 177.

Associate the drive values of the numerically controlled robot 288 at the robot work positions 289, the operation values of some of the operation consoles 7, the images taken by some of the tracking television cameras 80 and the drive values of the tracking television cameras 80 at the work positions of the numerically controlled robot 288. The relationship between the driving numerical values of the numerical control robot 288 at all the robot working positions 289, the photographed images of the tracking television camera 80 of its drive values in all its working positions and the driving numerical values 80 of the tracking television camera is calculated and acquired by interpolation calculation or the like.

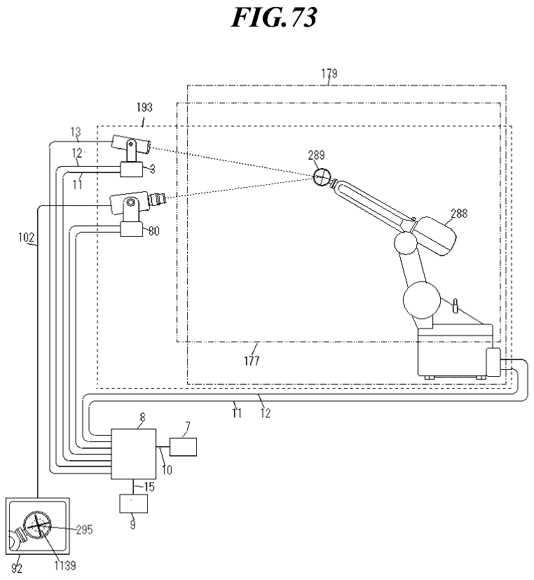

Example: The distance of the robot working position 289 of the numerically controlled robot 288 in FIG. 73 is measured by operating the console 7 with the tracking laser distance measuring device 3 driven by numerical control. At the same time, the tracking television camera 80 driven by numerical control photographs the robot working position 289 of the numerically controlled robot 288. The direction, angle of view, focal length, etc. of the robot working position 289 photographed by the tracking television camera 80 are photographed by operating the console 7 so that they appear in the center of the tracking television camera monitor screen 92. The operator console 7 is operated so that the measuring light of the tracking laser distance measuring device 3 is irradiated at the robot working position 289 and is displayed at the laser beam irradiation position 1069 on the tracking television camera monitor screen at the same position as the working position 295 on the tracking television camera monitor screen, which is displayed at the center of the tracking television camera monitor screen 92.

By irradiating the laser light irradiation at work position 295 on the tracking television camera monitor screen, the robot working position 289 of the numerically controlled robot 288, its drive numerical value of the numerically controlled robot 288, its measured distance, its measured direction, the driving numerical value of the tracking laser distance measuring device 3, the driving numerical value of the tracking television camera 80, and the photographed image can be related. All the robot working positions 289, the drive values of all the numerically controlled robots 288, all the measured distances and all its measured directions and the screens photographed by all the tracking television cameras 80 are calculated and acquired by interpolation calculation or the like from the relationship between some of its driving values of the numerically controlled robots 288, some of the measured distances and some of the measured directions, some of the driving values of the numerically controlled tracking laser distance measuring device 3, some of the driving values of the tracking television camera 80 and some of the photographed images at its robot working position 289 of some numerically controlled robots 288.

Example: The robot workplace position 289 of the numerical control robot 288 is photographed by the fixed television camera 1, and the distance of the working position 289 is measured by directing the tracking laser distance measuring device 3 at a position on the fixed television camera monitor screen corresponding to the working position 293 on the fixed television camera monitor screen 5. The angle of view and focal length corresponding to the measured distance are adjusted, and the tracking television camera 80 is operated to photograph. An image of the robot working position 289 can be displayed on the tracking television camera monitor screen 92. Similar operations are performed at several different robot work positions 289 of the numerically controlled robot 288 on the connected operator console 7.

The robot working position 289 of the numerically controlled robot 288, a position where the robot working position 289 is displayed on the fixed television camera monitor screen 5, the drive value of the drive mechanism that drove the numerically controlled robot 288 to that workplace position, a distance value obtained by measuring the distance of the robot working position 289, the driving numerical value of the driving mechanism irradiated with the measurement laser beam, the driving numerical value of the drive mechanism of the tracking television camera 80, which has photographed the direction of the robot workplace position 289 in order to photograph the robot workplace position 289, a driving numerical value of the driving mechanism of the tracking television camera 80, which matches the angle of view and the focal length of the tracking television camera 80, all of the images photographed by the tracking television camera 80 and recognized as images and the positions displayed on the tracking television camera monitor screen 92 are associated with the positions on the fixed television camera monitor screen 5, and the driving numerical values are obtained by performing calculations by interpolation or the like. At all of the associated positions on the fixed television camera monitor screen, the driving numerical value, the measured distance, and the direction of the drive mechanism can be operated in conjunction with the position of the tracking television camera monitor screen 92 and the position of the image-recognized subject or the like displayed.

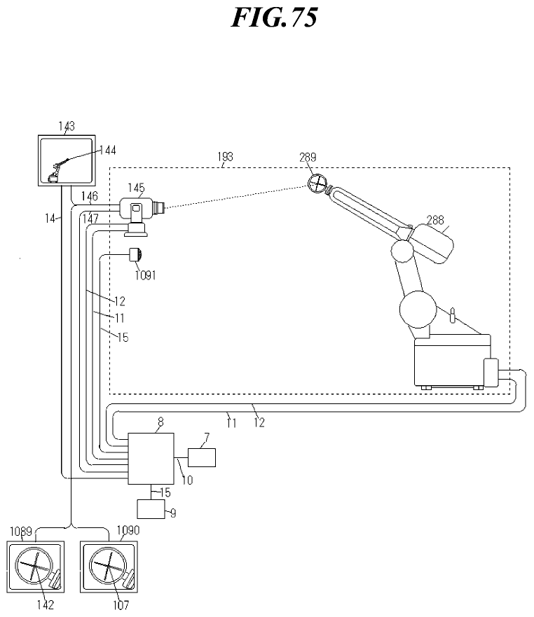

Example: The LED light-emitting element 107 of the LED light-emitting element unit 1090 at the same position as the image element 142 of the image element unit 1089 on which the image element measurement television camera measurement distance measuring device monitor screen 143 that detects the position of the robot work 144 on the television camera measurement distance measuring device monitor screen 143 photographed by Pixel measurement television camera distance measurement Image element measurement with adjusting the focal length in FIG. 75 of the television camera measurement distance measuring device monitor screen is illuminated. The displayed light irradiated to the robot working position 289 of the object is received by the light receiver 1091, and the distance to the robot working position 289 is measured from the phase difference of the displayed light.

Several robot working positions 289 of a numerically controlled robot 288, several driving numerical values driven by the driving mechanism of the numerically controlled robot 288, the several measured distances measured by the pixel measurement television camera distance measuring device 145 and the positions of some image elements 142 and the positions of the LED light emitting elements 107 at the same positions detected by the image element measurement television camera distance measuring device 145 are related to the several positions on the pixel measurement television camera distance measuring device monitor screen 143 of the pixel measurement television camera distance measuring device 145. Then, at all positions on the pixel measurement television camera distance measuring device monitor screen 143, the numerical values for driving the robot working position 289 of the numerically controlled robot 288 and the numerical values for the positions measured by the pixel measurement television camera distance measuring device 145 are acquired by calculating them by a method such as an interpolation method. By sharing the acquired numerical values, the associated device, the image-recognized subject or the like appearing at the position, and the position can be associated with each other and operated.

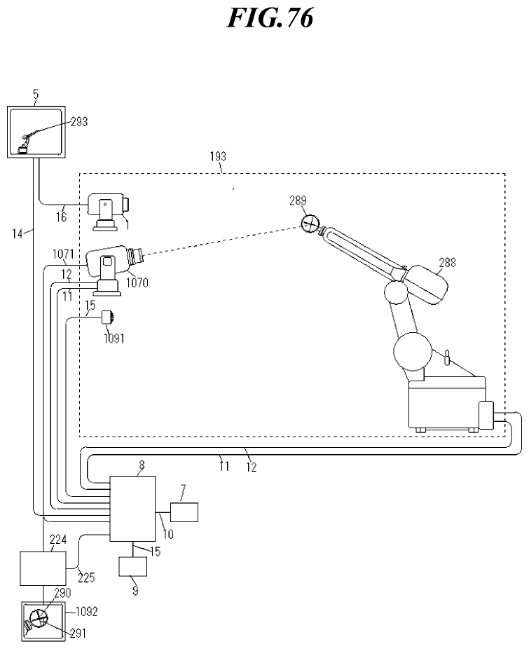

Example: On the fixed television camera monitor screen 5 photographed by the fixed television camera 1 in FIG. 76, the numerically controlled pixel measurement television camera distance measuring device 1070 is directed in the direction in which the image of the robot working position 289 of the numerically controlled robot 288 is detected. The robot working position 289 is irradiated with light emitted from the LED light emitting element 290 of the LED light emitting element unit of the numerical control pixel measurement television camera distance measuring device at the position of the image element of the image element unit on the pixel measurement television camera measurement distance measuring device monitor screen 1092 where the image is photographed through the optical lens. The displayed light passes through the optical lens and is received by the light receiving element 291 of the light receiving element unit of the numerically controlled pixel measurement television camera distance measuring device and measured. The flight time of the light is measured and calculated, and the distance of the robot working position 289 of the numerically controlled robot 288 is measured. The tracking television camera 80 photographs the robot working position 289 of the numerically controlled robot 288 by matching the angle of view of the image element 142 of the numerical control pixel measurement television camera distance measuring device 1070 and the focal length of the optical lens corresponding to the measured distance.

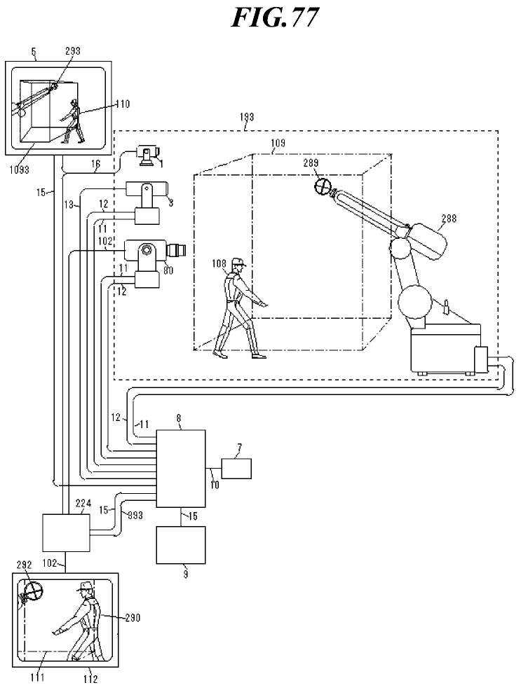

Example: An image of the worker 110 on the fixed television camera monitor screen 5 photographed by the fixed television camera 1 in FIG. 77 is detected. The tracking laser distance measuring device 3 is aimed in the direction corresponding to the position on the screen, and the distance to the worker 108 is measured. The angle of view and the focal length follow the measured distance, and the image of the worker 108 at the position shown on the monitor screen of the tracking television camera photographed by the tracking television camera 80 is recognized. A working position 293 on the fixed television camera monitor screen photographed by the fixed television camera 1 and displayed on the fixed television camera monitor screen 5 is image-detected. The tracking laser distance measuring device 3 is directed in the direction corresponding to the position on the screen, and the distance to the robot working position 289 is measured.

According to the measured distance, the angle of view and the focal length are followed, a working position 292 on the tracking television camera monitor working screen at a position shown on a screen 112 acquired by synthesizing the range of the tracking television camera monitor screen photographed by the tracking television camera 80 with the range of the CG screen is image-recognized. The work range obtained by measuring the robot work position 289 of the numerically controlled robot 288 is calculated and displayed as a CG work composition screen 1093 on the fixed television camera monitor screen 5. As the robot work position 289 approaches the worker 108, also measured, the robot work position 289 moves away or stops by displaying the measured worker 108 on the fixed television camera monitor screen 5,

The calculated CG work composite screen 1093 and the screen photographed by the tracking television camera 80 are superimposed on the tracking television camera monitor screen 112 in the screen range of the CG work composite screen 1093. On the synthesized screen, the image of the working position 290 on the tracking television camera photographing screen is recognized. Combining the range of the CG work synthesis screen 1093 with the range of the tracking television camera monitor screen 112, the robot working area 111 on the tracking television camera monitor screen is photographed by the tracking television camera 80, and the approach of the worker is image-recognized, and the robot working position 289 of the numerically controlled robot 288 is changed for work.

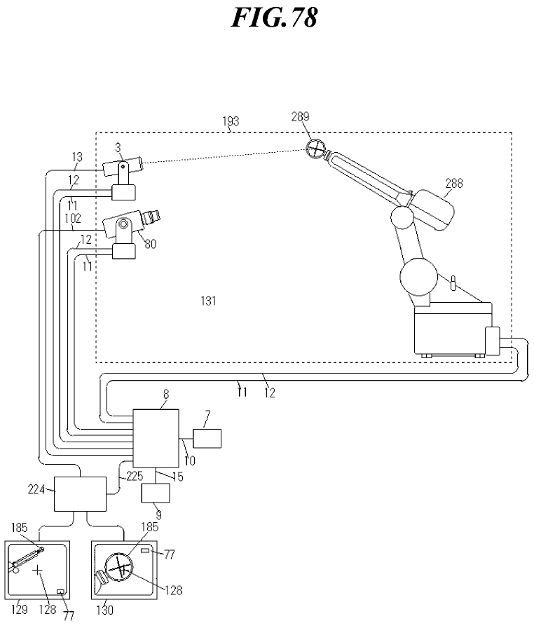

Example: The robot workplace positions 289 of all the numerically controlled robots 288 on the monitor screen 129 photographed at a wide angle of a tracking television camera photographed by a tracking television camera 80, measured by the tracking laser distance measuring device 3 in FIG. 78, their distances and directions, and the driving values of the robot working positions 289 of the numerically controlled robots 288 are grasped. A tracking television camera 80 photographs a robot working position 289 of a numerically controlled robot 288 at a wide angle. The image analyzer 224 detects the work 127 on the monitor screen of the tracking television camera at the robot working position 289 of the numerically controlled robot 288, which is displayed on the monitor screen 129 photographed with a wide angle of the tracking television camera. The tracking laser distance measuring device 3 measures the distance in the direction corresponding to the position where the image analysis of the task 127 on the tracking television camera monitor screen is performed. The measured distance is shown on a monitor screen 129 photographed at a wide angle of the tracking television camera and on a monitor screen 130 photographed at a narrow angle of the tracking television camera.

At the angle of view and focal length corresponding to this measured distance, the image analyzer 224 detects the work at the robot work position 289 of the numerically controlled robot 288 photographed on the monitor screen 130 photographed by the tracking television camera 80 at the narrow angle of the tracking television camera. At the working position 128 on the screen of the working position on the monitor screen of the tracking television camera on the monitor screen 130 photographed at the narrow angle of the tracking television camera, the work of the robot working position 289 is performed. The measured distance is displayed on the screen of the work position 128 on the tracking television camera monitor screen, and the display distance 77 on the tracking television camera monitor screen is displayed. Operation of the working position 128 on the monitor screen 130 of the tracking television camera photographed at the narrow angle of the tracking television camera is operated by the operator console 7 using the numerical value of the display distance 77 on the tracking television camera monitor screen.

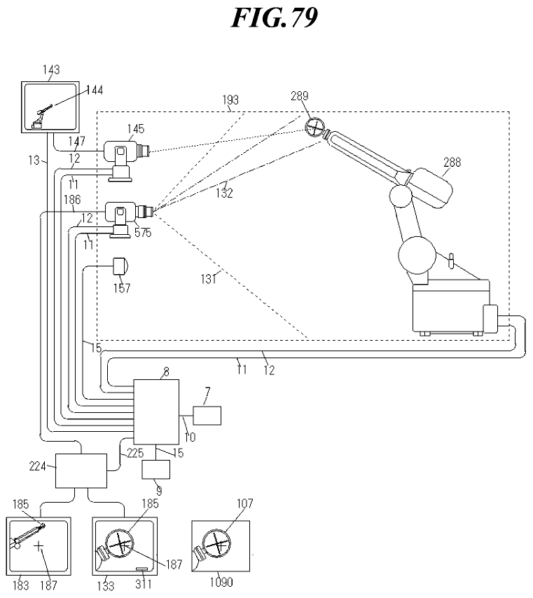

Example: All the robot working positions 289 and their distances of the numerically controlled robot 288 on the pixel measurement television camera measurement distance measuring device monitor screen 143 photographed by the pixel measurement television camera distance measuring device 145 in FIG. 79 and the driving values of the numerically controlled robot 288 are grasped. The LED light emitting element 107 corresponding to the working position 185 shown on the image element tracking television camera monitor screen of the Pixel measurement television camera distance measuring device 145 is caused to emit light in the direction corresponding to the pixel position of the working position 185 shown on the image element tracking television camera monitor screen in which an image is detected by widening the range of the image sensor on the image tracking television camera monitor screen 183 photographed in a photographing range 131 of a wide-angle image element of an image element tracking television camera distance measuring device, photographed by a pixel tracking television camera 575 with a wide-angle lens. Displayed light from the subject whose image is detected is received by the light receiver 157, the phase difference is measured, and the distance is calculated.

The pixel tracking television camera 575 corresponding to the measured distance takes an image. The direction and distance of the work position shown on the image element tracking television camera monitor screen 185 on the enlarged screen 133 of the pixel measurement television camera distance measurement monitor that detects images by narrowing the range of the image sensor and photographed in the photographing range 132 of the narrow-angle image sensor of the image element tracking television camera distance measuring device in the tracking photographing range, are measured toward the center of the image element tracking television camera monitor screen 185. Then, using the driving numerical values already acquired by the numerically controlled robot 288, the robot workplace position 289 is moved.

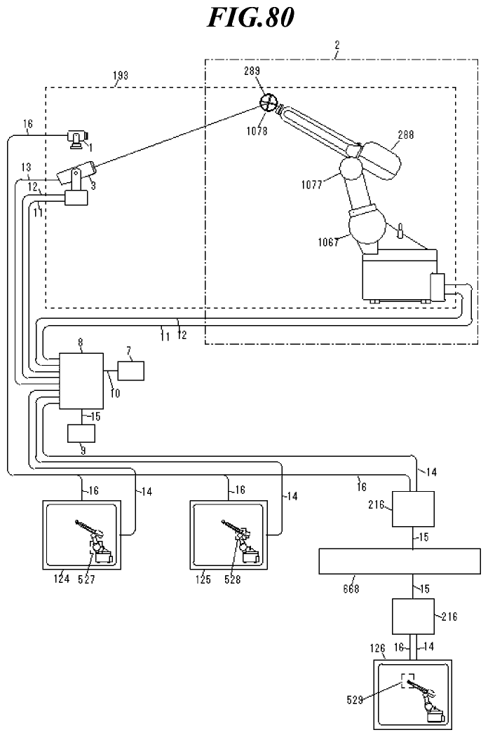

Example: All the fixed television camera monitor screen A 124, fixed television camera monitor screen B 125 displaying the screen photographed by the fixed television camera 1, measured by the tracking laser distance measuring device 3 in FIG. 80, via the Internet network 668, the robot working position 289 of the numerically controlled robot 288, its distance and direction, and the driving numerical value of the robot working position 289 of the numerically controlled robot 288 on the monitor screen C 126 are related.

On the fixed television camera monitor screens A 124, B 125, and on the fixed television camera monitor screen C 126 via the Internet network 668, which shows the screen photographed by the fixed television camera 1 at the robot working position 289 of the numerically controlled robot 288, each drive mechanism of numerically controlled robot 288 is operated at each position on the screen of the fixed television camera monitor by numerical drive mechanism C 529 via numerical drive mechanism A 527, numerical drive mechanism B 528 and Internet network 668, respectively on the screen of the fixed television camera monitor. In this way, complicated robot operations are shared and operated.

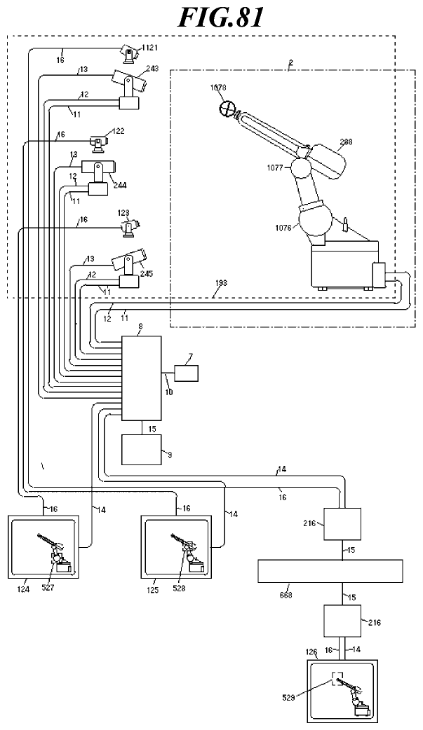

Example: By manipulating the position of the numerical drive mechanism A 527 on the fixed television camera monitor screen A 124 showing the screen of the robot work position 1076 of the numerically controlled robot 288 in FIG. 81 photographed by the fixed television camera 121, the drive mechanism of the numerically controlled robot 288 is operated at the robot working position A 1076. By manipulating the position of the numerical drive mechanism B 528 on the screen 125 of the fixed television camera monitor, which shows the screen photographed by the fixed television camera 122 of the robot working position 1077 of the numerically controlled robot 288, the robot working position B 1077 of the drive mechanism of the numerically controlled robot 288 is operated. The screen photographed by the fixed television camera 123 at the robot working position 1078 of the numerically controlled robot 288 is transmitted via the Internet network 668, and the position of the numerical drive mechanism C 529 on the fixed television camera monitor screen C 126 is manipulated to perform the work at the robot working position C 1078 of the drive mechanism of the numerically controlled robot 288.

The robot working positions 1076, 1077, 1078 of the numerically controlled robot 288, the fixed television camera monitor screens A 124 and B 125 display the images photographed by the fixed television cameras A 121 and B 122 at the robot's working position, the positions of the numerical drive mechanisms A 527, B 528, and C 529 on the fixed television camera monitor screen C 126, which displays the screen photographed by the fixed television camera C 123 via the 668 Internet network, the distances and directions measured by the tracking laser distance measuring devices 243, 244, and 245 for the robot working positions are associated with the driving numerical values of the robot working positions 1076, 1077, and 1078 of the numerical control robot 288. It is possible to operate on the screen of the television camera monitor via the Internet network, so that complicated robot operations can be shared and operated.

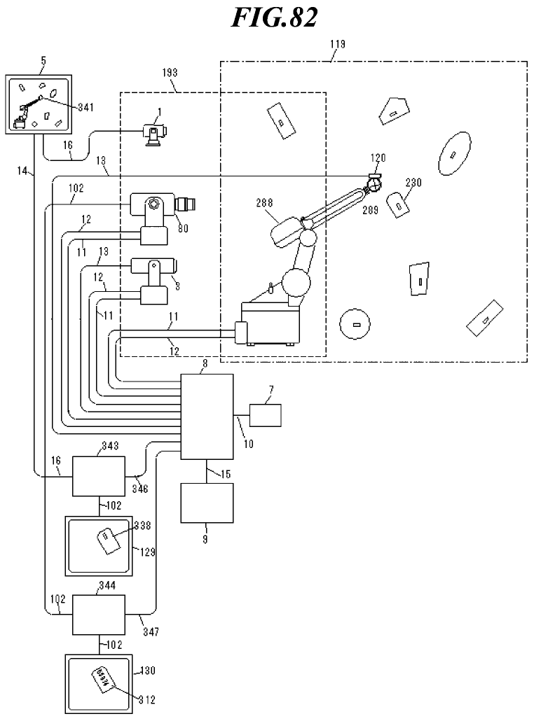

Example: A fixed television camera 1 photographs a robot work range 119 of a numerically controlled robot 288 in FIG. 82. A shaped object is detected on the monitor screen of the fixed television camera 5. The tracking laser distance measuring device 3 measures the distance in the direction corresponding to the position where the shaped object is detected. The angle of view and focal length corresponding to the measured distance are adjusted, and the image of the shape position 338 on the work screen is image-analyzed on the tracking television camera monitor work screen 129 photographed by the tracking television camera 80 at the wide angle of the tracking television camera.

At that position, the angle of view photographed by the tracking television camera 80 is narrowed, and the image of the barcode position 312 on the work screen of the tracking television camera monitor is image-recognized on the monitor screen 130 photographed at the narrow angle of the tracking television camera. The bar code display 230 is read by moving the bar code reader 120 attached to the robot working position 289 of the numerically controlled robot 288 to a position where the bar code display of the correct image on the monitor screen 130 photographed at the narrow angle can be read.

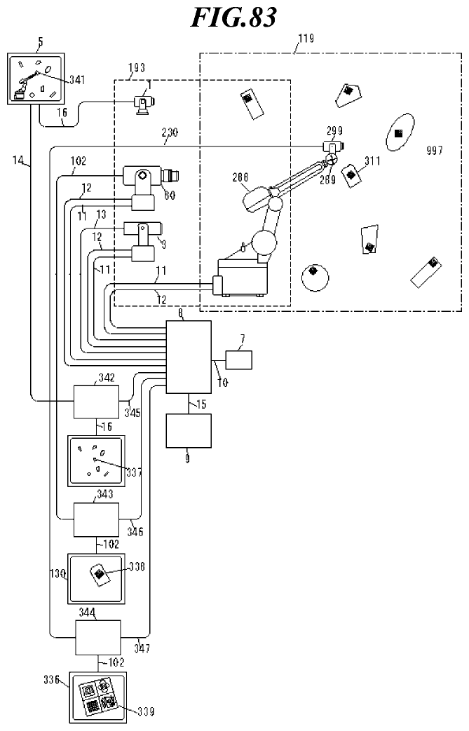

Example: The robot work range 119 of the numerically controlled robot 288 in FIG. 83 is detected as an information position 341 on the fixed television camera monitor screen 5 of the fixed television camera monitor screen by the shape position analyzer 342 captures the image photographed by the fixed television camera 1. The tracking laser distance measuring device 3 measures the distance in the direction corresponding to the shape position 337 on the fixed television camera monitor screen where the shaped object is detected. After adjusting the angle of view and focal length corresponding to the measured distance, the shape analyzer 343 recognizes the image described in the image information display 311 of the shape object on the monitor screen 130, which is an image of the shape object photographed by the tracking television camera 80 at a narrow angle of the tracking television camera.

A numerically controlled television camera 299 attached to a robot working position 289 of a numerically controlled robot 288 is moved to the position of the image information display 311 where the image has been recognized. The focal length is adjusted to the measured distance, the image information display 311 is photographed, and the information analyzer 344 reads the image information. Then, the image information display 339 on the television camera monitor screen 336 attached to the robot is decoded.

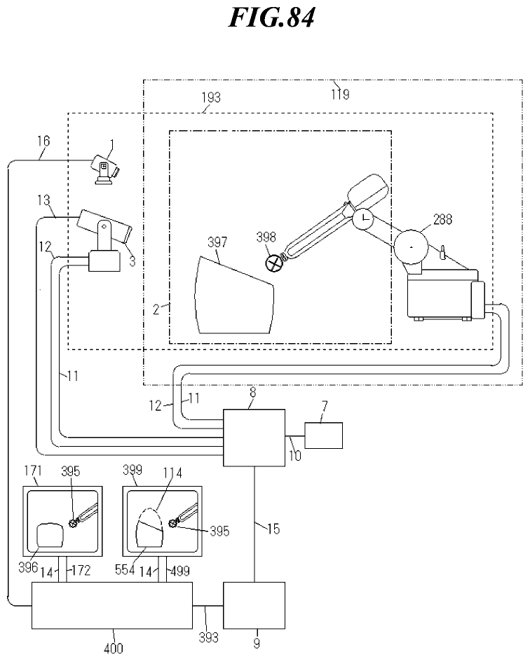

Example: The position of the 3D object assumed by the computer on the composite television monitor screen 171 showing the working position of the 3D molding machine at the robot working position 289 of the numerically controlled robot 288 within the fixed television camera imaging range 2 photographed by the fixed television camera 1 in FIG. 84, is the position where the tracking laser distance measuring device 3 can measure the distance. The working position of the 3D molding machine of the work machine 398 formed by the robot of the numerically controlled robot 288 is the position of the composite television monitor screen 171, which is a composite screen for two-dimensional operation.

The robot work range 119 of the numerically controlled robot 288 can assume a position in three-dimensional space by measuring the distance with the tracking laser distance measuring device 3 on a two-dimensional plane photographed by the fixed television camera 1. It is a composite screen of a three-dimensional space image of the side 399 of the 3D formation assumed by the computer and an image of the side of the 3D formation assumed by the computer. The position of the 3D screen 114 assumed in the image on the side 399 side of the 3D object assumed by the computer is the position of the CG screen recognized as the position in three-dimensional space as the position of the work machine 398 formed by the numerically controlled robot 288. Therefore, the position of the assumed 3D screen 114 is tracked by the working position of the 3D molding machine of the work machine 398 formed by the numerically controlled robot 288, so that a 3D object can be molded at the position of the 3D space assumed by the computer 9.

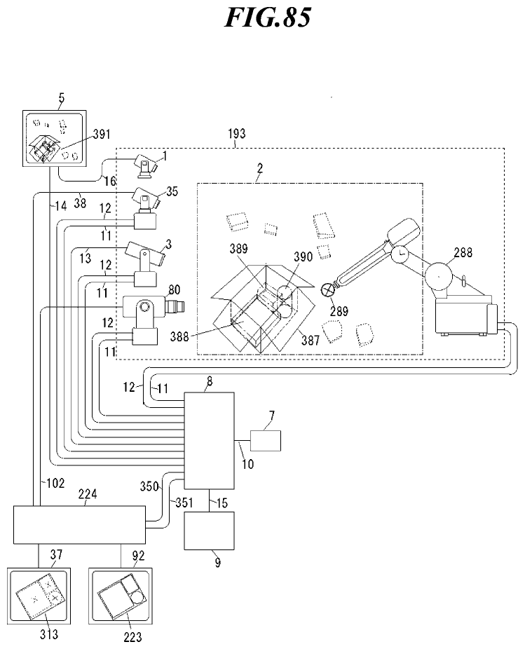

Example: Objects photographed by a fixed television camera 1 in FIG. 85 and detected as images on a fixed television camera monitor screen 5 are measured by a tracking laser distance measuring device 3 and a tracking television camera 80 for image recognition by measuring the position and shape of each object. The numerically controlled television camera 35 is directed in the direction of the cardboard box 387 for storing the image-recognized subject and the numerically controlled television camera monitor screen 37 is photographed. The tracking laser distance measuring device 3 measures the distance of the packing cardboard 387 and recognizes the outer shape. The cardboard boxes are measured, and priority is given to the objects to be stored that have already undergone image recognition, and the cardboard boxes of the measured objects are stored. Then, the storage object of the image-recognized subject to be stored is calculated.

The storage position of the object to be stored selected by the calculation is displayed on the cardboard screen displayed on the numerical control television camera monitor screen 37 at the calculated arrangement position 313. The subject image-detected on the fixed television camera monitor screen 5 and the image-recognized subject position acquired by measuring the position and shape of each subject with the tracking television camera 80 and the calculated placement position 313 on the cardboard screen displayed on the numerical control television camera monitor screen 37 are associated with each other. As a result, the contents of the object to be stored can be recognized on the fixed television camera monitor screen 5, and the work of storing the contents of the object to be stored can be performed as the robot work position 289 of the numerical control robot 288.

The image-detected object on the fixed television camera monitor screen 5 and the stuffing cardboard 387 screen displayed on the numerical control television camera monitor screen 37 are associated with the calculated layout position 313. As a result, the object to be stored can be recognized on the fixed television camera monitor screen 5, and the stuffing cardboard box 387 can be stored at the robot work position 289 of the numerical control robot 288. At the position on the fixed television camera screen 5 of the numerically controlled robot 288, the image-recognized contents of the object to be stored are acquired, and the work position to be moved is stored in the calculated placement position 313 of the cardboard screen displayed on the numerical control television camera monitor screen 37.

The image analysis of the position where the storage is calculated is performed by the tracking laser distance measuring device 3 and the tracking television camera 80, and the storage position is measured and confirmed. The position 391 of the cardboard box for packing on the fixed television camera monitor screen of the fixed television camera monitor screen 5 showing a robot working position 289 of a numerically controlled robot 288, is associated with the position and shape of the cardboard box on the numerical controlled television camera monitor screen 37 photographed by the numerical controlled television camera 35 by image recognition. As a result, according to the shape of the cardboard box, the storage method of the shaped object whose peripheral image is recognized is calculated and stored in the cardboard box.

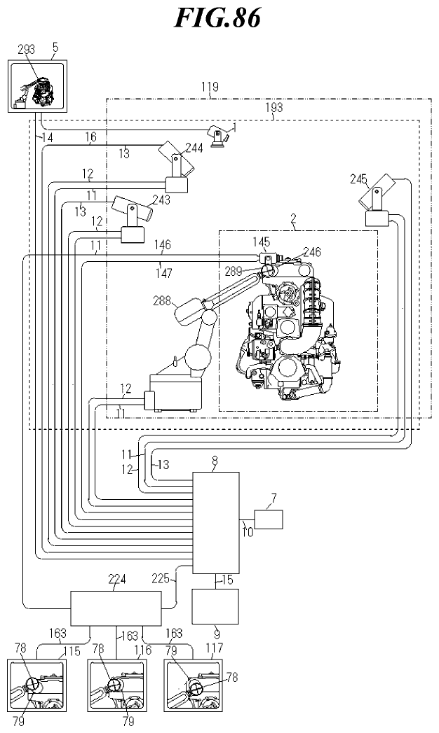

Example: If the robot processing position 246 in FIG. 86 cannot be measured by the tracking laser distance measuring devices A 243, B 244, and C 245, the robot working position 289 is measured from three directions. Using the robot working position 289 as a known position, the robot machining position 246 is measured indirectly. The fixed television camera 1 photographs the image element measurement television camera distance measuring device 145 attached to the robot working position 289 of the numerically controlled robot 288. The position of the image element measuring television camera distance measuring device 145 attached to the working position 293 on the fixed television camera monitor screen on the fixed television camera monitor screen 5 is measured from three directions of the tracking laser distance measuring devices A 243, B 244 and C 245. A highly accurate known position can be acquired by measuring the position of the image element measurement television camera distance measuring device 145 from three directions.

Similarly, the working position on the monitor screen of the pixel measurement television camera measuring distance device 78 displayed on the pixel measurement television camera screen measuring device monitor B 116, the monitor screen of the pixel measurement television camera measuring distance device 78 displayed on the pixel measurement television camera screen measuring device monitor C 117 and the distance of the robot working position 289 in the working range 119 of the robot from three directions are measured. The robot working position 289 can be a known position with high precision. The processing position 79 of the robot work photographed from different positions by the image element measurement television camera distance measurement device 145 attached to the robot work position 289 is measured from three known directions of the image element measurement television camera distance measurement device 78.

The working position on the pixel measurement television camera measurement distance measuring device monitor screen 78 is measured from three directions by a tracking laser distance measuring device. Pixel measurement television camera distance measurement device measures the distance of the processing position 79 on the monitor screen is measured from three directions by the pixel measurement television camera distance measurement device 145. The robot processing position 246 of the processing position 79 on the pixel measurement television camera measurement distance measuring device monitor screen can be measured with high precision and known position from the working position on the pixel measurement television camera measurement distance measuring device monitor screen 78 where the highly accurate known position is displayed. Highly accurate machining operations can be performed at the robot working position 289 of the numerically controlled robot 288 from the measured three known distances.

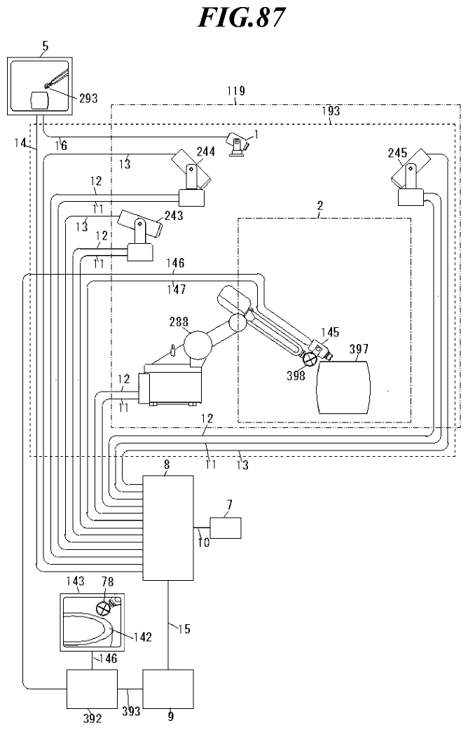

Example: The position of the working machine 398 formed by the robot 288 in the working range 119 of the robot is photographed within the fixed television camera photographing range 2 of the fixed television camera 1 in FIG. 87. A working position 293 on the fixed television camera monitor screen on the fixed television camera monitor screen 5 for photographing and displaying a work machine 398 formed by a numerically controlled robot 288 with a fixed television camera 1, is measured from three directions of the tracking laser distance measuring device A 243, B 244 and C 245, and the distance of the highly accurate position of the working machine 398 formed by the robot in the working range 119 of the robot is measured. By setting the measured position of the work machine 398 formed by the robot to a highly accurate position, the distance of the pixel measurement television camera measurement distance device 142 to the position of the 3D object 397 formed by the numerical control robot is measured from a highly accurate position from the working position on the pixel measurement television camera measurement distance device monitor screen of the pixel measurement television camera measuring distance device 78 of the image element unit 143 on which the monitor screen is displayed.

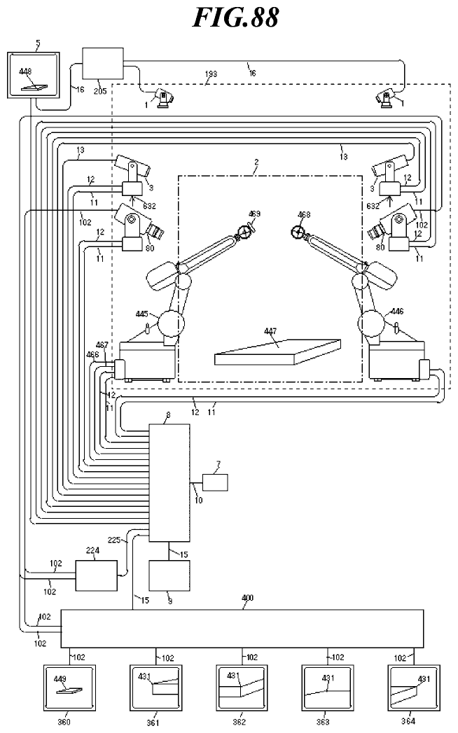

Example: A welding robot 445 and a support robot 446 are installed in the working space of the storage rack 193 in FIG. 88. A plurality of tracking television camera distance measurement systems 72 are collectively operated by the tracking controller 8 in the workspace. The working space is measured in advance by two tracking television camera distance measurement systems 72 and, if necessary, a plurality of units. The tracking controller 8 comprehensively grasps the subject of the image to be image-recognized in the work space, including the drive mechanism of the robot that performs the work. For image recognition of the work space, the fixed television camera monitor screen 5 photographed by the fixed television camera 1 directs the tracking laser distance measuring device 3 to the direction corresponding to the position where the recognized image is detected, and measures the distance from the detected image. There is a screen photographed by the tracking television camera 80 after adjusting the angle of view and focal length to the measured distance.

The tracking laser distance measuring device 3 measures the distance from the position of the image detected by the fixed television camera monitor screen 5. Adjust the angle of view and focal length at that measurement distance, the workbench on the tracking television camera monitor screen A 360 is measured 449 on the screen photographed by the tracking television camera 80. Workbench measurements 431 on the tracking television camera monitor screens of the tracking television camera monitor screens B 361, C 362, D 363, and E 364 are screens selected and confirmed by the image adjuster 400 after recognition of the image photographed by the tracking television camera 80. The position of the workbench 447 is measured on the screens of the tracking television camera monitor screens B 361, C 362, D 363, and E 364 that have undergone image recognition, and image recognition is performed to determine whether the shape is a known shape.

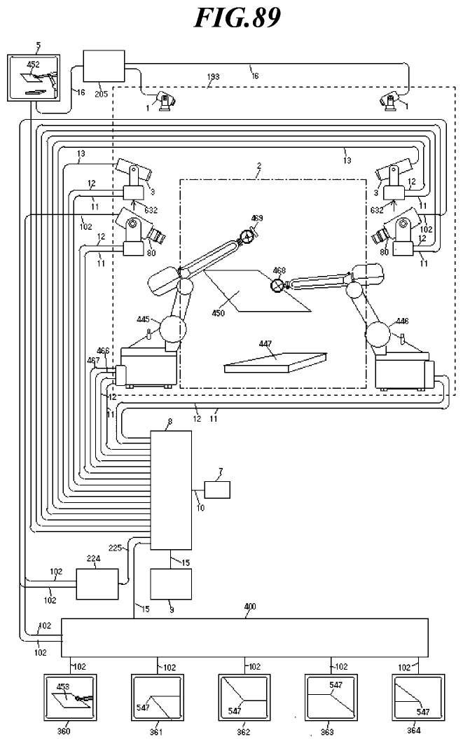

Example: The support robot 446 in FIG. 89 is a welding support machine 468, which brings the workpiece A 450 into the work space, and the tracking laser distance measuring device 3 measures the workpiece A450. It is confirmed by image recognition whether the image photographed by the tracking television camera 80 has a specified shape. In the tracking television camera monitor screen A 360, the tracking television camera monitor camera monitor screen in the working space, the outer shape of the processed material A 453 on the tracking television camera monitor screen, the tracking of the monitor screens B 361, C 362, D 363, and E 364.

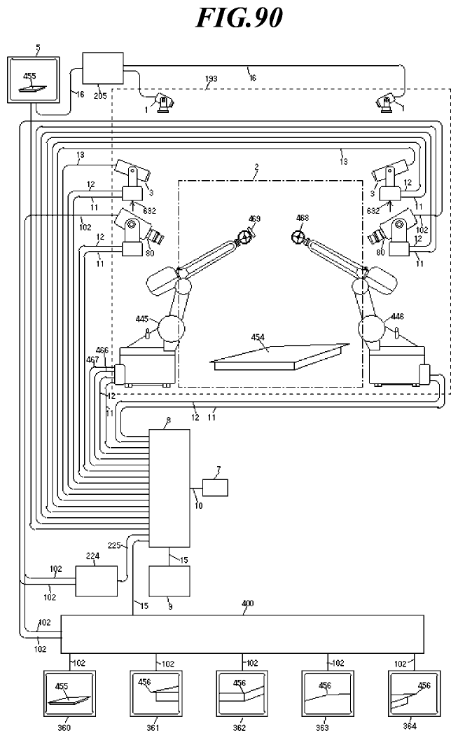

Example: The support robot 446 in FIG. 90 is a welding support machine 468, and places the workpiece A 450 on the workbench 447 in the work space at the position of the tracking television camera monitor screen A 360. On the tracking television camera monitor screen B 360, C 361, D 362, and E 363, the shape of the corner 456 of the workpiece A 454 on the workbench placed on the workbench 447 in the work space is checked and measured on the tracking television camera monitor screen B 360.

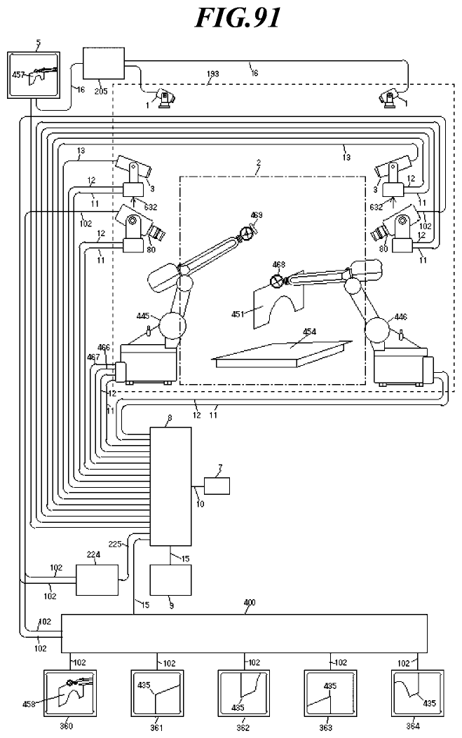

Example: The support robot 446 in FIG. 91 is a welding support machine 468, which brings the workpiece B 451 into the work space, and the tracking laser distance measuring device 3 measures the workpiece B 451. It is confirmed by image recognition whether the image photographed by the tracking television camera 80 has a specified shape. On the tracking television camera monitor screen A360, the shape of workpiece B 458 on the tracking television camera monitor screen of the tracking television camera monitor screen in the work space, and on the tracking television camera monitor screens B 361, C 362, D 363 and E 364 the shape of workpiece B 435 on the tracking television camera monitor screen are confirmed and measured.

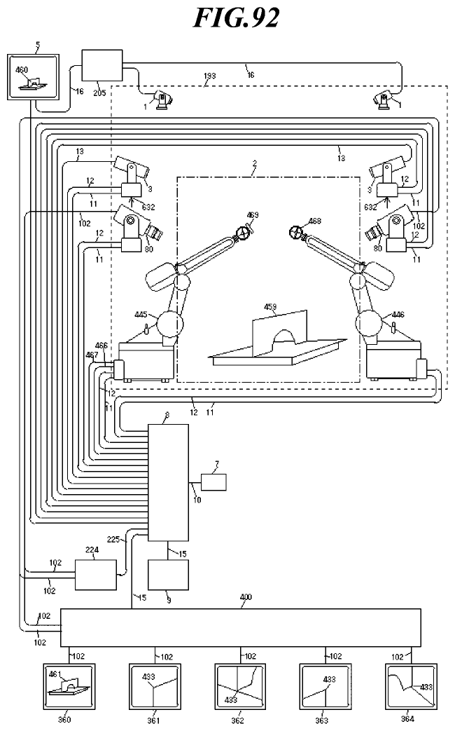

Example: The support robot 446 in FIG. 92 is a welding support machine 468, which places the workpiece B 451 on the workpiece A 454 on the working table in the working space, and temporarily assembles 459 the workpiece B on the workpiece A on the working table. The images measured by the tracking laser distance measuring device 3 and photographed by the tracking television camera 80 are checked by image recognition to see if they have a prescribed shape. In the work space of the tracking television camera monitor screen A 360, the position of the temporary assembly 461 on the tracking television camera monitor screen and the shape of the temporary assembly inspection 433 on the tracking television camera monitor screen of the tracking television camera monitor screens B 361, C 362, D 363 and E 364 are confirmed and measured.

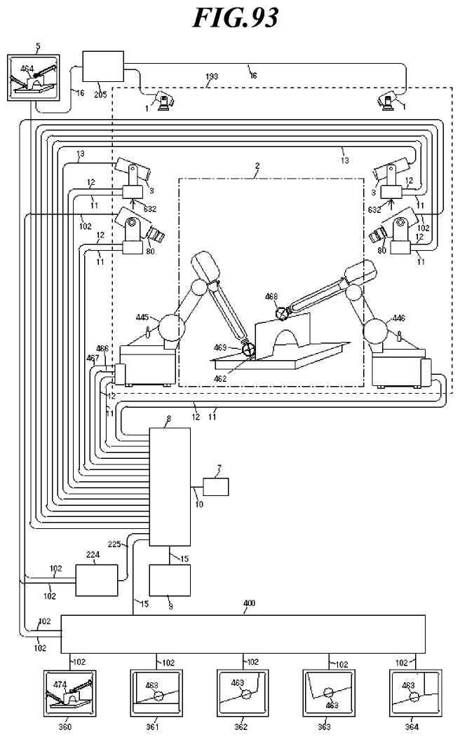

Example: While the welding support machine 468 of the support robot 446 in FIG. 93 supports the temporary assembly 454 of the workpiece B 451 and the workpiece A on the workbench, a welding robot 445 temporarily assembles 459 the processed material B to the processed material A on the workbench, and a welding machine 469 performs point welding to fix them. Point welding work 474 on the tracking television camera monitor screen in the work space on the tracking television camera monitor screen A 360, and point welding while checking the shape and measuring at the point welding points 463 on the tracking television camera monitor screens of the tracking television camera monitor screens B 361, C 362, D 363, and E 634.

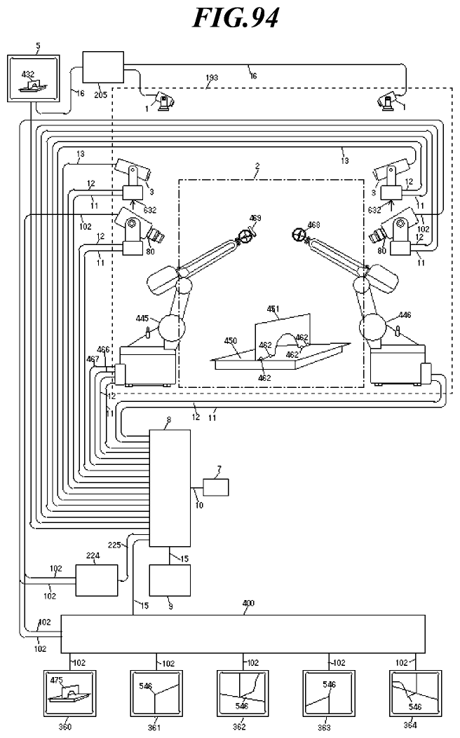

Example: The temporary assembly work fixed by point welding with the welding support machine 468 of the support robot 446 and the welding machine 469 of the welding robot 445 in FIG. 94 is inspected and measured. In the working space of the tracking television camera monitor screen A 360, shape confirmation and measurement are performed in the processing inspection 475 on the tracking television camera monitor screen, and the point welding inspection 546 on the tracking television camera monitor screens B 361, C 362, D 363, and E 364.

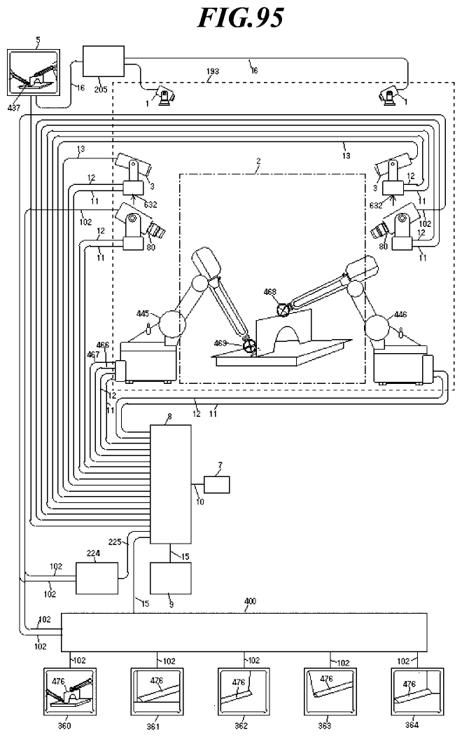

Example: While the welding support machine 468 of the support robot 446 in FIG. 95 assists the temporary assembly of the processed material B 451 and the processed material A 450, a welding robot 445 welds a temporary assembly 459 of the processed material B to the processed material A on the workbench using a welding machine 469. The welding work 476 on the tracking television camera monitor screen in the work space on the tracking television camera monitor screen A 360 and the welding work 476 on the tracking television camera monitor screens on the tracking television camera monitor screens B 361, C 362, D 363, and E 364 are confirmed and measured.

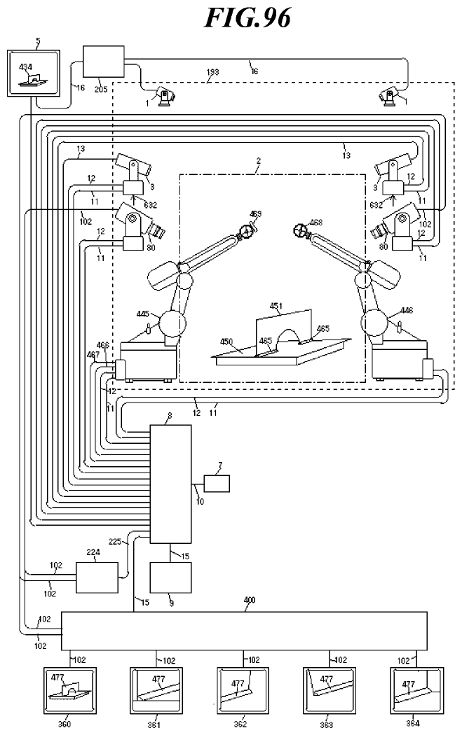

Example: The workpieces are inspected and measured to determine whether the welding by the welding support machine 468 of the support robot 446 and the welding machine 469 of the welding robot 445 in FIG. 96 is completed. Inspection of welding on the tracking television camera monitor screen 477 in the work space on the tracking television camera monitor screen A 360, inspection of welding on tracking television camera monitor screens B 361, C 362, D 363, and E 364, and shape confirmation and measurement.

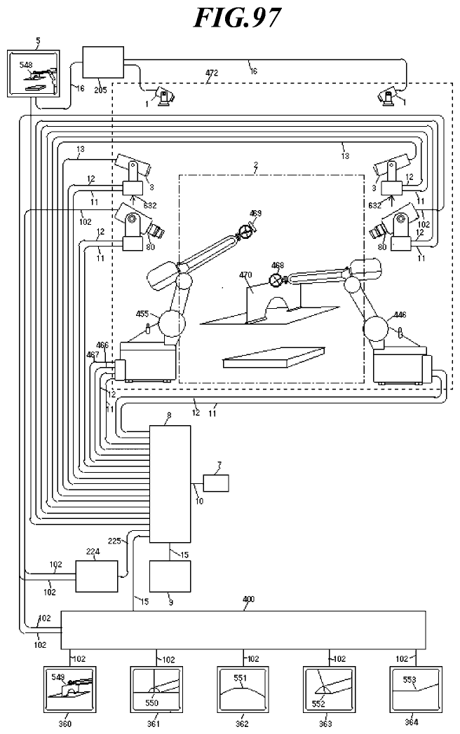

Example: The completed processed product in FIG. 97 is lifted by the welding support machine 468, and image confirmation and measurement of prescribed inspection points of the completed processed product are performed. In workspace with tracking television camera monitor screen A 360, check and measure is performed of the finish inspection 549 on the tracked television camera monitor screen, the tracking television camera monitor screen B 361 outer welding shape and inspection and position measurement 550, the measurement 551 of the curved surface of the tracking television camera monitor screen C 362, the inner welding shape and inspection of tracking television camera monitor screen D 633 and measurement of position 552 and the shape of the outer shape measurement 553 of the tracking television camera monitor screen E 364.

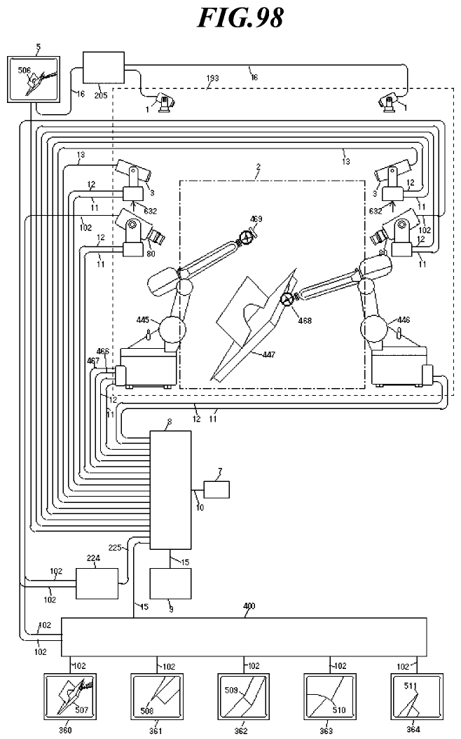

Example: The completed processed product of FIG. 98 is tilted by the welding support machine 468, and image confirmation and measurement of prescribed inspection points of the completed processed product are performed. In the work space on the tracking television camera monitor screen A 360, processing measurement 507 on the tracking television camera monitor screen, measurement 508 on the left position on the tracking television camera monitor screen of the tracking television camera monitor screen B 361, the measurement 509 of the front position on the monitor screen of the tracking television camera of C 362, measurement 510 of the right position on the monitor screen of the tracking television camera of D 363, measurement 511 of the position on the monitor screen of the tracking television camera of E 634 and shape confirmation and measurement such as contact inspection are performed. In accordance with this, a television camera and a tracking laser distance measuring device are attached to the support robot, and the position of the tracking laser distance measuring device is measured by the tracking laser distance measuring device of the tracking television camera distance measuring system 72. Defined locations of the finished work piece can be measured from positions with high positional accuracy.

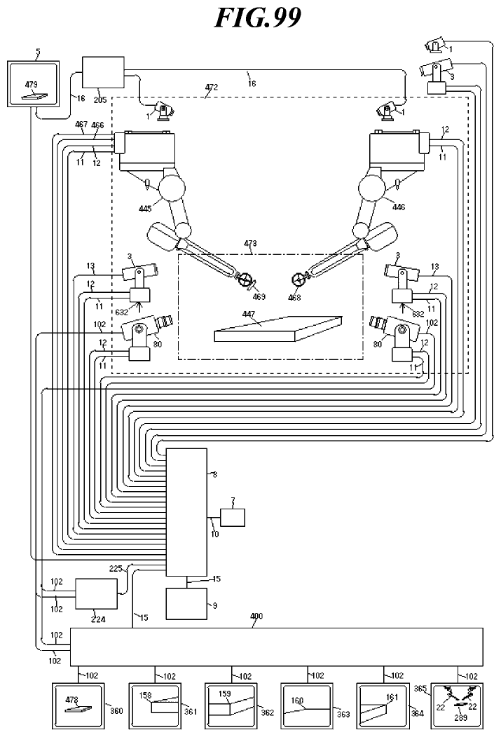

Example: FIG. 99 is an explanatory diagram of welding work by a mobile robot. The tracking television camera distance measurement system 72 incorporated in the common frame 447 of the space of the welding work 473 confirms the image of the space of the welding work each time, and the confirmed space of the welding work is the known measured space. A movable storage rack 472 incorporating a processing machine of a welding robot 445 and a support robot 446 and a plurality of tracking television camera distance measurement systems 72 is moved to a welding work space where there are workpieces to be welded. The plurality of tracking television camera distance measurement systems 72 and the processing machines of the welding robot 445 and support robot 446 that have been moved to the work space are collectively operated by the tracking controller 8.

In advance and as necessary, the tracking controller 8 comprehensively grasps the subject of the image of the work space, including the work of the robot, which is measured by the tracking television camera distance measurement system 72 and recognized as an image. As the image recognition of the work space, the tracking laser distance measuring device 3 measures the distance from the fixed television camera monitor screen 5 photographed by the fixed television camera 1 by analyzing the image detected or recognized. Adjust the angle of view and focal length at that measurement distance, and recognize the image with the tracking television camera 80 or the photographed screen.

Similarly, the tracking laser distance measuring device 3 measures the distance from the position of the image detected by the fixed television camera monitor screen 5. The angle of view and the focal length are adjusted at that measurement distance, and on the screen photographed by the tracking television camera 80, measurement 478 is performed at the work place of the movable storage rack on the tracking television camera monitor screen of the tracking television camera monitor screen A 360. Measurement of the shape and position 158 of the platform angle A on the tracking television camera monitor screen B 361, the measurement of the shape and position 159 of the platform angle B on the tracking television camera monitor screen of the tracking television camera monitor screen C 362, the measurement of the shape and position 160 of the workbench C on the tracking television camera monitor screen of the tracking television camera monitor screen D 363 and the measurement of the shape and position 161 of workbench D on the tracking television camera monitor screen of tracking television camera monitor screen E 364.

On the image-recognized screen of the tracking television camera monitor screen B 361, the tracking television camera monitor screen C 362, the tracking television camera monitor screen D 363 and the tracking television camera monitor screen E 364, the position of the work table 447 is measured from the movable storage rack 472, and its shape is the known image-recognized shape of the tracking television camera distance measurement system 72. Welding work can be performed with the numerical value of the position measured from the workpiece measured from the movable stand and the position developed from different positions. The movable storage rack 472 is moved to the position where the robot working position 289 shown on the tracking television camera monitor screen F 365 is measured by the tracking laser distance measuring device 3 on the screen photographed by the fixed television camera 1 installed in the factory yard. At the distance measured by the tracking laser distance measuring device 3, the processing machines of the welding robot 445 and the support robot 446 perform welding work. A wide range of robot welding operations can be performed by driving the movable storage rack 472 by numerical control.

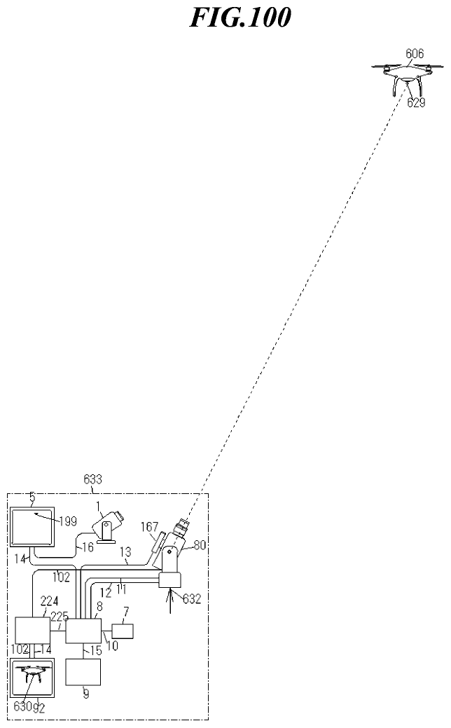

Example: The direction of the drone 606 flying over the sky of FIG. 100 is photographed by the fixed television camera 1, and the image of the measurement drone 199 on the fixed television camera monitor screen is detected on the screen on the fixed television camera monitor screen 5. A tracking television camera 80 with a laser distance measuring device 3 is directed to the direction corresponding to the position on the fixed television camera monitor screen 5 where the image is detected, and the drone 606 is photographed. After confirming that the drone 606 is being photographed, the laser distance measuring device 167 measures the distance to the drone 606.

According to the measured distance, the angle of view and the focal length of the tracking television camera 80 are adjusted, and the image of the distance measuring displaying mirror 630 displayed on the tracking television camera monitor screen of the tracking television camera 92 is recognized in advance. The tracking television camera 80 is driven to track so that the image of the distance measuring displaying mirror is displayed in the center of the tracking television camera monitor screen 92, and the laser distance measuring device 167 measures the distance to the drone 606 again. The measurement position at which the maximum value of the amount of displayed light to be measured is measured is taken as the distance from the distance-measuring displaying mirror.

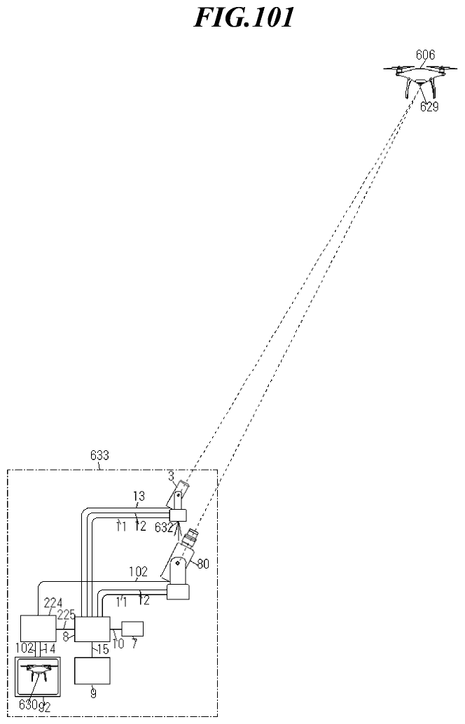

Example: By operating the tracking television camera in FIG. 101, the drone 606 flying in the sky is photographed with the tracking television camera 80 having a wide angle of view. The distance measuring displaying mirror 630 displayed on the tracking television camera monitor screen 92 is photographed, and the image of the mirror is recognized. The tracking television camera 80 and the tracking laser distance measuring device 3 are interlocked and driven so that the position of the image that recognizes the mirror on the tracking television camera monitor screen 92 is displayed in the center of the tracking television camera monitor screen 92 set in advance. The image of the mirror attached to the drone photographed by the tracking television camera 80 at the angle of view and focal length according to the distance measured by the tracking laser distance measuring device 3 is recognized. The tracking laser distance measuring device 3 measures the distance of the mirror in the vicinity of the direction image-recognized by the tracking television camera 80, and the maximum value of the displayed light of the tracking laser distance measuring device 3 is taken as the measured distance.

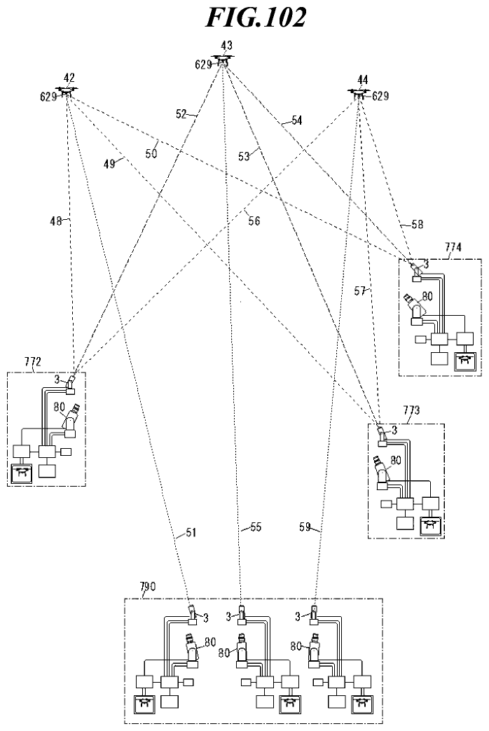

Example: From the positions of the known measurement locations A772, B773 and C774 of the known locations on the ground in FIG. 102 and the position of the tracking television camera distance measurement system 790 of the unknown measurement location, the tracking television cameras 80 are used to track the distance measurement reflection mirrors attached to the drones A 42, B 43, and C 44 flying over the sky, and photograph them. The tracking laser distance measuring device 3 measures the distance to the drone's distance-measuring displaying mirror using the driving numerical value photographed by tracking with the tracking television camera 80. The position of the drone A 42 is associated with the known measurement locations A 772, B 773, C 774 and the unknown measurement location 790 at the same time by the measurement distance. The position of the drone B 43 is associated with the known measurement locations A 722, B 773, C 774 and the unknown measurement location 790 simultaneously by the measurement distance. The position with the drone C 44 is associated with the known measurement locations A 772, B 773, C 774 and the unknown measurement location 790 simultaneously by the measurement distance.

The location of the unknown measurement location 790 can be the location of the known measurement location by using the distances measured from the tracking television camera distance measurement system at the unknown measurement location 790 and the known measurement locations A 772, B 773, and C 774 to the distance measurement reflection mirrors of each of the drones A 42, B 43, and C 44. The measuring positions of the displaying mirrors of the drones A 42, B 43, and C 44 associated with known measurement locations A 772, B 773, and C 774, and the positions of the three tracking television camera distance measurement systems that know the unknown measurement location 790 are associated with the measuring positions of the distance measurement reflection mirrors of the drones A 42, B 43, and C 44 for each drone. This allows the unknown measurement locations of the tracking television camera distance measurement system 790 at the unknown measurement location to be associated simultaneously with the known measurement locations A 772, B 773, and C 774, allowing the location of the unknown measurement location 776 to be the location of the known measurement location.

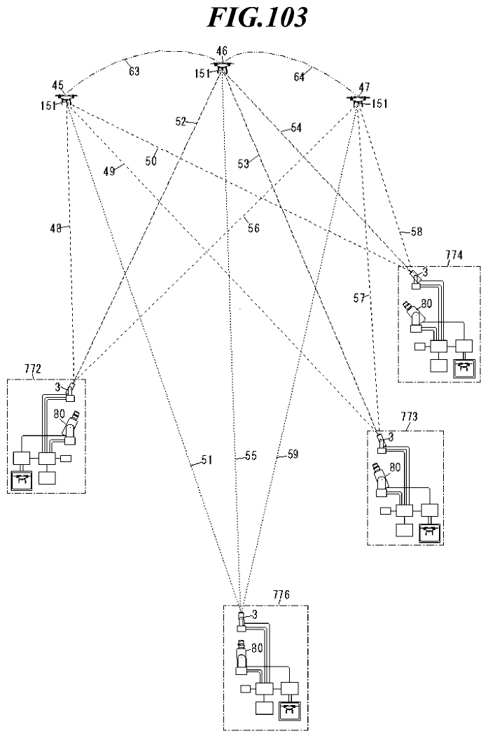

Example: The reflective mirror for distance measurement at the position of the drone, which flies over the sky in FIG. 103, is tracked and photographed by the image recognition method of the tracking television camera of the tracking television camera distance measurement system. A tracking laser distance measuring device linked to the tracking continues to measure the distance to the mirror. This allows the position of an unknown location to be related to the position of a known location from the computation of the distance to several locations of an overflying drone from the location of some known location and the location of an unknown location.

At the drone position A 45 flying over the sky, the distance between the tracking television camera distance measurement system A 772, B 773, C 773 at the known measurement location and the tracking television camera distance measurement system 776 at the unknown measurement location, and the measurement distances 1A 48, 1B 49, 1C 50, 1D 51 are measured simultaneously. At drone position B 46, simultaneously measure distances 2A 52, 2B 53, 2C 54, and 2D 55 between tracking television camera distance measurement systems A772, B 773, and C 773 at known measurement locations and tracking television camera distance measurement systems 776 at unknown measurement locations. At the drone position A 47, simultaneously measure the distance between the tracking television camera distance measurement system A 772, B 773, C 773 at the known measurement location and the tracking television camera distance measurement system 776 at the unknown measurement location, and the measurement distances 3A 56, 3B 57, 3C 58, and 3D 59.

From the measurement distances 1A 48, 1B 49, 1C 50, 1D 51 that measured the drone position 45 in the sky, the distance from the unknown measurement location 776 is known. From the measured distances 2A 52, 2B 53, 2C 54, and 2D 55, which measured another drone position 46 in the sky, another distance from the unknown measurement location 776 is known. From the measured distances 3A 56, 3B 57, 3C 58, and 3D 59, which measured another drone position 46 in the sky, yet another distance from the unknown measurement location 776 is known. By knowing the distance from drones A 46, B 47, and C 48 in the sky, the position of the unknown measurement location 776 can be made known. By using the known measurement locations A 772, B 773, and C 774 and the drone locations A 45, B 46, and C 47 flying above as known locations, the unknown measurement location 776 can be calculated as a known position by knowing the distance of the unknown measurement location 776 from the drone positions A 45, B 46, and C 47.

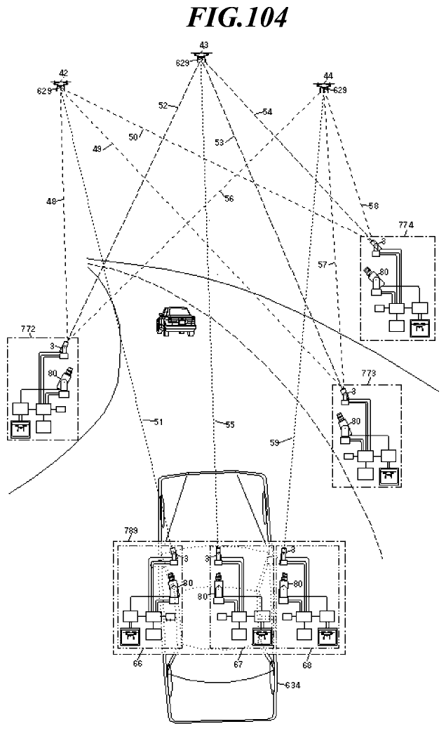

Example: From the positions of the known measurement locations A 772, B 773, and C 774 in FIG. 104, the distances to the drones A 42, B 43, and C 44 flying in the sky are tracked and measured at the same time. With range measurements from multiple known locations, drones A 42, B 43, C 44 can be associated with known locations. With the three of the tracking television camera distance measurement systems 789 attached to the automatic driving while driving, attached to the distance measurement car 634, while the car is running, the tracking television camera distance measurement system A 66, B 67, C 68 continuously measures the distance to each drone A 42, B 43, C 44. The position on the road on which the distance measuring automobile 634 travels is continuously measured while the known measurement locations A 772, B 773, and C 774 are associated with the position of the tracking television camera distance measuring system 789.

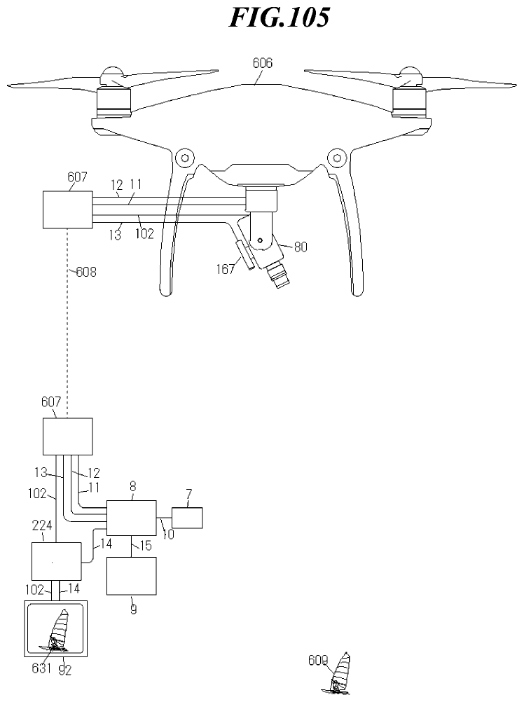

Example: With a camera 80 fitted with a laser distance measuring device 167 incorporated in a drone 606 with communication capabilities flying over a competing surfboard player 609 in FIG. 105, fly as if photographing the subject, surfboard player 609, with a wide angle. The operation signal, measured distance and image signal of the laser distance measuring device 167 and the tracking television camera 80 are connected to the tracking television camera distance measurement system on the ground by the data transmission/reception signal 608 of the data transmitter/receiver 607. The operation console is operated so that the surfboard player 609 is displayed in the center of the tracking television camera monitor screen 92. A laser distance measuring device 167 attached to the tracking television camera 80 measures the distance to the surfboard player 609. According to the measured distance, the angle of view of the tracking television camera 80 is narrowed to adjust the focal length, and the image of the surfboard player 609 on the tracking television camera monitor screen 92 is recognized.

By recognizing the image of the surfboard player appearing on the tracking television camera monitor screen 631, the tracking television camera 80 tracks and photographs the surfboard player at the measured distance so that he appears in the center of the image recognition position on the tracking television camera monitor screen 92. The image signal 102 photographed by the tracking television camera 80 incorporated in the drone 606 is transmitted by the data transmitter/receiver 607 and received by the data transmitter/receiver 608 having the operation function. A driving signal for the tracking television camera 80 and a driving signal for tracking the tracking television camera 80 are transmitted by the data transmission/reception signal 608 and received by the data transmission/reception device 607 of the drone 606.

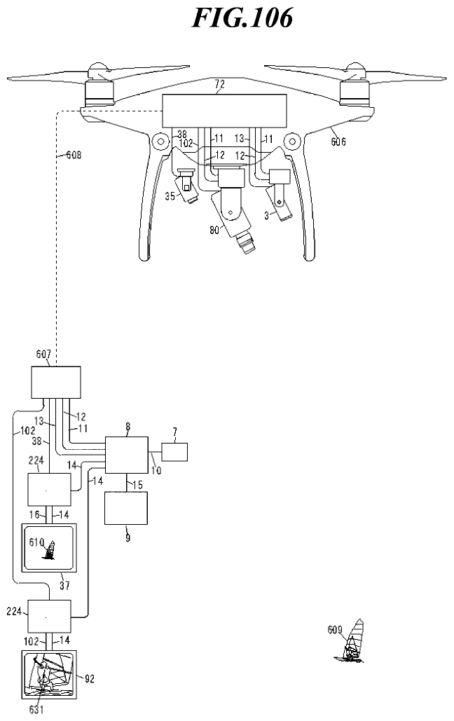

Example: A surfboard player 609 in competition is manually photographed by the numerical control television camera 35 with the tracking television camera distance measurement system 72 incorporated in the drone 606 equipped with a communication function flying over the sky of FIG. 106. On the numerical control television camera monitor screen 37, the surfboard player 610 displayed on the numerical control television camera monitor screen is image-recognized. The image of the surfboard player is recognized, and the numerically controlled television camera 35 is driven to track such that the image-recognized position on the screen appears in the center of the numerically controlled television camera monitor screen 37. The distance to the surfboard player 609 is measured by directing the tracking laser distance measuring device 3 in relation to the direction of the image recognition position where the surfboard player is photographed by the numerical control television camera 35.

According to the distance measured by the tracking laser distance measuring device 3 in the direction in which the numerical control television camera 35 is driven to track, the surfboard player 631 displayed on the enlarged tracking television camera monitor screen is photographed by the tracking television camera 80 whose angle of view and focal length are adjusted. The photographing direction of the tracking television camera 80 is track-driven so as to be displayed in the image recognition position in the center of the tracking television camera monitor screen 92, and the image is photographed by recognizing the image of the surfboard player 610 displayed on the monitor screen of the numerically controlled television camera 35 and continuing to track and photograph.

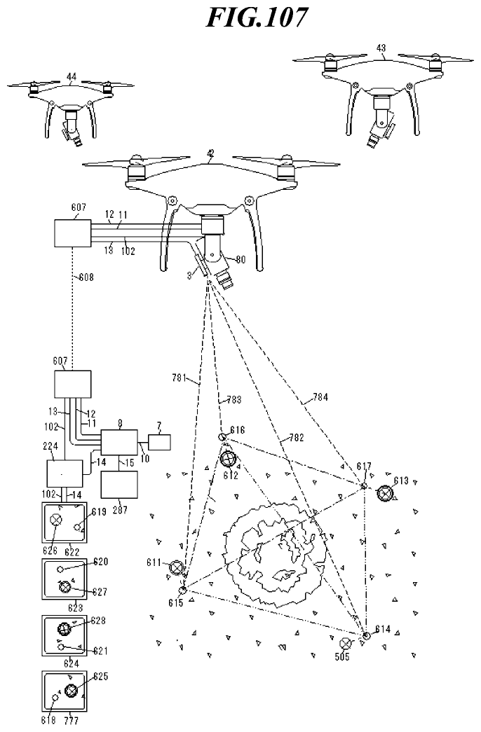

Example: A tracking television camera 80 equipped with a visible light laser distance measuring device 167 incorporated in the drone A 42 flying over the known and planned distance measurement site in FIG. 107 photographs a wide-angle image of the known and planned distance measurement site. A laser distance measuring device 167 attached to the tracking television camera 80 measures the distance between the known and intended distance measurement locations. According to the measured distance, the angle of view and focal length of the tracking television camera 80 are adjusted to photograph the information and the intended distance measurement location.

On the screen of the photographed known and distance measurement prediction position, tracking television camera monitor screens A 622, B 623, C 624, and D 777 show laser irradiation light, distance measurement laser light A 619, B 620, C 621, and D 618 shown on the Irradiation position tracking television camera monitor screen, and known measurement location A 626, B 627, C 628 and D 625 shown on the tracking television camera monitor screen monitor screen.

The images are recorded on an image storage medium in association with the measured distance of the images from the drone 42 and their azimuth and orientation. Play back the recording and view the image at a known planned distance measurement location on the ground. The distance to the position of the distance measuring laser beam 615 irradiated near the known measurement location A is actually measured on the ground from the known measurement location A 626 on the tracking television camera monitor screen shown on the tracking television camera monitor screen A 622 and the known measurement location A 611 on the ground corresponding to the position of the distance measurement laser beam A 619 displayed on the tracking television camera monitor screen.

The distance to the position of the distance measuring laser beam 616 irradiated near the known measurement location B is actually measured on the ground from the known measurement location B 627 on the tracking television camera monitor screen shown on the tracking television camera monitor screen B 623 and the known measurement location B 612 on the ground corresponding to the position of the distance measurement laser beam B 620 displayed on the tracking television camera monitor screen. The distance to the position of the distance measuring laser beam 617 irradiated near the known measurement location C is actually measured on the ground from the known measurement location C 628 on the tracking television camera monitor screen shown on the tracking television camera monitor screen C 624 and the known measurement location C 613 on the ground corresponding to the position of the distance measurement laser beam C 621 displayed on the tracking television camera monitor screen. The positions of drones A 42, B 43, and C 44 flying over the planned distance measurement site can be associated with the location of the known measurement location by associating the irradiation position of the laser distance measuring device 167 with the location of the known measurement location. The position of the distance measuring laser beam 614 emitted from the position of drones A 42, B 43, and C 44 flying over it, associated with the location of the known measurement location and irradiated near the planned measurement location is associated with the location of the known measurement location by actual measurement.

The distance from the planned measurement location 505 on the ground which corresponds to the planned measurement location 625 shown on the tracking television camera monitor screen D 777 and the position of the irradiated distance measuring laser beam 618 shown on the monitor screen, to the position of the distance measuring laser beam 614 irradiated near the planned measurement location is actually measured on the ground. The planned measurement location 505 is associated with the location known measurement locations A 611, B 612, C 613 of its known measurement locations. By performing similar measurements with the drones A 42, B 43, and C 44 flying over different known positions, the measurement accuracy of the planned measurement location 505 can be improved. If the known measurement location and the planned distance measurement location are the image of the subject photographed by the tracking television camera 80, the subject for image recognition, or the subject emitting light, the tracking function based on the image recognition of the tracking television camera 80 can omit the actual measurement of the position of the distance measuring laser light on the ground.

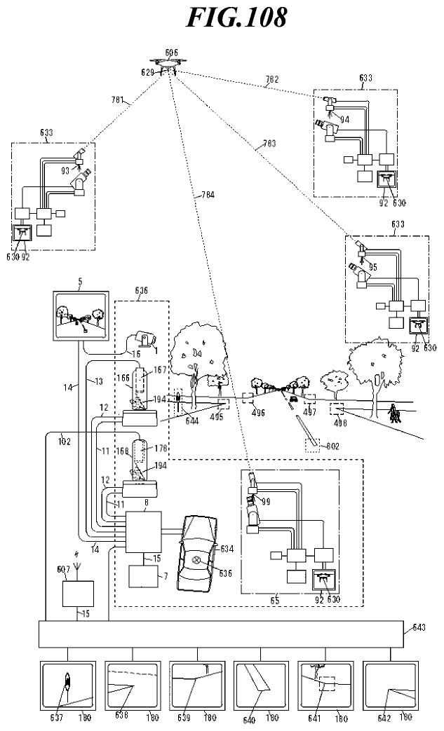

Example: Each tracking laser distance measurement system 633, installed at a known absolute position in FIG. 108 and a tracking television camera distance measurement system attached to a moving automobile 636 for distance measurement, measures the distance of the distance measurement A 781, B 782, C 783, D 784 to the distance measuring displaying mirror 629 attached to the drone 606 above it, tracking laser distance measurement base points A 93, B 94, C 95 and the planned measurement base point 99 of distance measurement automobile 634 are measured by synchronizing with the light emission of the LED attached to the drone.

The distance measurement D 784 measured by the tracking television camera distance measurement system 636 attached to the running distance measurement automobile is the distance to be measured while the distance measurement automobile 634 is running. The position of the drone 606 in the sky above it is calculated from the numerical values of the measured distance, photographing direction, and bearing from the tracking laser distance measurement base points A 93, B 94, and C 95 of each tracking laser distance measurement system 633. The distance-measuring automobile 634 calculates the photographing direction and azimuth numerical values with the distance measurement D 784 that continuously measures the position of the drone 609 in flight from the tracking laser distance measurement planned base point 99 and the tracking television camera 80 and the tracking laser distance measurement device 3 of the tracking television camera distance measurement system 65, measures the position during travel, and travels.

With the tracking television camera distance measurement system 65 attached to the traveling distance measurement automobile 636, the distance to the direction of the object image-detected by the fixed television camera 1 around the traveling road is measured by the mirror-tracking laser distance measurement device 166. An image photographed by the mirror tracking television camera 168 at an angle of view and a focal length corresponding to the measured distance is image-recognized. The image-detected image-recognized subject, the distance to the subject, the measurement direction, and the azimuth are calculated by numerical values of the distance from the known position while the distance-measuring automobile 634 is traveling. The position of the object image-detected and image-recognized by the fixed television camera 1 is measured as a known position.

A sign tower 637, a left front intersection corner 638, a left back intersection corner 639, a median strip display 640, a right back intersection corner 641 and a right front intersection corner 642 displayed on the monitor screen of the mirror tracking television camera monitor screen 180 on which the subject image-recognized by the mirror tracking television camera 168 is displayed are measured the positions of several objects image-recognized on the road surface, such as the sign tower 644 on the left side of the road, the front corner 495 of the intersection on the left side of the road, the back corner 496 of the intersection on the left side of the road, the back corner 497 of the intersection on the right side of the road, and the intersection on the right side of the road corner 498 on the left side of the road or the like, in the vicinity of the road in the traveling direction of the distance measuring automobile 634 as known positions. The positions of several measured and image-recognized objects are stored as absolute position information, transmitted by the data transmitter/receiver 607, stored as absolute position information, and shared.

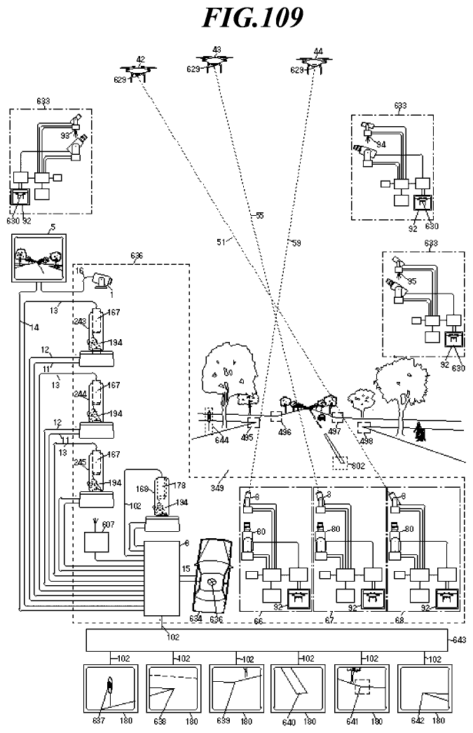

Example: The positions of a plurality of drones A 42, B 43, and C 44 flying over the sky are simultaneously measured from the locations of the plurality of known absolute position tracking laser distance measurement base points A 93, B 94, and C 95 described above in FIG. 109 and let each drone have a known position. Each of the tracking television camera distance measurement systems A 66, B 67, and C 68 of the tracking television camera distance measurement systems attached to the distance measuring automobile 636 incorporated in a distance measuring automobile 634 traveling through a plurality of known positions of which each position is measured; travels while measuring the distances 3D 59, 2D 55, and 1D 51 to the drones C 42, B 43, and C 44. It measures the position of the traveling distance measuring automobile 634 based on the numerical values of the distances to the drones A 42, B 43, and C 44.

The position of the running ranging automobile 634 is always measured and is a known position. As a result, The tracking laser distance measurement devices A 243 B 244 and C 245 provided in the tracking television camera distance measurement system attached to the distance measurement automobile 636 tracks and measures the distance of the recognized image at the sign tower 644 on the left side of the road on the side of the road at the position of beacon tower 637 shown on the mirror tracking television camera monitor screen, the corner 495 in front of the intersection on the left side of the road on the side of the road at the intersection corner in front of the left, the back corner 496 of the intersection on the left side of the road at the left back intersection corner, the center lane 802 at the median strip display position, the back corner 497 of the intersection on the right side of the road at the right back intersection corner and the front corner 498 of the intersection on the right side of the road at the right front intersection corner at the position displayed on the mirror-tracking television camera monitor screen 180 that recognizes the image photographed by the mirror-tracking television camera 168 provided in the tracking television camera distance measurement system attached to the distance measurement car 636 according to the position on the mirror tracking television camera monitor screen 180.

The image recognition objects around the travel route are made known positions from the known travel positions of the distance measuring automobile 634 that continuously measures the known positions of the drones A 42, B 43, and C 44 flying in the sky. The position of the distance measuring automobile 634 can be specified as a known absolute position by distance measurement in three directions from the position of the distance measuring automobile 634 during travel. Furthermore, by measuring distances in three directions from that position, the position of each recognized image can be specified as a known absolute position. The position of the identified image is the position measured from the tracking laser distance measurement base points A 93, B 94, C 95 with a plurality of known absolute bearings and the direction of travel of the automobile. Therefore, the sign tower 644 on the left side of the road, the front corner 495 of the left-hand road intersection, the rear corner 496 of the left-hand road intersection, the center lane 802, the rear corner 497 of the right-hand road intersection, and the front corner 498 of the right-hand road intersection are absolute bearing positions. Therefore, since this measured absolute azimuth position can be shared, it is stored as absolute position information, transmitted by the data transmitter/receiver 607, stored as absolute position information, and shared. All distance measuring automobiles 634 measure known absolute position information on the side of the road, and newly store absolute position information on the side of the road. Therefore, all the distance measuring automobiles 634 using the new absolute position information can travel with the new absolute position information.

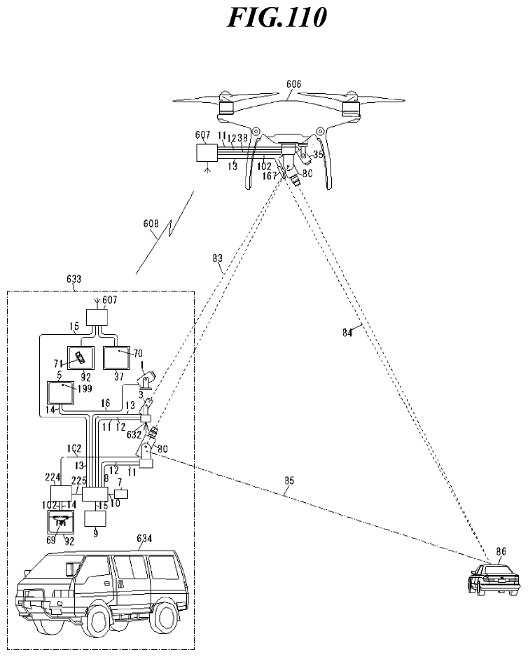

Example: The fixed television camera 1 of the tracking laser distance measurement system photographs the position of the drone 606 flying above the traveling distance measurement automobile 634 in FIG. 110. An image of the measurement drone 199 is detected on the fixed television camera monitor screen 5, which is displayed on the fixed television camera monitor screen. A tracking television camera 80 and a tracking laser distance measuring device 3 are directed to a position corresponding to the position of the fixed television camera monitor 5. The angle of view and focal length are adjusted to the distance to the drone 606 measured by the tracking laser distance measuring device 3, and the drone 606 in the tracking image 69 on the tracking television camera monitor screen 92 photographed by the tracking television camera 80 is image-recognized. The drone 606 is tracked and photographed by the tracking television camera 80 so that the recognized tracking image 69 of the drone 606 appears in the center of the tracking television camera monitor screen 92. The distance from the distance measuring automobile 634 to the drone 606 is measured by the tracking laser distance measuring device 3 in the direction in which the tracking image 69 on the tracking television camera monitor screen 92 is tracked and photographed.

A data transmitter/receiver 607 incorporated in the drone 606 and a data transmitter/receiver 607 incorporated in the tracking laser distance measurement system 633 are connected by a data transmission/reception signal 608. In order to photograph a traveling automobile 86 to be measured by a tracking television camera 80 having a numerical control television camera 35 and a laser distance measuring device 167, the angle of view of the numerical control television camera 35 built into drone 606, is widened to widen the photographing range of the numerical control television camera monitor screen 37. Manual operation is performed so that the running automobile 86 to be measured is displayed on the numerical control television camera monitor screen 37. By displaying the traveling automobile 70 to be measured on the numerical control television camera monitor screen on the numerical control television camera monitor screen 37, the angle of view of the numerical control television camera 35 is adjusted so that the traveling automobile 86 to be measured can be recognized as an image.

The numerical control television camera 35 is caused to track the traveling automobile 86 to be measured so that the enlarged traveling automobile 71 to be measured on the numerical control television camera monitor screen of the numerical control television camera monitor screen 37 appears in the center as the tracking image 69. A tracking television camera 80 attached with a laser distance measuring device 167 is driven to track according to the driving numerical value for tracking the numerically controlled television camera 35. The distance between the drone 606 and the traveling automobile 86 to be measured is measured by the laser distance measuring device 167 in order to convert the enlarged traveling automobile 71 to be measured on the screen of the tracking television camera monitor screen 92 for displaying the screen photographed by the tracking television camera 80 into a recognizable image. According to the measured distance, the angle of view and the focal length of the tracking television camera 80 are adjusted so that the recognized image appears in the center of the tracking television camera monitor screen 92, and the tracking television camera 80 is driven to track.

The laser distance measuring device 167 measures the distance between the traveling automobile 86 to be measured and the drone 606, which is tracked and photographed by the tracking television camera 80. The position of the drone 606 tracked and photographed by the tracking television camera 80 of the distance measuring automobile 634 can also be measured from the traveling distance measuring automobile 634. The direction and distance of the traveling automobile 86 to be measured can be continuously measured from the traveling distance measurement automobile 634 by associating with the position of the drone 606 measured by the tracking laser distance measurement system 633.

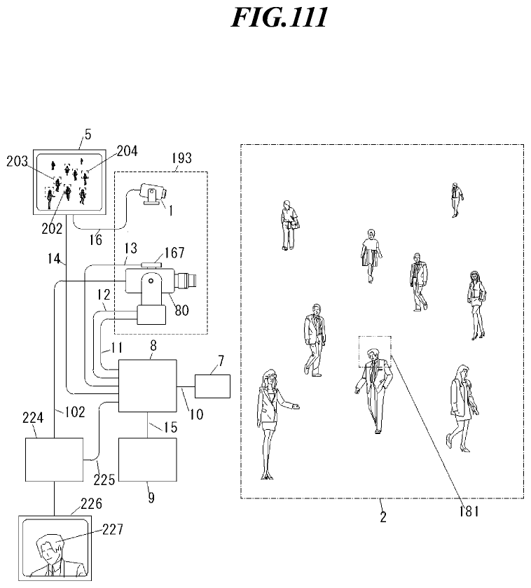

Example: An image on the fixed television camera monitor screen 5 showing a screen photographed by the fixed television camera 1 in the fixed television camera photographing range 2 in FIG. 111, is detected, and a tracking television camera 80 equipped with a laser distance measuring device 167 tracks and photographs a position corresponding to the position where the subject 1202 appears on the fixed television camera screen. At the distance measured by the laser distance measuring device 167, tracking photography is performed so that the angle of view and the focal length for tracking photographing by the tracking television camera 80 are matched, and the image of the subject is confirmed on the image analysis television camera monitor screen 226, and the image analyzed image 227 is displayed.

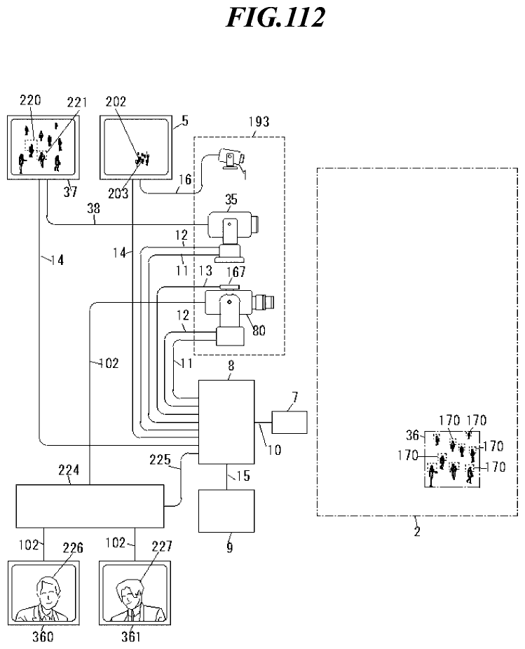

Example: Images of several subjects 170 were detected on the fixed television camera monitor screen 5 showing a screen by the fixed television camera 1 in the fixed television camera photographing range 2 in FIG. 112. The camera 35 is driven by driving numerical values in the directions corresponding to the positions where the two subjects of the subject 1 202 on the fixed television camera screen and the subject 2 203 on the fixed television camera screen among the several detected images, and the two subjects are photographed.

The position corresponding to the subject 1 220 and subject 2 221 on the numerical control television camera monitor screen of the numerical control television camera monitor screen 37 displaying the two images is measured by the tracking television camera 80 with the laser distance measuring device 167 attached, and the tracking image is photographed. The tracking television camera 80 photographs each subject by adjusting the angle of view, the focal length, etc. according to the distance measured by the laser distance measuring device 167. Each photographed image is image-recognized by the image analyzer 224, and image-analyzed image 1 226 is displayed on the tracking television camera monitor screen A 360 and image-analyzed image 2 227 is displayed on the tracking television camera monitor screen B 361.

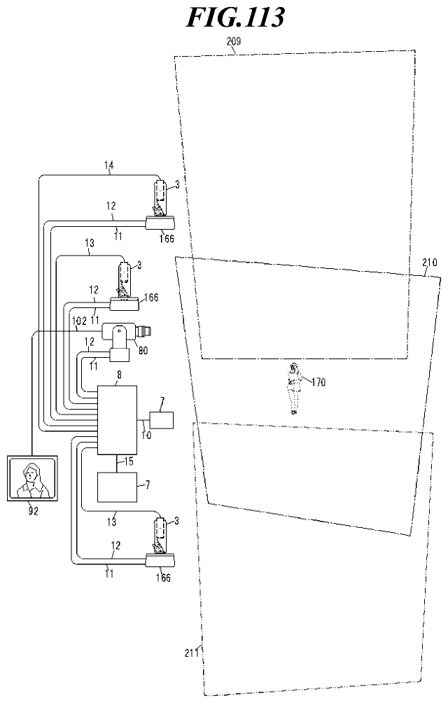

Example: In order to photograph a dark object at night in FIG. 113, the photographing range of the tracking television camera 80 is searched by a plurality of mirror-tracking laser distance measuring devices 166, and the subject is detected and its distance is measured by the displayed light of the range-measuring laser at a different distance than usual. The angle of view of the tracking television camera 80 is narrowed in the direction in which the object is detected, the focal length is adjusted according to the measured distance, the sensitivity is increased, and the tracking television camera monitor screen 92 is photographed. Information of an individual's image is acquired and stored from the image photographed by tracking.

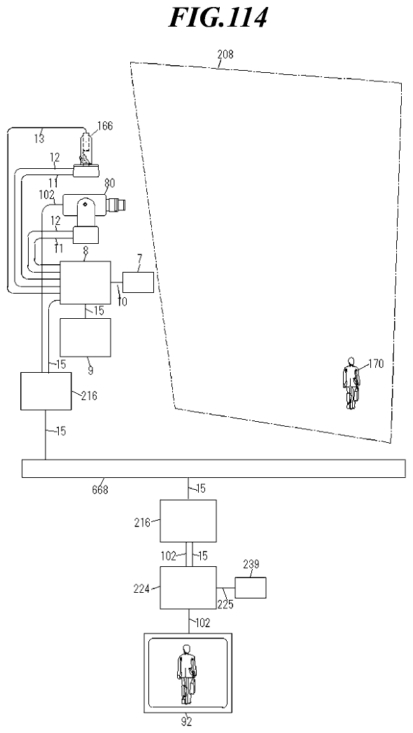

Example: The measurement range 208 of the mirror-tracking laser distance measuring device in FIG. 114 is searched by the mirror-tracking laser distance measuring device 166, and the object is detected by its displayed light, which is different from usual, and the distance is measured. The tracking television camera monitor screen 92 is photographed by adjusting the field angle and focal length of the tracking television camera 80 according to the measured distance in the direction in which the subject is detected. The photographed images are analyzed for image collation at another location via the Internet network 668.

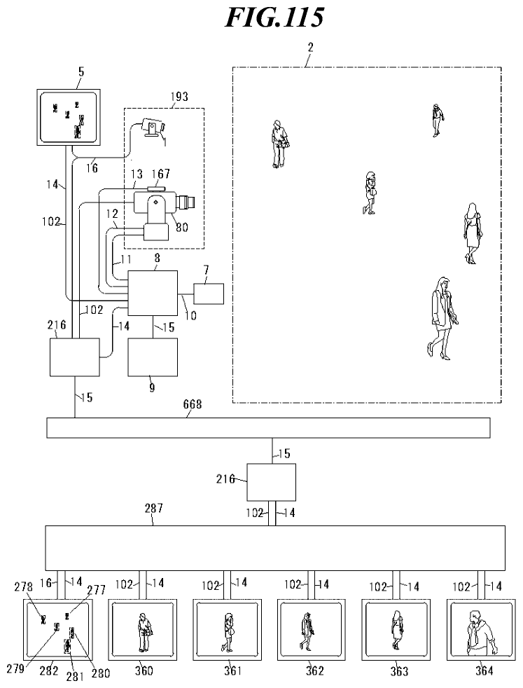

Example: On an image on the fixed television camera monitor screen 5 showing the fixed television camera photographing range 2 in FIG. 115, the detected image is tracked and photographed by the tracking television camera 80 with the laser distance measuring device 167 at a position corresponding to the image recognition positions A 277, B 278, C 279, D 280, and E 281 on the Internet fixed television camera monitor screen on fixed television camera monitor screen 282 via the internet through the internet network 668. Tracking photography is performed by matching the angle of view and focal length of the tracking television camera 80 to the distance measured by the laser distance measuring device 167.

The photographed images are stored in the image storage medium 287 via the Internet network 668 as the images of the tracking television camera monitor screens A 360, B 361, C 362, D 363, and E 364. On the tracking television camera monitor screens A 360, B 361, C 632, D 633, and E 364, a preset photographing method is selected so that the subject to be photographed by the tracking television camera 80 can be image-recognized. The direction, the angle of view, and the focal length are manipulated to perform tracking photography that enables image recognition, and the image is confirmed and stored. The images in each different region are compared with the images stored in the image storage medium 287 via the Internet network 668.

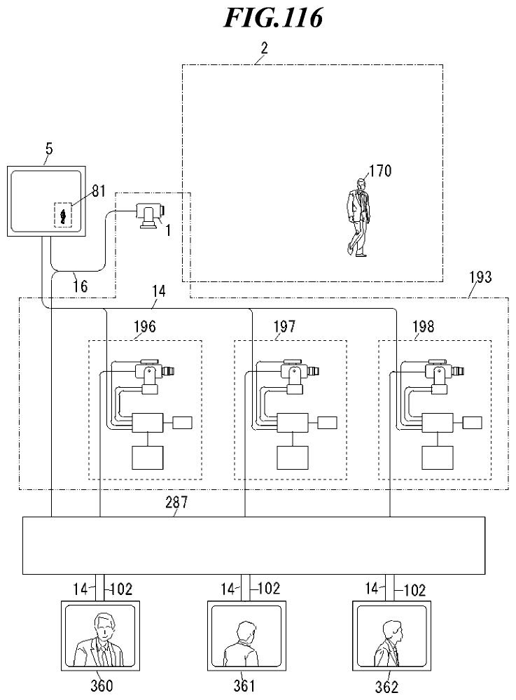

Example: The image on the fixed television camera monitor screen 5 showing a screen photographed by the fixed television camera 1 in the fixed television camera photographing range 2 in FIG. 116, is detected, and the position corresponding to the position on the fixed television camera monitor screen where the subject 81 appears on the screen is tracked and photographed by the tracking television camera 80 of the plurality of television camera tracking system A 196, B 197, C 198 equipped with the laser range distance measuring device 167. The angle of view and focal length photographed by each tracking television camera 80 are tracked at the distances measured by the respective laser distance measuring devices 167. The images analyzed in the tracking television camera monitor screen A 360 shows the front of the subject, the tracking television camera monitor screen B 361 shows the subject's back, and the tracking television camera monitor screen C 362 shows the side of the subject are expanded with each measured distance and direction and displayed on a composite screen of the tracking television camera monitor screen A 360, B 361, and C 362.

At all screen positions on the tracking television camera monitor screens A 360, B 361, and C 362, the numerical value of the driving numerical value tracked and photographed by the tracking television camera 80 of the tracking television camera tracking system A 196, B 197, C 198 is associated with the position on the fixed television camera monitor screen 5. With any of the above operations on the tracking television camera monitor screen, each tracking television camera photographs from a different direction with a numerical value driven by each tracking television camera associated with that operation. The degree of image recognition can be improved by storing images of the object 170 photographed from various angles in association with each other in the image storage medium 287. A photographing method suitable for image recognition is set in advance at positions on the tracking television camera monitor screens A 360, B 361, and C 362. According to the setting, the photographing method is modified and each tracking television camera photographs. Photographing information is added to the photographed image, and stored in numerical values that can be classified.

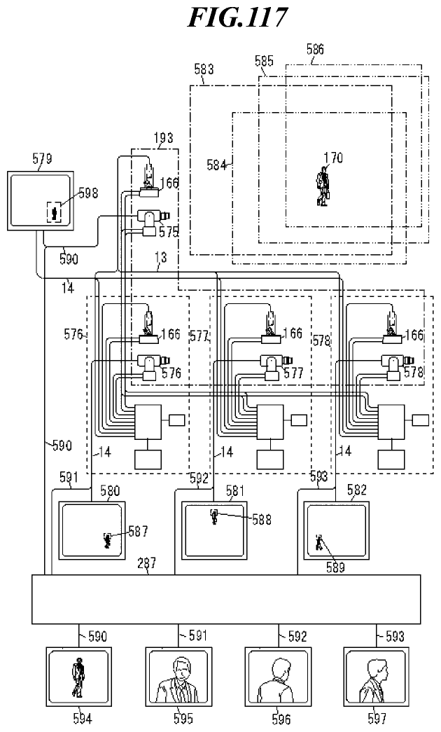

Example: The same imaging range in FIG. 117 is photographed from several different directions by pixel tracking television cameras A 576, B 577 and C 578. At any of its image tracking television cameras, A, B, C photographing ranges 584, 585, 586, each mirror-tracking laser distance measuring device is directed to the direction corresponding to the position of the detected image of the subject, A 587, B 588, and C 589 on the pixel tracking television camera monitor screen on the pixel tracking television camera monitor screens A 580, B 581, and C 582 by using the numerical value for the subject photographed by any of the pixel tracking television cameras A 576, B 577, C 578, of the mirror-tracking laser distance measuring device that shares the driving numerical value in advance.

The distance to the subject 170 is measured from the position of each mirror-tracking laser distance measuring device 166. According to the measured distance, the image elements of each pixel tracking television cameras A 756, B 757, C 758 are narrowed down and focused to the measured distance. As a result, it is possible to photograph the pixel tracking screen of the subject 170 on the pixel tracking television camera monitor and the screen tracked by the image elements A 595, B 596, and C 597. Any of the pixel tracking television camera systems A 576, B 577, and C 578 can detect the image of the subject 170, which can be image-recognized on a plurality of screens. Any pixel tracking television camera system, A 576, B 577, C 578, can measure the distance to the subject 170 from which the image is detected. In the case of the measurement method that measures the distance by emitting light from the LED light emitting element at the position of the image element detected by the pixel tracking television camera systems A 576, B 577, C 578, image recognition can be performed instantaneously since distance measurement can be performed at the same time.

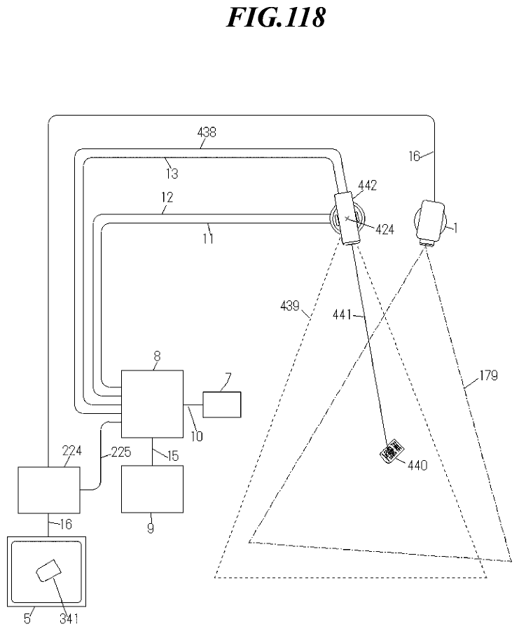

Example: An image of a subject with information position 341 on the fixed television camera monitor screen is detected on the fixed television camera monitor screen 5 photographed by the fixed television camera 1 in FIG. 118 over a wide range. A numerically controlled bar code reader laser distance measuring device 442 having a distance measuring function and a bar code reading function is directed in the direction corresponding to the detected position of the subject image on the screen. The distance to the subject is measured, and the reader light is emitted at the scanning speed of the barcode reader laser light of the barcode reader laser distance measuring device 442 according to the measured distance to the subject. The barcode written on the object is acquired with a laser beam that matches the distance of the barcode marking position 440.

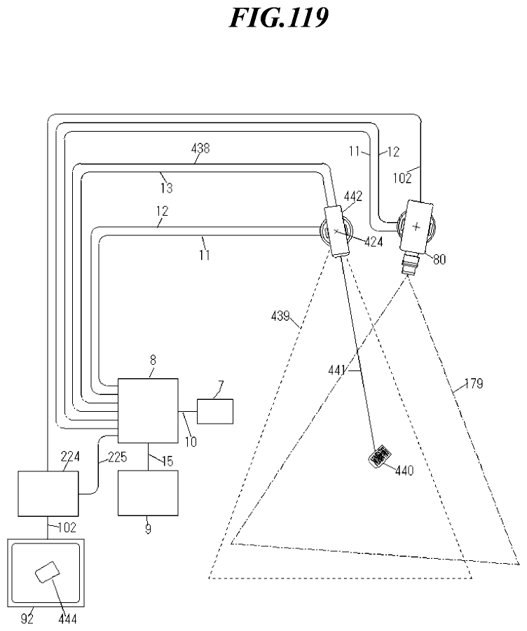

Example: A bar code reader reading range 439 in FIG. 119 is photographed by a numerical control bar code reader laser distance measuring device 442 having a distance measurement function and a bar code reading function and a tracking television camera 80. The angle of view of the tracking television camera 80 is widened, and a barcode reader 442 and a laser distance measuring device 442 are directed to the position of the detected image of the subject of the barcode notation shape 444 on the tracking television camera monitor screen 92. Then, the distance to the object is measured, and the tracking television camera 80 photographs another image with the angle of view and focal length corresponding to the measured distance, and the image that detects the object is image-recognized. The tracking television camera 80 is driven so that the image photographed by the tracking television camera 80 and image-recognized appears in the center of the tracking television camera monitor screen 92. The barcode reader 442 and the laser distance measuring device are driven to the position where the image recognition of the barcode notation shape 444 on the tracking television camera monitor screen on the tracking television camera monitor screen 92 photographed at the driven position is performed, and the distance is measured again. Refocus the barcode reader to that distance and read the barcode display. The image photographed by the tracking television camera 80 and recognized on the monitor screen of the tracking television camera is attached to the bar code display and stored.

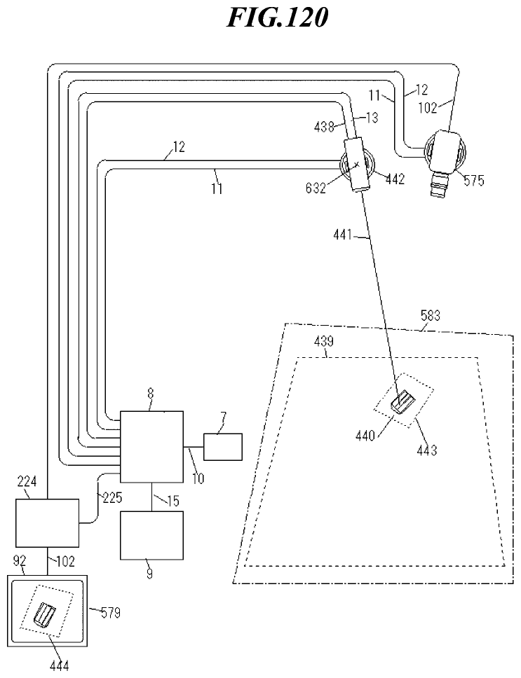

Example: A numerically controlled bar code reader laser distance measuring device 442 having a distance measuring function and a bar code reading function, and a television camera device having a pixel tracking television camera 575 function are installed toward the barcode reader reading range 439 in FIG. 120. The pixels photographed by the pixel tracking television camera 575 are wide-angle, and the barcode reader laser distance measuring device 442 is directed to the position of the image where the subject is detected on the pixel tracking television camera monitor screen 579, and the distance to the subject is measured. The pixel tracking television camera 575 photographs images again at the pixel angle of view and focal length corresponding to the measured distance, and the image of the subject detected on the pixel tracking television camera monitor screen 579 is recognized. The distance is adjusted to the image-recognized bar code notation position 440 on the pixel tracking television camera monitor screen 579, and the bar code reader laser distance measuring device 442 measures the distance again. The barcode reader is refocused on the measured distance, and the barcode notation shape 443 is read. The image of the recognition image of the barcode notation shape 444 on the pixel tracking television camera monitor screen 579 is attached to the barcode display and stored.

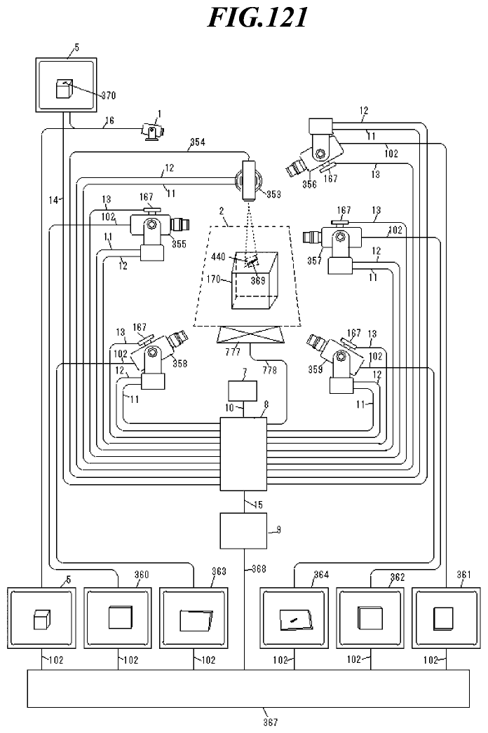

Example: A Tracking television cameras A 355, B 356, C 357, D 358, E 359 equipped with a plurality of laser distance measuring devices 167 photographs the direction in which the position 370 for detecting the shape of the image on the fixed television camera monitor screen on the fixed television camera monitor screen 5 taken by the fixed television camera 1 in FIG. 121, is detected, and each laser distance measuring device 167 measures the distance to the shape. At the angle of view and focal length corresponding to the measured distance, the shape is photographed from that direction, each image is analyzed, and the image is recognized. The barcode notation shape 443 is image-recognized from the image-recognized image, the tracking barcode reader 353 is directed to the barcode-notated position 440, and the barcode display 369 is read according to the scanning speed of the distance corresponding to that position.

At the same time, the weight of the image-recognized shape is measured by the weighing machine 777. The image of the position where the shape of the image on the fixed television camera monitor screen 370 photographed by the fixed television camera 1 is detected, the images on the tracking television camera monitor screens A 360, B 361, C 362, D 363, E 364 photographed and recognized by tracking television cameras A 355, B 356, C 357, D 358, and E 359 and the weight measurement data 778 measured by weight measuring machine 777 are attached to the numerical information acquired by reading the bar code 369 display, and stored in the data 367 and the image storage medium.

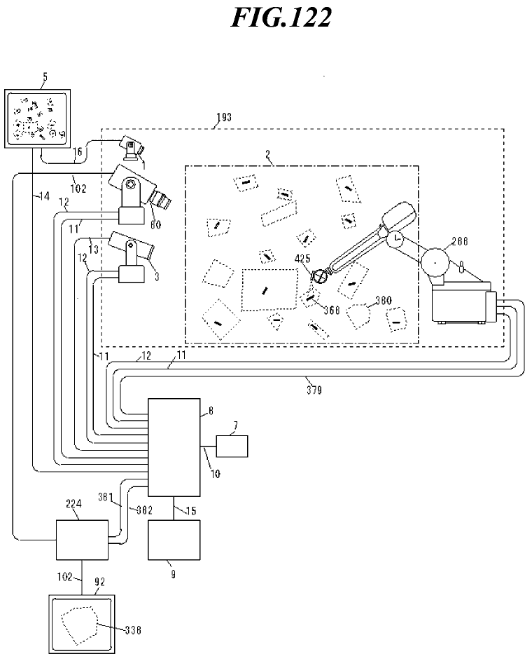

Example: The tracking laser distance measuring device 3 and the tracking television camera 80 are directed to the position of the object labeled with the image detected information data on the monitor screen of the fixed television camera 1 in FIG. 122. At the angle of view and focal length corresponding to the distance measured by the tracking laser distance measuring device 3, the object information data 368 of the object with the information data notation is photographed by the tracking television camera 80, and the image is recognized. The object image-recognized by the tracking television camera 80 with a numerically controlled television camera 35 attached to the working position of the numerically controlled robot 288, is driven to the position where the tracking laser distance measuring device 3 measures and can be decoded, and the numerical control television camera 35 decodes the object information data 368. The image of the detected subject photographed by the tracking television camera 80 is collated with the acquired decoded information data.

A tracking laser distance measuring device 3 measures the distance of the position of an object from which an image is detected on a fixed television camera 1 monitor screen photographing a fixed television camera photographing range 2 of a wide collection site. The subject photographed by the tracking television camera 80 is image-recognized at the angle of view and focal length corresponding to the measured direction and distance. Further, the subject information data 368 is photographed at the position of the subject at a focal length corresponding to the distance measured by the numerically controlled television camera 35 attached to the working position of the numerically controlled robot 288, and the information data is decoded. Although described as a barcode reader, the information data to be decoded can also be object information data such as other barcodes. The notation information of the object information data 368 notation shape is associated with the image detected position on the monitor screen of the fixed television camera 1, the image recognized by the tracking television camera 80, the measured position, and the driving numerical value of the numerically controlled robot 228.

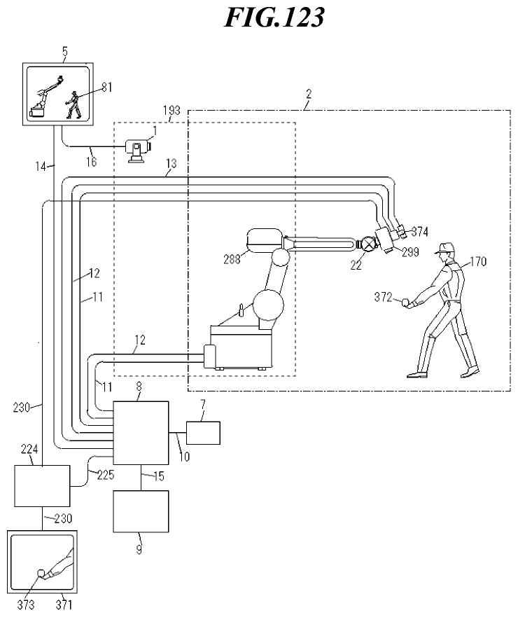

Example: A tracking laser distance measuring device 374 attached to the robot and a numerically controlled television camera 299 attached to the numerically controlled robot 288 are driven to a position corresponding to the image detection position of the indicator 372 held by a worker that indicates the work place of the robot held by the worker of the subject 81 shown on the fixed television camera monitor screen 5 photographed by the fixed television camera 1 in FIG. 123.

A tracking laser distance measuring device 374 attached to the robot measures the distance from an indicator 372 held by a worker that indicates the robot's work place. The instruction display of the indicator 372 photographed by the numerical control television camera 299 attached to the robot at the angle of view and focal length corresponding to the measured distance, and held by the worker that indicates the work place of the robot is decoded, and the robot performs the work 22 of the image-recognized content of the processed product held by the worker.

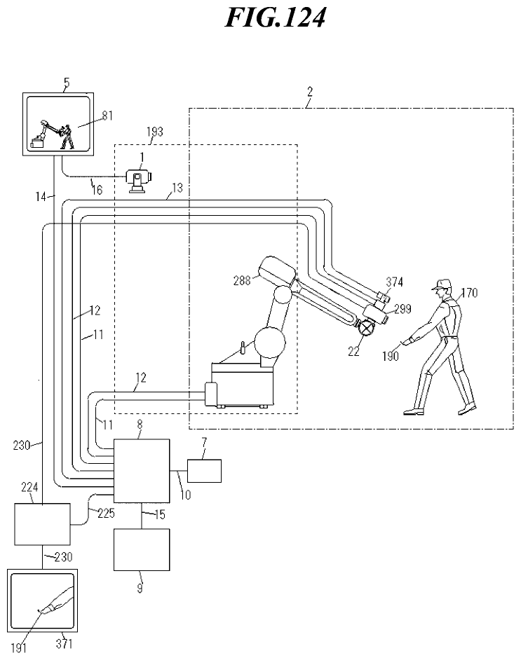

Example: A tracking laser distance measuring device 374 attached to the robot and a numerically controlled robot 288 to which a numerically controlled television camera 299 is attached are driven to their working positions to the position where the hand of the worker of the subject 81 displayed on the fixed television camera monitor screen 5 photographed by the fixed television camera 1 in FIG. 124 is detected. A tracking laser distance measuring device 374 attached to the robot measures the distance of the position instructed 190 by the operator. The image recognition of the position indicated 191 on the television camera monitor screen attached to the robot photographed by the numerically controlled television camera 299 is performed at the angle of view and focal length corresponding to the measured distance. The robot operation 22 of the numerical control robot 288 is performed by analyzing the contents of the image recognition.

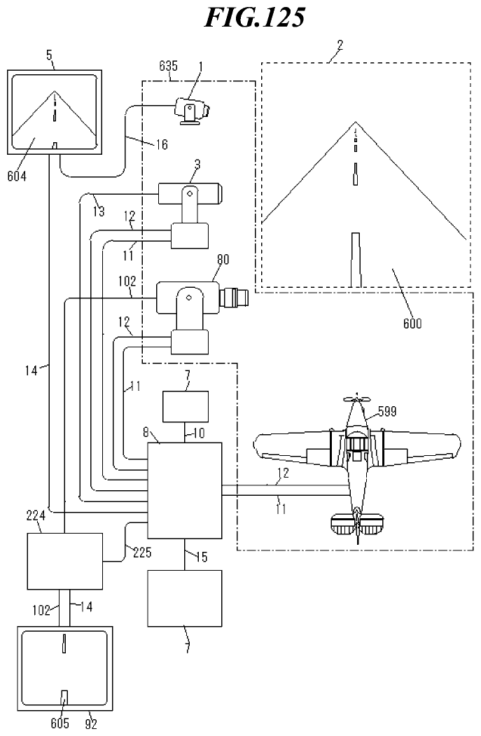

Example: The tracking laser distance measuring device 3 and the tracking television camera 80 are directed in the direction in which the image of the runway sign displayed on the fixed television camera monitor screen 604 photographed by fixed television camera 1 incorporated in tracking television camera laser distance measurement system 635 attached to a small aircraft as a support image when the small aircraft 599 in FIG. 125 is landing on a small airport runway 600, is detected. The angle of view and the focal length are adjusted according to the measured distance, and the notation 605 on the runway shown on the tracking television camera monitor screen 92 is recognized in detail. The detailed image of the image recognition in the same situation acquired in advance is compared to display the difference from the image of the runway notation 605 on the detailed tracking television camera monitor screen photographed by the tracking television camera 80.

The display of the difference from the image on the small aircraft 599 in preparation for landing is the direction taken by the fixed television camera 1, the distance measured by the tracking laser distance measuring device 3, the driving numerical value photographed by the tracking television camera 80 corresponding to the measured distance and the position shown on the tracking television camera monitor screen 92. The flight direction of the small aircraft 599 in its landing attitude is corrected in order to correct its image in the center of the fixed television camera photographing range 2 in the photographing direction of the fixed television camera 1. The display of the difference from the image is matched to the previously acquired image in order to modify the drive values of the drive mechanism that drives the small aircraft 599 in its landing readiness. For this purpose, the driving numerical values photographed by the tracking television camera 80 are developed and displayed in the direction of the driving numerical values that match the previously acquired driving numerical values. Then, the driving numerical value of the driving mechanism that drives and maneuvers the small aircraft 599 in the landing posture is corrected.

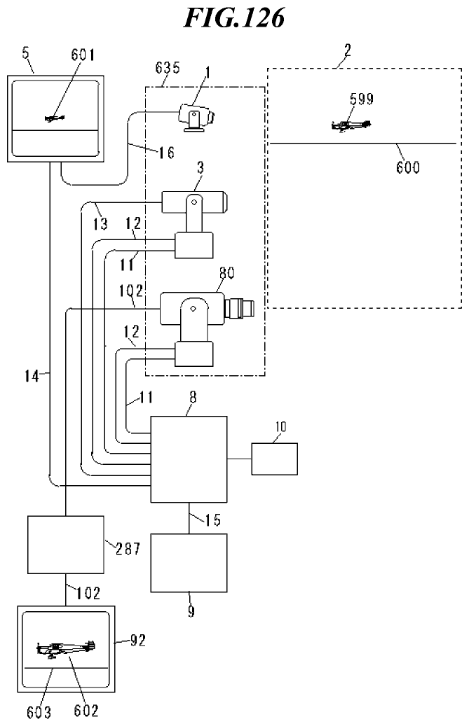

Example: As a support image when the small aircraft 599 in the landing posture of FIG. 126 lands on the small airport runway 600, the small aircraft 599 in the landing preparation lands on the runway 600. The small aircraft 699 in the landing preparation is photographed on the ground where the tracking television camera laser distance measurement system 635 is installed on the side of the runway. The fixed television camera monitor screen 5 photographed by the fixed television camera 1 of the tracking television camera laser distance measurement system 635 detects an image of a small aircraft 601 in a gliding landing posture displayed on the fixed television camera monitor screen. The tracking television camera 80 and the tracking laser distance measuring device 3 are directed to the direction corresponding to the detected position, and the distance to the small aircraft 599 ready for landing is measured. The image of the tracking television camera monitor screen 92 photographed by the tracking television camera 80 at the angle of view and focal length corresponding to the distance is image-recognized.

The image of the landing attitude of the small aircraft 602 in the gliding and landing attitude shown on the tracking television camera monitor screen is compared with the image of a similar landing attitude obtained by image recognition in advance. The driving numerical value of the drive mechanism for driving and maneuvering the small aircraft 599 in the landing posture, which is associated with the position of the screen photographed by the fixed television camera 1, is transmitted to the small aircraft 599 in the landing posture to correct the driving maneuver so that the driving numerical value photographed by the tracking television camera 80 and the position of the distance measured by the tracking laser distance measuring device 3 are the driving numerical value photographed by the tracking television camera 80 which photographed the image of the same landing posture acquired by image recognition in advance and the position of the distance measured by the tracking laser distance measuring device 3.

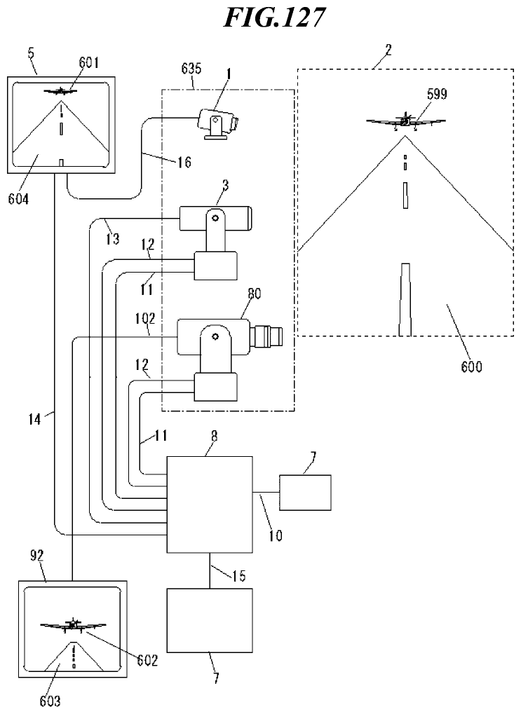

Example: As a support image when the small aircraft 599 in the landing posture of FIG. 127 lands on the small airport runway 600, the small aircraft 599 in the landing preparation lands on the runway 600. The small aircraft 699 in the landing preparation is photographed on the ground where the tracking television camera laser distance measurement system 635 is installed on the side of the runway. The fixed television camera monitor screen 5 photographed by the fixed television camera 1 of the tracking television camera laser distance measurement system 635 detects an image of a small aircraft 601 in a gliding landing posture displayed on the fixed television camera monitor screen. The tracking television camera 80 and the tracking laser distance measuring device 3 are directed to the direction corresponding to the detected position, and the distance to the small aircraft 599 ready for landing is measured. The image of the tracking television camera monitor screen 92 photographed by the tracking television camera 80 at the angle of view and focal length corresponding to the distance is image-recognized.

The image of the landing attitude of the small aircraft 602 in the gliding and landing attitude shown on the monitor screen of the tracking television camera is photographed. The driving numerical value of the tracking television camera 80 is compared with the driving numerical value 80 of the tracking television camera acquired by photographing an image of a similar landing posture obtained by image recognition in advance. Drive maneuvering the small aircraft 599 ready for landing, and transmit the drive values of the drive mechanism to the small aircraft 599 ready for landing to modify the drive maneuvers so that the driving numerical value of the tracking television camera 80 for photographing with the acquired driving numerical value of the tracking television camera 80 for photographing.

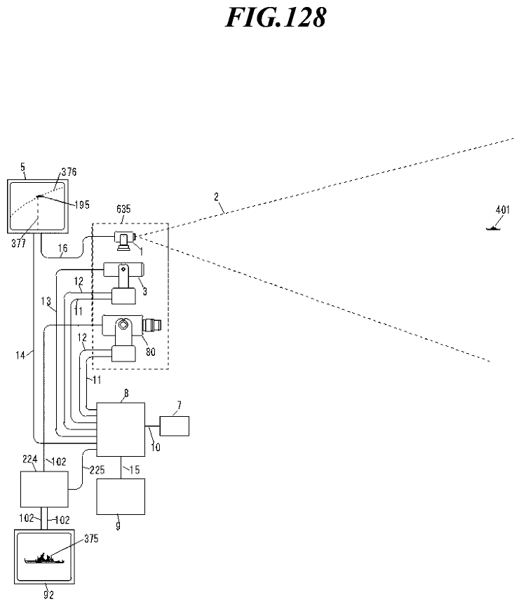

Example: A tracking television camera 80 and a tracking laser distance measuring device 3 are directed to a direction corresponding to a position where an image is detected on a fixed television camera monitor screen 5 photographed by the fixed television camera 1 by the tracking television camera distance measurement system 635 and the tracking television camera laser distance measurement system 635 for distance measurement attached to the ship in FIG. 128. The ship 401 is photographed by adjusting the photographing angle of view, focal length and illuminance of the tracking television camera 80 according to the distance measured by the tracking laser distance measuring device 3. The ship photographed by the tracking television camera 80 tracks and photographs the image of the ship 401 so that the image photographed of the ship 401 appears in the center of the tracking television camera monitor screen 92 even when the own ship moves and shakes.

An image of the ship 401 detected on the fixed television camera monitor screen 5 photographed by the fixed television camera 1 is displayed as the ship 401 advances and shakes. Therefore, the driving mechanism of the tracking television camera 80 is track-corrected according to fluctuations in the photographing direction, angle of view, and focal length of the tracking television camera 80. The tracking television camera monitor screen 92 stably displays the ship's position 375 on the tracking television camera monitor screen. It is possible to display a screen that corrects the display position on the monitor screen for the periodic shaking of the own ship. By adjusting the angle of view, focal length, and illuminance of the tracking television camera 80 and photographing the ship 401, the image of the ship can be recognized. The image of the ship 375 on the tracking television camera monitor screen is analyzed and compared with the image of the ship already stored to recognize the ship as an image.

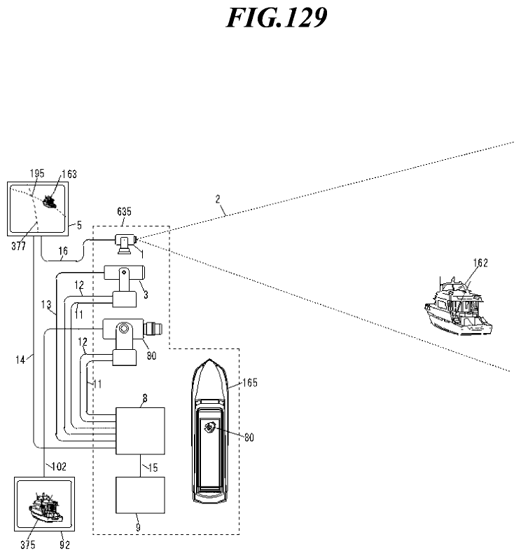

Example: The image of the cruiser boat 163 on the fixed television camera monitor screen is detected by the fixed television camera monitor screen 5 photographed by fixed television camera 1 with tracking television camera laser distance measurement system 635 attached to own ship in FIG. 129. The image of the cruiser boat 163 on the fixed television camera monitor screen is detected by the fixed television camera monitor screen 5. A tracking laser distance measuring device 3 is directed to a direction corresponding to the position of the fixed television camera monitor screen 5. The distance to the cruiser boat 162 detected in the image is measured. The image of the cruiser boat 163 on the fixed television camera monitor screen is continuously measured and photographed. As a result, the traveling direction of the cruiser boat 162 and the traveling position of the own ship are predicted, and when the predicted collision position 195 is predicted on the fixed television camera monitor screen 5, the collision avoidance operation of the ship is performed.

Example: An image 375 of the ship's position on the tracking television camera monitor screen 92, which displays the screen photographed by the tracking television camera 80, can be checked. The position of the cruiser boat 162 photographed and stored by the tracking television camera 80 is developed in the traveling direction of the fixed television camera monitor screen 5 with the measured distance and direction. Thus, by displaying the direction in which the own ship has traveled and the direction in which the cruiser boat 162 has traveled on the same screen, the direction in which the own ship has traveled can be determined.

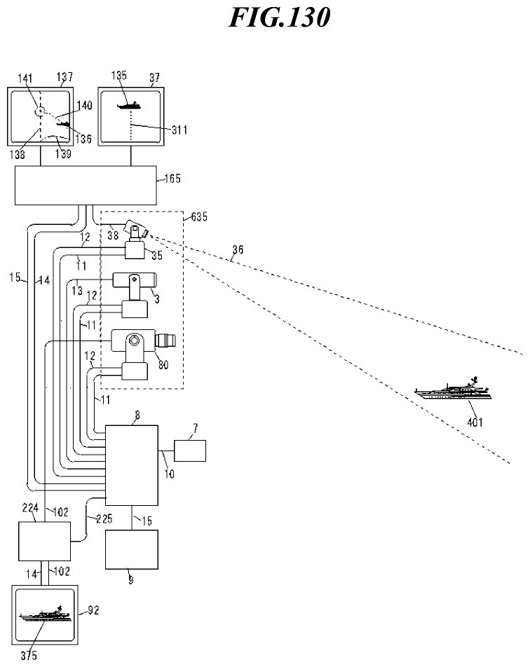

Example: A ship 401 in FIG. 130 advancing from the rear of the own ship is detected on the screen photographed by the fixed television camera 1 attached to the rear of the own ship. The direction corresponding to the position on the screen is photographed by the numerically controlled television camera 35 and the image is detected by the numerically controlled television camera monitor screen 37. The tracking laser distance measuring device 3 and the tracking television camera 80 are directed to the direction corresponding to the driving numerical value of the numerical control television camera 35 that detected the image on the numerical control television camera monitor screen 37 and the position on the screen, and the distance to the ship 401 is measured.

Image recognition of the detected image on the tracking television camera monitor screen 92 photographed by the tracking television camera 80 is performed at the angle of view and focal length corresponding to the measured distance. The image recognition of the ship is performed by comparing with the already acquired image recognition of the recognized ship. The position of the ship 135 on the distance measurement monitor screen of the numerical control television camera screen is displayed on the image information display 311 of the advancing ship photographed by the tracking television camera 80 on the numerical control television camera monitor screen 37 displaying the image of the numerical control television camera 35 photographing the rear of the own ship.

The image of the ship photographed by the tracking television camera 80 is expanded and synthesized at the measured distance and direction, and displayed in accordance with the traveling direction of the superimposed composite television camera monitor screen 137 on the screen photographed by the fixed television camera 1 attached to the rear of the ship. The ship on the numerical control television camera monitor screen 37 continues to be displayed by developing the photographed position at the measured distance, and the course of the ship detected by the image can be simulated. It will turn to change path 139 of collision avoidance on the screen if the simulated course of the own ship's traveling direction and the simulated course of the ship recognized by the image become the collision area 141 on the overlapped composite television camera monitor screen.

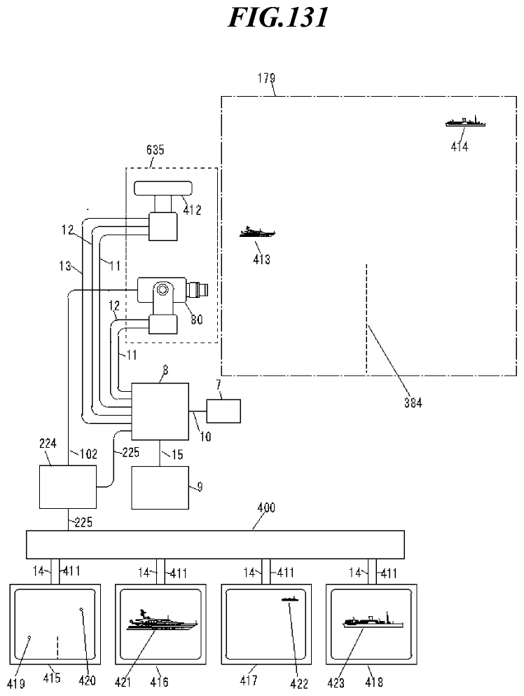

Example: The ship radar detector 412 attached to the own ship in FIG. 131 fits the direction and distance of several ships detected by the ship radar detector 412 on the ship radar monitor screen 415, and adjusts its angle of view, focal length, and illuminance, and the image adjuster 400 discriminates the image photographed by the tracking television camera 80. As the tracking television camera monitor screen showing a yacht at a short distance 416, the tracking television camera monitor screen 417 showing a distant container ship and the tracking television camera monitor screen 418 showing a long-distance container ship with tracking image manipulation, a tracking television camera monitor screen 416 that displays several short-distance yachts whose images have been identified, a tracking television camera monitor screen 417 that displays a long-distance container ship, and a tracking television camera monitor screen 418 showing a distant container ship that has undergone tracking image manipulation are displayed according to the degree of attention required for the distance and the image-recognized information. Image information display 311 is displayed on tracking television camera monitor screens ship radar monitor screens 415, 416, 417, and 418, adding information identifying the image of the subject and the degree of caution.

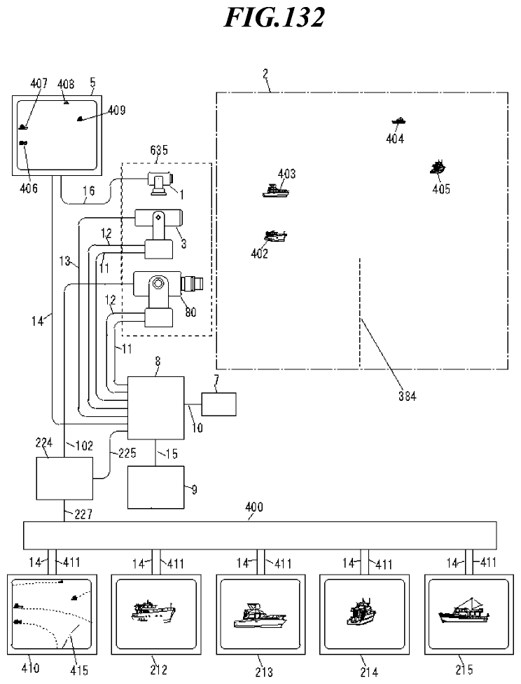

Example: The fixed television camera 1 of the tracking television camera laser distance measurement system 635 attached to the ship in FIG. 132 photographs the subject boats 1 402, 2 403, 3 404, and 4 405 in the fixed television camera photographing range 2 and detects the images. The positions of the subject boats 1 406, 2 407, 3 408, and 4 409 on the fixed television camera monitor screen detected by the fixed television camera monitor screen 5, are measured in the direction of the position on the fixed television camera monitor screen 5 by the tracking laser distance measuring device 3. The tracking television camera 80 adjusts the angle of view and focal length according to the direction and the measured distance, and photographs and stores images of the subject boats 1 212, 2 213, 3 214, and 4 215 on the tracking television camera monitor screen.

Each image is image-analyzed, compared with already acquired image-recognized ships, and the information of the ships is grasped. A composite screen 410 of a fixed television camera monitor screen and an image adjustment screen is displayed with the driving numerical value of the tracking television camera of the recognized ship and the information of the ship added. The ship can be photographed by the tracking television camera at the position where it appears on the composite screen. The ship can be photographed by the tracking television camera at the position on the subject boat on the tracking television camera monitor screen. The course of each ship simulated from the distance continuously measured by the tracking television camera laser distance measurement system 635 is displayed on the combined screen 410 of the fixed television camera monitor screen and the image adjustment screen. By displaying the simulated heading of each ship and the tracking television camera monitor screen of each ship, it is possible to avoid the progress of own ship and collision accidents.

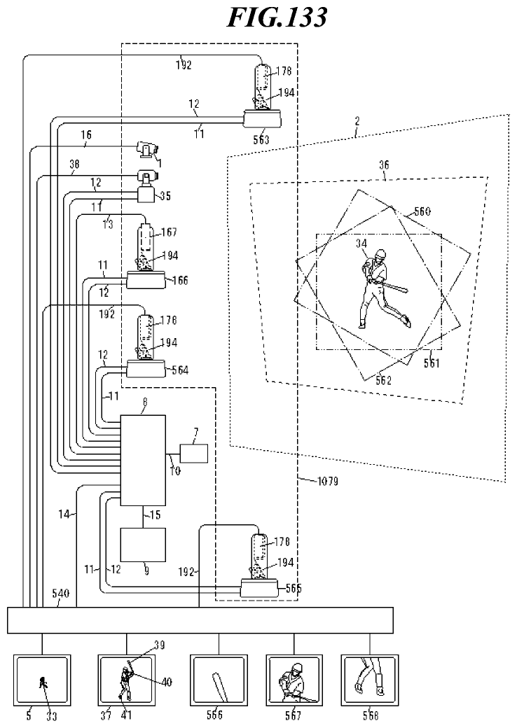

Example: In order to research and correct the batting form of the baseball player in FIG. 133, a plurality of mirror-tracking television cameras 168 is used to capture rapid movements of the main points of interest in order to confirm them in detail at the same time. In order to compare with the official game, a tracking mirror television camera laser distance measurement system 1079 is installed in a place where it can be installed in the official game. The place that can be installed in official games is the distance from the batting plate of the baseball player 34. Therefore, in order to limit the photographing range of the numerical control television camera 35, the position of the baseball player 34 of the subject 33 on the fixed television camera monitor screen 5 of the fixed television camera 1 is indicated. Then, the distance to the baseball player 34 is measured by directing the mirror-tracking laser distance measuring device 166 in the direction corresponding to the position on the fixed television camera monitor screen 5.

The field angle and focal length are adjusted to the measured distance, and the numerically controlled television camera 35 is driven to photograph the baseball player 34 within the photographing range 36 of the numerically controlled television camera by instruction of the position of the baseball player of subject 33 on the fixed television camera monitor screen. To grasp and correct the major points of the baseball player 34, a clear image of the major points and an image showing details are photographed. For this purpose, the angle of view, focal length, etc. are adjusted according to the measured distance, and the baseball player 34 in that direction is photographed by the mirror-tracking television cameras A 563, B 564, and C 656. The distance to the baseball player 34 is measured, and the angle of view, focal length, etc. of the mirror-tracking television cameras A 563, B 564, and C 565 are adjusted and photographed.

The position 39, Grip Position 40 and Right Foot Position 41 of the baseball player's bat on the numerical control television camera monitor screen of the baseball player are indicated on the numerical control television camera monitor screen 37, and the mirror tracking television cameras A 563, B 564, and C 565 for photographing the baseball player 34 are driven. The main grasping and correction points for photographing the 34 baseball players are confirmed in advance at the position of the image on the 37 numerical control television camera monitor screen. As a result, the images of the mirror tracking television camera screens A 566, B 567, and C 568 can be tracked and photographed.

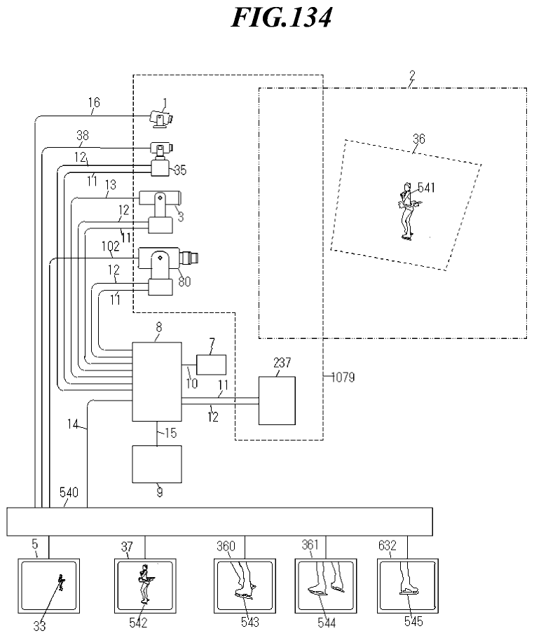

Example: In order to research and correct the skate jumps of skater 541 in FIG. 134 and to grasp the main part and confirm the correction part in detail at the same time, the quick movement of the main part is photographed by the tracking television camera. To compare skating jumps on a wide skating rink, a tracking mirror television camera laser distance measurement system 1079 is installed at a location that can be installed on a wide skating rink. The place where skater 541 skate jumps is moved to a place where it can be installed in a wide skating rink. Therefore, in order to limit the photographing range of the numerically controlled television camera 35, the skater 541 of the subject 33 on the fixed television camera monitor screen 5 photographed at a wide angle by the fixed television camera 1 is indicated. Then, the tracking laser distance measuring device 3 is directed to the direction corresponding to the position on the fixed television camera monitor screen 5 to measure the distance to the skater 541.

The numerical control television camera 35 is driven in the direction corresponding to the position on the fixed television camera monitor screen 5, and the angle of view and focal length are adjusted to the measured distance. Then, the skater 541 in the photographing range 36 of the numerically controlled television camera photographed by the numerically controlled television camera 35 is photographed. On the numerically controlled television camera monitor screen 37, the skater 541 is pointed at the skater's image indication position 542 appearing on the numerically controlled television camera monitor screen, and the tracking television camera 80 for photographing the skater 541 is driven.

The major points for grasping and correcting the image of the skater 541 are to check the image of the skater's image indication position 542 on the numerical control television camera monitor screen 37 in advance on the numerical control television camera monitor screen 37. As a result, a skate edge image 543, an icing image 544, and a pre-jump image 545 of the skater appearing on the tracking television camera monitor screen can be photographed. Each image is delayed and displayed so that it can be confirmed at the same time. It is necessary to adjust the photographing direction, moving position, angle of view, focal length, etc. of the tracking television camera 80 in order to research and correct the key points of skater 541's skate jump, to capture clear and detailed images of the key points. A skater can grasp the situation by seeing a clear image of the main part of the skate jump and a detailed image in a short time when the feeling of skater's skate jump remains.

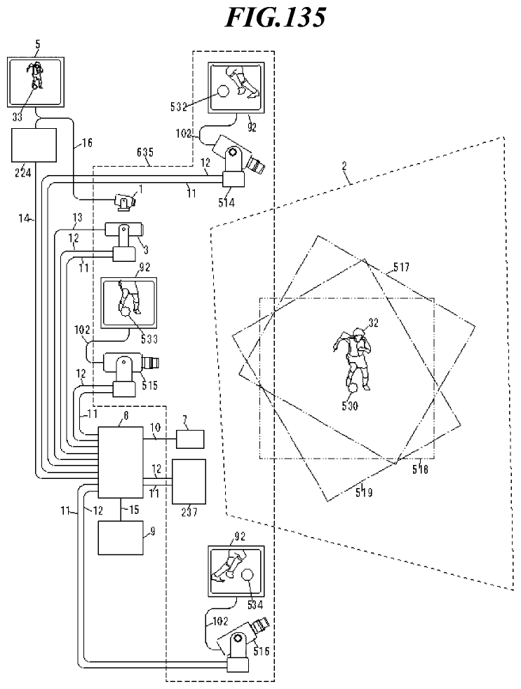

Example: A soccer player 32 as a subject 33 on the fixed television camera monitor screen is indicated on the fixed television camera monitor screen 5 photographed by the fixed television camera 1, in order to grasp and correct the movement of the soccer ball 530 dribbling by the soccer player 32 on the soccer practice field of FIG. 135 and FIG. 37. Then, the tracking laser distance measuring device 3 is directed to the direction corresponding to the position on the fixed television camera monitor screen 5 to measure the distance to the soccer player 32. The soccer player 32 is photographed by narrowing the angle of view of the tracking television cameras A 514, B 515, and C 516 based on the measured distance and direction.

The tracking laser distance measuring device 3 measures the distance from the position of the spike on the foot kicking the soccer ball 530 of the soccer player 32 in the image on the fixed television camera monitor screen 5 showing a soccer player 32 photographed by a fixed television camera 1. With the direction, angle of view, and focal length corresponding to the measured distance, the spike is tracked and photographed from different positions of the tracking television cameras A 514, B 515, and C 516 with narrowed angles of view.

An image photographing the soccer player 32, an image that photographing the spike of the kicked foot and an image photographing the movement of the kicked soccer ball 530 are selected, and the images from different directions are viewed in detail at the same time. As a result, the movement of the soccer ball 530 is tracked and confirmed by looking at the soccer balls displayed on the monitor screens A 532, B 633, and C 634 of the television camera, and the dribbling practice is repeated to make corrections without seeing the foot spikes of soccer player 32 who kicked soccer ball 530.

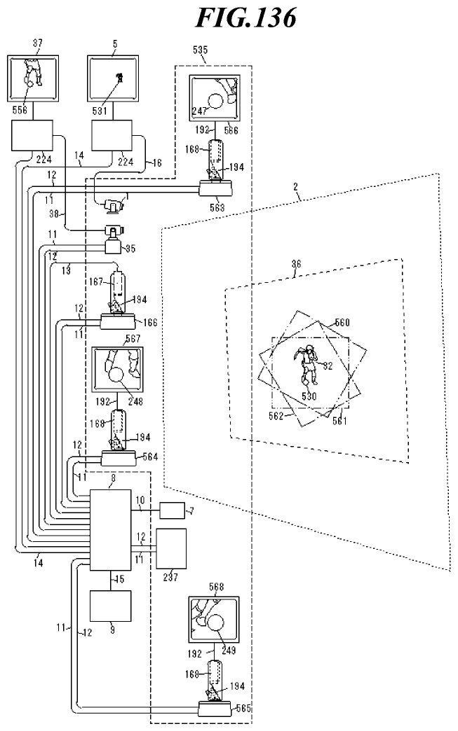

Example: A soccer ball 531 displayed on a fixed television camera monitor screen is image-recognized from the image on the fixed television camera monitor screen 5 showing the soccer player 32 photographed by the camera 1, and the distance is measured by the mirror tracking laser distance measuring device 166 in order to grasp the movement of the soccer ball 530 dribbling by the soccer player 32 on the wide pitch of the soccer field 647 in FIG. 136. The numerical control television camera 35 photographs in the direction and focal length of the position corresponding to the measured distance. A soccer ball 556 kicked by a soccer player 32 on the numerical control television camera monitor screen 37 is image-recognized, and the distance is measured by a mirror-tracking laser distance measuring device 166 capable of high-speed tracking. A soccer ball 530 is tracked and photographed with high-speed mirror-tracking television cameras A 563, B 564, and C 655 in the direction, angle of view, and focal length of the position corresponding to the measured distance.

According to the direction of the position and the measured distance, the numerically driven storage rack 535 is moved with the running of the soccer player, it is driven so as to maintain the position of the soccer ball on the television camera monitor screen 564 of the mirror tracking television camera 248 on the television camera monitor screen 567 of the mirror tracking television camera B and its measured distance and direction. Soccer balls 247, 248, and 249 on the mirror-tracking television camera monitor screens of the mirror-tracking television cameras A 566, B 567, and C 568 photographed by the mirror-tracking television cameras A 563, B 564, and C 655 are displayed from different directions.

The numerically driven storage rack 535 is driven to follow the running position of the soccer player 32 at equal distances and angles. Soccer balls 247, 248, and 249 on mirror-tracking television camera monitor screens 566, 567, and 768 of mirror-tracking television cameras A, B, and C taken with mirror-tracking television cameras A 563, B 564, and C 656 are different. The screen that was tracked from the direction, the soccer player 32 compares the image of the kicked foot spike and the image of the kicked 530 soccer ball at the same time, and compares the multiple images to watch the dribbling practice in detail. As a result, the movement of the soccer ball 530 is confirmed by the image from the feeling transmitted from the spike of the foot kicking the soccer ball 530, and the dribbling is practiced and corrected without looking directly at the foot spike that kicked that soccer ball 530.

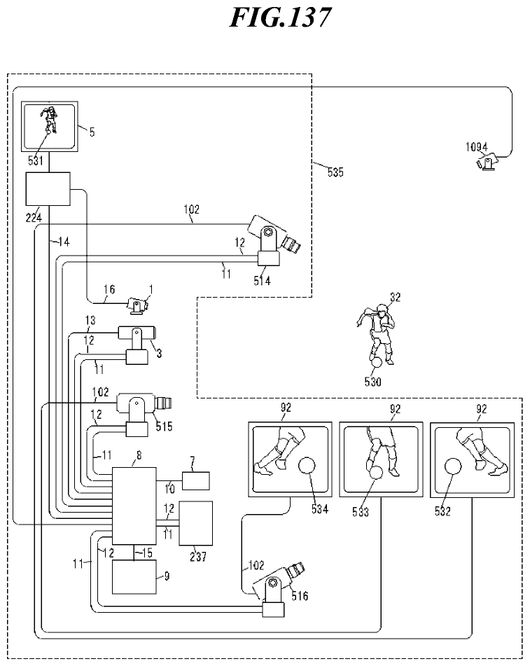

Example: A plurality of tracking television camera distance measurement systems 72 and a plurality of tracking television camera monitor screens 92 are installed and driven on a numerically driven storage rack 535 in order to grasp the movement of the soccer ball 530 dribbling by the soccer player 32 on the wide pitch of the soccer field in FIG. 137. The position of the soccer ball 531 displayed on the fixed television camera monitor screen 5 showing soccer player 32 photographed by fixed television camera 1 of tracking television camera distance measurement system 72, is measured by a tracking laser distance measuring device 3. The tracking television camera B 515 tracks and photographs the soccer ball 530 with the direction, angle of view, and focal length of the position corresponding to the measured distance. Based on the direction of the position where the soccer player appears on the fixed television camera monitor screen 5 and the measured distance, the numerically driven storage rack 535 is driven so as to keep the direction and the distance according to the running of the soccer player. Soccer balls 532, 533 and 534 appearing on tracking television camera monitor screens A, B and C photographed by tracking television cameras A 514, B 515 and C 516 are tracked and photographed from different directions and displayed on a plurality of tracking television camera monitor screens 92.

Screens obtained by tracking and photographing soccer balls 532, 533, and 534 appearing on the tracking television camera monitor screens A, B, and C of the tracking television cameras A 514, B 515, and C 516 taken from the numerically driven storage rack 535, from different directions are displayed on a plurality of tracking television camera monitor screens 92 right before the soccer player 32 dribbles. The soccer player 32 compares the images taken of the spikes of his kicking foot and the images photographing the movement of the kicked soccer ball 530, and compares the images at the same time to see the practice during a continuous dribbling run in detail. As a result, the movement of the soccer ball 530 is checked on the image by the feeling transmitted from the spike of the foot kicking the soccer ball 530, and the dribbling is practiced and corrected without looking directly at the foot spike that kicked that soccer ball 530. The stored image is analyzed to grasp the tendency of the player. Numerically driven storage rack 535 can be driven to an indicated position on the screen on which the pitch is photographed by associating the position of the numerically driven storage rack 535 shown on the fixed television camera monitor screen photographed by the fixed pitch camera 1094 with the driving numerical value of the numerically driven storage rack 535 by the related method described above.

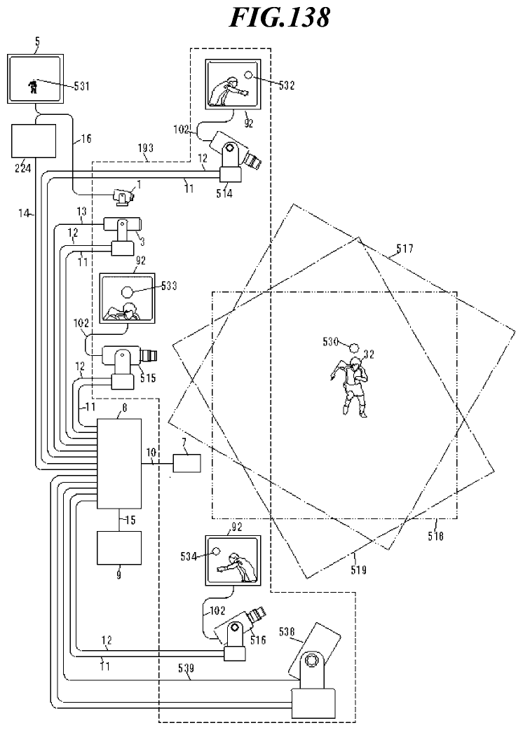

Example: The soccer ball projector 538 of FIG. 138 is for soccer players 32 to practice heading competitions and posts the soccer ball 530 to the running position in accordance with the running of the soccer player 32 with the same driving numerical value, and the soccer player 32 practices heading. A tracking laser distance measuring device 3 measures the distance from the position where the soccer player 32 recognizes the soccer ball 530 in the image on the fixed television camera monitor screen 5 showing the soccer player 32 photographed by the fixed television camera 1. A tracking television camera B 515 is used to track and photograph the soccer ball in the direction corresponding to the measured distance at the angle of view and focal length.

The tracking laser distance measuring device 3 measures the distance from the position of the head of the soccer player 32 recognized in the image on the fixed television camera monitor screen 5. A soccer ball 630 is displayed in a direction and position corresponding to the measured distance by a numerically controlled soccer ball projector 538 whose projection numerical values are acquired in advance. The soccer balls 532, 533, and 534 appearing on the tracking television camera monitor screens A, B, and C photographed by the tracking television cameras A 514, B 515, and C 516 are tracked and photographed from different positions close to the soccer player 32 in the direction of the position and the distance measured by the soccer player 32.

The vicinity of the head of the soccer player 32 is photographed in order to repeatedly practice the feeling of heading the soccer player 32 without looking at the hitting point between the soccer ball 530 and the soccer player's 32 head. The same throwing ball of the soccer ball projector 538 is repeated. Then, practice the sense of repetition practice of the soccer player 32 head batting game by a method in which the soccer player 32 simultaneously views a plurality of images of the tracking screen of the soccer ball 530 in the heading direction and the tracking screen of the soccer player's head batting game.

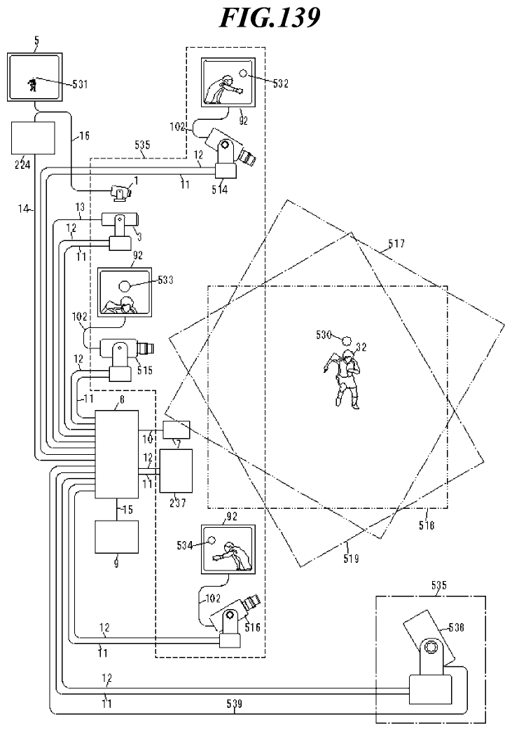

Example: A soccer ball projector 538, a plurality of tracking television camera distance measurement systems 72, and a plurality of tracking television camera monitor screens 92 are installed and driven on the numerically driven storage rack 535 of FIG. 139. The tracking television camera laser distance measurement system that photographs the soccer player 32 measures distance and direction with a tracking laser distance measuring device 3, and is driven by a numerical drive storage rack 535 in the same direction and distance so that the position where the image of the soccer ball 531 on the fixed television camera monitor screen 5 photographed by the fixed television camera 1, displayed on the fixed television camera monitor screen can be photographed in the running direction of the soccer player 32. The soccer ball projector 538 incorporated in the numerically driven storage rack 535 projects the soccer ball 530 from the same direction and distance with the same driving value according to the running of the soccer player 32, so that the soccer player 32 can practice heading by the numerically controlled projector, for the training of the soccer player's 32 heading competition.

The tracking laser distance measuring device 3 performs image recognition of a soccer ball 531 appearing on the fixed television camera monitor screen on the fixed television camera monitor screen 5 showing a soccer player 32 photographed by a fixed television camera 1 incorporated in a numerically driven storage rack 535, and measures the distance at that position. The soccer balls 532, 533, and 534 appearing on the tracking television camera monitor screens A, A, and C photographed by the tracking television cameras A514, A515, and B516 are tracked and photographed from different positions close to the soccer player 32 by the running position, the running direction, and the measured distance in which the soccer player 32 runs in the direction corresponding to the measured distance.

Soccer balls 532, 533, and 534 displayed on the tracking television camera monitor screens A, B, and C and the reference screen display are also displayed at the position of the line of sight of the soccer player 32 immediately before running on a plurality of tracking television camera monitor screens 92 that display the screens photographed by the tracking television camera laser distance measurement system incorporated in the numerically driven storage rack 535. The image is confirmed, the numerically controlled projection machine is projected for practice, and the numerically driven storage rack 535 and the tracking television camera laser distance measurement system are driven in accordance with the projected ball by storing the set image recognition image. The tracking television camera A 514 tracks and photographs the projected ball, and the tracking television cameras B 515 and C 516 track and photograph the position of the soccer player's 32 heading. For soccer player 32 programmed heading practice, 32 soccer players are trained to match the driving of the tracking television camera laser range finding system.

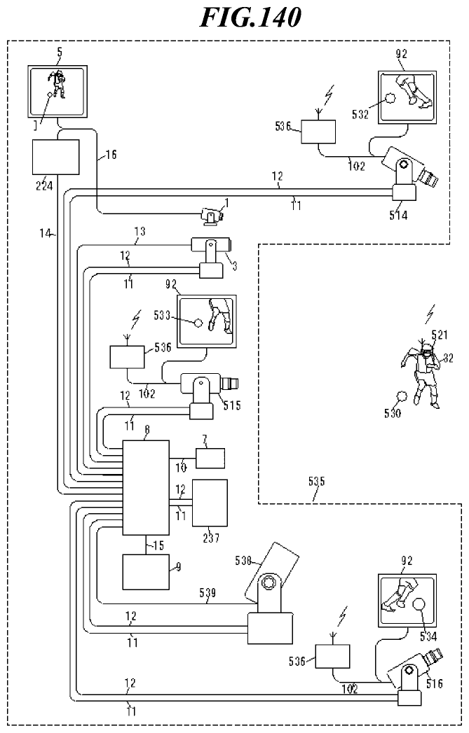

Example: A soccer ball projector 538, a plurality of tracking television camera distance measurement systems 72, a plurality of tracking television camera monitor screens 92, and a plurality of image transceivers 536 are installed and driven on the numerically driven storage rack 535 of FIG. 140. A tracking television camera laser distance measurement system incorporated in the numerically driven storage rack 535, an image transmitter/receiver 536 for transmitting images photographed by the tracking television camera system of the numerically driven storage rack 535 and a soccer ball projector 538 that projects a soccer ball 530 with the same drive number are incorporated in a numerically driven storage rack 535 driven by numerical control in order to grasp and correct the movement of the spike that kicked the soccer ball 530 of the running direct kick of soccer player 32.

The tracking laser distance measuring device 3 measures the distance from the spike of the foot kicking the soccer ball 530 of the soccer player 32 or the position where the soccer ball 530 is image-recognized on the image on the fixed television camera monitor screen 5 showing soccer player 32 photographed by fixed television camera 1. The angle of view and focal length are adjusted in the direction corresponding to the measured distance, and the spike is tracked and photographed as the position of the image for image recognition by the tracking television cameras A 514 and C 516. At the same time, the numerically driven storage rack 535 is driven to keep the distance from the soccer player 32 at the measured distance and direction.

The angle of view and the focal length are matched in the direction corresponding to the measured distance, and the tracking television camera B 515 tracks and photographs the soccer ball 530 as the position of the image for image recognition. Soccer player 32 transmits a detailed image capturing the kicking foot swing and a detailed image capturing movement of the kicked soccer ball 530 via image transmitter/receiver 536. By looking at the image in detail on the screen of the wearable monitor 521 of the image receiver at the same time, the soccer player 32 visually recognizes the movement of the soccer ball 530 while the feeling of kicking the soccer ball 530 remains, and repeats running direct kick practice to make corrections without looking directly at the foot spike that kicked that soccer ball 530.

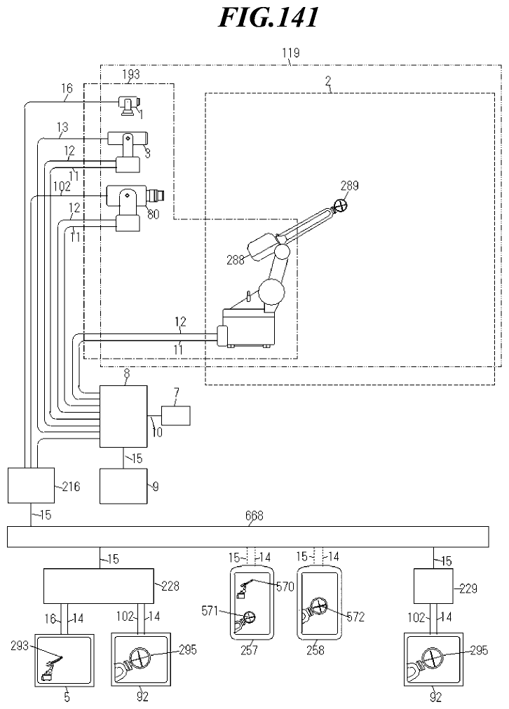

Example: The fixed television camera 1 in FIG. 141 photographs the robot working position 289 of the numerically controlled robot 288 in the robot working range 119, and the image signal 16 is displayed on the fixed television camera monitor screen 5 via the Internet network 668. The work position 293 on the fixed television camera monitor screen displayed on the fixed television camera monitor screen 5 is operated. Using the screen position signal 14, the tracking television camera 80 and the tracking laser distance measuring device 3 are directed to the working position 289 of the robot via the Internet network 668, and the distance is measured. The tracking television camera 80 photographs the working position 289 of the robot at an angle of view and a focal length corresponding to the distance measured by the tracking laser distance measuring device 3.

The image signal 102 photographed by the tracking television camera 80 is displayed via the Internet network 668, and the screen work of the work position 295 on the tracking television camera monitor screen is operated on the tracking television camera monitor screen 92. With the operation position signal 14, the work of the robot work position 289 of the numerically controlled robot 288 is performed via the Internet network 668. The operation of each working position can also be replaced by manual operation or programmed operation. The operation of the screen work at the work position 295 on the tracking television camera monitor screen can also be performed on a plurality of tracking television camera monitor screens 92 displayed via the Internet 668 on the tracking television camera monitor screen 92 displayed at another location via the Internet network 668.

The robot working position 289 of the numerically controlled robot 288 is operated on the fixed television camera monitor screen 5 shown in the smartphone operation A 570 on the screen of the smartphone A 257 connected to the interface of the smartphone application. A work operation at a work position 295 on the tracking television camera monitor screen is performed on the tracking television camera monitor screen 92 displayed in the smartphone operation B 571. A work operation at a work position 295 on the tracking television camera monitor screen is performed on the tracking television camera monitor screen 92 displayed on the smartphone operation C 572 on the tracking television camera monitor screen 92 displayed on the smartphone B 258. The application of interfaces A 228 and B 229 connected via the Internet 668 operates the robot work position 289 of each numerically controlled robot 288.

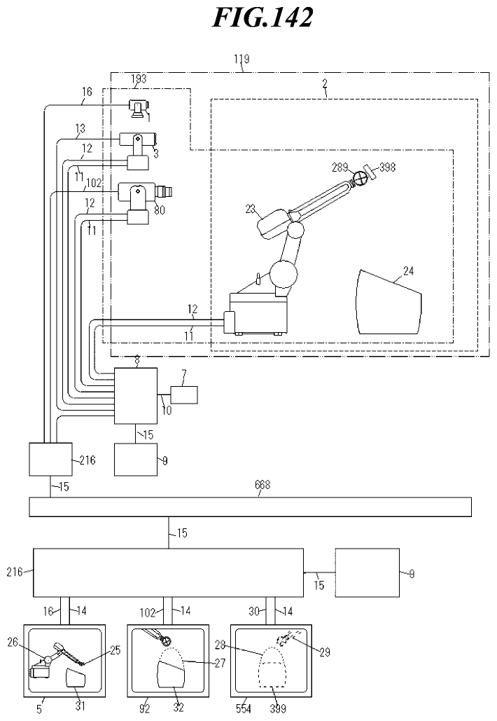

Example: The fixed television camera 1 in FIG. 142 photographs the tracking numerically controlled 3D forming machine 23 of the numerically controlled robot 288 in the working range 119 of the robot. The image signal 16 is displayed on the fixed television camera monitor screen 5 via the Internet network 668. The driving position of the 3D forming machine 25 on the fixed television camera monitor screen of the numerical control robot 288 shown on the fixed television camera monitor screen 5 is operated. Using the screen position signal 14, the tracking laser distance measuring device 3 is directed to the working machine 398 forming the 3D robot at the robot working position 289 via the Internet network 668, and the distance is measured.

The tracking television camera 80 photographs the working machine 398 formed in 3D by the robot at the bot working position 289 with an angle of view and a focal length corresponding to the distance measured by the tracking laser distance measuring device 3. The working range 119 of the robot can be known by the position of the image recognized by the tracking laser distance measuring device 3 and the tracking television camera 80 and the image analysis. The position of the work machine 398 that is 3D formed by the robot is also image-recognized each time, and the position of the work range 119 of the robot is measured. These image recognition and position information can also be received by the computer 9 via the Internet network 668.

The image of the 3D molded object assumed by the computer 9 is displayed on the tracking television camera monitor screen 92, and the image of the 3D molded object 27 assumed by the computer on the tracking television camera monitor screen is displayed in a composite screen from the robot's working area 119 received by computer 9. By knowing the working range 119 of the robot in the computer 9, the image of the side surface 399 of the 3D structure assumed by the computer 9 and the 3D structure image 28 on an assumed side tracking television camera monitor screen of an assumed 3D computer of the computer 9, are displayed as a composite screen on the two-dimensional screen position photographed by the tracking television camera 80, on the screen of the side image 554 assumed by the computer expressing the 3D screen position.

The position on the tracking television camera monitor screen 92 and the position of the side image 554 assumed by the computer are known or measurable positions as the position of the working range 119 of the robot. Therefore, the tracking numerically controlled 3D forming machine 23, the robot working position 289, and the 3D forming working machine 398 of the robot can be operated via the 668 Internet network at the two-dimensional screen position on the tracking television camera monitor screen 92 and the three-dimensional screen position on the screen of the side image 554 assumed by the computer.

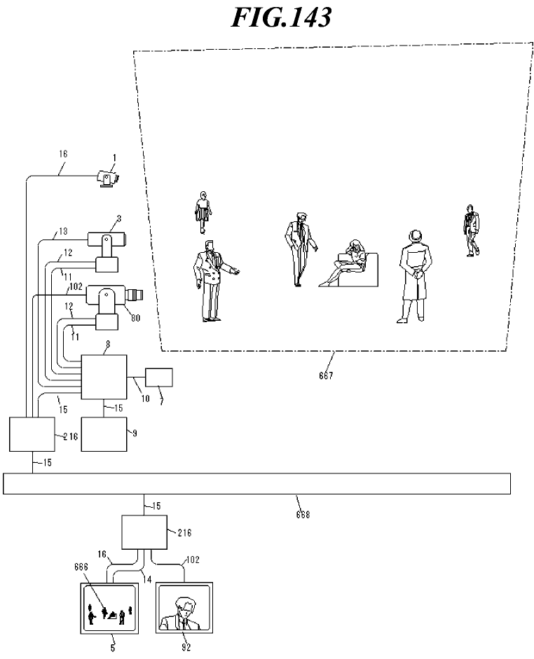

Example: A theater stage 667 is photographed by a fixed television camera 1 in FIG. 143, and its image signal 16 is displayed on a fixed television camera monitor screen 5 via an Internet network 668. The tracking television camera 80 can be operated on the fixed television camera monitor screen 5 via the Internet network 668 to point the Internet fixed television camera monitor screen indication position 666 to the fixed television camera monitor screen 5. The tracking laser distance measuring device 3 and the tracking television camera 80 are directed to the operated position, and the tracking laser distance measuring device 3 measures the distance to the performer corresponding to the designated position 666 on the Internet fixed television camera monitor screen by a drive signal 11 corresponding to the position operated on the fixed television camera monitor screen 5 via the Internet network 668. The tracking television camera 80 photographs the performer at the angle of view and focal length corresponding to the measured distance. The image signal photographed by the tracking television camera 80 can be viewed on the screen of the tracking television camera monitor screen 92 via the Internet network 668.

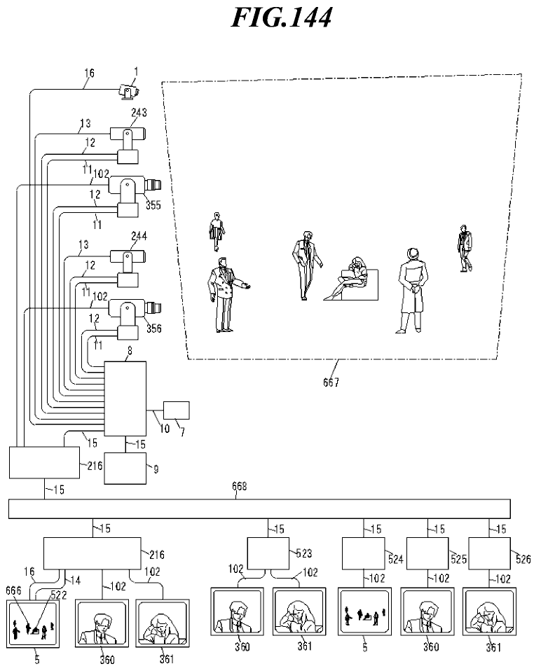

Example: A theater stage 667 is photographed by a fixed television camera 1 in FIG. 144, and the fixed television camera image signal 16 is displayed on a fixed television camera monitor screen 5 via an Internet network 668. Multiple performers 666 displayed on a fixed television camera monitor screen 5, the location of the performer 522 at the indicated location on the Internet fixed television camera monitor screen and the image-recognized position, the position of a plurality of performers 666 and the position of the performer 522 at the designated position on the Internet fixed television camera monitor screen and the image-recognized position are shown on the fixed television camera monitor screen 5, it is possible to operate the tracking television camera A 355 and to operate the tracking television camera B 356 for tracking photography via the Internet network 668.

Each tracking laser distance measuring device measures the distance between the pointing position 666 of the subject on the Internet fixed television camera monitor screen and the position of the performer corresponding to the subject 522 recognized by the image recognition of the fixed television camera. Tracking television cameras A 355 and B 356 photograph each performer at the angle of view and focal length corresponding to the measured distance. The image signals photographed by the tracking television cameras A 355 and B 356 can be viewed on either the fixed television camera monitor screen 5 or the tracking television camera monitor screens A 360 and B 361 by interface 216, interface C 523, D 524, E 525, F 526 via Internet network 668.

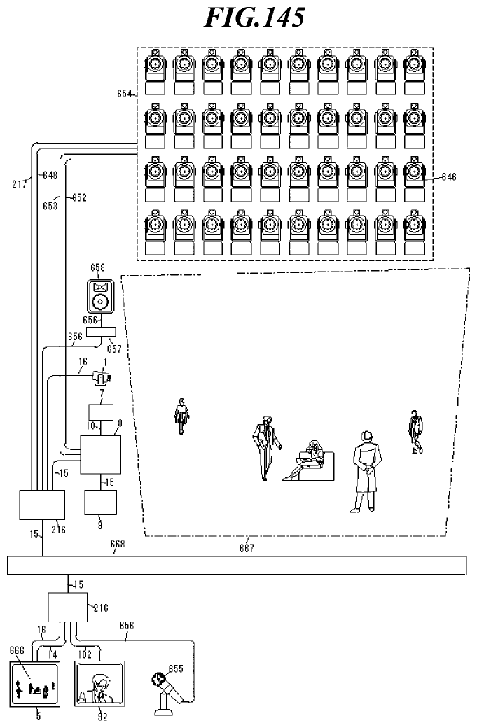

Example: A theater stage 667 in FIG. 145 is photographed by a number of tracking television camera systems 646 in a tracking television camera system storage rack 654. A plurality of performers is displayed on the fixed television camera monitor screen 5 via the image signal network 217 of the many fixed television cameras, the tracking television camera image signal network 648, the drive position signal network 653, the drive signal network 652, and the Internet network 668. Location of on-screen instructions for multiple actors. Based on the position of instructions on the screen of multiple performers, the tracking television camera 80 of the tracking television camera system 646 and the tracking laser distance measuring device 3 selected by the instruction are directed in the direction corresponding to the position of the instruction on the fixed television camera monitor screen 5 via the Internet network 668. A tracking laser distance measuring device 3 measures the distance to the performer. Tracking television camera 80 of tracking television camera system 646 photographs the performer at an angle of view and focal length corresponding to the measured distance.

The photographed image signal is viewed on a tracking television camera monitor screen 92 associated with the fixed television camera monitor screen 5 that instructed the performer via the Internet network 668. The cheering for the performer is picked up by a microphone 655 and transmitted to the performer via a speaker 658 installed on a theater stage 667 via an Internet network 668. A number of individual spectators in tracking television camera system storage racks 654 use tracking television camera system 646 to view, in their own way, each performer on theater stage 667 and convey cheers and cheering indications.

Example: A theater stage 667 in FIG. 145 is photographed by a number of tracking television camera systems 646 in a tracking television camera system storage rack 65. Images are displayed on the multiple fixed television camera monitor screens 5 through the multiple tracking television camera image signal network 217 of the multiple tracking television camera system 646, the tracking television camera image signal network 648, the tracking television camera image signal network 648, the driving position signal network 653, the driving signal network 652 and the Internet network 668. Based on the position of instructions on the screen of the multiple performers shown on the large number of fixed television camera monitor screens 5, the multiple tracking television cameras 80 of the multiple tracking television camera system 646 and the multiple tracking laser distance measuring device 3 are directed to directions corresponding to the multiple designated positions on the screen via the Internet network 668. The many tracking laser distance measuring device 3 measure the distances to the many performers.

The multiple tracking television cameras 80 photograph the performer at angles of view and focal lengths corresponding to the multiple measurement distances. The large number of photographed image signals are individually viewed on the large number of tracking television camera monitor screens 92 directing to the large number of performers via the Internet network 668. Through the Internet network 668, a large number of viewers can individually select and appreciate the performances of the individual performers on the theater stage 667.

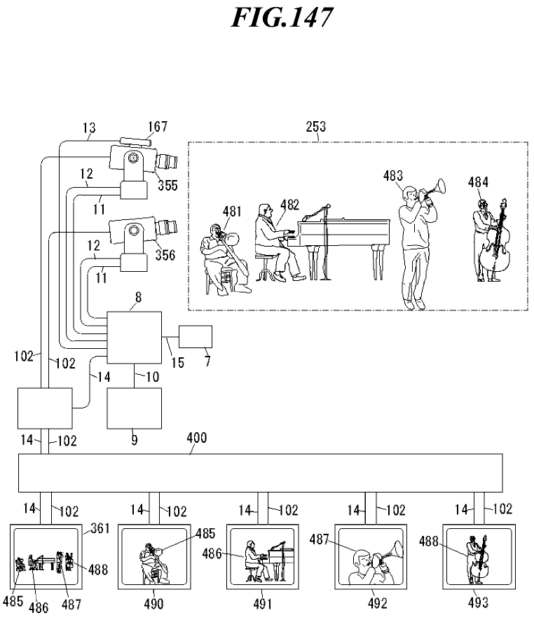

Example: All the jazz performers at the jazz live house 253 in FIG. 147 are photographed with a wide angle of view of the tracking television camera A 355 equipped with the laser distance measuring device 167. A laser distance measuring device 167 measures the player's direction and distance by indicating the positions of the trombone player 485, the plano player 486, the trumpet player 487, and the bass player 488 on the tracking television camera monitor screen of each performer shown on the tracking television camera monitor screen B 361. The measured performer is photographed on the optimum screen by adjusting the angle of view, focal length, and photographing direction of the tracking television camera A 355 with using the measured distance. The adjusted and photographed angle of view, focal length, and photographing direction drive values are stored in association with each performer.

According to the situation of the jazz performance, a trombone player 485, a plano player 486, a trumpet player 487 and a bass player 488 on the stage of jazz live house 253 are displayed on the tracking television camera monitor screen B 361 photographed by the tracking television camera A 355 using the driving numerical values photographed on the optimum screen associated for each performer. The trombone player 481, the plano player 482, the trumpet player 483 and the bass player 484 on the stage of a jazz live house 253 are displayed on the optimal screen of the tracking television camera, which was photographed with the optimal screen of the tracking television camera B 356 for each of the trombone player 490, the plano player 491, the trumpet player 492, and the bass player 493 on the tracking television camera monitor screen.

According to the situation of the jazz performance, the trombone player 490, the plano player 491, the trumpet player 492, and the bass player 493 of each performer are photographed by a tracking television camera B 356, and the best performance is adjusted to the best photographing method and photographed on the tracking television camera monitor screen 355. According to the situation of the jazz performance, adjust the angle of view, focal length and photographing direction of the tracking television camera A 355 and the tracking television camera B 356 in advance, and photographs with the optimum screen of the memory of the drive values. Its memory of its drive values is updated with the performance of further operating methods.

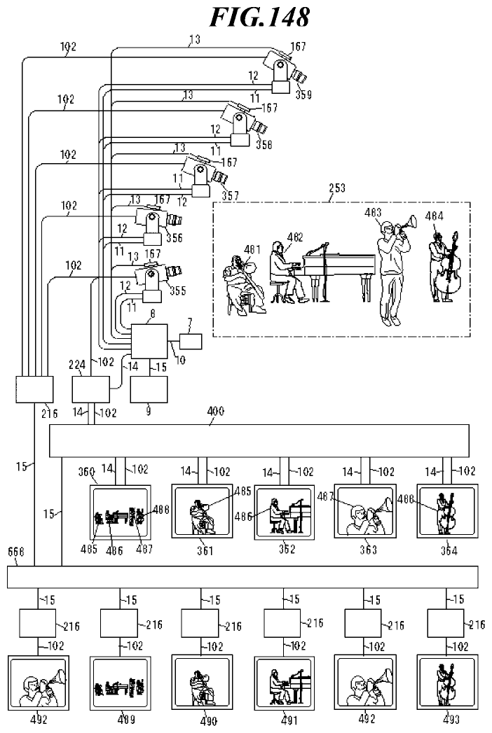

Example: A tracking television camera A 355 equipped with a laser distance measuring device 167 narrows the angle of view to photograph each jazz performer in the jazz live house 253 in FIG. 148, and confirms the image of each performer. The tracking television camera A 355 has a wide angle of view, photographs all the jazz performers on the tracking television camera monitor screen A 360, and recognizes the images of each performer. The drive numbers on the tracking television camera monitor screens A 361, B 362, C 363, and D 364 that photographed each jazz performer at the narrow angle of tracking television camera A 355 are associated with the image-confirmed position of each jazz performer on the tracking television camera monitor screen A 360 that photographs all the performers at that wide angle.

At the positions of the trombone player 485, the plano player 486, the trumpet player 487, and the bass player 488 on the monitor screen of the tracking television camera, which was photographed at that narrow angle and recognized, the direction and distance of each performer were measured with the laser distance measuring device 167 attached to the tracking television camera B 356, C 357, D 358, and E 359 by manipulating the position of each performer on the screen of the tracking television camera monitor screen 360 photographed at that wide angle. Each player is photographed on the optimum screen by adjusting the angle of view, focal length, and photographing direction of the tracking television camera A 355 by using the measured distance. The adjusted and photographed angle of view, focal length, and photographing direction drive values are associated with each performer through image recognition and stored.

The image adjuster 400 attaches information such as each performer, lead performer, optimum image, etc., and selects and appreciates it on the television camera monitor screen via the Internet network 668. According to the situation of the jazz performance, The images of the trombone player 485, the plano player 486, the trumpet player 487, and the bass player 488 displayed on the tracking television camera monitor screen B 361, C 362, D 363, E 364 photographed by tracking television camera B 356, C 357, D 358, E 359, on the tracking television camera monitor screen are selected and viewed on the television camera monitor screen via the Internet network 668 by using the image recognition that memorized each performer in association with the photographing of the performer on the optimal screen.

According to the situation of the jazz performance, the images photographed by the tracking television cameras B 356, C 357, D 358, and E 359 of each performer are adjusted at the positions on the tracking television camera monitor screens on the tracking television camera monitor screens B 361, C 362, D 363, and E 364. According to the situation of the jazz performance, in advance, the angle of view and focal length of the tracking television camera A 355 and the optimum photographing method are updated for image recognition, and the driving values used to photograph the image are stored and updated.

In the case of a jazz live house, the performer's movements, technique and voice add to the optimal image recognition. The image signals of the tracking television cameras A 355, B 356, C 357, D 358, and E can be viewed by all band players, the trombone player 489, the plano player 490, the trumpet player 491 and the bass player 492 on the tracking television camera monitor screen via the Internet network 668 connected by the interface 216. Each viewer selects the performer's screen that best fits the image recognition.

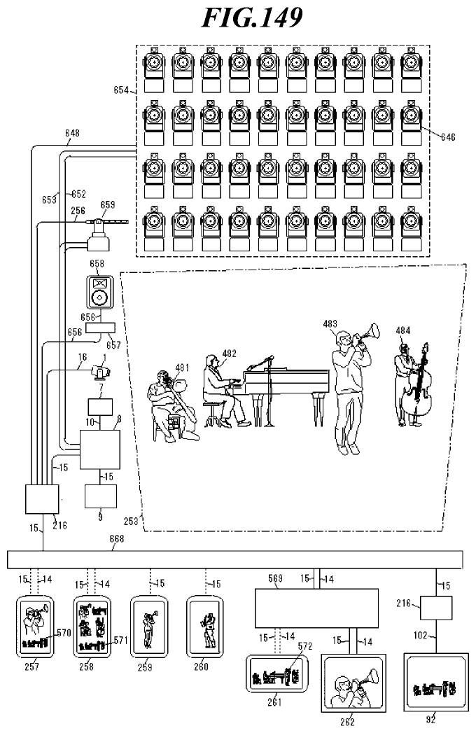

Example: A jazz live house 253 in FIG. 149 is photographed by a large number of tracking television camera systems 646 of a tracking television camera system storage rack 654. The fixed television camera image signal network 217 of the image signal 16 of the fixed television camera of the tracking television camera system 646 is displayed on each display screen via the Internet network 668 as a fixed television camera monitor screen via the Internet network 668. As a fixed television camera monitor screen, the positions of a plurality of performers on the screen are indicated by a drive position signal network 653 and a drive signal network 652. The selected tracking laser distance measuring device of the tracking television camera system 646 via the Internet network 668 is directed to the direction corresponding to the indicated position on the screen and the distance to the performer is measured.

The performer is photographed with the tracking television camera at the angle of view and focal length corresponding to the measured distance. The image signal photographed by the tracking television camera is viewed through the Internet network 668 of the tracking television camera image signal network 648 on the medium corresponding to the tracking television camera monitor screen 92 that instructs the performer. The screen operation signal and the image signal photographed by a fixed television camera that photographs a performer performing at jazz live house 253, connects the operation signal and the image signal photographed by each tracking television camera system 646 of the tracking television camera system storage rack 654 to the drive position signal network 653 and the drive signal network 652 via the Internet network 668 by the interface 216.

One of the tracking television cameras of the tracking television camera system 646 is operated, and the image of the tracking television camera is displayed on the smartphones A 257, B 258, C 259, and D 260 by incorporating an application corresponding to the operation and the image signal into the smartphone A 257, B 258. The Internet tracking television camera system B 261 corresponding to the fixed television camera monitor screen photographed by the fixed television camera 1 is operated by incorporating an application corresponding to its operation and its image signal into the Internet tracking television camera system B 261. An image of any of the tracking television cameras of the tracking television camera system 646 connected by an interface 569 for smartphone applications, is displayed on the screen operation television camera monitor screen 262 or the tracking television camera monitor screen 92.

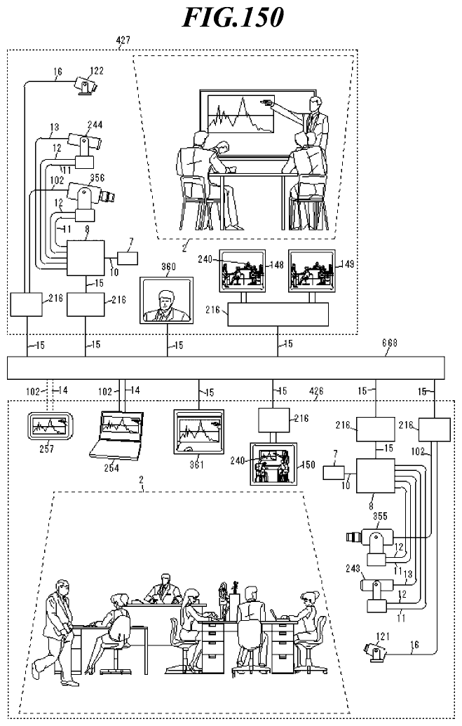

Example: A fixed television camera A 121 in the head office 426 in FIG. 150 of the tracking television camera system installed at head office 426 and branch office 427 and a fixed television camera B 122 in the branch office 427 photograph each office. An image signal of the branch office 427 photographed by the fixed television camera B 122 is connected by the interface 216 via the Internet network 668 connected by the interface 216, and displayed on the screen of the fixed television camera monitor C 150 of the head office 426. The image signal of the headquarters office 426 photographed by the fixed television camera A 121 is displayed on the fixed television camera monitors A 148 and B 149 of the branch office 427 connected by the interface 216 via the Internet network 668 connected by the interface 216.

Drive the tracking laser distance measuring device B 244 and the tracking television camera B 356 in the branch office 427 through the Internet network 668 connected to the interface 216 by operating the fixed television camera monitor screen indication position 240 on the fixed television camera monitor C 150 screen in the headquarters office 426. According to the distance measured by the tracking laser distance measuring device B 244, the image signal photographed by the tracking television camera B 356 is displayed on the tracking television camera monitor screen B 361 in the headquarters office 426 via the internet network 668 connected by the interface 216.

Similarly, it is displayed on the tracking television camera monitor screen A 360 in the branch office 427, by operating the tracking television camera A 355 in the headquarters office 426. Images taken by the tracking television camera A 355 in the headquarters office 426 and by the tracking television camera B 356 in the branch office 427 can be displayed by the same operation by incorporating an application corresponding to the operation and the image signal into the smartphone A 257. Images taken by the tracking television camera A 355 in the headquarters office 426 and by the tracking television camera B 356 in the branch office 427 can be displayed by the same operation by incorporating an application corresponding to the operation and the image signal into the personal computer 254.

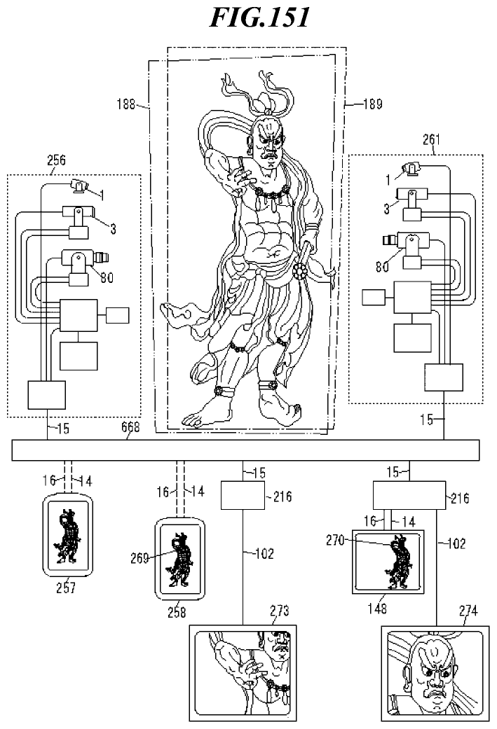

Example: Internet tracking television camera systems A 256 and B 261 are installed to photograph the Kongo Rikishi statue at the temple gate of FIG. 151, and the image of the Kongo Rikishi statue photographed by the fixed television camera is connected to the Internet network 668 through its interface. The tracking television camera of the Internet tracking television camera system A 256 is operated via the Internet network, and the image 80 photographed by the tracking television camera of the Internet tracking television camera system A 256 is viewed on the smartphone 257 via the Internet by incorporating an application corresponding to the operation and the image signal into the smartphone A 257, B 258. Alternatively, it is viewed on the Internet tracking television camera monitor screen A 273 connected to the Internet network through the interface 216.

The operation of the fixed television camera monitor screen indication position B 270 of the Internet on the fixed television camera monitor A 148 screen connected to the Internet network by the interface 216. The tracking laser distance measuring device 3 and the tracking television camera 80 of the Internet tracking television camera system B 261 connected to the Internet network at interface 216, are directed in the operation direction of the Internet fixed television camera monitor screen indication position B 270, and the distance is measured. An image photographed by the tracking television camera 80 at the angle of view and focal length corresponding to the distance is transmitted to the connected Internet network through the interface 216. It is viewed on the Internet tracking television camera monitor screen B 274 connected to the interface 216. Internet tracking television camera monitor screen B 274 is viewed on the corrected screen by correcting the operation position of the Internet fixed television camera monitor screen indication position B 270 on the fixed television camera monitor A 148 screen while watching on the Internet tracking television camera monitor screen B 274.

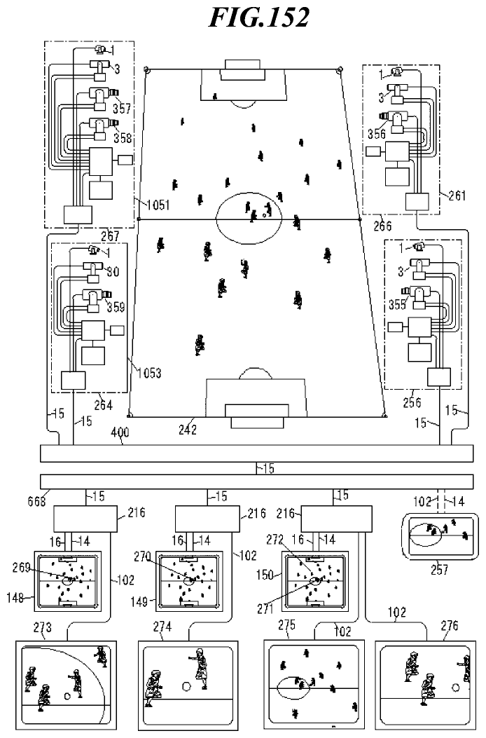

Example: Internet tracking television camera systems A 256, B 261, C 1052, and D 1053 are installed in the children's soccer game venue 242 in FIG. 152, and the image signals and operation signals of these systems are connected to the Internet network 668 through an interface. The signal is connected to the Internet network 668, and the interface 216 operates on the screens of fixed television camera monitors A 148, B 149, and C 150 of the Internet tracking television camera system to photograph the game at the children's soccer game venue 242.

A tracking television camera A 355 and a tracking laser distance measuring device 3 of the Internet tracking television camera system A 256 measure the distance to the player kicking the soccer ball at the fixed television camera monitor screen position A 269 showing A player kicking a soccer ball on a fixed television camera monitor A 148. According to the distance, the angle of view and focal length of the tracking television camera A 355 is used to photograph the player kicking the soccer ball. The player kicking the soccer ball can be seen on the Internet tracking television camera monitor screen A 273 via the Internet network 668.

A tracking television camera B 356 and a tracking laser distance measuring device 3 of an Internet tracking television camera system B 261 measure the distance to the soccer ball at Internet fixed television camera monitor screen indication position B 270 where the image of the soccer ball on the fixed television camera monitor B 149 screen was recognized. According to the distance, the soccer ball is photographed with the angle of view and focal length of the tracking television camera B 356. Through the Internet network 668, the soccer ball and the kicking player can be seen on the Internet tracking television camera monitor screen B 274. A plurality of tracking television cameras C 357 and D 358 was installed in the Internet tracking television camera system C 1052, and the tracking laser distance measuring device 3 of the tracking television cameras C 357 and D 358 of the Internet tracking television camera system C 1052 measures the distance to the soccer ball at Internet fixed television camera monitor screen indication position C 271 and D 272 where the image of the soccer ball on the fixed television camera monitor screen 150 is recognized. According to the distance, the soccer ball is photographed with the angle of view and focal length of the tracking television cameras C 357 and D 358. The soccer ball and the kicking player can be seen on the tracking television camera monitor screens C 275 and D 256. via the Internet network.

A tracking television camera D 358 and a tracking laser distance measuring device 3 measure the distance to the player trying to steal the soccer ball at the Internet fixed television camera monitor screen indication position D 272 that the player trying to steal the soccer ball on the fixed television camera monitor screen 150 by watching the soccer ball and kicking player on the tracking television camera monitor screen C 275. According to the distance, the angle of view and focal length of the tracking television camera D 358 is used to photograph the player trying to steal the soccer ball. The player trying to steal the soccer ball can be seen on the tracking television camera monitor screen D 276 via the Internet network.

An application corresponding to the operation and the image signal is installed in the smartphone A 257. The tracking television camera E 359 and the tracking laser distance measuring device 3 measure the distance to the soccer ball at the position already specified from some recognized images of the match, where the image of the soccer ball is recognized on its game display screen on its fixed television camera monitor screen of Internet tracking television camera system D 1053 connected to smartphone A 257 from some image recognition images of the game. According to the distance, the soccer ball can be photographed with the angle of view and focal length of the tracking television camera 359, and the players around the soccer ball can be seen on the screen of the smartphone A 257 through the Internet network. It is possible to select and view some of the images on the television camera monitor screen via the Internet network by selecting some of the optimum images recognized by the image adjuster 400 from each image taken by a number of Internet tracking television camera systems.

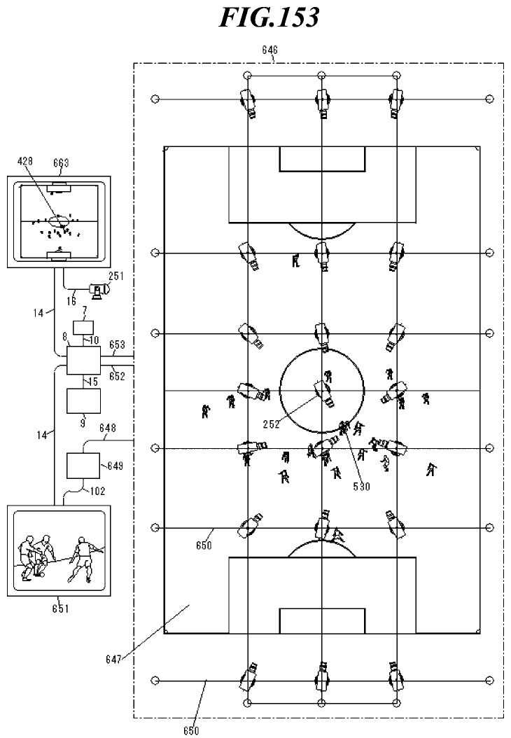

Example: A plurality of tracking television camera systems 646 is installed on the tracking television camera fixing wire 650 above the pitch of the soccer field 647 in FIG. 153. A designated position 428 on the CG monitor screen of the tracking camera system is designated on the screen 663 composed of the fixed television camera monitor screen 5 photographed by a fisheye lens fixed television camera attached to a tracking television camera system 252 mounted on tracking television camera fixing wire 650 in the center of the top of the pitch, and the CG screen displaying the pitch. As a result, the plural tracking television camera systems 646 turn to the indicated direction and photograph the soccer ball at that distance, that angle of view, and that focal length.

The soccer ball photographed by the tracking television camera system 646 is image-recognized. The image of the tracking television camera of the tracking television camera system, which photographs the optimum screen of the soccer ball, is selected and displayed on the image signal switching tracking television camera monitor screen 651. The distance to the soccer ball is measured by the tracking laser distance measuring device in the direction corresponding to the position where the soccer ball is displayed on each of the tracking television camera monitor screens. According to the distance, the soccer ball is photographed at the angle of view and focal length of the tracking television camera. The soccer ball is image-recognized on the screen photographed by each of the tracking television cameras, and the tracking television camera learns the image-recognized position of the soccer ball, tracks it, and photographs it.

The best game screen of a soccer player including the soccer ball photographed by each tracking television camera system is switched by an image signal switcher 649 and watched on an image signal switching tracking television camera monitor screen 651. It is also possible to adjust the tracking television camera that displays the screen and adjust the tracking television camera that displays the screen at the distance measured again by the tracking laser distance measuring device with the screen operation on the tracking television camera monitor screen 651.

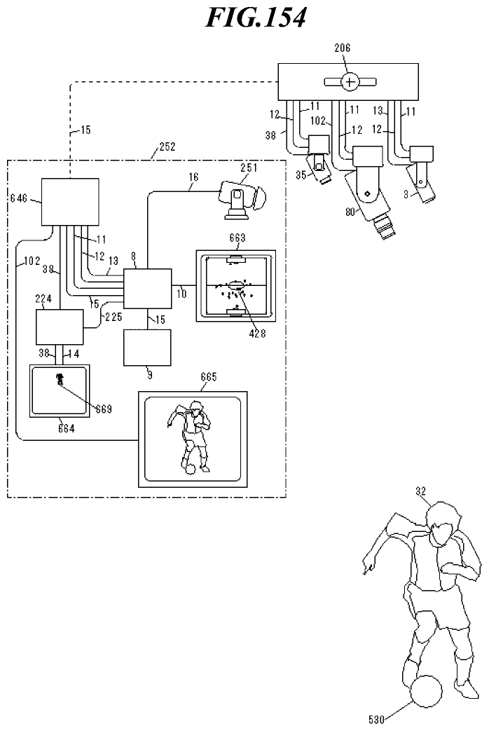

Example: In FIG. 154, a fish-eye lens fixed television camera 251 attached to a stadium tracking television camera system 252 installed above the center of the soccer field 647 in FIG. 153 photographs the entire venue pitch. Each fixed wire-mounted tracking television camera system 206 is positioned in advance to indicate the photographing direction of the numerically controlled television camera 35 which is set in the stadium pitch screen at the position on the fixed fish-eye television camera monitor screen that photographs the entire pitch with a fish-eye lens fixed television camera 251 attached to a stadium tracking television camera system 252, and the CG screen displaying the pitch and the fixed fish-eye television camera screen and the CG synthesis monitor screen 663.

The image-recognized position 669 of the ball on the numerically controlled television screen of the tracking camera system is manually instructed on the numerically controlled television camera monitor screen 664 of the tracking camera system photographed by the numerically controlled television camera 35 of the tracking television camera system 206 on each fixed wire rack at the indicated position 428 of the CG monitor screen of the tracking camera system on the fixed fisheye television camera screen and the CG synthesis monitor screen 663, which was photographed by the fisheye lens fixed television camera 251 and synthesized with the screen and the stadium pitch screen. The tracking laser distance measuring device 3 is directed to the image-recognized position 669 of the ball on the numerically controlled television screen of the tracking camera system on the numerical control television camera monitor screen 664 of the tracking camera system photographed by the numerical control television camera 35 incorporated in each fixed wire rack tracking television camera system 206, or in the manually instructed direction, and the distance of the soccer ball 530 kicked by the soccer player 32 is measured. The angle of view and focal length of the tracking television camera 80 are adjusted according to the measured distance, and the tracking television camera 80 photographs the tracking television camera monitor screen 665 of the tracking camera system.

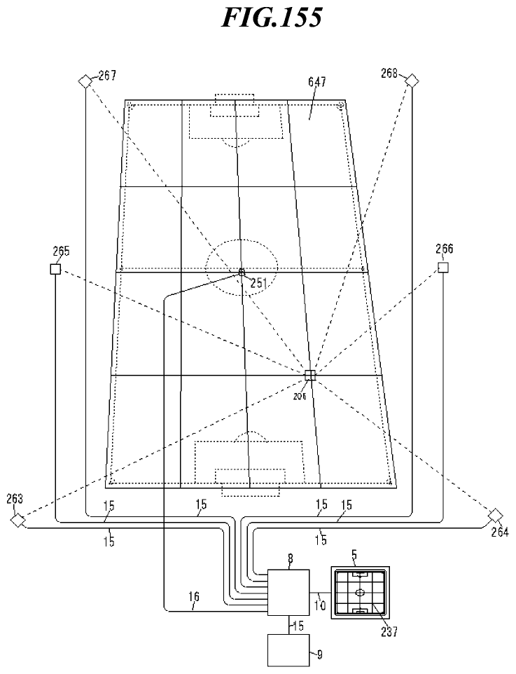

Example: The height distance of the measurement position 237 on the monitor screen of the composite screen between the fixed television camera monitor screen 5 photographed by fisheye lens fixed television camera 251 installed above the center of the pitch of 647 soccer field in FIG. 155 and the CG screen displaying the pitch is measured. The tracking television camera of the tracking television camera system 206 and the tracking laser distance measuring device 3 are directed directly downward, and the measured values of the pitch and the height are acquired at the pitch position of the soccer field 647, which corresponds to the measurement position 237 on the fixed television camera monitor screen on the fixed television camera monitor screen 5. The wire numerical drive system A 263, B 264, C 265, D 266, E 267 and F 268 for maintaining the height distance is driven to associate the driving numerical value of each numerical drive mechanism with the measured height distance 237 on the monitor screen on the screen 5 at all positions 206 of the soccer field 647 to be measured. At all positions on the fixed television camera monitor screen 5, the measured height distance is associated with numerical values that associate the driving numerical values of the respective numerical driving mechanisms by a method such as an interpolation method or the like by using several different measurement positions 237 on the monitor screen on the fixed television camera monitor screen 5 and the numerical value associated with the measured height distance and the driving numerical value of each numerical driving mechanism that operated the wire numerical driving mechanism system A 263, B 264, C 265, D 266, E 267, F 268.

At all positions on the fixed television camera monitor screen 5, at all height distances to be measured, numerical values that associate the driving numerical values of each numerical driving mechanism are associated by a method such as an interpolation method by using Several different measurement positions 237 associated with several distances of different heights to be measured on the monitor screen and the measured height distance and the numerical value associated with the driving numerical value of each numerical driving mechanism that operated the wire numerical driving mechanism system A 263, B 264, C 265, D 266, E 267 and F 268.

The relationship between all the positions on the screen photographed by the fisheye lens fixed television camera 251 associated with it, all positions on the CG screen, the position of the pitch of soccer field 647, the measured height and the driving numerical values for driving the driving mechanisms of the wire driving systems 263, 264, 265, 266, 267, 268 is calculated by interpolation and stored. The drive mechanism of wire numerical drive systems A 263, B 264, C 265, D 266, E 267, F 268 can drive the position 206 of the tracking television camera system rack with its drive number at all positions of the pitch of the soccer field 647 corresponding to all positions on the composite screen.

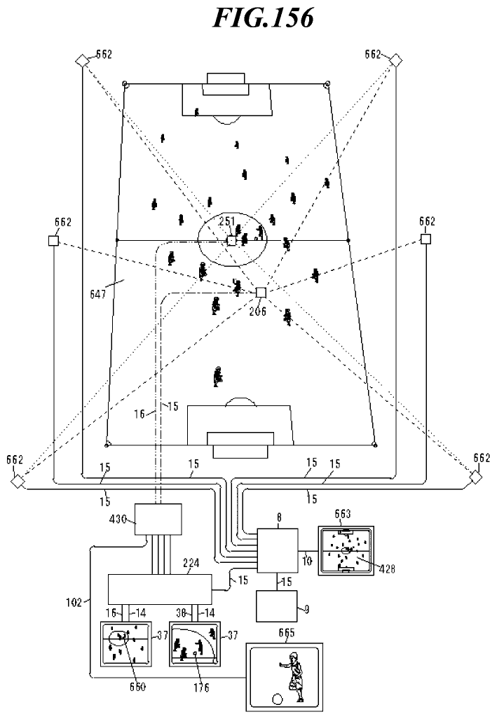

Example: While measuring the height from the ground and maintaining the distance, it moves according to instructions from the wire drive system 662 from each direction by the driving numerical value for driving the driving mechanism of the wire driving system is the numerical value already acquired by the calculation such as the interpolation method described above to move to the position corresponding to the indicated position 428 of the CG monitor screen of the tracking camera system on the fixed fish-eye television camera screen and the CG composite monitor screen 663 of the composite screen of the fixed television camera monitor screen 5 photographed with a fisheye lens fixed television camera 251 installed above the center of the pitch of soccer field 647 in FIG. 156 and the CG screen displaying the pitch, of the soccer field 647 pitch, to the position of the fixed wire rack tracking television camera system 206.

The numerically controlled television camera 35 incorporated in the tracking television camera system of the tracking television camera system 206 photographs in the indicated direction. In the indicated direction, the position of the soccer ball on the indicated position 660 of the numerically controlled television screen of the tracking camera system, which is photographed by the numerically controlled television camera 35 and displayed on the numerically controlled television camera monitor screen 37, is indicated. The tracking laser distance measuring device 3 is directed to the direction corresponding to the image recognition position of the soccer ball on the pointing position 660 of the numerical control television screen of the tracking camera system shown on the numerical control television camera monitor on screen 37, and the distance is measured. The position of the soccer ball displayed on the numerical control television camera monitor screen 37 according to the measured distance is image-recognized at the position 176 of the numerical control television camera screen of the tracking camera system.

The tracking laser distance measuring device 3 and the tracking television camera 80 are directed in the direction corresponding to the image recognition position 176 on the screen of the numerically controlled television camera of the tracking camera system, which is displayed on the numerical control television camera monitor screen 37 from the position where the tracking television camera system 206 was driven. Tracking laser distance measuring device 3 measures the distance to soccer ball 530. According to the measured distance, the tracking television camera 80 adjusts the angle of view and focal length to photograph the image of the soccer ball on the tracking television camera monitor screen 665 of the tracking camera system.

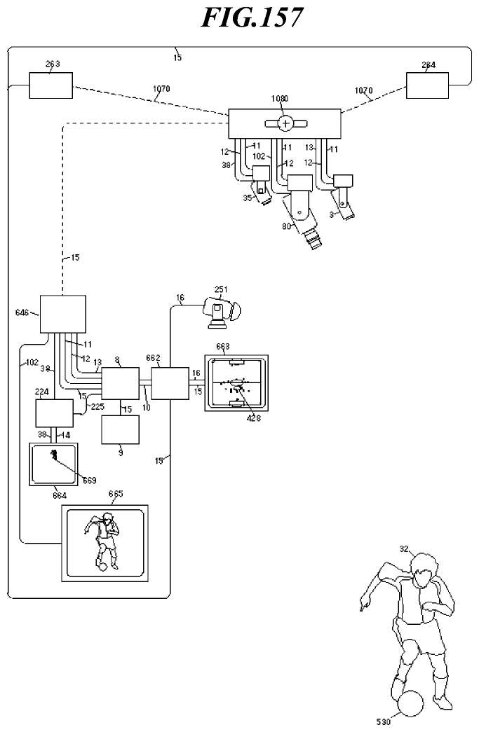

Example: Wire driving mechanisms 263, 264, 265, 266, 267 and 268 incorporated in the tracking television camera system are driven to move to positions in the optimum photographing direction at the position on the screen 663 composed of the fixed television camera monitor screen photographed by a fisheye fixed television camera attached to a tracking television camera system 252 at the top center of the pitch of soccer field 647 in FIG. 157, and the CG screen displaying the pitch.

At the instruction position 428 on the CG monitor screen of the tracking camera system on the CG soccer synthesis screen 663, the photographing direction of the numerically controlled television camera is indicated. The tracking laser distance measuring device 3 and the tracking television camera 80 incorporated in the tracking television camera system 1080 of the numerical control wire rack are directed toward the image-recognized position 669 where the image of the ball on the numerical control TV screen of the tracking camera system photographed by numerically controlled television camera 35 Tracking camera system on numerically controlled television camera monitor screen 664 is recognized or the direction of the manually instructed position, and the distance of the soccer ball 530 kicked by the soccer player 32 is measured. The angle of view and focal length of the tracking television camera 80 are adjusted according to the measured distance, and the tracking television camera 80 photographs the tracking television camera monitor screen 665 of the tracking camera system. The image of the ball displayed on the CG soccer synthesis screen 663 is photographed at the optimum distance and angle of view of the tracking television camera 80, which are set in advance at the detection position of the image of the ball.

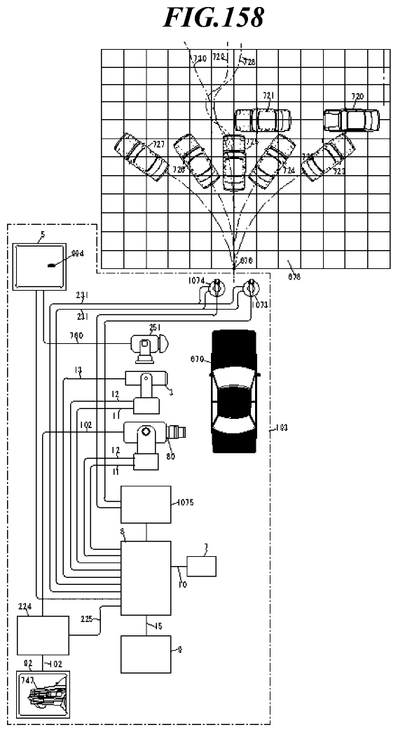

Example: Numerically controlled directional microphones A 1073 and B 1074, which can change the sound pickup direction by numerical control, are attached to the entire surface of the automatic driving data acquisition automobile 670 in FIG. 158. The phase difference of the sound picked up by each microphone is compared for each frequency band, and numerically controlled directional microphones A 1073 and B 1074 are driven and directed in the direction of the early phase. The numerically controlled directional microphones A 1073 and B 1074 are driven so as to match the driving numerical value of the driving mechanism in the direction where the phase difference is small. Turning at the tracking laser distance measuring device 3 and the tracking television camera 80, and the image of the sound source on the screen photographed by matching the angle of view and focal length of the tracking television camera 80 is recognized as an image of the 747 right-hand running car on the tracking television camera monitor screen 92 by the numerical value equivalent to the measured.

### INDUSTRIAL APPLICABILITY

Television satellite stations, Internet video sites, diversification of images, image recognition and security, sports education, stadiums, tourist facilities, measuring equipment, data maps, simple operation of robots, diversity of industrial robots, walking robots, automobiles Autonomous driving, car accident avoidance, car driving skill test, agricultural robot, logistics support robot, personal mobile device, safety support equipment, production site support equipment,

1. A method, comprising:
associating the driving numerical value of the driving position of the numerical controlled device with the numerical value acquired by measuring the distance and direction from the driving position by the distance measuring device of the numerical control,
acquiring the driving numerical values of all the driving positions of the numerical controlled device and related numerical values that relates with numerical values acquired by measuring the distances and directions from all the driving positions, wherein
the calculation is performed by using several different drive values of said numerical controlled device corresponding to several different driving positions of said numerical controlled device and numerical values measured the distances and directions from the several different driving positions by said numerically controlled distance measuring device by said numerically controlled distance measuring device by calculating with a formula such as the interpolation method.

2. The method according to claim 1, the method further comprising:
associating the driving numerical value of the driving position of the numerical controlled device with the numerical value acquired by measuring the distance and direction from the fixed position by said numerically controlled distance measuring device attached to the driving position of said numerical controlled device,
acquiring the driving numerical values of all the driving positions of the numerical controlled device and the related numerical values that relates with numerical values acquired by measuring the distances and directions from all the driving positions to the fixed position by said numerically controlled distance measuring device attached to the driving position of said numerical controlled device, wherein
the calculation is performed by using several different drive values of said numerical controlled device corresponding to several different driving positions of said numerical controlled device and values acquired by measuring the distance and direction from the several different drive positions to the fixed position by said numerically controlled distance measuring device attached to the driving position of said numerical controlled device by calculating with a formula such as the interpolation method.

3. The method according to claim 1, the method further comprising:
associating the driving numerical value of the driving position of the numerical controlled device with the numerical value acquired by measuring the distance and direction from the driving position by the distance measuring device of the numerical control at the position of an image of the driving position shown on a television camera monitor screen, which is photographed by a television camera,
acquiring the driving numerical values of all the driving positions of the numerical controlled device and the related numerical values that relates with all numerical values acquired by measuring the distances and directions from all the driving positions by said numerically controlled distance measuring device at the position of the image of all the driving positions photographed, wherein
the calculation is performed by using numerical values associating the several different numerical values of the distances and directions measured by the numerically controlled distance measuring device at the several different driving positions with the driving numerical values of the several different driving positions of the numerical controlled device at the positions of images of the several different driving positions photographed by said television camera and displayed on the television camera monitor screen by a television camera and displayed on the television camera monitor screen by calculating with a formula such as the interpolation method.

4. The method according to claim 1, the method further comprising:
associating the driving numerical value of the driving position of the numerical controlled device with the numerical value acquired by measuring the distance and direction from the fixed position by said numerically controlled distance measuring device attached to the driving position of said numerical controlled device at the position of an image of the fixed position shown on a television camera monitor screen, which is photographed by a television camera attached to the driving position of said numerical controlled device and photographs the fixed position,
acquiring the driving numerical values of all the driving positions of the numerical controlled device and the related numerical values that relates with all numerical values acquired by measuring the distance and direction from the numerically controlled distance measuring device attached to the driving position to the fixed position at the positions of all fixed-position images on a television camera monitor screen photographed by the television camera mounted in the driving position at the positions of all fixed-position images on a television camera monitor screen photographed by the television camera mounted in the driving position, wherein
the calculation is performed by using numerical values associating the several different numerical values of the distances and directions measured by the numerically controlled distance measuring device attached to the driving position of said numerical controlled device at the several different driving positions with the driving numerical values of the several different driving positions of the numerical controlled device at the positions of images of the several different driving positions photographed by said television camera and displayed on the television camera monitor screen by calculating with a formula such as the interpolation method.

5. The method according to claim 1, wherein:
measuring the distance and direction between the image and the subject by said numerically controlled distance measuring device from the position of the television camera regarding the image photographed by the television camera and confirmed on the Television camera monitor screen;
developing the image with the numerical values of the measured distance and direction on the screen of the television camera of the television camera, where the television camera continuously moves or is photographs by the television camera at different related positions.

6. The method according to claim 1, wherein:
measuring the distance and direction of the position of the recognized image on the television camera monitor screen shot by the television camera with the numerically controlled distance measuring device;
displaying the television camera monitor screen as a three-dimensional image by adding the measured numerical value to the two-dimensional image of the television camera monitor screen.

7. The method according to claim 1, wherein:
measuring the distance and direction of the position of the recognized image on the television camera monitor screen photographed by the television camera with the numerically controlled distance measuring device;
operating the numerical controlled device at the position of the image on the television camera monitor screen using the measured values.

8. The method according to claim 1, characterized by:
setting a numerical value acquired by measuring a distance and a direction with the numerically controlled distance measuring device as the driving range of the numerically controlled device.

9. The method according to claim 1, characterized by:
operating the numerical controlled device in the shape of the recognized image on the television camera monitor screen photographed by the television camera or the television camera attached to the driving position of the numerical controlled device.

10. The method according to claim 1, characterized by:
measuring the distance and direction of the driving position of the numerical controlled device on the screen of the television camera monitor photographed by the television camera with the distance measuring device of the numerical control;
operating the numerical controller with an image in which numerical values of distance and direction are added to the driving position on the television camera monitor screen.

11. The method according to claim 1, characterized by:
measuring the distance and direction of the subject of the image on his television camera monitor screen photographed by the television camera with the numerically controlled distance measuring device,
photographing a image with a television camera driven by the numerical control in relation to the measured numerical value.

12-80. (canceled)
